(19) United States
(12) Patent Application Publication
(10) Pub. No.: US 2012/0226536 A1
(43) Pub. Date: Sep. 6, 2012

(54) Encryption-Free Content Purchase Platform Apparatuses, Methods And Systems

(76) Inventor: Adam Kidron, Bronx, NY (US)

(21) Appl. No.: 13/248,024

(22) Filed: Sep. 28, 2011

Related U.S. Application Data
(60) Provisional application No. 61/526,210, filed on Aug. 22, 2011.
(60) Provisional application No. 61/496,512, filed on Jun. 13, 2011.
(60) Provisional application No. 61/387,450, filed on Sep. 28, 2010.
(60) Provisional application No. 61/387,453, filed on Sep. 28, 2010.

(51) Int. Cl. G06Q 30/02

(52) U.S. Cl. 705/14.23

(57) ABSTRACT

The ENCRYPTION-FREE CONTENT PURCHASE PLATFORM APPARATUSES, METHODS AND SYSTEMS (“ECPP”) transform content seed selections and recommendations via ECPP components such as discovery and social influence into events and discovery of other contents for users and revenue for right-holders. The ECPP may obtain from a user of a universally resolvable media content (“URMC”) service a request to purchase an unlocked URMC item. The ECPP may obtain the user's social influence metric in the service and a purchase price associated with the URMC content item. The ECPP may further determine, based on the user's social influence metric, a discount. The ECPP may receive from the user an indication and an authorization to purchase the URMC item, and in response, may charge an account associated with the user the purchase price reduced by the discount. The ECPP may provide the user a mechanism for unlocking the URMC item.

### CLAIM FOR PRIORITY

This application claims priority to and benefit from International Application Number PCT/US2011/53780, filed 28 Sep. 2011, and titled CONTENT DISCOVERY AND DELIVERY PLATFORM APPARATUSES, METHODS AND SYSTEMS (Attorney Docket No. 20676-012PC); U.S. Provisional Application Ser. No. 61/526,210 filed on Aug. 22, 2011 titled CONTENT DISCOVERY AND DELIVERY PLATFORM APPARATUSES, METHODS AND SYSTEMS (Attorney Docket No. 20676-012PV1); U.S. Provisional Application Ser. No. 61/496,512 filed on Jun. 13, 2011 titled CONTENT DISCOVERY AND DELIVERY PLATFORM APPARATUSES, METHODS AND SYSTEMS (Attorney Docket No. 20676-012PV); U.S. Provisional Application Ser. No. 61/387,450 filed on Sep. 28, 2010, titled APPARATUSES, METHODS AND SYSTEMS FOR A MOLECULAR MULTIMEDIA SEARCH PLATFORM (Attorney Docket No. 20676-003PV); and U.S. Provisional Application Ser. No. 61/387,453 filed on Sep. 28, 2010 titled APPARATUSES, METHODS AND SYSTEMS FOR A MULTIMEDIA PIVOT SEARCH PLATFORM (Attorney Docket No. 20676-004PV).

The entire contents of the aforementioned applications are herein expressly incorporated by reference.

### APPLICATIONS OF INTEREST

Applications of interest include: International Application Number PCT/US2009/061296, filed 20 Oct. 2009, and entitled A METHOD AND SYSTEM FOR ACCOUNTING FOR DOWNLOAD TRANSACTIONS AND SOCIAL NETWORK INTERACTION; International Application Number PCT/US2009/061307, filed 20 Oct. 2009, and entitled A METHOD AND SYSTEM FOR ACCOUNTING FOR DOWNLOAD TRANSACTIONS AND SOCIAL NETWORK INTERACTION; and International Application Number PCT/US2009/061309, filed 20 Oct. 2009, and entitled A METHOD AND SYSTEM FOR ACCOUNTING FOR DOWNLOAD TRANSACTIONS AND SOCIAL NETWORK INTERACTION.

The entire contents of the aforementioned applications are herein expressly incorporated by reference.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present innovations are directed generally to apparatuses, methods, and systems for multimedia applications, and more particularly, to ENCRYPTION-FREE CONTENT PURCHASE PLATFORM APPARATUSES, METHODS AND SYSTEMS.

### BACKGROUND

Consumers of music and other multimedia have several options to purchase music that they like. They may go to music retail stores such as BEST BUY, TARGET or other independent stores and purchase a copy of their desired album packaged in the ubiquitous compact disc (CD) format. Consumers may also purchase digital copies of music from online music stores such as ITUNES and AMAZON, and subscription based services from service providers such as NAPSTER.

### BRIEF DESCRIPTION OF THE DRAWINGS

The accompanying appendices and/or drawings illustrate various non-limiting, example, innovative aspects in accordance with the present descriptions:

FIG. 1 shows a diagram illustrating discovery aspects in one embodiment of the ECPP;

FIG. 2 shows a diagram illustrating example modes of discovery in some embodiments of the ECPP;

FIG. 3 shows an example data flow illustrating generation of a magic playlist in some embodiments of the ECPP;

FIGS. 4a-b are logic flow diagrams illustrating magic playlist generation component in one embodiment of the ECPP;

FIG. 4c-d are data flow diagrams illustrating remote client play in some embodiments of the ECPP;

FIG. 4e is a logic flow diagram illustrating non-local content cache component in some embodiments of the ECPP;

FIG. 4f is a logic flow diagram illustrating smart caching component in some embodiments of the ECPP;

FIG. 5 shows a logic flow diagram illustrating stagelight/spotlight search in some embodiment of the ECPP;

FIG. 6a shows an example shared discovery in some embodiments of the ECPP;

FIG. 6b shows an example shared discovery settings configuration in some embodiments of the ECPP;

FIGS. 7a-c show logic flow diagrams illustrating shared discovery components in some embodiments of the ECPP;

FIG. 8a shows a logic flow diagram illustrating the Gurus rewarding component in some embodiments of the ECPP;

FIG. 8b shows a logic flow diagram illustrating the Gurus offer delivery and redemption component in some embodiments of the ECPP;

FIGS. 9-14 are schematic views of the example ECPP application interface in some embodiments of the ECPP;

FIGS. 15a-g are schematic views of the example stagelight/spotlight interface in some embodiments of the ECPP;

FIGS. 16a-c are schematic views of the discover stream component in some embodiments of the ECPP;

FIGS. 17a-f are schematic views of the discover lens component in some embodiments of the ECPP;

FIGS. 18a-c are schematic views of the discover stacking component in some embodiments of the ECPP;

FIGS. 19a-h are schematic views of the molecular discovery component in some embodiments of the ECPP;

FIGS. 20a-n are schematic views of the example mobile application interfaces in some embodiments of the ECPP;

FIGS. 21a-b are schematic views of the example mobile application molecular interfaces in some embodiments of the ECPP;

FIG. 22a is a data flow diagram of an example content identification component in some embodiments of the ECPP;

FIG. 22b is a logic flow diagram illustrating an example content identification in some embodiments of the ECPP;

FIG. 23 is a logic flow diagram illustrating an example license acquisition component in some embodiments of the ECPP;

FIGS. 24a-b are data flow diagrams illustrating example licensing component in some embodiments of the ECPP;

FIG. 24c is a logic flow diagram illustrating an example license acquisition component in some embodiments of the ECPP;

FIG. 25 is a data flow diagram illustrating an example usage reporting component in some embodiments of the ECPP;

FIGS. 26a-b are logic flow diagrams illustrating example play count reporting components in some embodiments of the ECPP;

FIG. 27 is a logic flow diagram illustrating an example royalty reporting component in some embodiments of the ECPP; and

FIG. 28 shows a block diagram illustrating embodiments of a ECPP controller.

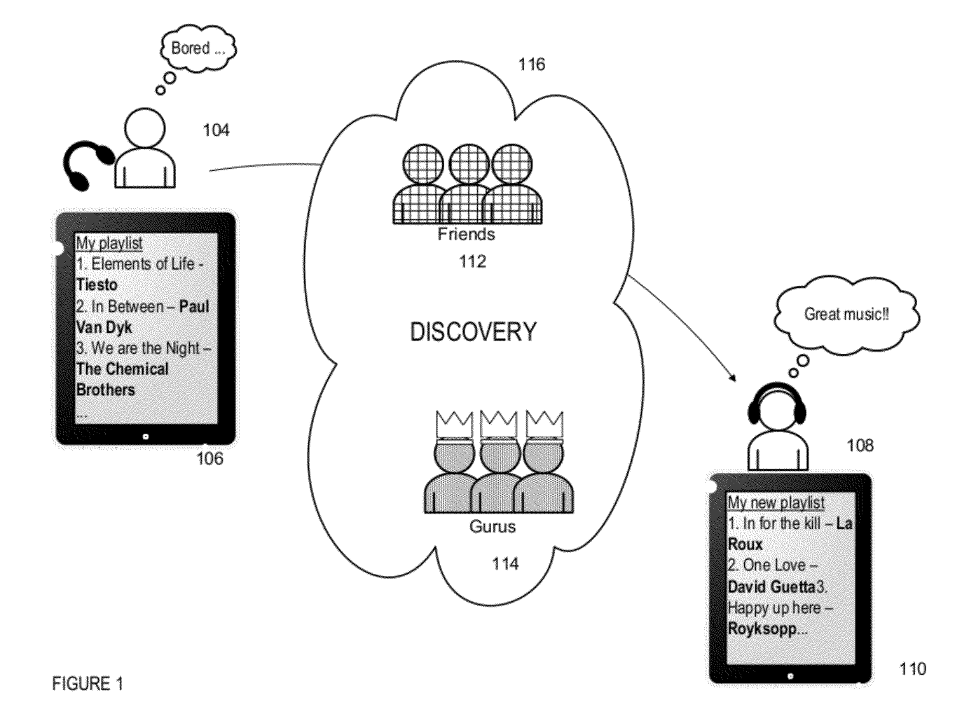

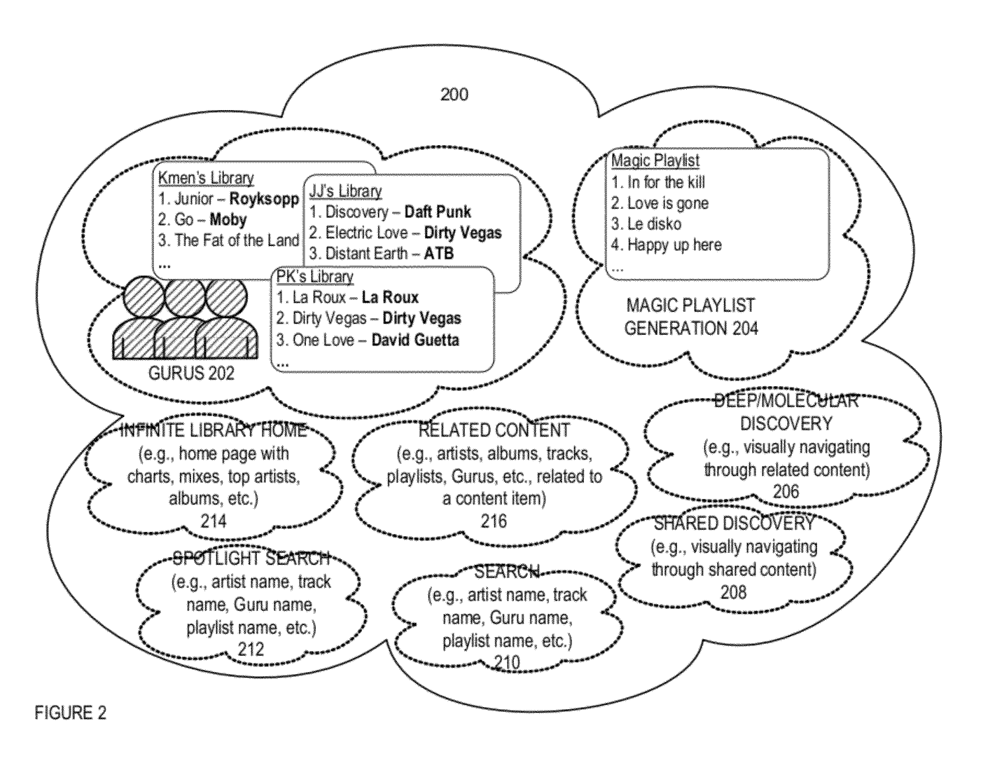

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Ecpp

In one embodiment, the ECPP allows unlimited, lifetime-of-device and lifetime-of-ownership access to a comprehensive catalog of music (“Infinite Music Library,” “universal music library, “ECPP catalog”) on licensed devices (LDs). Such LDs support digital rights management (DRM) and adhere to the ECPP specification for reporting instances of digital downloads and/or plays (“play count”). LDs include a licensed ECPP client (“application”), a full-features music management application providing access to a comprehensive catalog of music via catalog browsing, music discovery, social networking, track download and playback, and/or the like.

In some embodiments, the ECPP may include facilities for music downloads, music playback controls, library management, playlist management and sharing, license activation, account registration, artist, album or Guru browsing, automatic disc-space management features, music search, a variety of discovery interfaces include molecular, lens, streaming and stacking discovery interfaces, automatic playlist synchronization to the universal music library, and across one or more user devices, user library reconciliation (“beyondization”), side-loaded device management, direct social interaction through the ECPP community and extended social interaction with existing online communities such as FACEBOOK, MYSPACE, TWITTER and LINKEDIN, player add-ons that extend the capabilities of the ECPP application in search, recommendation, sharing and discovery, and/or the like.

In some embodiments, the ECPP may include a web-based browser interface with search, discovery, cloud-based content sync, social music features and other components. For example, a ECPP user (“user,” “consumer” or “customer”) may download tracks, albums or playlists, may obtain song previews or listen to full length tracks, learn more about artists and their music, and discover related artists and their music.

In some other embodiments, the ECPP may include a portal or an application client for web-based partner (B2B) account management and partner interface functioning as the face of the one or more databases and/or tables. Some components of the ECPP may account for and pay copyright owners royalties, in a way that ASCAP, Harry Fox, SESAC or BMI may do, for each and every play of a digital music file on an LD. Copyright owners, including record labels, publishers, and other entities associated with content rights are referred to as partners.

The ECPP catalog includes a large number of content items that have been cleared for legal distribution and sharing among the ECPP users. Each content item in the ECPP catalog is uniquely identified. Some embodiments of the ECPP may facilitate assigning of unique identifier for licensed and distributable music. Other embodiments of the ECPP may further facilitate assigning of unique identifiers for unlicensed music on a local client device, thereby uniquely and universally resolving each content item.

The ECPP's user interfaces facilitate several modes of content discovery. Content discovery may allow users to discover new music, new social connections, new information, and/or the like. The ECPP may further facilitate users to expand and/or refine their own music preferences and knowledge base from others users' usage history, playlists, favorites, etc. In some embodiments, discovery may be driven by driven by a variety of factors including Gurus, personal usage patterns and/or content meta data. In other embodiments, discovery may be facilitated by a variety of visually engaging and interactive user interfaces.

As such, aspects of the ECPP facilitate discovery, sharing, playback, and secure usage data aggregation and reporting, and/or the like.

The ECPP application may run on a variety of operating system platforms including Windows, Macintosh, iOS (Apple iPhone, iPod Touch, etc.), Android, Symbian, Java/J2ME, Samsung Bada, Windows Mobile 7, RIM Blackberry, HP Palm WebOS, Google Chrome, set top boxes (Linux), automotive devices, other mobile handsets, portable media players and consumer electronic devices. In some implementations, manufacturers may install a copy of the application in devices during manufacturing. The ECPP application may also be installed on devices, post-manufacture, by device resellers (e.g., mobile carriers), by technicians at a point-of-sale location, or by consumers themselves (e.g., from a website, an application store for mobile devices, web stores such as Chrome web store, etc.).

FIG. 1 shows a diagram illustrating discovery aspects in one embodiment of the ECPP Platform. As illustrated in the diagram, a user 104/108 may be uninterested in his or her current selection of music on his or her LD. He or she may desire to know not just what is currently popular, or on the top 40 lists, but also what his or her friends are listening to, which tracks are being recommended, and/or the like. The discovery interface 116 facilitates the discovery of music which the user may enjoy using LDs 106/110.

In one implementation, the discovery interface 116 may include a network of friends 112 and/or subject experts known as “Gurus” 114 through whom the user 104/108 may discover music. Gurus are users who have opted in to the Guru program which is discussed in detail with respect to the Guru program component.

FIG. 2 shows a diagram illustrating example modes of discovery in some embodiments of the ECPP. Examples modes of discovery 200 include, for example, Gurus 202, magic playlist 204, deep/molecular discovery 206, shared discovery 208, search 210, stagelight/spotlight search 212, infinite library home 214, and/or the like. Each of these modes of discovery 200 is discussed in greater detail below.

### Magic Playlist Generation (MPG) Component

Magic playlists are automatically generated playlist of content related to a “seed” item such as an artist, an album, a track, a playlist, another user or a combination thereof. In one embodiment, a magic playlist generation algorithm may utilize historical (e.g., listening/usage history), social (e.g., what friends are listening to), usage, profile, Gurus, track rating, crowd sourcing and other data to create a magic playlist. In one implementation of the MPG algorithm, these factors may be weighted using one or more weighting criteria. For example, in one implementation, a “social” weighting criterion may be selected. Such “social” criteria may result in more weight being accorded to social factors such as friends' listening history, Guru recommendations, crowd sourcing, etc. Similarly, other criteria may include personal usage (e.g., emphasis on the listener's usage history), profile (e.g., emphasis on the listener provided profile information), promotional (e.g., emphasis on music promoted by advertisers or other third parties), music traits (e.g., emphasis on music trait analysis), and/or the like. In some implementations, a combination of one or more of these criteria may be utilized to identify tracks that a user is likely to enjoy and/or share with other users.

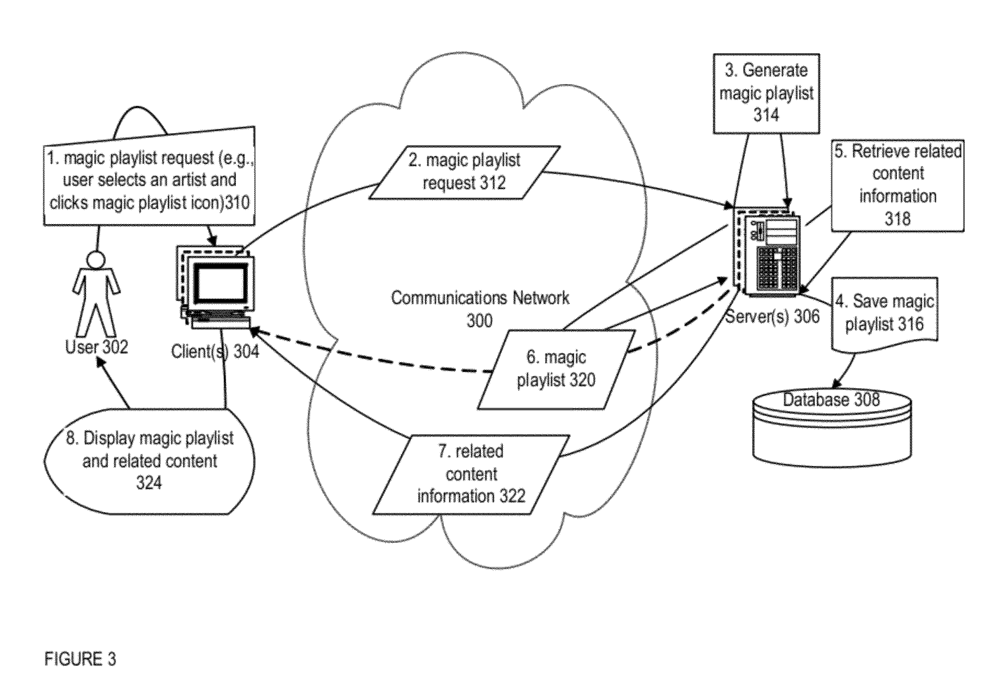

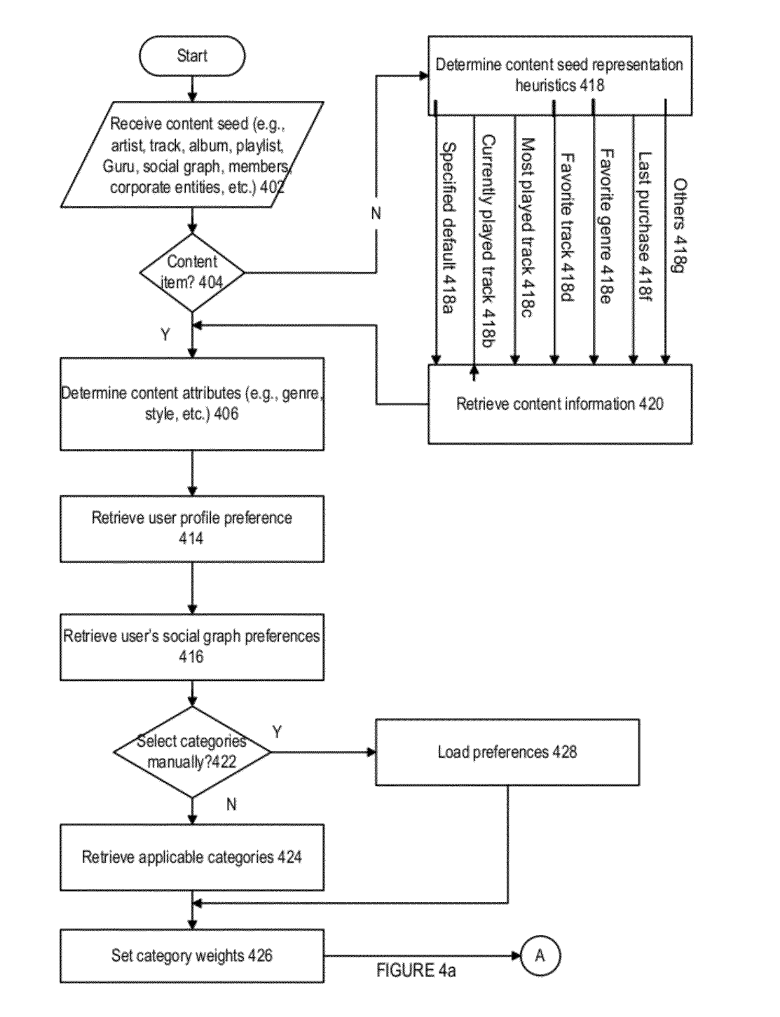

FIG. 3 shows an example data flow illustrating generation of a magic playlist in some embodiments of the ECPP. As shown in FIG. 3, in one implementation, a user 302 may request a magic playlist at 310 by selecting, for example an artist, as a content seed and clicking a “magic playlist” icon. In one implementation, the magic playlist request may be packaged as an HTTP(S) POST message for transmission to the servers 306. An example magic playlist request message 312 formatted in the eXtensible Markup Language (XML) form may be as follows:

```
POST /magicplaylist.php HTTP/1.1
Host: www.websitename.com
Content-Type: Application/XML
Content-Length: 1306
<?XML version = “1.0” encoding = “UTF-8”?>
<MagicPlaylist>
          <Username>dingdong555@gmail.com</Username>
          <Timestamp>2011-02-22 15:22:43</Timestamp>
          <ClientDetails>
                <ClientIP>192.168.23.126</ClientIP>
                <ClientType>smartphone</ClientType>
                <ClientModel>HTC Hero</ClientModel>
                <OS>Android 2.2</OS>
                <AppIinstalledFlag>true</AppInstalledFlag>
          </ClientDetails>
          <EventDetails>
                <Event>create magic playlist</Event>
                <SeedType>artist</SeedType>
                <SeedName>pink floyd</SeedName>
          </EventDetails>
</MagicPlaylist>
```

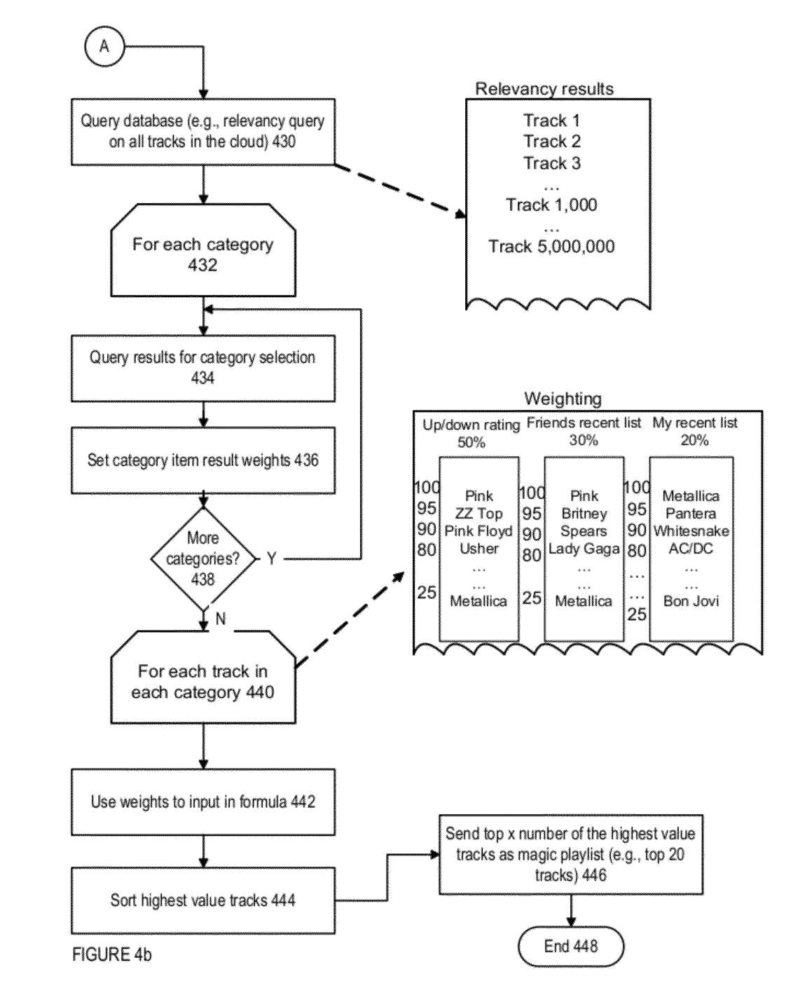

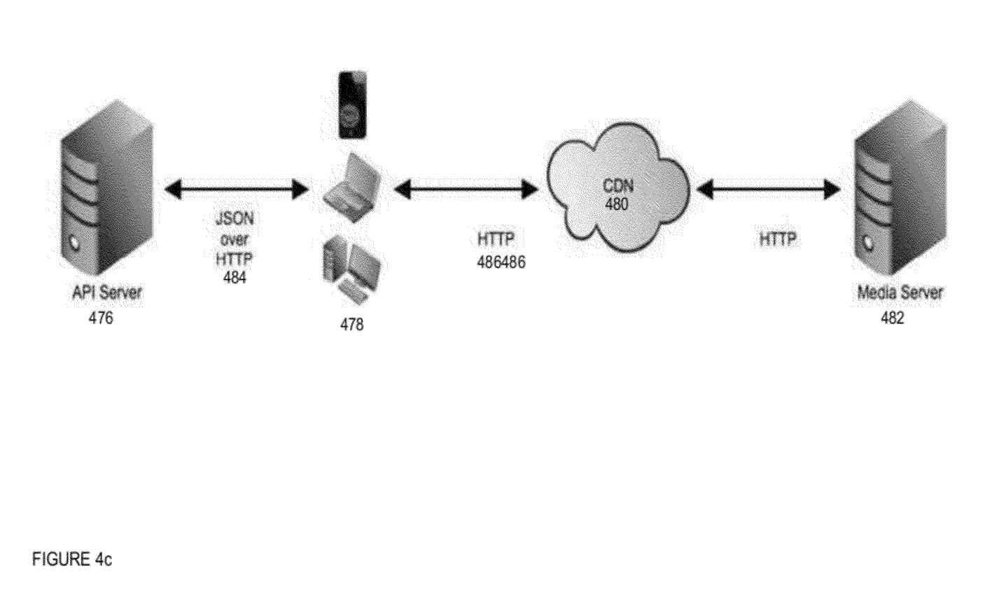

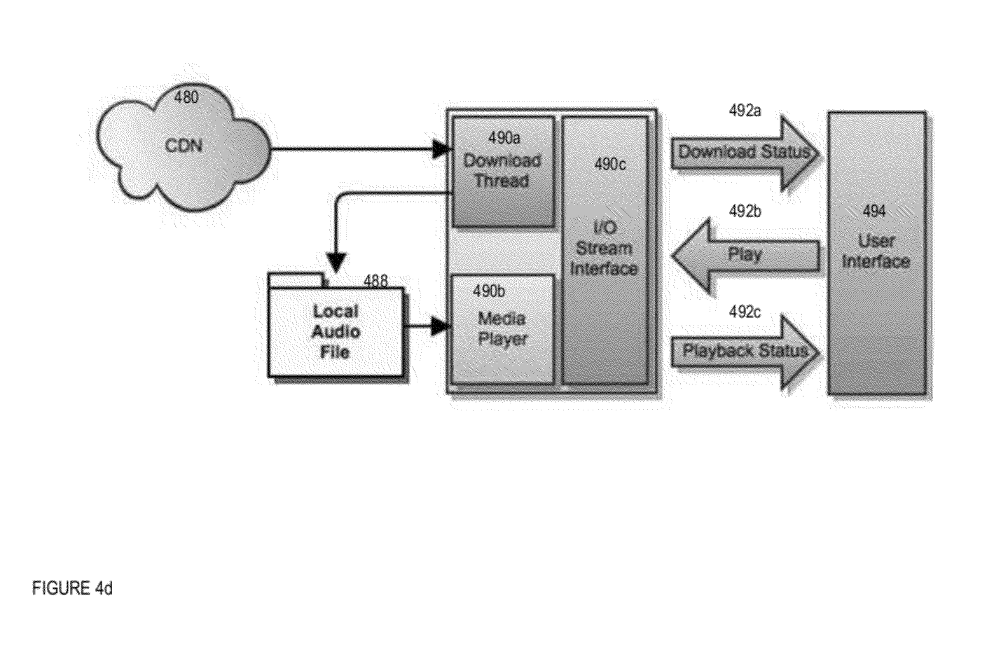

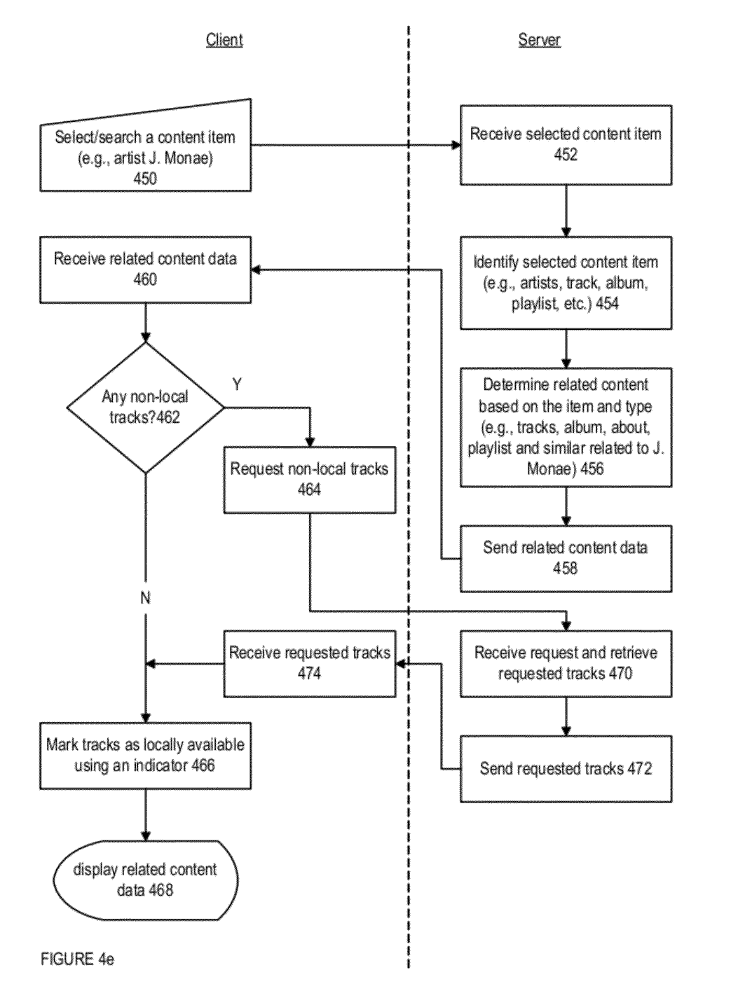

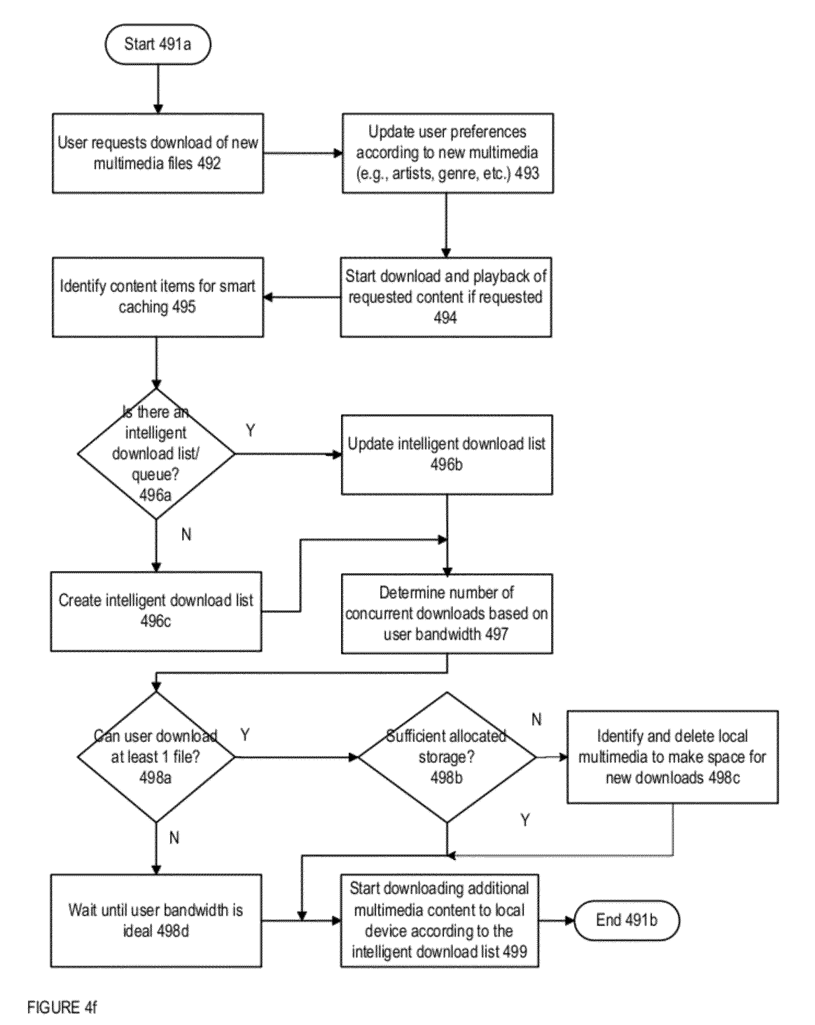

The magic playlist request message 312 may be transmitted to the servers 306 over the communication network 300 for further processing. In one implementation, the request 312 may be routed to those servers that are geographically proximal to the location of the user's client device 304. At 314, the servers may initiate generation of the requested magic playlist that may include a list of tracks selected based on the seed item and/or other factors. In one implementation, the servers 306 may execute the magic playlist generation algorithm to obtain a list of tracks for the requested magic playlist. Details of the magic playlist generation algorithm(s) are discussed with respect to FIGS. 4a and 4b.

At 316, the created magic playlist may be saved in a playlist database 308. The playlists in the playlist database 308 may be available to all users or may be subject to restrictions imposed by the respective creators. At 318, content related to the magic playlist tracks may be retrieved. For example, if the magic playlist includes a track by the artist “Eagles,” the related content may include, for example, a list of playlists including the same track that are created and shared by other users. Similarly, information such as similar artists, albums corresponding to the tracks, etc., may also be retrieved. Identification of related content information is further discussed in detail with respect to the Smart Caching component.

At 320, the generated magic playlist may be sent by the servers 306 over the communications network 300 to the client device 304. At 322, the related content information may also be sent over the communications network 300 to the client device 304. In one implementation, the response message 320 and/or 322 from the servers 306 may include track IDs and thumb nail images corresponding to the tracks in the magic playlist. In a further implementation, the response message 320 and/or 322 may also include information on related tracks, artists, albums, playlists including the magic playlist tracks, Gurus associated with the magic playlist tracks, and/or the like. The response message may specifically include track names, track IDs, album names, album IDs, artist names, artist IDs associated with the related content. An example response message 320 and/or 322 may be in XML format substantially in the following form:

```
<XML>
  <MagicPlaylist>
    <PlaylistInfo>
      <Username>dingdong555@gmail.com</Username>
      <Timestamp>2011-02-22 15:23:00</Timestamp>
      <PlaylistName>Pink Floyd Magic Playlist</PlayListName>
      <PlaylistImg>DM2345.png</PlaylistImg>
      <SeedType>artist</SeedType>
      <SeedName>pink floyd</SeedName>
    </PlayListInfo>
    <TrackIDInfo>
      <TrackID1>6786865</TrackID1>
      .
      .
      .
      <TrackID20>342554</TrackID20>
    </TrackIDInfo>
    <TrackImgInfo>
      <TrackImg1>DM3243.png</TrackImg1>
      .
      .
      .
    </TrackImgInfo>
    <RelatedArtistInfo>
      <RelatedArtist1>Genesis</RelatedArtist1>
      .
      .
      .
      </RelatedArtist9>Peter Gabriel</RelatedArtist9>
    </RelatedArtistInfo>
    <RelatedPlaylistInfo>
      <Playlist1>Jeb loves Roger Waters</Playlist1>
      <Playlist2>Jenna's Wall</Playlist2>
      .
      .
      .
    </RelatedPlaylistInfo>
  </MagicPlaylist>
</XML>
```

In one implementation, the ECPP client may receive the message 320 and/or 322 and may parse the received message to extract the track IDs. The ECPP client may also use the extracted track IDs to retrieve and display track information such as track name, track length, location of the track (e.g., local library, cloud library or connected device library), images, and/or the like.

In some implementations, the ECPP client may keep a log of various events associated with playlists which may include magic playlists. For example, a user may remove a track that was part of a playlist, and may create a new version of the playlist without the removed track. As another example, a user may reorder the tracks within a playlist in a different sequence. Example playlist events logged by the ECPP client may include, but is not limited to: tracks removed from the playlist, name of artist upon which magic playlist was created, name of track upon which magic playlist was created, name of tracks in playlist, name of playlist upon which magic playlist was created, name of album upon which magic playlist was created, total times a playlist was renamed (track composition may or may not have changed), total times playlist was reordered, and/or the like. The log may be periodically uploaded to the ECPP server(s).

FIG. 4a is a logic flow diagram illustrating MPG component in one embodiment of the ECPP. In one implementation, the ECPP may receive seed item information such as an artist, a track, an album, a playlist, a Guru, and/or the like at 402, which is provided as an input to the MPG algorithm. The seed item may be universally resolvable. A user may provide this information by selecting or entering the seed item. If the seed item is a content item as determined at 404, one or more content attributes that define the seed item may be extracted at 404. Examples of content attributes may include, for example, track meta data information such as album, artist, comment, copyright, title, track, performers, genre, label, cover art, song length, a globally unique identifier (GUID), and/or the like. The content attributes may further include stylistic traits such as female vocal, electric guitar, tonality, tempo, bass, etc. and/or the like.

If the user provided content seed is not a content item, the content seed may be analyzed using several heuristics. Examples of non-content items, i.e., items that are not content and do not have a corresponding media file, may include, for example, a friend name, a Gurus name, mood, tempo, comment and/or the like. At 418, content seed representation heuristics may be determined. Examples of the content seed representation heuristics may include a specified default or predetermined item 418a, currently played track 418b, most played track 418c, favorite track 418d, favorite genre 418e, last purchase 418f, others 418g and/or the like. These representative heuristics may also be derived from aggregated correlation among entire community of users, circle of friends or entity graph.

In some implementations, entity graph may include social graph and interest graph. Social graph may include categories of friends and/or acquaintances from social networks such as FACEBOOK, MYSPACE, TWITTER, GOOGLE+, and/or the like. Social graph may also include categories of friends and acquaintances from the ECPP community and/or other communication media such as instant messengers, contacts from address books, and/or the like. Interest graph may include categories of friends and acquaintances from any of the above social networks and the ECPP community who have an interest profile similar to a user. Additionally, an interest graph of a user is more expansive and may include people that do not have a social relationship with the user, but with who the user may share similar interests, usage pattern, listening history, and/or the like. In addition to people, entities may also include organizations and companies reachable through any of the mentioned social networks, ECPP community network and other communication media.

Referring to FIG. 4a, content information pertaining to one or more of these heuristics may be retrieved at 420. For example, for the last purchase heuristic 418f, an album ID or a track ID corresponding to the last purchase made by the user may be obtained. Now that the non-content item seed is transformed using heuristics to a content item seed, the attributes of the content item seed may be determined at 406.

At 414, user profile preference information may be retrieved. The user profile preference information may include user provided information such as favorite artist, favorite genre, album, etc. Such information may be provided by the user during registration, profile creation or profile update. The user profile preference may also be derived from the user's ECPP profile. The ECPP profile may be an “in house” profile organically built over time using information learned from the user, such as listening history. The ECPP profile may include not only information such as the user's preferred album, tracks, artists, genre and other attributes, but also a breakdown of the user's preferences according to location, time, mood (e.g., mood indicated by the user's mood status) and/or the like. For example, the ECPP may track and analyze the user's listening history over time to surmise that the user is likely to listen to ambient music late at night, rock music in early morning, and instrumental music at midday, etc. Furthermore, the user profile preference information may facilitate the ECPP's efforts to pre-fetch tracks in anticipation of the user's desire to listen to such pre-fetched tracks.

Further at 416, the user's social graph information may be retrieved. Social graph information may include friends, family, acquaintances, corporate entities, and/or the like. Social graph connections may exist within the ECPP network as well as other social network sites such as FACEBOOK, TWITTER and LINKEDIN. Using the social graph information, the ECPP may obtain information such as music his or her friends are interested, their listening history, playlists, currently played, most played, favorite, last purchased tracks, artists or albums, and/or the like. In a further implementation, the degree of separation and/or degree of friendship between the user and members of his or her social network may be taken into consideration. The degree of friendship may be established using information provided by the user and/or information derived from the frequency of communication exchanged between two users, existence of similar relationship in multiple social networks, and/or the like. The degree of separation may be established using the social graphs of various users in the network.

In one implementation, one or more weighting categories may be established in order to determined a magic playlist that embodies not just the musical attributes, but also one or more social and personal preferences. These categories may be selected manually at 422, which may trigger a dialog box requesting, for example, the user to select or input one or more social/personal categories that should be considered. The user selected category preferences may then be loaded at 428. On the other hand, these categories may be predefined parameters in the algorithm, in which case, applicable categories may be retrieved at 424. These categories may include, for example, the user's listening history, thumbs up/down rating of tracks, Guru rating of tracks, the user's friends' listening history, most recently played, most frequently played, most shared, most purchased, recently released, day/time preferences, and/or the like. Further, each category may be assigned its category weight. In one implementation, these category weights may be predetermined and as such, set by the ECPP at 426. In an alternate implementation, these category weights may be included in the loaded preferences specified by the user at 428. The user, when asked for category selections, may also be requested to specify how important that category is for the user. (For e.g., How important is social influence—select one: (a) very important, (b) not so important or (c) indifferent).

Referring now to FIG. 4b, the extracted content attributes, along with the retrieved user profile preferences and social graph information, may be utilized to form a query for searching a list of content items that have matching or similar content attributes. Such a search may be executed on one or more databases and/or tables of the ECPP at 430. Further, such a search may be executed for relevancy, popularity, aggregated popularity, and/or the like. Relevancy, for example, may be established in various ways. Consider, for example, an artist ATB as a seed item. ATB may have attributes such as trance roots, dance feel and female vocal. A relevancy search based on these attributes may find other artists/tracks having these attributes. Further, a three attribute match may be considered more relevant than a two-attribute match. In some implementations, relevancy search may be based on fingerprinting technologies provided by third party services such as Gracenote.

At 432, for each heuristic category, the magic playlist algorithm may be used to identify content items for the magic playlist. A query based on each content criterion may be constructed and run on one or more databases and/or tables at 432. Although each query may result a small or large number of results, only the first n number of results having high similarity metric may be selected. At 436, the category weight may be assigned to each category items obtained from the query. The process may continue until all the category item results have been assigned category weights. When all the categories have been exhausted at 438, each content item result for each category may be assigned a position factor or ranking based on relevance at 440. In one implementation, the algorithm may determine “relevancy” by calculating a relevancy score for each identified track. Table 1 below illustrates example results from a query based on four criteria and the calculation of the relevancy score for each unique result.

CATEGORY (C)

| POSITION (P) | 1 | 2 | 3 | 4 |
|---|---|---|---|---|
| 10 | Track A | Track B | Track C | Track D |
| 9 | Track X | Track A | Track Y | Track A |
| 8 | Track B | Track P | Track Q | Track E |
| 7 | Track C | Track R | Track F | Track J |
| . . . | . . . | . . . | . . . | . . . |
| 1 | Track Q | Track J | Track J | Track A |

For each unique track t, based on the category weight (C) and the position weight (P), the relevancy score may be calculated as below in one implementation:

$${S}_{t = 1 to x} = {\sum }_{j = 1}^{M} {\sum }_{k = 1}^{N} {C}_{j} \times {P}_{jk}$$

Where, S=relevancy score, x=track, j=category and k=position in the list. In this example, M=4 and N=10.

At 442, the weights (category and position) may be used to input in the formula above to obtain the relevancy score for each unique track identified. The highest value tracks i.e., the unique tracks having the highest relevancy scores S may be sorted at 444. At 446, top x number of the highest value tracks (e.g., 20 tracks) may be selected for inclusion in the requested magic playlist. In some implementations, other methods of calculating relevancy based on weighted criteria may be utilized.

Once the content items for the magic playlist have been identified, the magic playlist may be sent to the requesting user's client device. The user may then select a content item to play. FIGS. 4c-d show data flow diagrams illustrating remote client play in some embodiments of the ECPP. In FIG. 4c, a client device 478 may make an application programming interface (API) request to an API server 476 that returns metadata information for the selected content item. If the content item is licensed for the authenticated user, download universal resource locators (URLs) for standard/mobile audio files may be included. The API request 484 may in one implementation be a JSON over HTTP POST request. Another HTTP post request 486 may then be made to a content distribution network (CDN) 480 for downloading an audio/video file for the requested content item using the appropriate download URL obtained from the API server 476. In one implementation, the CDN may be utilized for facilitating faster downloads. The CDN may be in communication with a media server 482 over HTTP for 486 for obtaining copies of the audio/video files. The downloaded audio/video file may then be played back by the user.

Referring now to FIG. 4d, data flow between the CDN 480, the ECPP client and the user interface 494 is discussed in more detail. In one implementation, the ECPP client may include a download thread 490a, a media player 490b and an Input/Output (I/O) stream interface 490c. In one implementation, the download thread 490a and/or the I/O stream interface 490c may be substantially implemented using C++. In some implementations, the media player 490b may be implemented using a software development kit (SDK) that are digital rights management (DRM) compatible. The download thread 490a may track the download status of a content item (e.g., an audio file). For example, the item being downloaded may be saved locally as a local audio file 490. The download thread 490a may track the download status and may issue download status events to indicate state transitions for the local file. Examples of state transitions may include “downloading” to “playable” to “downloaded.”

When the user interface 494 receives the download status event 496a from the download thread 490a indicating that the local audio file is playable, it can start playback. When the user selects a play control from the user interface 494, the play event 492b may be sent to the media player 490b to begin playback of the requested local audio file 490. The media player 490b may then issue playback events that are used in the generation of playback status events 492c for the user interface, and in playcount event recording. In one implementation, the audio file may become playable after only a small portion of the file is downloaded. In one implementation, the small portion may include only the license, the MP4 atoms, and/or the portion of the encrypted content that contains the first sample of the unencrypted content. For a track that is minutes and 30 seconds long, it may be playable after approximately 30 kB (e.g., mobile quality file size), and approximately 50 kB (e.g., standard quality file) have been downloaded.

### Content Caching Component

In some embodiments of the ECPP, one or more local client devices may be provided with facilities for media content caching. In one implementation, caching may be limited to those content items that are not available locally in the client device. In another implementation, caching may be for those content items that match the client device owner specified preferences. Caching may be carried out in the background without any active user intervention in some implementations.

FIG. 4c shows a logic flow diagram illustrating the content caching component in some embodiments of the ECPP. In one implementation, a user may select or input a content item at 450. For example, a user may select an artist as a content seed. The selected content item may be received by the server at 452. The server may then identify the selected content item at 454 and determine related content based on the item at 456. For example, if the user selected artist “Janelle Monae”, the ECPP platform may identify tracks related to the artist, albums related to the artist, information about the artist, playlists including tracks by the artist, artists similar to Janelle Monae, and/or the like. The determination may include creating a content query based on the received input and/or other input identifying information and querying one or more content databases using the created content query. The related content data determined by the ECPP may be sent to the user's client device at 458 and may be received by the user's client device at 460.

In one implementation, at 462, a determination as to whether any of the tracks returned by the search are non-local tracks. In some implementations, non-local tracks are tracks that are not available locally in the client device. For example, non-local tracks may be present in the universal music library in the cloud, but are absent in the user's local device, either in one or more media folders, or cache. This determination may be achieved, for example, by comparing the track IDs returned from the search with the track IDs of the tracks saved locally. If there are no non-local tracks, i.e., all tracks from the search result are local, those tracks may be marked as locally available using an indicator at 466 to distinguish them from non-local tracks. The related content may then be displayed on the client device at 468.

On the other hand, if one or more tracks are non-local tracks, a local cache request may be generated for requesting the non-local tracks from the server. In one implementation, the local cache request for the non-local tracks may be in XML format substantially in the following form:

```
<XML>
    <ClientDetails>
        <ClientIP>192.168.22.111</ClientIP>
        <ClientType>smartphone</ClientType>
        <ClientModel>HTC Hero</ClientModel>
        <OS>Android 2.2</OS>
      </ClientDetails>
    <UserName>JaneSmith@gmail.com</UserName>
    <NonLocalTrackDetails>
        <Track1ID>238348</Track1ID>
        <Track2ID>338458</Track2ID>
        .
        .
        .
        <Track18ID>245788</Track18ID>
    </NonLocalTrackDetails>
</XML>
```

The server may receive the request for non-local track and may retrieve the requested tracks from one or more media content databases using the universally resolvable track ID in the XML request at 470. The retrieved tracks may then be sent to the requesting user's client device at 472. The requested tracks may be received by the client device at 474 for temporary storage in the client device cache. The received tracks may be encrypted, and may become playable after only a small portion of the content file is downloaded.

In one implementation, the content items stored in the cache may be made permanent by the user at any time as long as the item has not been cleared from the cache. The ECPP client may mark the previously local tracks as locally available tracks at 466 and may update the ECPP client interface to display the received and/or identified related content data at 468.

In another embodiment of the ECPP, the content caching component may facilitate caching of non-local items in a media content collection explored, created or copied by a user. For example, a user may create a playlist (or request a magic playlist) which may include a list of tracks. The ECPP may then automatically determine whether any of the tracks in the list are non-local, and if so, may obtain the non-local tracks for temporary storage in the local cache. Such automatic caching for non-local items may enhance user experience, whether the user is online or offline, with seamless delivery of music.

In some implementations, the content caching component may include a cache manager component. The cache manager component may facilitate management of content data stored temporarily in the cache. When cache memory is filled up, there may not be enough space in the cache to store new content items. In order to make room for new content items, older content items may have to be deleted. The cache manager may determine which content items to delete based on various factors such as priority, play count, last play date and time, size of content items, date and time of storage, and/or the like. In one implementation, priority may be determined based on user preference. In another implementation, priority may be determined based on track play attributes. For example, if a content item is a recommendation engine ranked song or of a ranked album, the content item may have a higher priority and thus may not be the first track to be deleted.

### Smart Caching (SC) Component

Some embodiments of the ECPP may include an SC component that may facilitate smart caching of content items that are likely to be consumed by a user. The SC component may include a recommendation engine that generates music recommendations based on, in one implementation, users' implicit interests. In a further implementation, the SC may also include a cache manager component that manages caching queue. Together, the recommendation engine and the cache manager may identify tracks that are likely to be of interest to the user, and download the identified tracks to the user's client cache. In one implementation, a user's interests may be derived from the behavioral and use data collected from the user's client and/or website. For example, length of play, i.e., whether the user plays a track for 10 seconds or the full length, may be a strong indicator of the user's interest in that particular track, genre or artist. Similarly, if the user adds a track to a playlist, creates a magic playlist with a track or shares a track, such activities may also be a strong indicator of the perceived value of the track to the user. As yet another example, tracks that are played in proximity in terms of timing and/or session may also suggest common clusters for recommendation.

In some implementations, the collected play data may include, but are not limited to play data such as track play detail, track added to playlist, track shared, rating, track plays in close proximity, track ID, track bookmarked, track used to create magic playlist, and/or the like. Track play detail may include information such as genre, data and time of play, partial or full play, and/or the like. In one implementation, a play that is less than 30 seconds long may be classified as partial play, while a play that is longer than or equal to 30 seconds may be classified as full play. In other implementations, the critical play length may be a number different from 30 seconds, or may even be a percentage of the track length (e.g., a track play that is at least 30% of the track length may be considered a full play).

In some implementations, the collected data may also include personally identifiable information (PII), user ID, and/or the like. In one implementation, PII may include any information (i) that may identify or may be used to identify, contact, or locate the person to whom such information pertains; and (ii) from which identification or contact information of an individual person is derived. In some implementations, PII may include, but is not limited to: name, address, phone number, fax number, email address, financial profiles, medical profile, social security number, credit card information, and/or the like. Additionally, in some other implementations information such as a personal profile, unique identifier, biometric information, IP address, and/or the like associated with PII may be considered PII. In yet other implementations, PII may not include information that is aggregated or collected anonymously (i.e., without identification of the individual user) or demographic information not connected to an identified individual. In some implementations, PII may include third party PII. In some implementations, user ID may be a totally anonymous number series or alphanumeric characters.

Using the collected data, the recommendation engine may in some implementations, aggregate tracks, artists, albums, Gurus, playlists that are consistently favored or banned by the user. The recommendation engine may also keep track of user ratings (e.g., thumbs up, thumbs down) for content items. In a further implementation, the aggregated tracks may be periodically refreshed to ensure that the recommendation source content items are currently of interest to the user. These recommendation source content items may also be a part of the user profile in some implementations. Table 1 below shows example fields of data collected and maintained by the recommendation engine.

| FIELD | DATA TYPE |
|---|---|
| most_played_artist | char |
| most_played_album | char |
| most_played_playlist | char |
| most_played_genre | char |
| most_played_track | char |
| artists_filtered_out_as_thumbs_down | char |
| playlists_filtered_out_as_thumbs_down | char |
| albums_filtered_out_as_thumbs_down | char |
| tracks_filtered_out_as_thumbs_down | char |
| guru_filtered_out_as_thumbs_down | char |
| artists_flagged_as_thumbs_up | char |
| playlists_flagged_as_thumbs_up | char |
| albums_flagged_as_thumbs_up | char |
| tracks_flagged_as_thumbs_up | char |
| guru_flagged_as_thumbs_up | char |
| tracks_bookmarked | char |
| most_shared_track | char |
| most_popular_track_in_interest_graph | char |

In some implementations, the recommendation engine may consider one or more of the listed fields of collected data to identify seed content items for recommendation. For example, the recommendation engine may consider the tracks identified by the fields: most_played_tracks, tracks_filtered_out_as_thumbs_up, most_shared_track and most_popular_track_in_interest_graph. The recommendation engine may then compute a fingerprint for each recommendation seed using a fingerprinting technology. The fingerprinting technology may use digital signal processing algorithms to process actual audio signal of a recording to compute the fingerprint.

In some implementations, the recommendation engine may package the recommendation seeds and/or other identifying information in an XML format and send to a third-party service such as Gracenote MusicID Service via an application programming interface (API) for identifying related content. In yet other implementations, recommendations may be generated using crowd sourcing methods such as that of Pandora or collaborative filtering approach of Amazon (e.g., others who bought x, also bought y).

FIG. 4f is a logic flow diagram illustrating smart caching component in another embodiment of the ECPP. At the start 491a, the user may request download of a new multimedia file at 492. Using the attributes of the multi-media file and/or other play detail information, at 493, the user's preference profile is updated. At 494, as soon as an engageable portion of the multimedia file is obtained, it is ready for playback if requested by the user. At 495, the SC component may identify content items for smart caching. The SC component may utilize the recommendation engine to identify the content items for smart caching. At 496a, the SC component may determine whether there is an existing intelligent download list/queue. If there is an intelligent download list, the SC component may update the list with the identified content items at 496b. If there is no intelligent download list, one may be created at 496c using the identified content items. At 497, the SC component may determine if the user has enough bandwidth to determine the number of concurrent downloads. If the bandwidth is high enough to download at least one file, the SC component may instruct the ECPP cache manager to identify and delete local multimedia in the cache to make space for the new files at 498b. If the user bandwidth does not have enough bandwidth at 498a, the SC component may hold caching until user bandwidth is ideal at 498c. Once the bandwidth is ideal, the SC component may provide the additional multimedia content to local client device according to the intelligent download list at 499. This may conclude the SC component caching at 491b.

### Stagelight/Spotlight Search

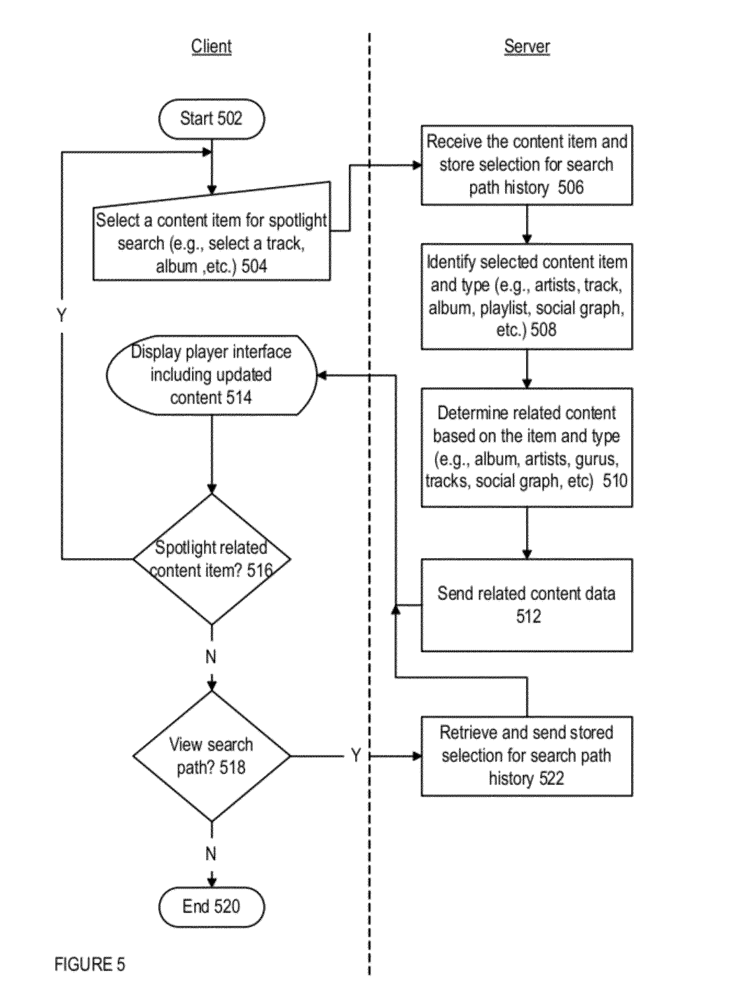

FIG. 5 shows a logic flow diagram illustrating stagelight/spotlight search in some embodiments of the ECPP. In one implementation, the stagelight search may begin at 502 with a user selection of a content item for stagelight search at 504. For example, a user may select a track, artist, album, etc., and initiate a stagelight search. The selected content item may be received by the server at 506. The server may then initiate user selection tracking. User selections and the sequence in which such selections are made may be employed to generate a search path history.

At 508, the selected content item may be identified as an artist, track, album, playlist and/or the like. Using the identified content item, other related content items may be searched and identified at 510. In some implementation, related content items may include albums, tracks, artists, Gurus, playlists, and/or the like. The related content item data may then be sent to the user's client device at 512. The sent content item data may be utilized to render an updated client interface at 514. At this time, the user may continue interacting with content items to discover related content items. For example, the user may select a related content item, which may lead to discovery of additional related content items. If the user wishes to stagelight a related content item displayed on the user interface, the user may select the content item and may click on stagelight option or icon at 504.

In another implementation, the stagelight interface may feature a drag and drop interface, where the user may stagelight a content item by dragging and dropping the content item to a stagelight object. At 516, the user may decide to not stagelight any of the related content items, at which point the user may exercise the option to view the search path traversed so far. At 518, the user may request to view the search path traversed, and in response, the server may retrieve the stored user selections including indications of the sequence in which they were selected and may send them to the client device at 522. At 514, the client device may receive the search path data and may render the graphical interface to display the search path taken by the user as the user traversed through related content items. The process may end at 520 when the user exits the stagelight search interface within the ECPP client.

### Shared Discovery Component

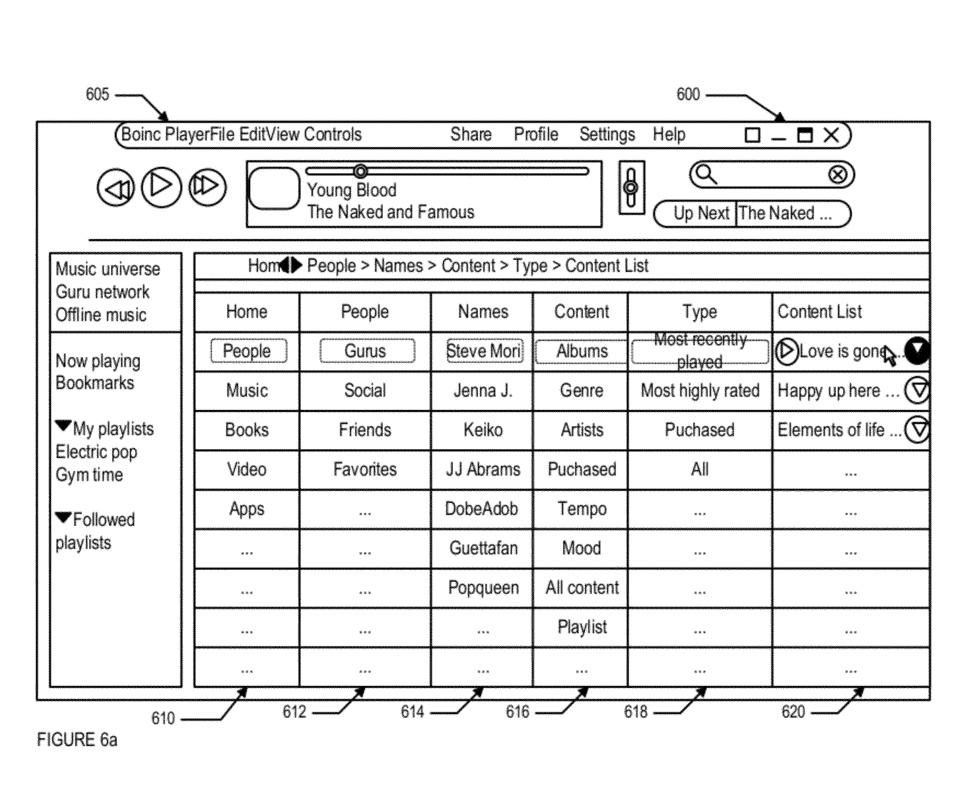

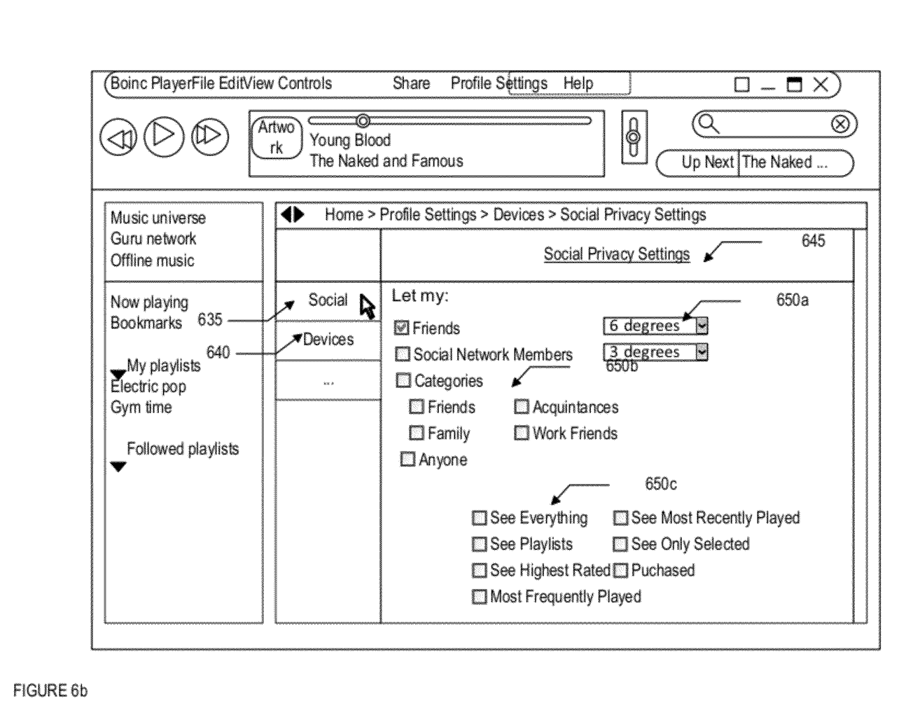

FIG. 6a shows an example shared discovery in some embodiments of the ECPP. In one implementation, the ECPP facilitates graphical discovery of shared content items through the network of users of the ECPP and/or the network of users of other social networking sites such as FACEBOOK, MYSPACE, LINKEDIN, etc. For example, using the ECPP GUI 600, a user may see a list of all other users who are sharing their content (e.g., library, playlists, etc.). The user may navigate further by selecting options such as “home,” “people,” “names,” “content,” “type,” “content list” and/or the like. When the user selects “home,” a list of options 610 may appear under the “home” column for further selection. In one implementation, the “home” option 610 may include an option to select people, music, books, video, apps, and/or the like. As shown in FIG. 6a, the user may select “people” from the column 610. The selection may then populate the “people” column 612 for further selection options. These options may include Gurus, social, friends, favorites, and/or the like. In one implementation, the user may select “Gurus” from the column 612. The selection of “Gurus” may in turn populate the next column 614 with Guru names for further selection. In one implementation, the user may select a Guru name (e.g., Steve Mori) from the names column 614. The selected user (i.e., Steve Mori) may have configured for sharing one or more content items such as albums, genre, artists, purchased, tempo, mood all content, playlist, and/or the like as shown in the content column 616. Further granularity in terms of content type 618 and content list 620 may also be available for selection in some implementations. As shown in FIG. 6a, the user may be provided an option to select “albums” from the content column 616, which in turn may provide a drilled down view of content type 618 for selection. Examples of content type may include most recently played, most highly rated, purchased, all, and/or the like. Any selection of the content type items from the content type column 618 may lead to a display of content list in column 620. As shown, the content list may display a list of tracks under any of the selected content type (e.g., most recently played). In one implementation, the user may select any of the displayed tracks for playing, downloading or creating magic playlist. In another implementation, the user may generate a playlist including all or selected tracks from Steve Mori's shared library. For example, the user may create a playlist including the most recently played tracks, most highly rated tracks or all tracks.

In one embodiment, users who wish to share their content with other users may be able to individually configure their social privacy settings to define what items they would like to share and what items they would like to keep private. FIG. 6b shows an example shared discovery settings configuration in some embodiments of the ECPP. In one implementation, a user may select profile settings option from the menu to view the profile settings interface. An example profile settings interface may include options to configure social settings, device settings, publishing settings, and/or the like. In one implementation, the user may select social settings to reveal an interface including options for social privacy settings. In a further implementation, the social privacy settings interface may include options to select who can view what type of contents from the user's library contents. Example options for selecting who can view may include friends, friends of friends, social network members, network members, anyone, and/or the like and any combination thereof. Example options for selecting what can be viewed may include see everything, see playlists, see most recently played, see only selected, and/or the like and any combination thereof. As shown in FIG. 6b, a user may select to let his friends see everything. In an alternate implementation, there may be options to configure social privacy settings on a group basis. For example, the user may configure to let his friends see everything, friends of friends see most recently played, anyone see his playlists, and/or the like.

In some implementations, the privacy settings may include options to specify the people, music, books, video, apps, and/or the like listed in column 610o in FIG. 6a. For example, the user may configure people who are gurus named Jenna J., J J Abrams or Guettafan access to albums, purchased and playlist content that are most recently played. In this way, only the specified gurus may be given access to specified content type.

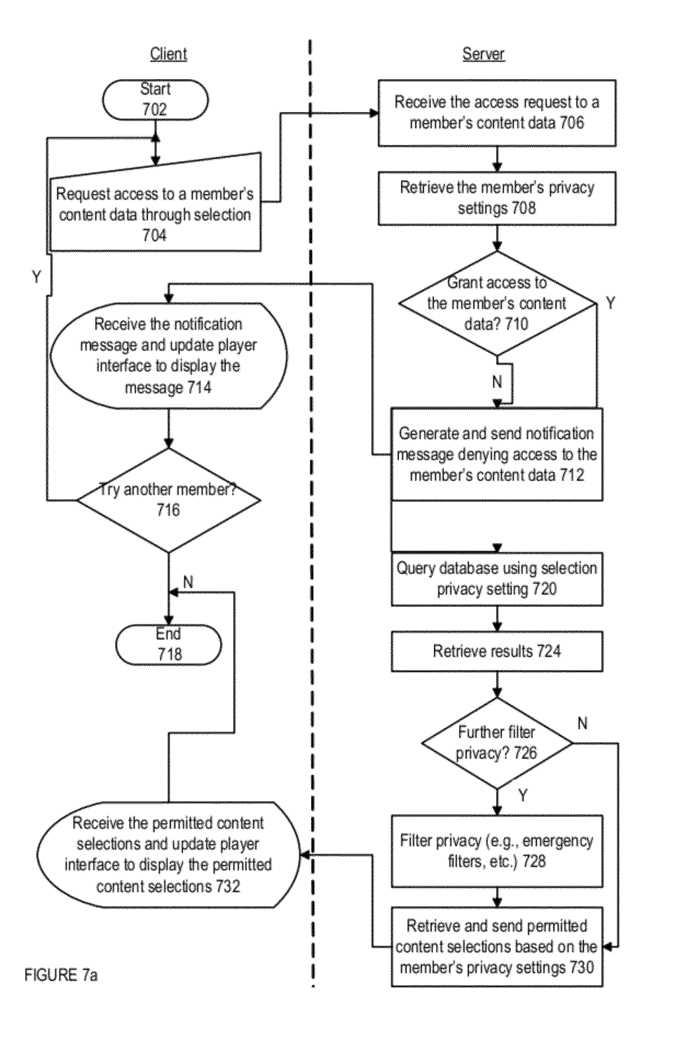

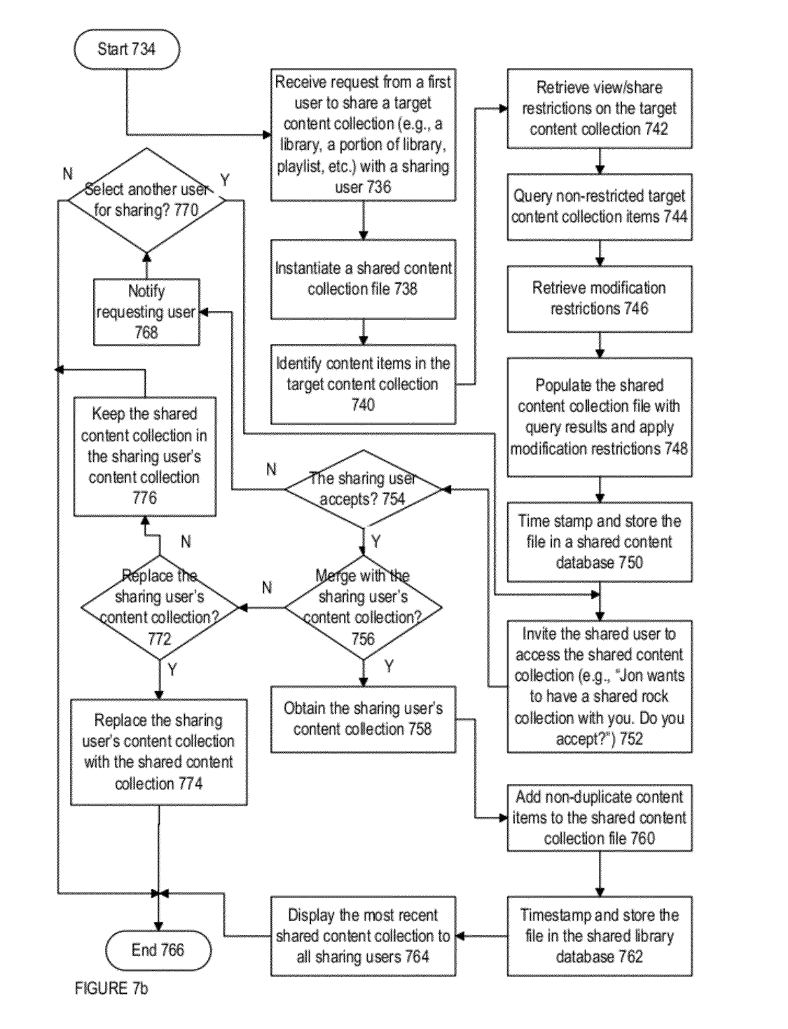

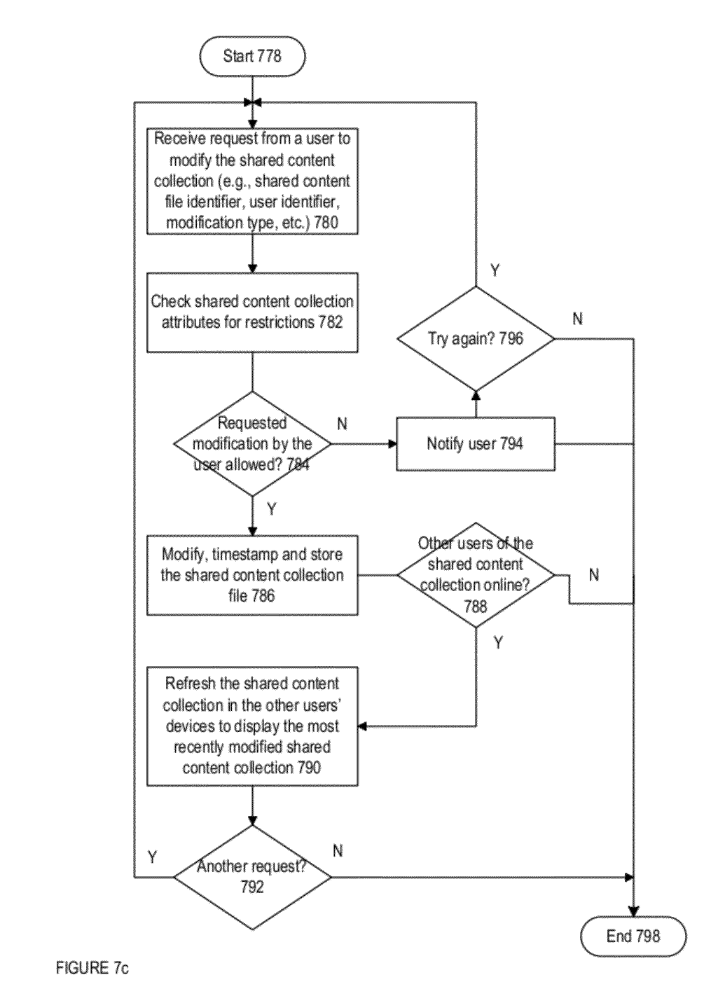

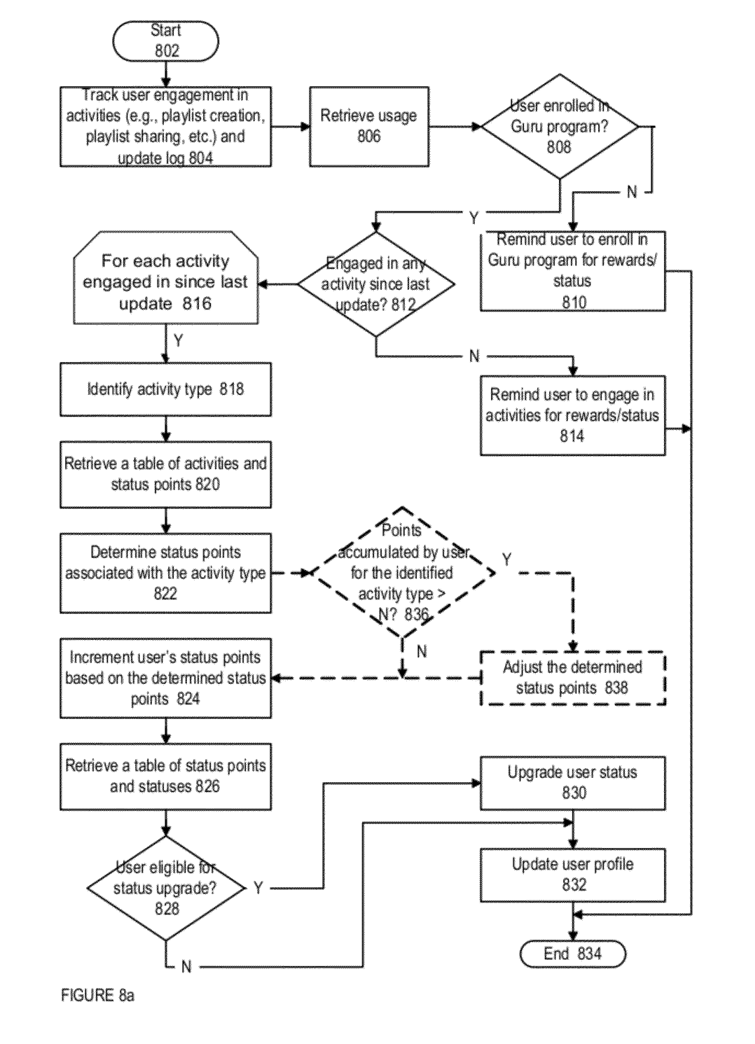

FIG. 7a shows a logic flow diagram illustrating shared discovery in some embodiments of the ECPP. In one implementation, the process may begin at 200 with a user using his or her client device to request access to a member's content data at 702. The request may involve, for example, selection of the member's name or alias. The request may be received by the server at 704. The server may then retrieve the member's privacy settings at 706. In one implementation, the relationship between the member and the requesting user may be determined for applying the member's privacy settings. For example, the member's privacy settings may permit sharing with friends, and the relationship between the member and the requesting user may be determined in order to facilitate the user's request. At 708, a determination may be made whether the requesting user should be granted access to the member's content data. Based on the privacy settings and/or the member-user relationship, if the user is not granted access to the member's shared content data, a notification message indicating denied access may be generated and sent to the user at 710. Such a notification message may be received and rendered on the client interface at 712. At this time at 714, the user may select another member and request access to the selected member's shared content, or may end the process at 716.

If the user is granted access to the member's shared content, the server may retrieve and send to the user's client device permitted content selections at 718. Permitted content selections may include the contents selected by the member for sharing with users of certain designations such as friends, friends of friends, network members, etc. The permitted content selections may be received by the user's client device for rendering on the client interface at 720.

### Shared Content Management (SCM) Component

The shared media content management component of the ECPP may, in some embodiments, allow multiple users to collaboratively manage a shared media content collection such as a media library, a portion of a media library, a playlist, a specific collection (e.g., “my jazz collection” or “Smith family library”). Collaborative management may take various forms depending on the type of users involved. For example, a family may seek to create and maintain a single “family library” which can be modified by one or more family members using their individual LDs such that each LD having access to the “family library” may be automatically synchronized to display the most recently modified “family library.” As another example, two friends, each having their own LD, may seek to manage a shared “jazz collection.” The shared “jazz collection” would then be commonly owned by the two friends and any change one makes to the collection would be immediately reflected in the collection displayed to the other friend if the friend is connected to the internet, or upon connection to the internet.

In some implementations, LDs in the vicinity of each other may establish communication with each other via blue tooth, infra-red or other near field communication methods when such communication methods are enabled by the respective users. A handshake protocol, where a LD that is offline is authenticated through via another LD that is offline, may be carried out. After successful completion of the handshake protocol, the offline LD may receive content shared by the online LD, including updates to any shared collection commonly owned by the online LD and offline LD.

FIG. 7b shows a logic flow diagram illustrating SCM component set up in an embodiment of the shared discovery of the ECPP. The set up may start at 734, where a server may receive a request from a client device of first user (“sharing user”) to share a target content collection with a second user (“shared user”) at 736. The target content collection may include a library, a portion of a library, playlist, and/or the like. The share request may include information relating to client details such as client IP address, device type and model, operating system, and/or the like. The request may also include identifying information relating to the sharing user and the shared user. User identifying information may include, but is not limited to, an email address, user name, alias or nick name, address, phone number, and/or the like. The request may also identify the content collection being shared, such as the content collection name (e.g., library name, collection name, playlist name, etc.), and in some implementations, the track identifiers (e.g., Track ID) of the tracks in the specified content collection. The share request, in one non-limiting example, may be in XML format substantially in the following form:

```
<XML>
    <ClientDetails>
        <ClientIP>192.168.22.111</ClientIP>
        <ClientType>smartphone</ClientType>
        <ClientModel>HTC Hero</ClientModel>
        <OS>Android 2.2</OS>
      </ClientDetails>
    <UserDetails>
        <UserName>JaneSmith@gmail.com</UserName>
        <SharedUser1>JoeKline@gmail.com</SharedUser1>
        <SharedUser2>BillMadd@hotmail.com</SharedUser2>
    </UserDetails>
    <SharedContentDetails>
        <SharedLibraryName>Jane's Jazz
        Collection</SharedLibraryName>
        <Track1ID>238348</Track1ID>
        <Track2ID>338458</Track2ID>
        .
        .
        .
        <Track50ID>245788</Track50ID>
    </SharedContentDetails>
</XML>
```

At 738, after receiving the share request from the sharing user, an instance of the specified content collection may be created. Content items may be populated in the instantiated shared content collection file according user specified constraints. At 740, the SCM component may identify content items in the target content collection. In one implementation, the identification may include extracting Track IDs of content items in the target content collection from the XML share request. At 742, the SCM component may any retrieve restrictions on the target content collection. These restrictions may be restrictions on who can view and/or share, when the contents may be viewed and/or shared, where the contents may be viewed and/or shared, and/or the like. In some implementations, these restrictions may be specified by the sharing user. For example, a sharing user may want to make the shared collection a private collection between himself or herself and the shared user. In other implementations, these restrictions may be related to license rights. For example, certain tracks in the sharing user's target collection may be licensed for Japan. The tracks licensed for Japan would be decrypted by the sharing user's LD when the sharing user is in Japan. However, when the sharing user shares such tracks licensed only for Japan with a shared user in the United States, the SCM component may detect the licensing restrictions, and apply such restrictions to the appropriate tracks in the target collection to ensure that shared user may view and/or share only those tracks that are licensed for his or her own territory, in this example, the United States.

At 744, the SCM component may query one or more media content databases and/or tables for the non-restricted target content collection items, i.e., the target content collection items from which restricted content collection items have been removed. At 746, the SCM component may then retrieve any modification restrictions to be imposed on the target content collection. The modification restrictions may be specified by the sharing user, and may include rights to modify the shared target content collection. Modifications may include adding, deleting or renaming content items or collection, and/or the like. For example, in some implementations, a sharing user may allow adding content items to the shared target content collection, but restrict the sharing user from deleting any items from the target content collection. Selective restrictions may also be possible. For example, a sharing user may allow deletion of any artists other than, for example, “Norah Jones.” These modifications may be displayed in the form of options for users to select. The user may also be allowed to craft and apply one or more restriction rules. For example, when a parent is sharing a content collection with a child, the parent may set up rules that, for example, do not allow any tracks having explicit lyrical content or other parental advisories to be added to the content collection.

At 748, the SCM component may then populate the shared content collection file with the results of the query and apply the retrieved modification restrictions. At 750, the SCM component may time stamp the shared content collection file and store the file in one or more shared content database and/or tables. Time stamping not only ensures that the most recently updated instance of the content collection file is retrieved when requested, but also allows a user to go back in time to retrieve prior versions of the shared content collection. At 752, the SCM component may invite the shared user to access the shared content collection. For example, an invitation email or message within the ECPP (e.g., “Jon wants to have a shared rock collection with you. Do you accept?”) may be sent to obtain the shared user's acceptance. If the shared user accepts at 754, the SCM component may confirm with the shared user if he or she would like to merge the shared content collection with her or her own content collection. If the user agrees to merge at 756, the SCM component may obtain the list of content items in the shared user's collection at 758. The SCM component may then compare the shared user's content collection with the shared content collection to identify non-duplicate content items. The identified non-duplicate content items may be added to the shared content collection file at 760. Allowing the option to merge would require that there are no restrictions to add content items. Other view/share restrictions and modification restrictions may be applicable in some implementations. The shared content collection file may then be time stamped and stored in the shared content database at 762. At 764, the most recent shared content collection would be displayed to all shared users.

At 756, in one implementation, the shared user may not agree with the merger, or may be restricted from exercising the merger (e.g., adding to the shared content collection). In this case, the shared user may be provided an option to replace his or her content collection at 772. If the shared user agrees, the SCM component may then replace his or her content collection with the shared content collection at 774, concluding the set up process at 766. However, if the shared user does not agree to the replacement, the shared content collection will be saved as a separate collection in the shared user's ECPP account at 776. The shared content collection may then be displayed on the user interface of the ECPP application as a separate shared content collection.

At 754, the shared user may not accept the sharing user's invitation to access the shared content collection. In this case, the SCM component may notify the requesting user i.e., the sharing user at 768. At 770, the sharing user may be given an option to select another user to share the target content collection. If the sharing user decides to select another user, the set up process may move to 752. On the other hand, if the sharing user does not want to select another user for sharing, the set up process concludes at 766.

FIG. 7c shows a logic flow diagram illustrating SCM component update in an embodiment of the shared discovery of the ECPP. Once a shared content collection has been established, the SCM component may maintain and update the shared content collection as necessary. The update process may start at 778. At 780, a user of the shared content collection may request to modify the shared content collection. The request may be initiated when a user attempts to modify the shared content collection. In one implementation, the ECPP application interface may include an icon or button for requesting modification. The modification request may include an identifier for the shared content collection (e.g., SC768765, name of collection, etc.), user identifier, modification type (e.g., add, delete, rename, etc.), content items to be modified, and other relevant information. At 782, the SCM component may check the attributes of the shared content collection for any restrictions, including view/share restrictions and modification restrictions. If the requested modification by the user is not allowed, the requesting user may be notified at 794. The requesting user may also be provided an option to try again at 796 (e.g., try a different modification or try a different shared content collection). If the requested modification by the user is allowed at 784, the SCM component may make the modification, and then time stamp the modified version of the file before saving it on the shared content database at 786. The determination of whether a modification request by a user is allowed or not may involve examining the attributes for restrictions from 782. Specifically, in some implementations, the SCM component may verify whether the user has the right to modify the content collection and/or whether the modification is acceptable under the restrictions in 782. At 788, the SCM component may check to determine if any of the users of the shared content collection are online (i.e., connected to the ECPP). At 788, when no users of the shared content collection are online, the SCM component update process may end at 798. However, if at 788, one or more users of the shared content collection are online, the SCM component may push the updates to the users' client devices to display the most recently modified shared content collection at 790. In some implementations, the users may be notified of the availability of updates and may be requested to provide approval for pushing the update. At 792, the SCM component may entertain any additional modification requests available.

### Guru Program Component

In some embodiments, the Guru program component helps identify and recognize and/or reward users for the value, whether intrinsic or extrinsic, they deliver. In some implementations, value may be derived directly or indirectly from the activities of Gurus. Examples of value for the ECPP include driving new and/or repeat license sales, enhancing the experience for other users by influencing their music plays, driving promotions sponsored by partners such as artists, labels, publishers, and/or the like. In some other implementations of the Guru program, driving new and repeat license sales may be deemed a function of enhancing the experience for other users by influencing their music plays. As such, in some implementations, influence may directly correlate with plays.

In one implementation, influence may be any activity carried on by or caused by a user that is responsible for content items played by another user. For example, when a user publishes a playlist, the user's activity may be an influencing activity if another user plays songs from the published playlist or publish notification, follows the playlist and play songs in it, navigate to the user's profile and play songs from the playlist directly from the profile, and/or the like. Similarly, an influencing activity may also include a user sharing a content item such as an artist, album, song, and/or the like, with which another user may end up interacting. Non-limiting examples of such interaction may include a user playing songs from the share notification, clicking through the share and playing songs from the artist or album page, adding the artist, album or song to his or her personal collection (e.g., “My Collection”) and playing songs from there. Other examples of an influencing activity may include a user playing a song, and another user navigating to the user's profile and playing songs from designated collections such as “Top Artist,” “Most Recently Played,” “Most Frequently Played,” “Top Songs,” and/or the like directly from the user's profile. The another user may also navigate to the user's profile and add songs from the designated collections to his or her own collection (“My Collection”) and play songs from the collection.

While there are many examples of influence within a social graph, an interest graph or the wider community of user of the ECPP, not all activities of a user that leads to song play by another user may be considered influencing activities. Table 2 below shows some non-limiting examples of non-influencing activities:

| ACTIV- | |
|---|---|
| ITY | EXPLANATION |
| Copying | If User B copies the songs in User A's published playlist into |
| | one of his or her own playlists and plays songs from there, |
| | User A may not get points for plays from the copied playlist. |
| Searching | If User B learns about an artist/album/song/playlist from |
| | User A, searches for it, and then plays it or adds it to My |
| | Collection and plays it from there, User A may not get points |
| | for plays from the search. |
| Multi- | If User A influences User B who influences User C, User A |
| User | may not get points for User C plays |
| Related | If User A influences User B who plays a song related to the |
| Content | influence, User A may not get points for related plays |
| Plays | |

In other alternate implementations, the non-influencing activities from table 2 may be considered influencing activities.

Other activities that may lead to rewards and/or recognition include, without limitation, sharing libraries, playlists and/or knowledge, posting to other users', friends', and followers' comment streams, recruiting new followers and/or friends, suggesting and/or recommending music to friends and/or followers, sharing playlists for followers, friends and/or other, increasing music consumption, reviewing contents (artists, albums, playlists) and posting to content comment streams, and/or the like.

In one embodiment of the Guru program these and other influencing activities may be tracked to recognize and reward users for their advocacy and effort. Table 3 below list some non-limiting examples of use cases and exemplary data tracked in some embodiments of the Guru program.

| USE CASES | EXPLANATION | TRACKED DATA |
|---|---|---|
| Track plays | Evaluate if and/or how Gurus | Source, track type, access method, |
| | impact other customers' | track ID, date & time, and/or the like |
| | behavior (e.g., usage volume, | |
| | range of choice, and/or the like), | |
| | before and after they begin | |
| | following; | |
| | Form an informed profile of | |
| | Gurus. | |
| Playlist | Determine if a Guru delivers value | Playlist creation and/or publishing, |
| | to a follower | following, and unfollowing history, |
| | | playback frequency, copying of |
| | | playlists (i.e., becoming an owner), |
| | | editing, reviews and/or comments, |
| | | ratings, and/or the like. |
| Sharing | Determine if a Guru is | Sharing channel, consumer response |
| | proactively sharing content | to the sharing, and/or the like. |
| Purchase | Identify who to attribute a sale | Purchase history of ECPP licenses, |
| | of a LD, a ECPP license and/or | buying process, funnel conversion, |
| | subscription to. | and/or the like. |
| Opt-in | Guru accepts invitation to | Opt-in preference. |
| | participate in the Guru program | |
| | and agrees to share data publicly | |
| Followers | Evaluate relationship between | Personally identifiable information |
| | Gurus and their followers. | (PII), user ID, following status, |
| | | and/or the like. |

As shown in Table 3 above, behavioral, product use, account management, registration, and other information relating to Gurus and/or followers may be tracked. In some implementations, data relating to track plays may be obtained for evaluating if and/or how Gurus impact other users' behavior, before and after they began following one or more Gurus. For example, a Guru shares a track via TWITTER and a non-ECPP user clicks on a link within the tweet. The link takes the user to the ECPP hosted landing page where he or she buys a license and plays the track. In this case, the Guru who shared the track via TWITTER gets a credit for play, free trial and/or paid accounts. Various user behavior data including usage volume, range of choices, etc., and whether such behavior occurrences are increasing and/or expanding may be tracked for rewarding Gurus, to get more information on product usage, to create and maintain an informed Guru profile, for music intelligence, customer profiling, product feature evaluation, dashboard reporting, marketing response, fraud monitoring, partner reporting and/or the like.

As listed in Table 3, track play detail data for Gurus and/or followers may include, but are not limited to, source, track type, access method, track ID, date and time, and/or the like. A source may include the ECPP library, imported content, shared content (e.g., via email, FACEBOOK, TWITTER, links, etc.), and/or the like and details relating to the sharing user. Track type may include information relating to whether a track is downloaded by the user, downloaded in the smart cache, streamed from the cloud, imported, and/or the like. Similarly, access method may include information relating to how and/or from where the track was accessed. For example, access method may indicate where in the user interface (e.g., library, discovery or community) or from which artist, album, track, playlist, published playlist, chart, offline view, bookmarks, etc., a track was accessed from. Further, track ID may include the track number, associated meta data and/or the like. These data may be collected from the client and/or website.

In some implementations, Guru playlist related data may be collected for determining if a Guru delivers value to one or more followers. Examples of playlist related data collected may include playlist creation and/or publishing, following and/or unfollowing history, playback frequency, copying of playlist (becoming an owner), editing, reviews and comments, ratings, and/or the like. For example, unfollowing may suggest that the follower did not find any value in a Guru's playlist, while interaction with a playlist may suggest value. Similarly, playlist contributions of followers may be a function of Guru influence. These data, in addition to providing an insight into user behavior and/or product use, may also be useful for music intelligence, customer profiling, product feature evaluation, dashboard reporting, marketing response, fraud monitoring, partner reporting and/or the like.

In some implementations, sharing data may be collected to determine if a Guru is proactively sharing music. In particular, 1:1 sharing where messages make a single loop may be useful in evaluating how recipients are responding to shared content items. The sharing data may also be utilized to assess if a Guru is stimulating more listening, what channels are being used for sharing, which channel is most effective, and/or the like. Examples of tracked sharing data may include sharing channel, consumer response to the sharing, and/or the like. Sharing channel may include sharing via channels such as email, FACEBOOK, TWITTER, within the ECPP, hyperlink on website or other digital channels, and/or the like. Consumer response may include response of users to the sharing in the form of track plays, track downloads, purchase of tracks, licenses, LDs, and/or the like. In addition to behavior and product use information, these data may also have other uses in customer profiling, product feature evaluation, dashboard reporting, marketing response, partner reporting, and/or the like. These data may be collected from the client and/or websites.

In some implementations, purchases may also be tracked to identify who to attribute a sale of a LD, a ECPP license and/or subscription. They may also facilitate in determining whether a follower buys more licenses, whether a user buys a LD when his or her old device dies, whether license sales is attributable to a Guru activity, whether a Guru is driving new business, and/or the like. The outcome from these determinations may feed into the Gurus' points and rewards discussed in further detail below. Non-limiting examples of tracked data may include purchase history of ECPP licenses, buying process, funnel conversion, and/or the like. Purchase history may include information including type of license, price, device type, and/or the like. Buying process may include channels and source of traffic such as email, FACEBOOK, TWITTER, within the ECPP, hyperlink on website or other digital channels, and/or the like, as well as funnel conversion. These data may uses in customer profiling, product feature evaluation, dashboard reporting, marketing response, partner reporting, and/or the like. Purchase data may be collected from website registration page(s), account management portals, or from any appropriate locations from the client and websites.

In some implementations, opt-in preference data may be collected from users who accept invitation to participate in the Guru program. The opt-in data may be used for publicly recognizing and rewarding users in the Guru program. In a further implementation, opting in may require the user to agree to share his or her data publicly. Opt-in preference may be collected from the account management portal or relevant web page from where the user may opt in. In one implementation, the default opt-in value may be “off” and Guru participation may require a user to opt-in in order to change the value to “on.”

In some implementations of the Guru program, data on followers may be collected for evaluating relationship between Gurus and their followers. Such data may include, in one non-limiting example, Personally Identifiable Information (PII), user ID, following status and/or the like. Following status in some implementations may include information that may identify whether a user is following another or is being followed by another. In some implementations, Guru and follower user IDs and/or other information may be attached to play events, sale events, or other events. In some implementations, there may be an option to create an alias or nickname that is public facing. These data may be collected from website registration page and account management portal among others. In addition to the Guru program, these data may be used for music intelligence, customer profiling, product feature evaluation, dashboard reporting, marketing response, partner reporting, and/or the like.

In some embodiments, the Guru program may be leveraged by the discovery and social aspects of the ECPP. The point-based system for rewarding users may, in some embodiments, sustain user engagement with the facilities of the ECPP and encourage users to actively listen, share and manage music. In some implementations, “Guru” may be the designation bestowed to those users who may have opted in to the Guru program and are eligible to receive rewards and/or recognition. In other implementations of the Guru component of the ECPP, a user opt-in to the Guru program to earn influence points may be optional. As discussed above, influence points may be earned when one user plays a song due to influence from another user. Each play by the influenced user may earn the influencing user one or more points or a fraction thereof. In one implementation, when the influencing user earns his or her first point, it triggers a 12 month timer. In some implementations, a time period other than the 12 months may be selected. During the 12 month period, the influencing user may earn points for all plays by the influenced user according to a schedule. An example schedule may, for example, reward the influencing user 1 point for each play by an influenced user during the first month. The example schedule may further stipulate that for the next 2-3 months, each play by an influenced user may earn the influencing user 0.75 points. Similarly, for the next 4-6, the points earned may be 0.5 points, and for the following 7-12 months, 0.25 points. After the 12 month time period, any play by the influenced user would not earn any points for the influencing user. In one implementation, each user that the influencing user influences to play a given song or other content may initiate a separate timer such that the influencing user may perpetually earn points for a given song or other content as long as new users continue to play it. While one specific example of an earning schedule is discussed herein, other variations in the earning schedule are within the scope of the various embodiments of the ECPP.

The Guru program, in some embodiments, may comprise of several levels, each of which corresponds to the number of influence points earned by a user. For example, in one implementation, the Guru program may include a base level and levels 1-5. In some implementations, any user may achieve the base level, but in order to ascend to levels 1-5, a user may need to enroll or opt in to the Guru program. The base level may, in one implementation, be achieved by acquiring a follower, and may be maintained, without opting in to the Guru program, so long as the user has at least one follower. User who has opted in to the Guru program, on the other hand, may earn influence points and be eligible for levels 1-5. In one implementation, a Guru program user's current level may be determined based on the total influence points earned during the previous 30 day period. In a further implementation, the current level may be calculated periodically, or in a daily basis. As such, a user's influence level may fluctuate periodically, or daily, depending on the total influenced points amassed. Further, when a user stops earning influence points, his or her influence level may steadily decline until the base level is reached. A user may also revert back to the base level, provided there is at least one follower, when he or she opts out of the Guru program. In some implementations of the Guru program, a user's influence points may not be lost or may not expire so long as the user is a member of the ECPP. In a further implementation, this may be true even for those users who opt out of the Guru program, but remain a member of the ECPP service. An exemplary level and point correspondence is illustrated below in Table 4. Depending on the distribution of users, the influence point ranges may be adjusted to achieve a desired distribution (e.g., a normal distribution, as opposed to a skewed distribution).

| | INFLUENCE | |
|---|---|---|
| LEVEL | POINTS | PREMIUM STATUS |
| 1 | 10-39 | None |
| 2 | 40-89 | Gem |
| 3 | 90-159 | Silver |
| 4 | 160-249 | Gold |
| 5 | 250-449 | Platinum |
| 6 | 450+ | Executive Platinum |

As discussed above, a user's current influence level may be based on the total influence points earned during the previous 30-day period. In one implementation, the Guru program may also track the user's lifetime influence points. In such an implementation, a user with 10,000 lifetime influence points may be a level 1 Guru if he or she has influenced only between 10-39 plays during the preceding 30-day period. In other implementation, a combination of points earned over a lifetime and over a preceding number of days may be utilized to determine the current influence level of a user. In a further implementation, Gurus may be accorded a premium status based on the accrued influenced points. For example, Gurus may be accorded platinum, gold and silver status based on the accrued influence points.

As discussed above, Gurus contribute towards a more social environment, generate value, and generally uplift the ECPP experience. In return, Gurus enjoy benefits, recognition and/or rewards. All Gurus in the ECPP community may be recognized by the level they have achieved on their profile page and with a level-based icon on their image. Further, a user, by opting into the Guru program and agreeing to allow ECPP to feature himself or herself as music influencers throughout the ECPP experience, may become eligible to be featured in one or more product areas such as the “Music Trends” page, “Music Genre” page, “Music Artist” page, “Music Album” page and/or the like. In a further implementation, the higher the Guru status, the more likely it may be for the Gurus to be featured in relational search results, which may in turn lead to acquiring more friends, followers and influence. Being featured in various product pages, searches and/or interfaces of the ECPP may further reinforce the user's status as a Guru and music influencer. It may also increase opportunities for the Guru to influence other users' plays and earn influence points.

Gurus may also be eligible to earn badges for their influential activities. The badging may be tiered such that it may become progressively more difficult to complete activities and earn badges as a user rises through the tiers. Example badges may include level badges (e.g., level 1 badge, level 2 badge, etc.), follower badges (e.g., 10 followers, 100 followers, 1000 followers, etc.), influenced play badges (e.g., 10 influenced plays, 100 influenced plays, etc.), and/or the like.

In some implementations, Gurus may receive perks and incentives for their social influence. Through relationships with music labels and other rights holders, Gurus may have opportunities to earn external rewards and recognition related to the content they most heavily influence. Some non-limiting example of rewards include, merchandise, concert tickets, autographed memorabilia, artist meet and greets, and/or the like. Other examples of rewards include invitation to Guru-only offline and online events, such as concerts by artists they support, incentives provided by partners to further promote plays of their repertoires in earning more royalties, monetary incentives such as commissions on a play count basis, and/or the like. Furthermore, in some implementations, the premium status Gurus may be more highly targeted by partners for promotions of artists and songs than others.

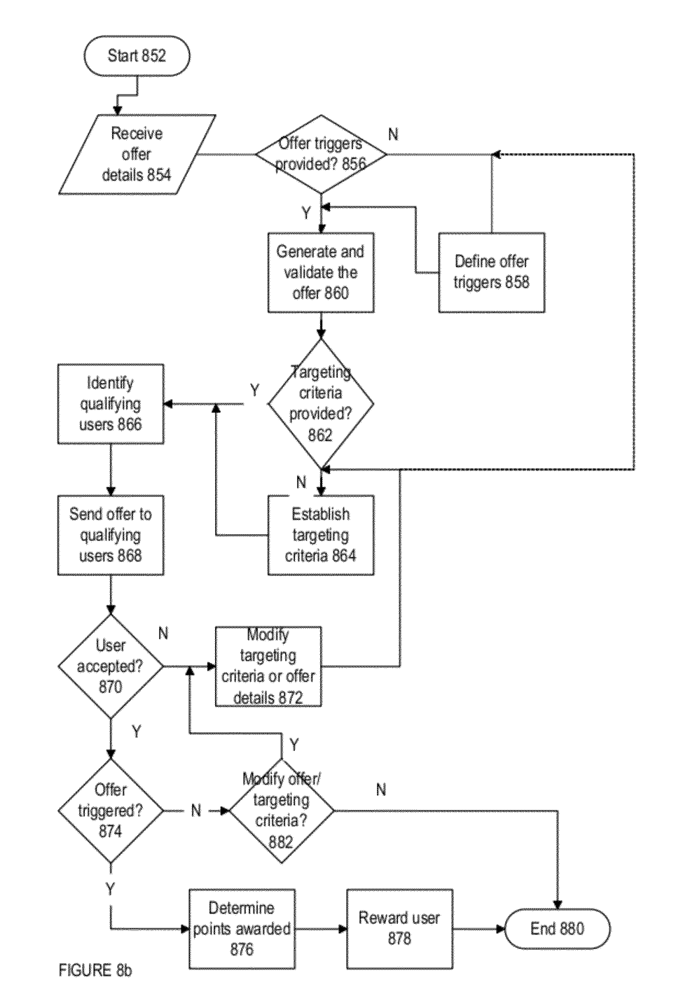

FIG. 8 shows a logic flow diagram illustrating the Gurus rewarding component in some embodiments of the ECPP. In one implementation, for example, the process may begin at 802, with the tracking of user engagement in various activities relating to social, usage, influence, and/or the like at 804. Example activities include posting to other users', friends', and followers' comment streams, recruiting new followers and/or friends, suggesting, referring and/or recommending music to friends and/or followers, sharing playlists for followers, friends and/or other, increasing music consumption, reviewing contents (artists, albums, playlists) and posting to content comment streams, using micro-blog “beats” about their music and related interests, including providing referrals, recommendations for new music to friends and/or the community. These posts or beats may be limited to 140 characters and may include a bit of text and a link. Comments about content (e.g., artist, album, track, etc.) found in the universal music library may automatically hyperlink to contextual information about that product and ways to further explore that subject.

At 806, a determination as to whether a subject user is enrolled in the Guru program may be made. If the user is not enrolled or has not opted in the Guru program, the user may be reminded at 808 to enroll in the Guru program for rewards and/or status benefits and may conclude the process at 810. However, if the user is enrolled in the Guru program, a determination may be made at 812 whether the user is also engaged in activity whether social, usage and/or influence. In one implementation, each activity may have a corresponding value in status points. At 816, type of activity that the user may be engaged in may be identified and the number of status points associated with the activity type may be determined. For example, a user engaged in recommending playlists that are eventually downloaded and/or played by another user may obtain 2 status points.

In one implementation of the Guru rewards program, the ECPP may increment the user's status points by the determined value at 820. A determination may then be made, based on the incremented status points, whether the user is eligible for a status upgrade at 822. For example, the user may have accumulated 24 status points before acquiring 2 more status points in this instance, causing the total status points to exceed, for example, a cut-off of 25 for silver status. In one implementation, if the user is eligible for a status upgrade, the user's status may be upgraded to the next level at 830 and the user's profile may be updated to reflect the change in status at 824. On the other hand, if the user is determined to be ineligible for a status upgrade, the user profile may be updated at 824, without any status upgrades. The user profile may include published user profile and/or profile in one or more user databases at the backend that is not published.

In another implementation of the Guru rewards program, the ECPP may implement a rewards program that encourages users to engage in a variety of activities, and not merely the kind of activities that have previously had some success. For example, at 826, the ECPP may determine whether the points accumulated for the identified activity exceeds a threshold N. If the threshold is not exceeded, the user's status points may be incremented at 820. However, if the threshold has exceeded, the determined status points may be adjusted at 1228 before incrementing the user's status points by the value of the adjusted status points. Adjustment may include an adjustment by a factor less than or greater than 1.

### ECPP User Interfaces

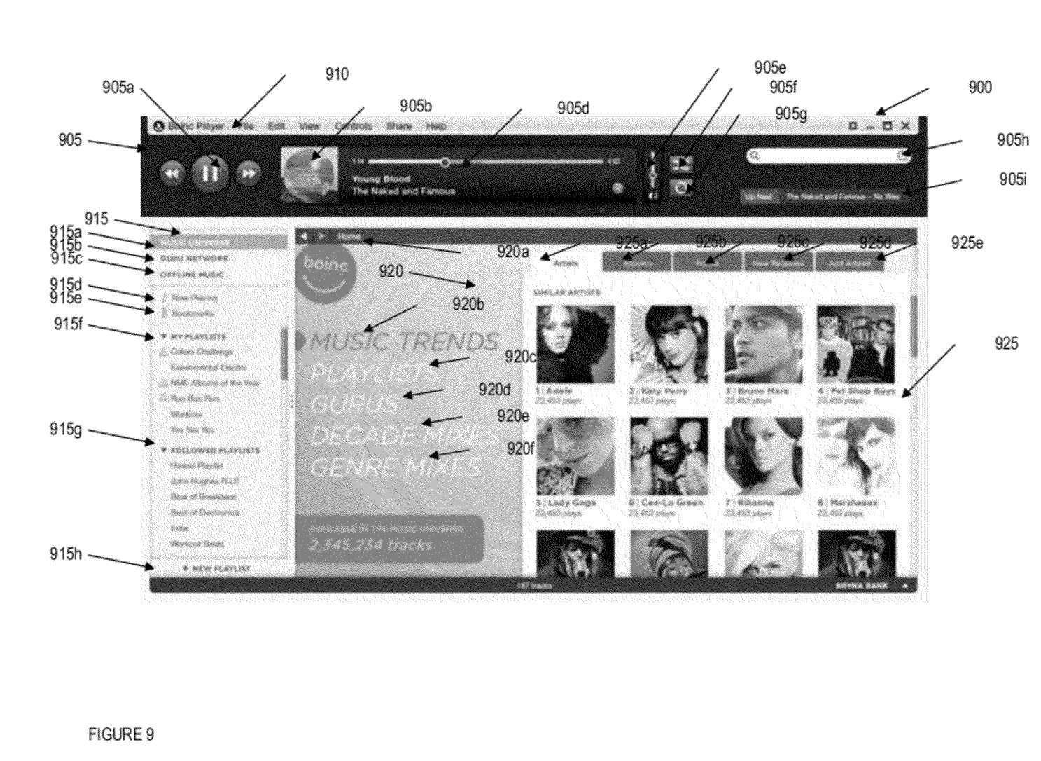

FIG. 9 is a schematic view of the ECPP application interface in one embodiment. A user launching the ECPP application may encounter an interface 900 that provides a quick overview of information. The interface 900 may include 905 player control panel, menus 910, a media explorer panel 915, a media display panel 920, information panel 925, and/or the like. In one embodiment, the menu 91o may include menu items such as file, edit, view, controls, share, help, etc. The player control panel 905 may include various controls such as play controls 905a, logos/artwork 905b, current track information 905c, track position bar 905d, volume control bar 905e, shuffle button 905f, repeat button 905g, search bar 905h, next track information 905i, and/or the like. The media explorer panel 915 may include various selectable items such as music universe 915a, Guru network 915b and offline music 915c. Selection of the music universe item 915a may facilitate the display of information relating to media in the ECPP catalog. As shown in FIG. 9, wherein the music universe 915a has been selected, the media display panel 920 shows items such as music trends 920b, playlists 920c, Gurus 920d, decade mixes 920e, genre mixes 920f, and any other links to organized content in the music universe. On the right of the interface 900 is an information panel 925 which displays additional information based on selections of items such as 920b-f in the media display panel 920. The information display panel 925 may include several tabs, for example tabs 925a-e. Information corresponding to the selected tab and the selected item 920b-f may be displayed in the information display panel. For example, when music trends items 920b is selected, the information panel 925 is updated to display artists in one tab 925a, albums in 925b tab, tracks in 925c tab, new releases in 925d tab and just added in 925e tab. Similarly, when the Gurus item 920d is selected, the information panel 925 is updated to display information relating to the Guru network. For example, the selection of the Guru network may include a listing of all or some Gurus having the most followers.

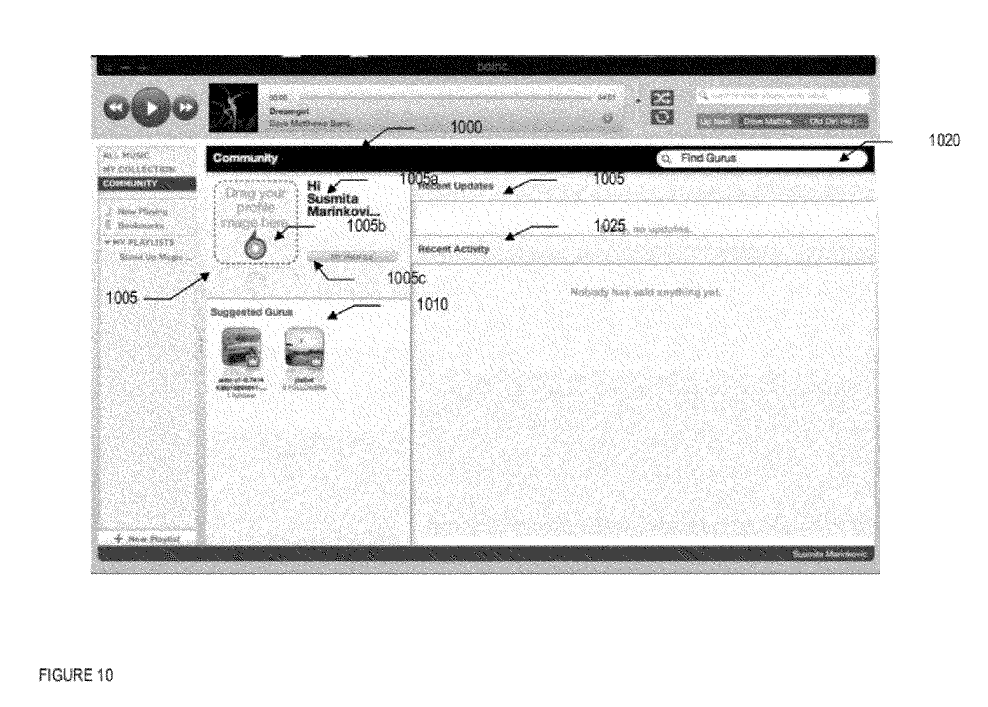

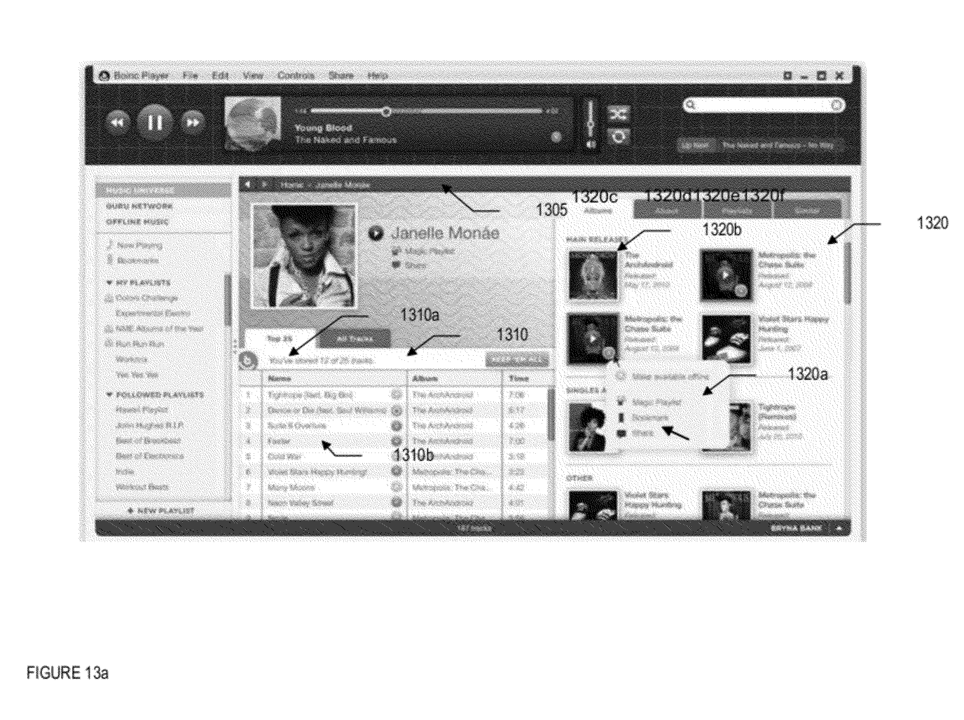

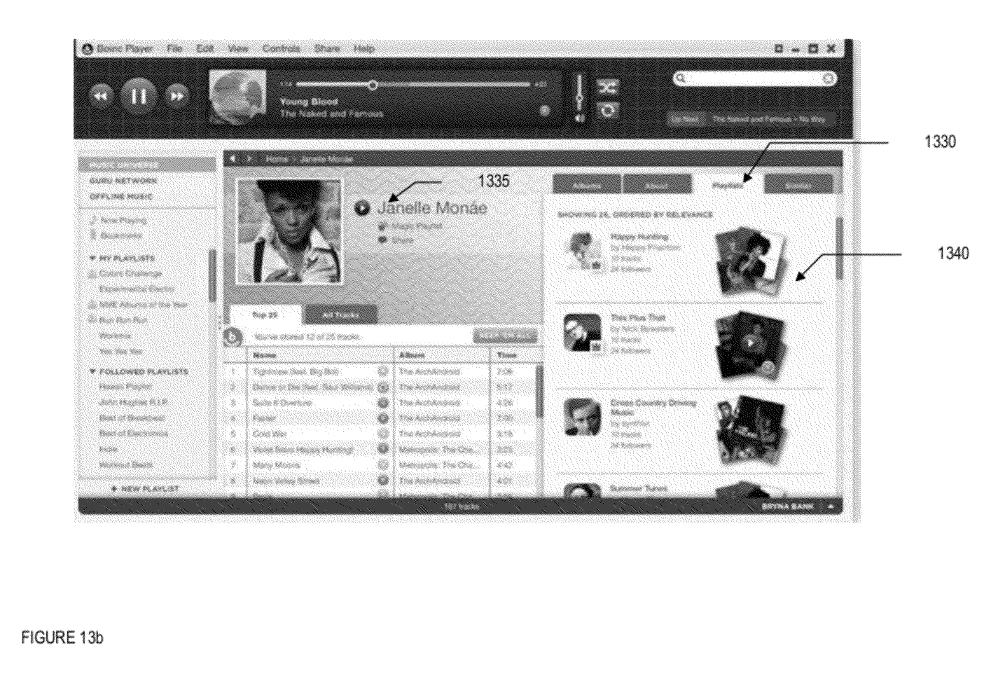

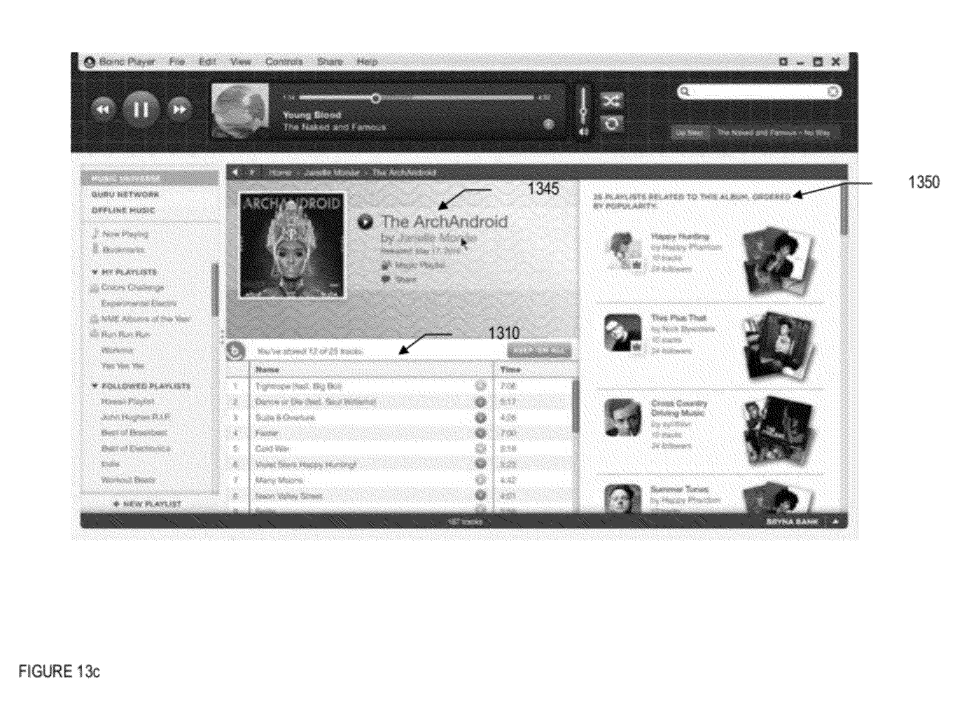

The media explorer 915 also include the item Guru network (or “community”) 915b. When the Guru network 915b is selected, a community (or Guru) display panel 1000 is displayed, as shown in FIG. 10. The community display panel may include a profile area 1005 that may identifying user information 1005a, profile image 1005b, and a “my profile” button 1005c. The “my profile” button 1005c display the user's profile information and is discussed in further detail in FIG. 13. The community display panel may also include Gurus panel 1010 which may include Gurus suggested by the ECPP, Gurus currently followed, and/or the like. The right of the community display panel 1000 may include one or more panels 1015-1025 displaying activity streams. In addition, the community display panel 1020 may also include a search bar 1020 which may be used to search for Gurus.

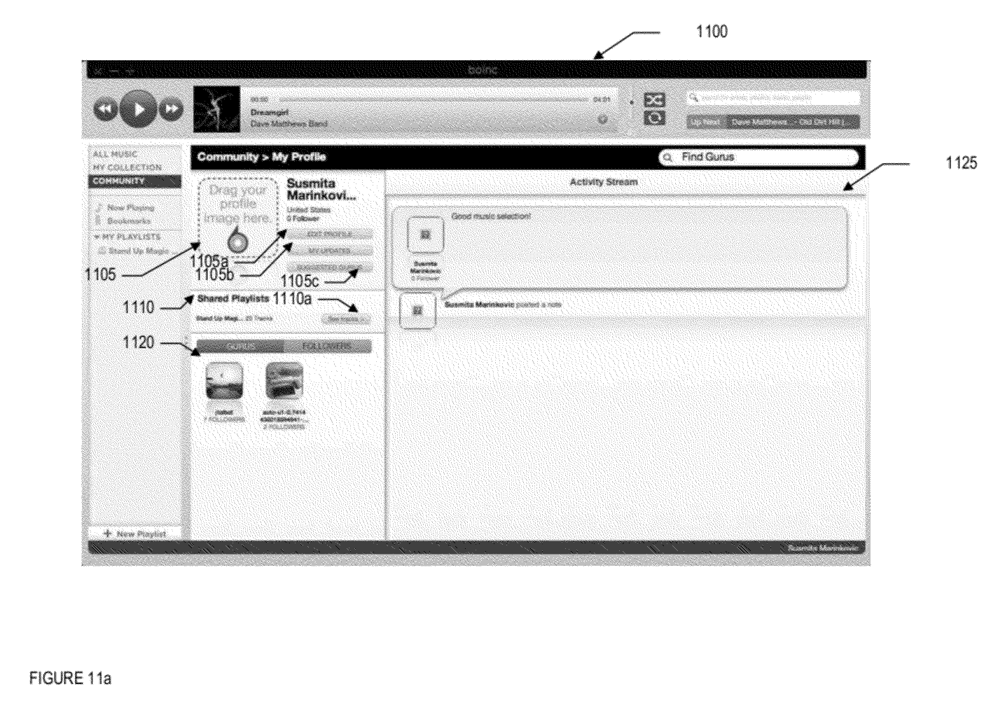

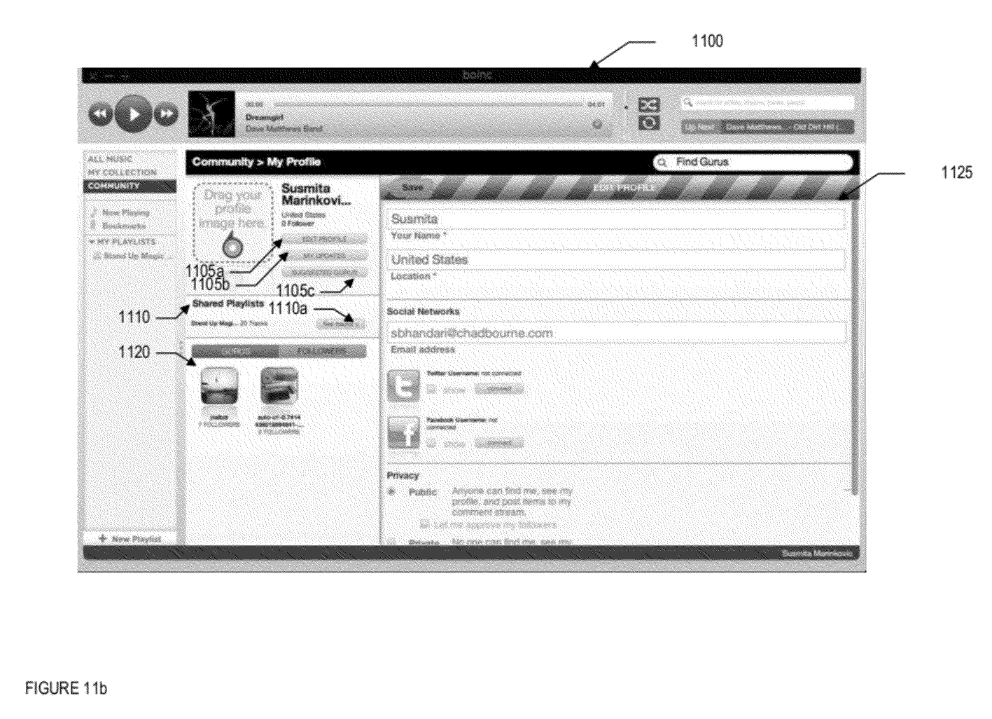

FIG. 11a is a schematic view of the ECPP application interface that is displayed in response to the selection of my profile button 1005c in one embodiment. The profile area 1105 may include buttons 1105a-c to edit profile information, view updates and view suggested Gurus respectively. The profile display panel 1100 may also include shared playlist area 1110 that provides an overview of the playlists that a user has shared with others, or has made available for sharing. Next to each listed shared playlists, the user may click the see tracks button 1110a to explore the tracks in the playlist. Also provided in the profile display panel 1100 is the Guru information area 1120 which may list Gurus that the user follows, as well as other users following the user. On the right side of the profile display panel 1100, an activity stream display panel 1115 may be provided for displaying posts, beats, comments or other messages exchanged between the user and others in the community.

FIG. 11b is a schematic view of the ECPP application interface that is displayed in response to the selection of edit profile button 1105a in the profile area of the profile display panel 1100 in one embodiment. The edit profile panel 1125 allows the user to edit and/or update identifying information such as name, location, email address, social networks, etc. The user may also select options to integrate with other social networks such as TWITTER and FACEBOOK. In addition, the user may also set privacy options of his or her profile. For example, the user may make his or her profile public which would let anyone to find the user (e.g., by search), view his or her profile, post items to his or her comment/activity stream, send messages, and/or the like. The user may also specify whether or not to use an approval process to let other users follow him or her. These facilities may no longer apply if the profile is set to be private. Additionally, the interface may also include facilities to set preferences for the activity stream 1125. Examples of such preference settings may include options to select information displayed in the activity stream 1125 in FIG. 11a to those involving friends having a specified degree of separation, Gurus, followers, and/or the like.

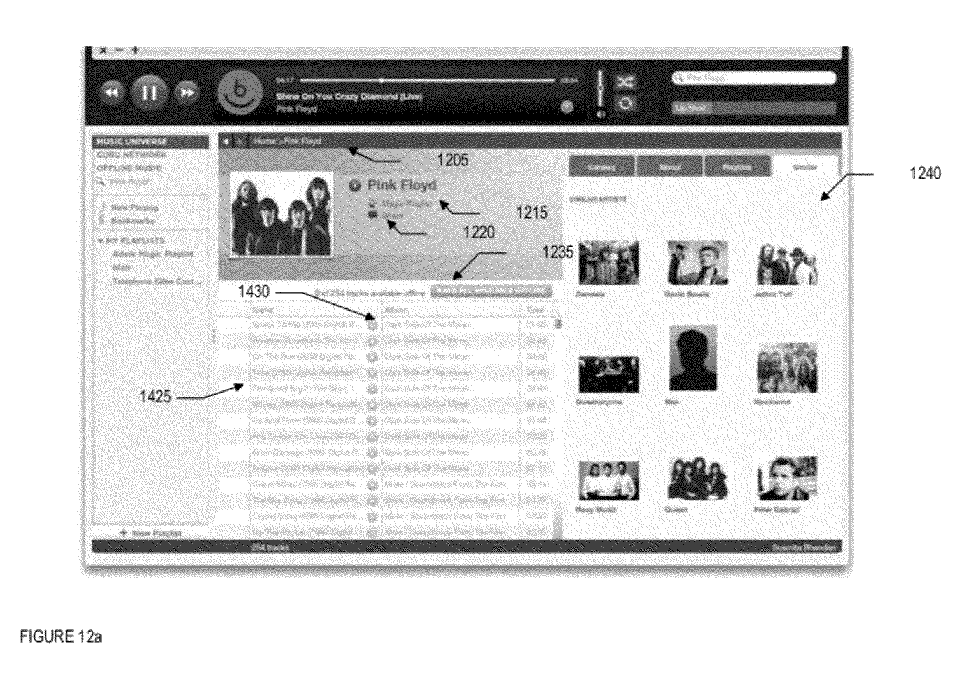

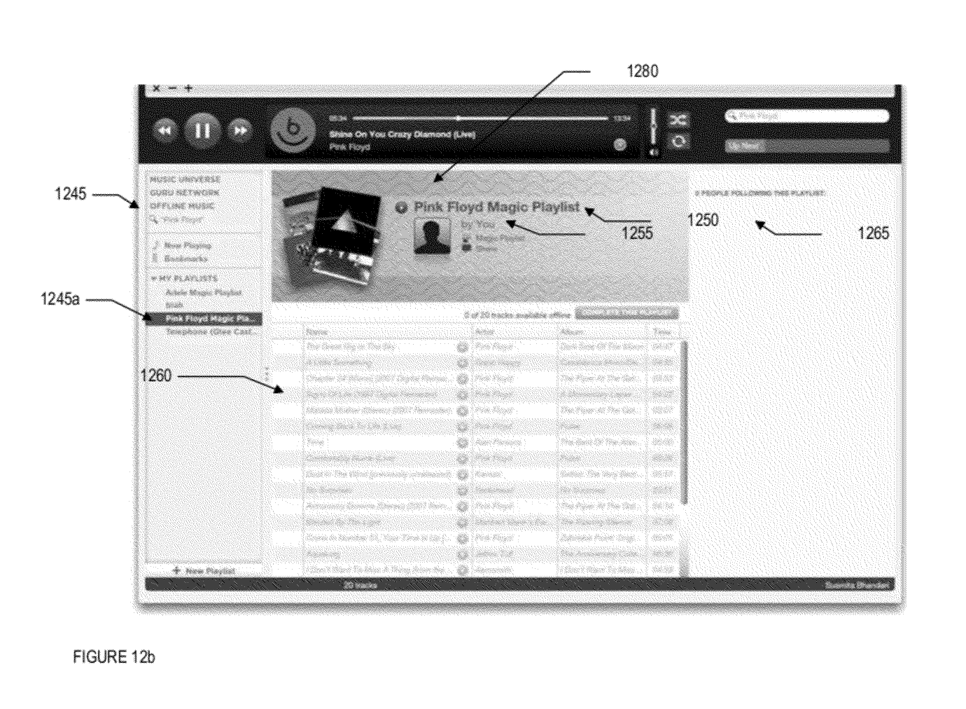

FIG. 12a is a schematic view of one embodiment of the ECPP application interface. As shown in FIG. 12a, the media display panel 1205 displays information relating to a selected item (e.g., artist Pink Floyd). The media display panel 1205 may display identifying information 1210, and a listing of tracks 1225 pertaining to the selected item 1210. The user may have the option to create a magic playlist based on the selected item 1210 by clicking on the magic playlist icon 1215. In addition, the user may also share the tracks 1225 with other users by clicking on the share icon 1220.

Next to each track in the listing 1225, is provided a track location indicator 1230. The indicator 1230 may specify using color or other indicia whether or not the track is available in the local/offline library. As shown in the figure, each of the tracks in the listing 1225 may be made available offline by clicking on the make all available offline button 1235. The ECPP, in response to the request to make all tracks available offline, may identify the tracks that are not present in the local or offline library and download them to the user device. Instead of downloading all of the tracks listed at 1225, the user may also individually select one or more tracks for downloaded. Of course, the user may also play, pause or skip these tracks, regardless of whether they reside in the local library or on the cloud.

FIG. 12b is a schematic view of one embodiment of the ECPP application interface. When the magic playlist icon 1215 shown in FIG. 12a is clicked, the media display panel 1280 is displayed. Here, the display panel may show the magic playlist 1250 that was created in response to the request. The playlist may identify the creator at 1255 and include options to create another magic playlist or share the playlist with other users. At the media explorer bar 1245, the listing of playlists may be updated to include the newly generated magic playlist. Similar to FIG. 12a, the media display panel may also list the tracks included in the magic playlist at 1260. In addition, on the right side of the interface, in the information panel 1265, information such as people following the playlist, people who have downloaded the playlist, those who have shared the playlist with others, and/or the like may be displayed.

FIG. 13 is a schematic view of one embodiment of the ECPP application interface. Here, an artist has been selected as shown in the media display panel 1305. A list of selected tracks (e.g., by popularity) or all tracks related to the artist may be listed in the track listing area 1310. Further, the listing area may also identify the tracks that are located in the local library, and their total number using the location indicator 1310b, and the item 1310a. On the right side of the interface, is the information panel 1320, which may provide additional information on the item displayed on the media display panel 1305. For example, as shown in FIG. 13a, the artist's main releases are shown in the information panel under the albums tab 1320b. Any of these albums may be made available offline, used for creating a magic playlist, bookmarked or shared using the options in the popup menu 1320a. Information about the artist may also be displayed by selecting the about tab 1320c. FIG. 13b is a schematic view of one embodiment of the ECPP application interface of FIG. 13a after the playlists tab 1320d has been selected. The playlist tab 1330 may provide a listing of all or selected playlists 1340 that include or are similar to the selected item (e.g., artist Janelle Monae) 1335 ordered by relevance, popularity, or any other criteria. Similarly, FIG. 13c is a schematic view of one embodiment of the ECPP application interface of FIG. 13a after the item 1320f has been selected. As in the previous figures, the media display panel 1345 displays identifying information on the selected item, as well as a track listing. In addition, the information panel 1350 on the right may display playlists that are related to the selected item, and ordered using or one more criteria such as popularity, published date, relevance, and/or the like.

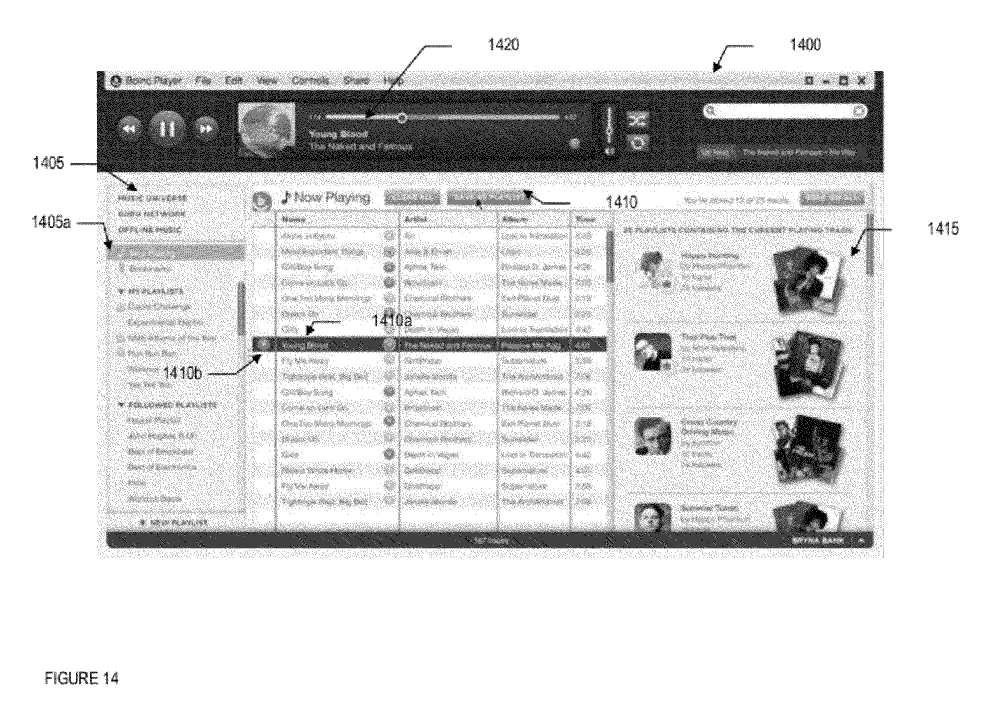

FIG. 14 is a schematic view of one embodiment of the ECPP application interface. The interface 1400 shown in FIG. 14 is rendered in response to the selection of the now playing item 1405a in the media explorer panel 1405. The media display panel 1410 may provide a listing of tracks that are in a play queue. Such a queue may include tracks that were previously played, is currently being played and are in queue for playing next. For example the track 1410a has been selected, and is the track being played as indicated by the indicator 1410b and by the player control panel 1420. Additionally, the information display panel 1415 on the right is updated in response to the selection of track 1410a. The information display panel 1415 may list playlists including the current playing track. Such a listing may be arranged based on one or more criteria such as popularity, preference, recently published, and/or the like.

### Discovery User Interfaces

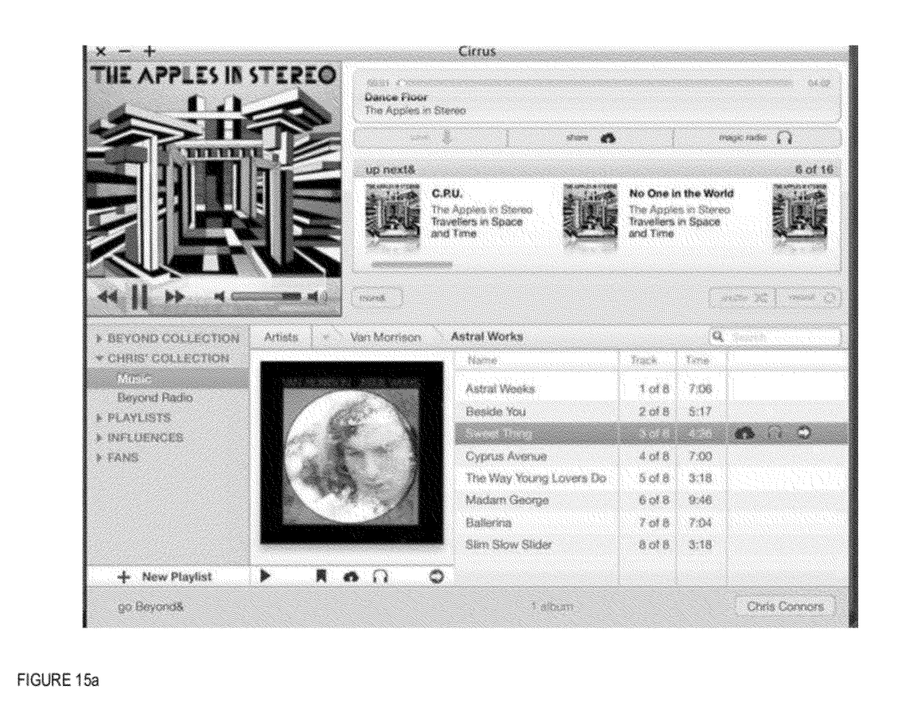

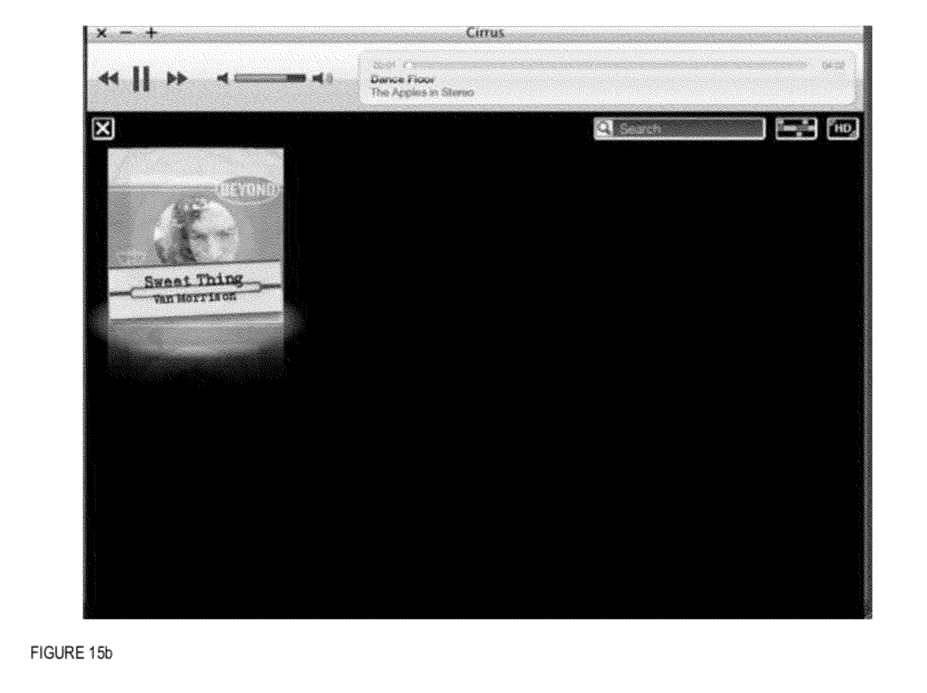

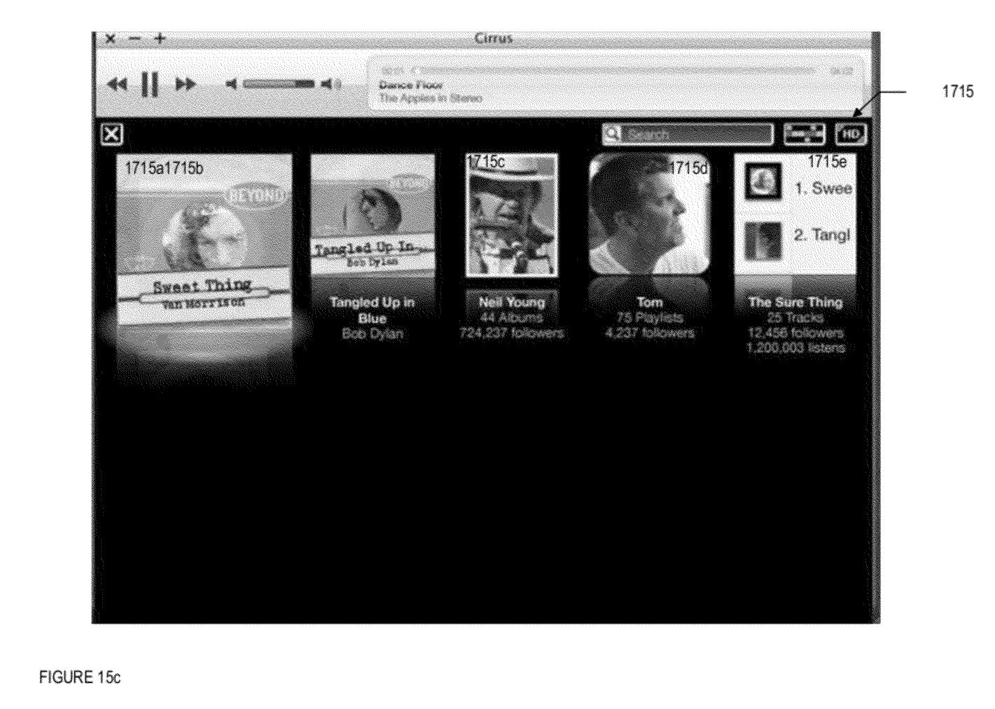

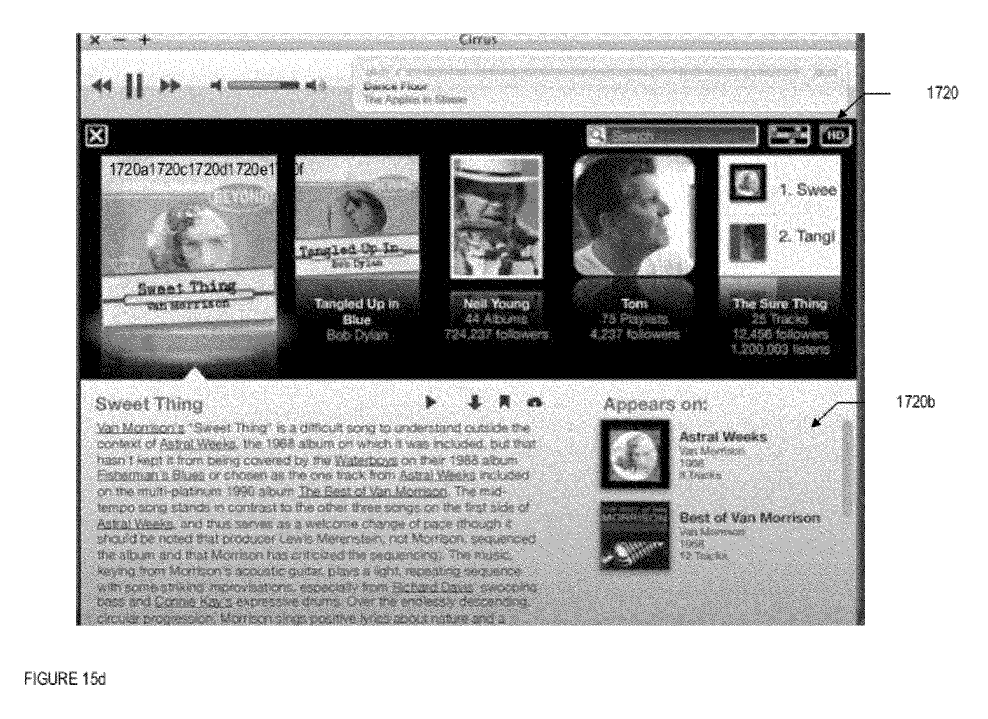

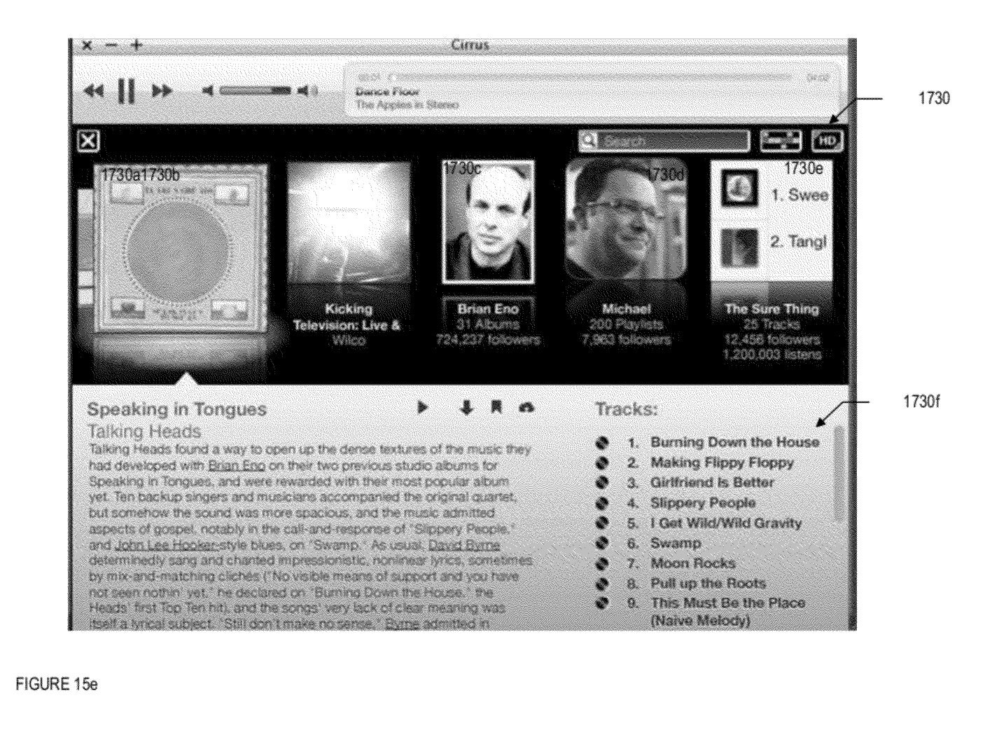

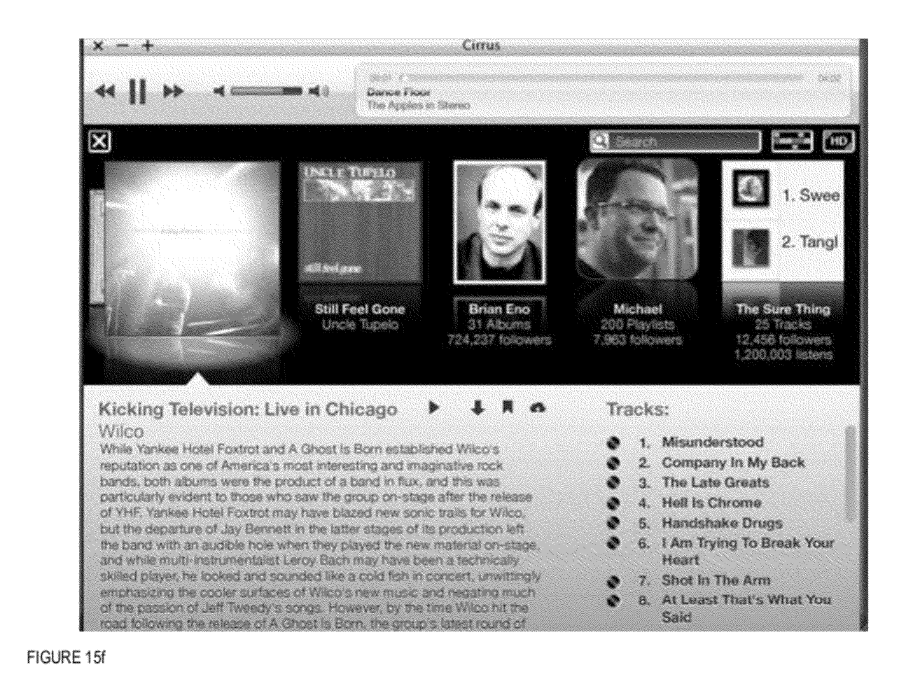

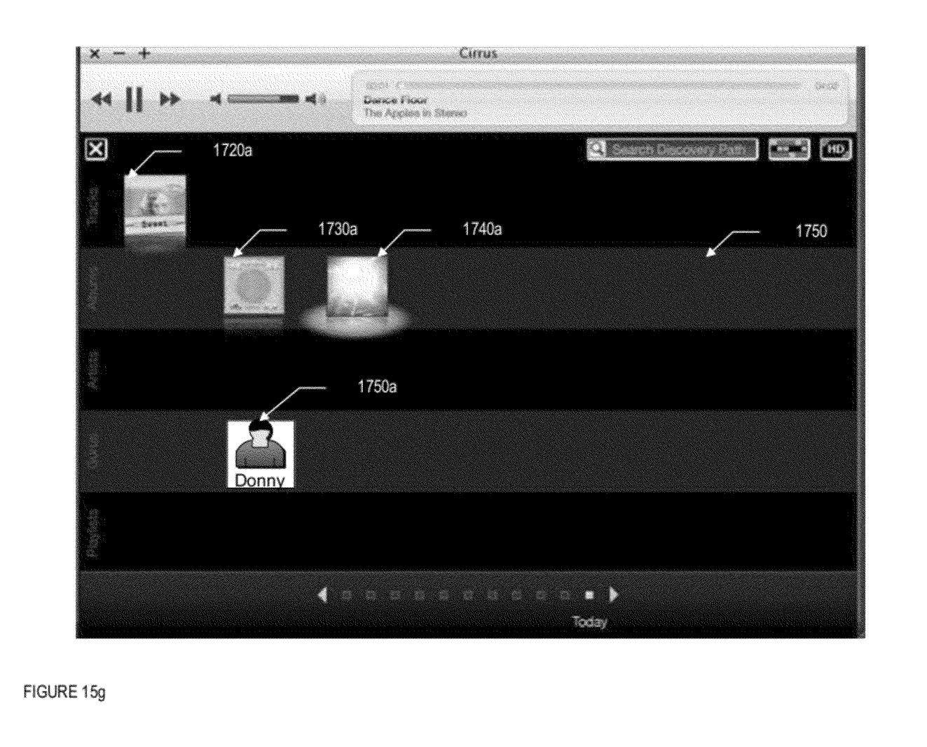

Referring now to FIGS. 15a-g, in one embodiment of the ECPP, there is shown a sequence of player interfaces as the user explores and discovers music related to an item. In general, the user may discover related music by selecting a displayed item, for example, the photo of Van Morrison at the bottom middle of FIG. 15a. The ECPP may then generate recommendations of related items based upon the selected item.

Referring again to FIG. 15a, the user may select an artist (“Van Morrison”), an album of the artist (“Astral Works”), and more specifically, a track in the album (“Sweet Thing”). Referring now to FIG. 15b, an image representing the track selected may be displayed in a stagelight/spotlight window. Referring now to FIG. 15c, images representing selected items 1515b-e related to item 1515a may be displayed in the stagelight window 1515. The images displayed in the window 1515 may include an image representing a related track 1515b, an image representing an album 1515c, an image representing another user 1515c and an image representing a playlist 1515d that includes tracks 1515a and 1515b. Referring now to FIG. 15d, the user may select the track 1520a, in response to which, the stagelight window 1520 is presented. The stagelight window 1520 may display additional information about that selected track 1520a and also albums 1520b in which the track may appear. Similarly, items 1520c-f may also be selected to obtain additional information. In addition, selection of one of the items 15e-f may reveal control options to scroll through other images corresponding to other tracks. The user may simply use click through the images.

Referring now to FIG. 15e, the stagelight window 1530 is updated to show the user selection of another item (“Speaking in Tongues”) image 1530a, causing it to overlay the item 152a image of FIG. 15d. Selection herein may include selecting a stagelight button or icon, double click, single click, right click and select stagelight or drag and drop. The user may now be presented with more information about the selected item 1530a and the images representing tracks, artists, and playlists related to 1520c-e have been replaced with images of an album 1530b (“Kicking Television: Live in Chicago”), an artist 1530c (“Brian Eno”) and another user offering playlists 1530d (“Michael”) related to item 1530a. In addition item 1530f may show the tracks in the selected item 1530a. Referring now to FIG. 15f, the user may select the item 1530b (“Kicking Television: Live in Chicago”) image from 1530b, causing it to replace the item 1530a image of FIG. 15e. The user may be presented with more information about the stagelit item 1540a and one or more updated items including 1540b.

Referring now to FIG. 15g, the user may be presented with a time line of their exploration/discovery sequence in the stagelight window 1550. The top row 1550a is for tracks and includes the track item 1520a from FIG. 15d. The track item 1520a was the first selected item in time sequence. The second row 1550b is for albums and includes album item 1530a from FIG. 15e. The album item 1530a came second in time sequence, after the track item 1520a. Similarly the third item selected in time sequence is the album 1540a from FIG. 15f. Other rows 1550 c-e (in order from top to bottom) are for “artists”, “Gurus” (other users like “Tom” and “Michael” with trusted recommendations) and playlists (like “The Sure Thing”). Thus, FIGS. 15a-g illustrate an exploration/discovery sequence in which the user is provided facilities, via the ECPP stagelight/spotlight user interface, to discover and play music related to an initial musical selection using recommendations of various sources including related tracks, related albums, related artists and trusted advisors (Gurus).

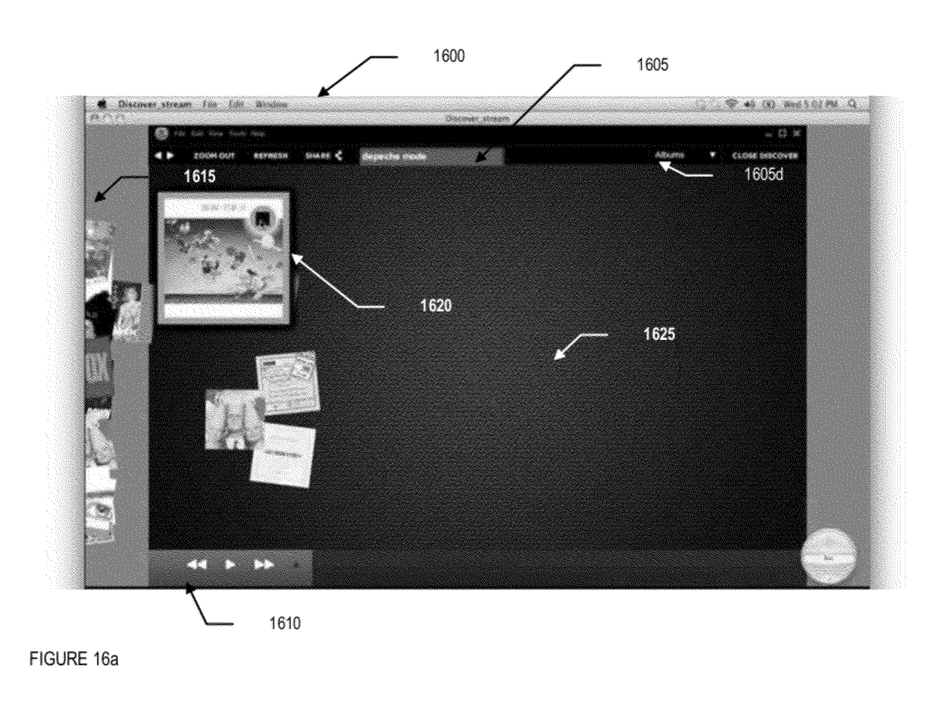

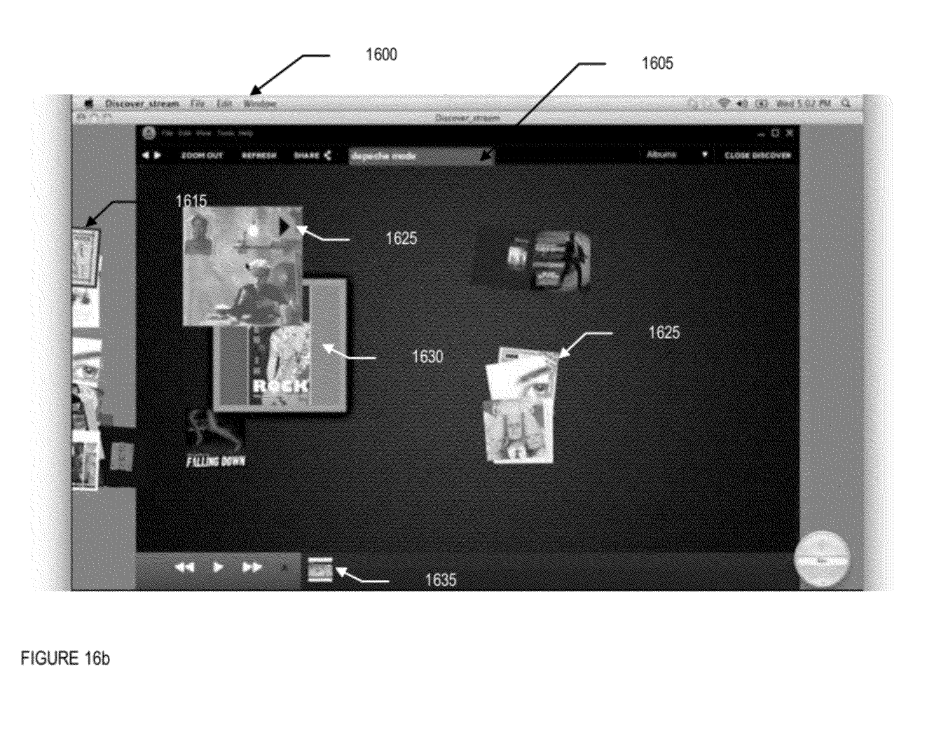

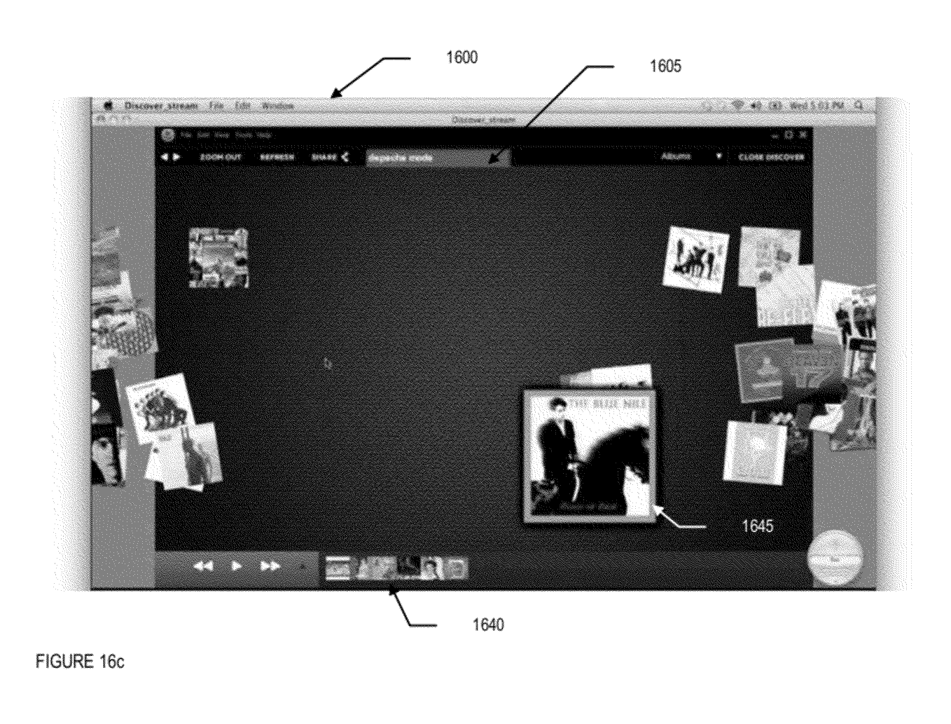

FIGS. 16a-c are schematic views of the discover stream component in some embodiments of the ECPP. As shown in FIG. 16a, the discover stream user interface includes a display window 1600. The display window further comprises an input text box 1605 where a user may input a content item name such as an artist, album, playlist, track, and/or the like. As shown in the FIGURE, an artist “depeche mode” is input as a content item seed, and an album view 1605d is selected. The display area 1625 displays a stream of albums of artists similar to “depeche mode.” Instead of an album view, users may select other views such as artists or tracks. When a content item seed is provided to the discover stream component, the recommendation engine may take the provided content item seed and generate other content items that are related to the seed. The discover stream component may then stream the related content items, i.e., albums 1615 from the left side of the screen to the right side. At any time a user may click or select an album 1630 as shown in FIG. 16b. The selection may cause the discover stream component to take the selected album 1630 as an input to the recommendation engine to regenerate an album stream related to the selected item 1630. The selected item may stay stationary while related albums may continuously stream from the left to the right. A user may also hover a curser over an album 1625 to display control icons such as play, stop and pause. In one implementation, the discover stream component may allow the user to play a representative track which may include, without limitation, a track selected at random, the most popular track, a track determined to be most likely of interest to the user by the recommendation engine, the most frequently played track, the most highly recommended track, and/or the like.

In one implementation, the discover stream interface may also keep track of and display all selections made by a user. The bread crumb panel shown in FIG. 16b shows an icon 1635 of the selected album. Further, FIG. 16c shows a bread crumb panel 1640 that includes six album selections made by the user. The bread crumb panel establishes a sequential history of the selections made by the user. In one implementation, the user may select any of the album icons and may perform a variety of operations including, but not limited to: play a track, download the album, create a magic playlist, share the album, download the album to a cache memory, download the album to your local client library, and/or the like.

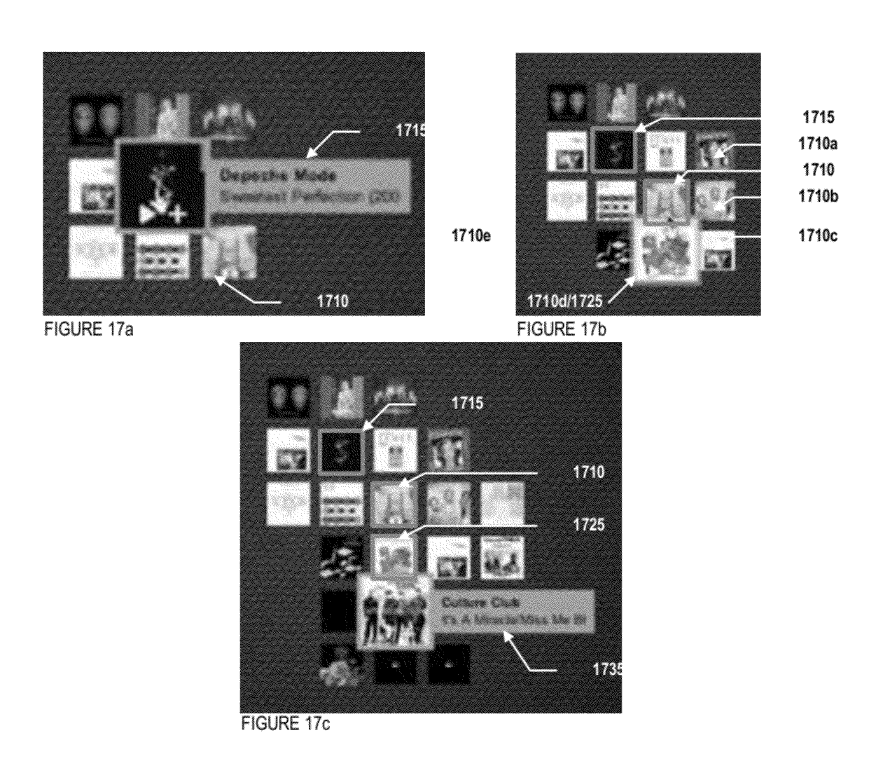

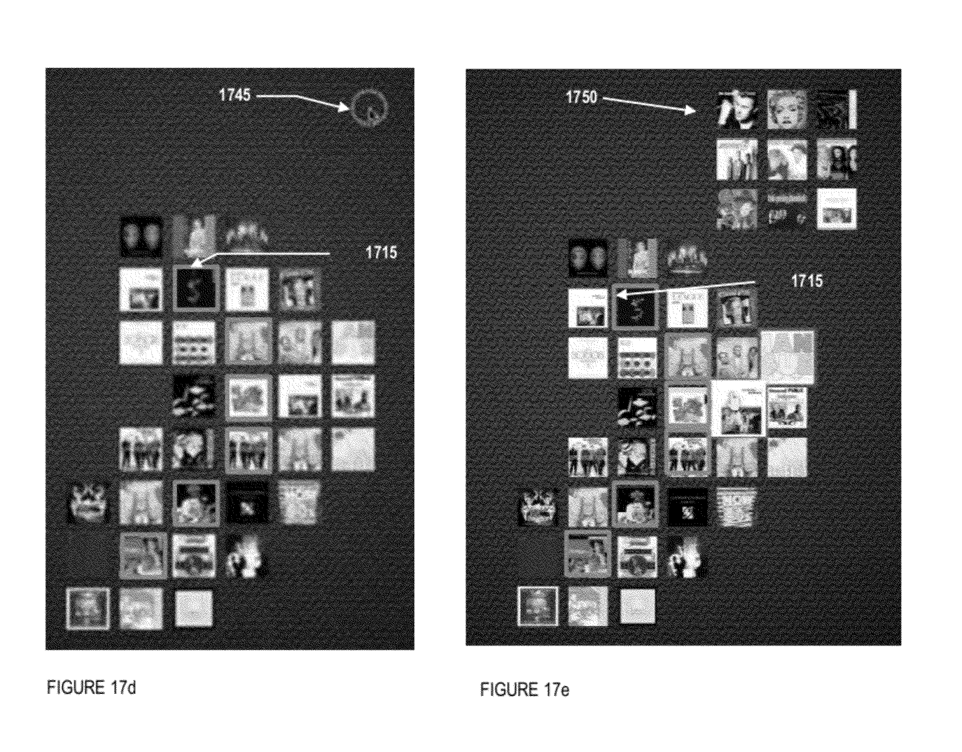

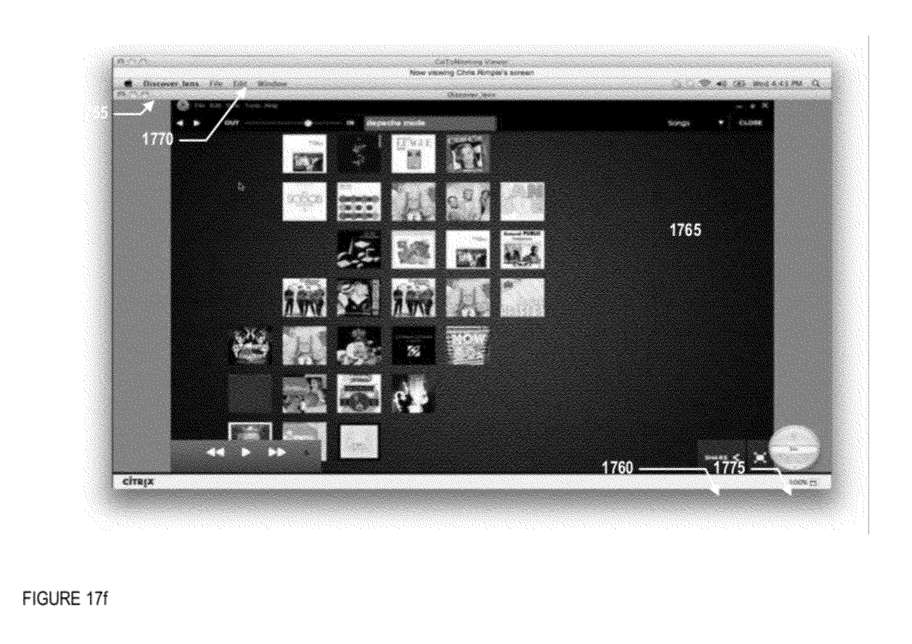

FIGS. 17a-f are schematic views of the discover lens component in some embodiments of the ECPP. As in the discover stream component of FIGS. 16a-c, a user may enter a content item seed as an input (for e.g., “depeche mode”). When a track view is selected, the recommendation engine may generate tracks (e.g., track 1710) that are similar to the track 1715 by the artist depeche mode. As shown in FIG. 17a, the related tracks including track 1710 may be rendered around the seed track 1715. In one implementation, a user may select the seed track 1715 to play the track or add the track in a playlist, download to the client, share with other users, and/or the like. In some implementations, the seed track may be selected based on the user-provided track input. In other implementations, the seed track may be derived from the user provided content seed such as an artist name, album name or a playlist name. In a further implementation, a representative track may be selected for the track view. The representative track may be a track selected at random, the most popular track, a track determined to be most likely of interest to the user by the recommendation engine, the most frequently played track, the most highly recommended track, and/or the like.

When the user selects the track 1710 from FIG. 17a, the discover lens component interface may be updated to display a collection of tracks as shown in FIG. 17b. Here the nine tracks from FIG. 17a are displayed, with track 1715 being displayed in a bounding box. Further, track 1710 is also displayed in a bounding box. In one implementation, a track that was previously selected or is currently selected may be displayed in a bounding box. When track 1710 is selected, the recommendation engine generates related tracks 1710a-e. The user may then continue to select any of the displayed tracks (e.g., track 1710d) and obtain more related tracks. In this way, the discover lens component may facilitate a visual lens like discovery of related content items. Furthermore, as shown in FIG. 17c, the discovery lens component may also map out the discovery path traversed by the user. For example, from FIG. 17c, it is clear that the user selected track 1715, track 1710, track 1725 and track 1735 to generate the tracks displayed. In one implementation, the discovery path and the related tracks displayed may provide an indication of how far the user has traveled from his or her initial selection of track 1715 to the last selected track 1735. The distance between track and track 1735 may visually show the degree of relatedness between the tracks.

In some implementation, the discovery lens component may support clicking and holding the cursor at a location 1745 in the display window farther away from the center (the seed track 1715), as shown in FIG. 17d. The action may then result in a cluster of related tracks 1750 shown in FIG. 17e. The cluster 1750 is not only visually farther out from the origin (the seed track 1715), but also in terms of relatedness with respect to the seed track 1715.

In one implementation, the discover lens component interface may include facilities for retrieving and displaying a prior search. FIG. 17f displays a back/forward icon 1755 that may be utilized to go back or forward a pre-defined number of past searches, even when the searches were carried out in separate sessions. In one implementation, these search results may be stored as a series of numbers in a grid based format, such that with the location of the grid and identifier of the track (e.g., track ID), the entire display of related tracks may be accurately regenerated and displayed for the user. In another implementation, these search results may be stored in an array, which could be used for reproducing the lens map 1765. In a further implementation, the discover lens component may include a share icon 1760. Via the share feature, the user may share the lens map 1765 with other users. In one implementation, the lens map 1765 including the display of related tracks may be shared as an image file (e.g., JPEG, PNG, TIFF, BMP, and/or the like), as a reproducible list, in an email among others. In the case of the reproducible list in an email or in comment stream, the recipient may load the file in the discovery lens component interface and obtain the lens map 1765. Various other features such as zoom 1770 and maximize 1775 may also be available for the user to customize his or her viewing preferences.

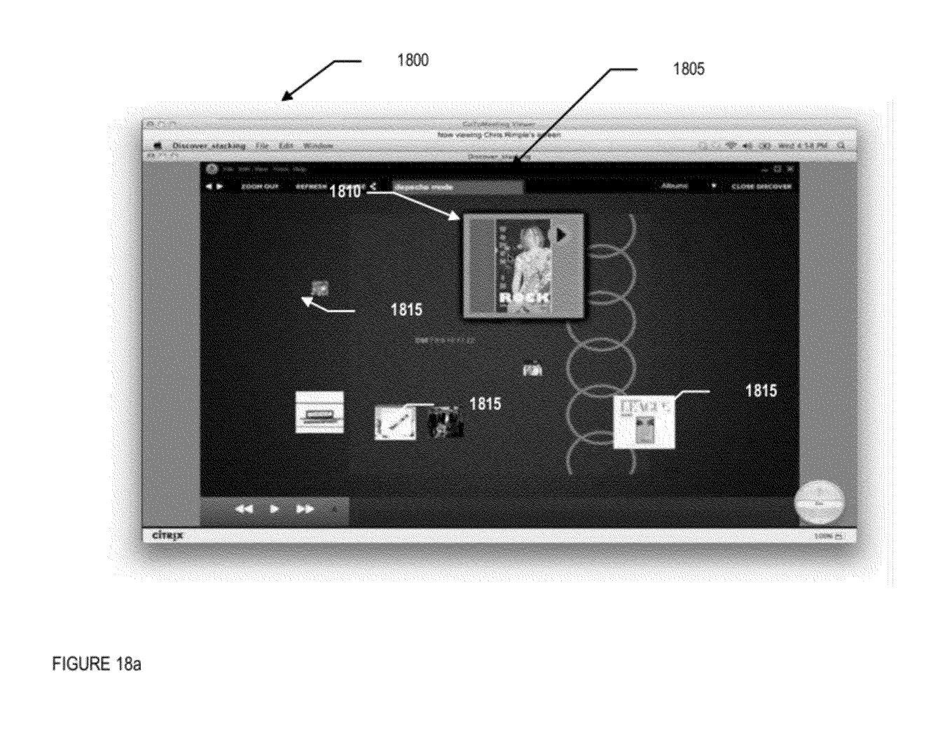

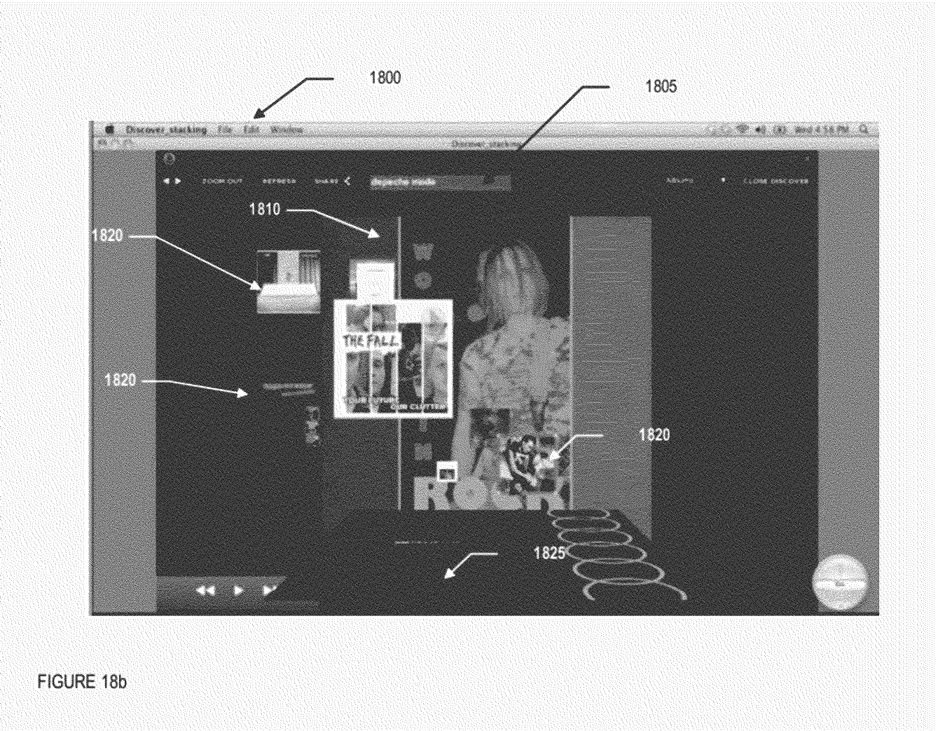

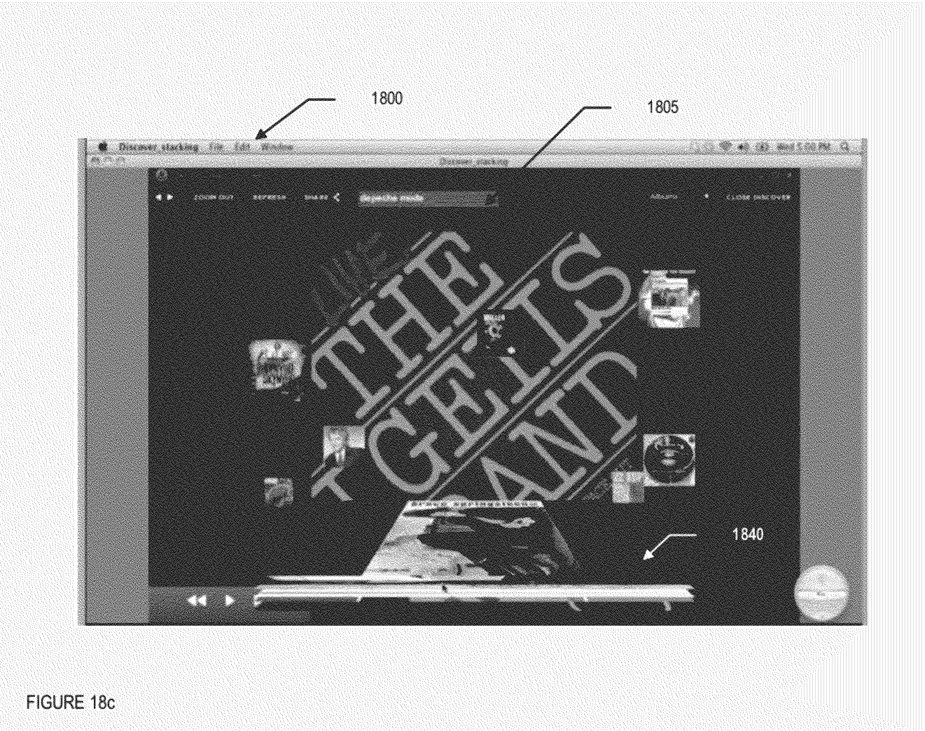

FIGS. 18a-c are schematic views of the discover stacking component in some embodiments of the ECPP. In some implementations, the discover stacking component interface may include a display window 1800, similar to that of the discover streaming and lens components. A user may enter a content item name in the input entry box 1805. In this example, an artist name “depeche mode” is entered. The recommendation engine may then take this input and run its algorithm to identify related albums 1815 (or songs, playlists, artists, etc.). Thumb nails of the identified related albums 1815 may be displayed on the window. In some implementations, the thumb nails of the album covers may shrink and grow to gain the user's visual attention. In one implementation when a user selects an album 1810 (shown in FIG. 18a), the selected album may be brought to the forefront and the previously selected album 1825 may be added to the album stack (shown in FIG. 18b). When the album 181o is selected, related albums 1820 may be identified and displayed as shown in FIG. 18b. The user may repeatedly select various albums as he or she is discovering music. As the user continues to select albums, the discover stacking component may continue to provide new recommendations as well as add the last selected album continues to the stack 1840, making the stack 1840 grow as shown in FIG. 18c. In a further implementation, the discover stacking component may allow the user to peel away albums from the stack 1840 in a manner similar to flipping through a stack of record. In some implementations, facilities for sharing and publishing may be provided to the user.

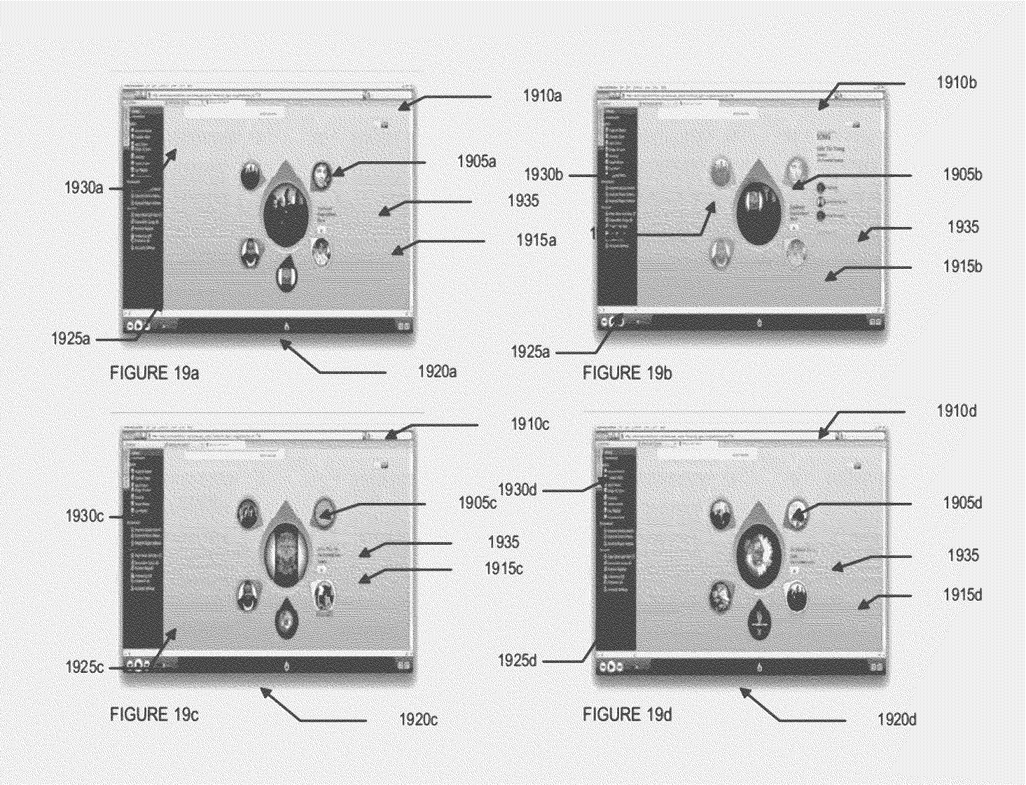

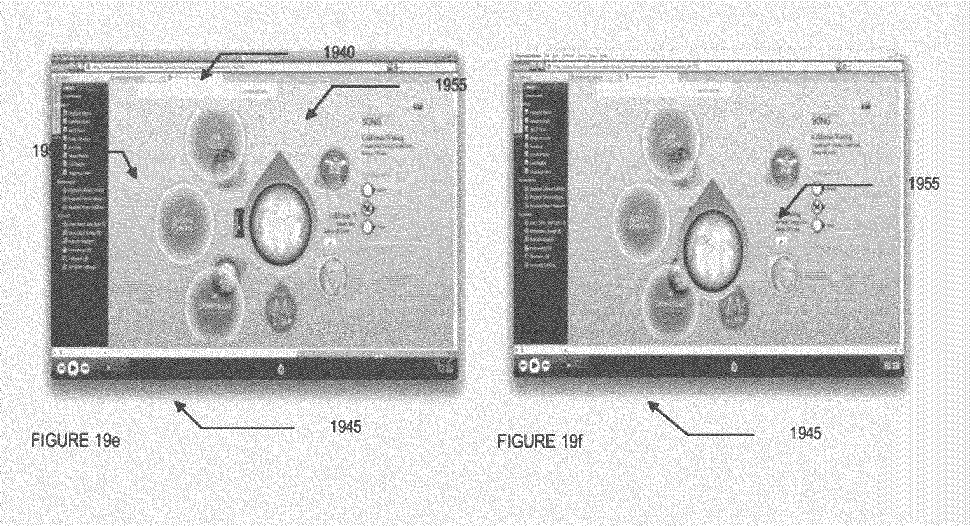

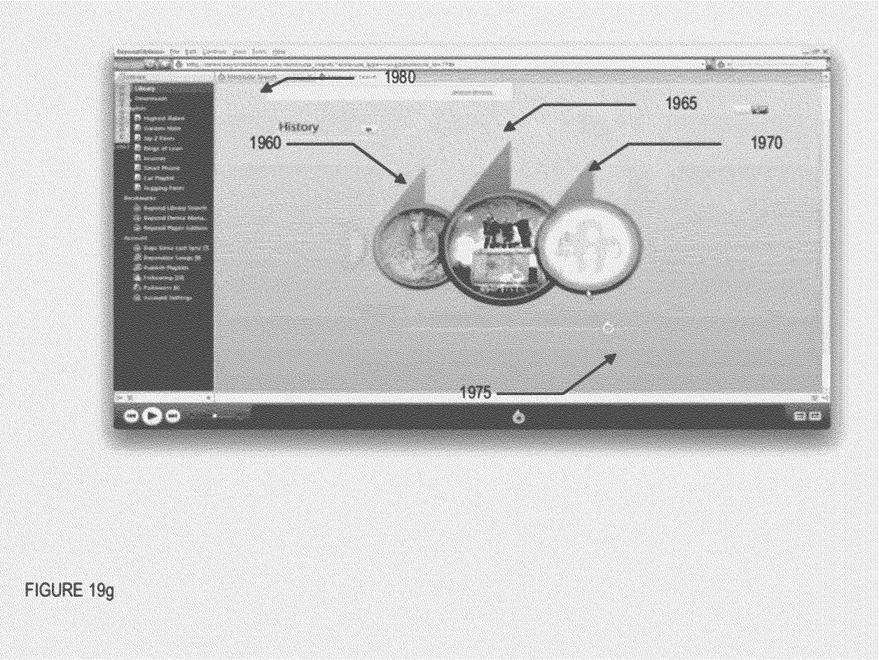

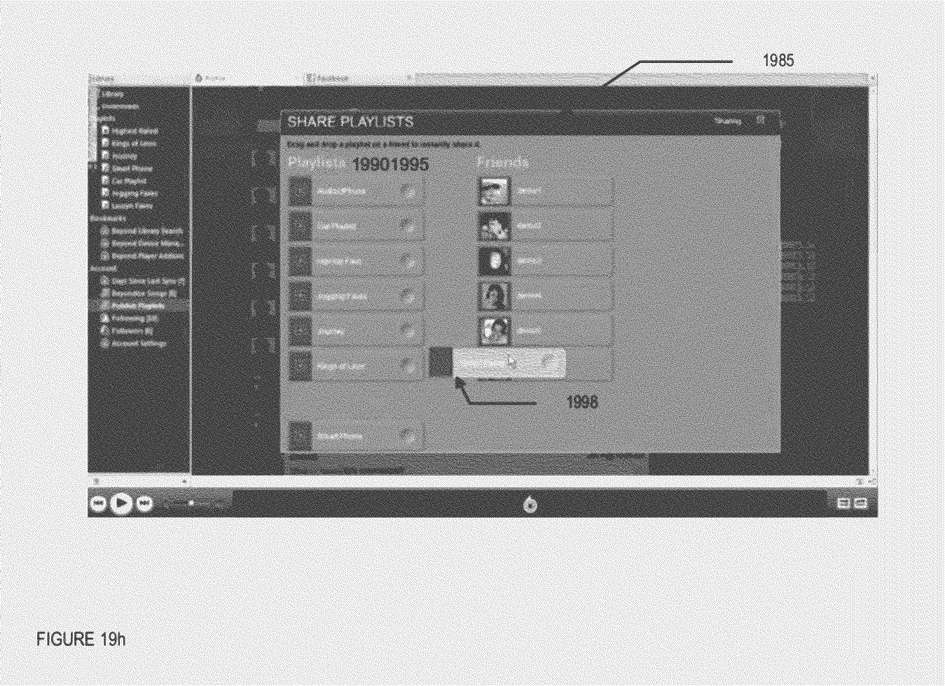

FIGS. 19a-g are schematic views of the molecular discovery component in some embodiments of the ECPP. In some implementations, the molecular discovery component interfaces may facilitate content discovery related to their selection. In FIGS. 19a-d, the center molecule 1905a-d respectively represents the selection. It is also the user's entry point as well as search subject. Surrounding the center molecule are top related results by category for album 1910a-d, artist 1915a-d, song 1920a-d, Guru 1925a-d, and genre 1930a-d. The user may follow a new path of discovery by dragging any result in the surrounding categories and dropping it to the center, where that center molecule becomes the new subject and is surrounded by top results directly related to the category.

FIG. 19b shows the song molecule 1920a of FIG. 19a dragged and dropped into the center molecule 1905a. As a result of this action, the song molecule 1920a becomes the center molecule 1905c as shown in FIG. 19c. The molecular discovery component then generates top results for the surrounding categories 1910c, 1915c, 1920c, 1925c and 1930c based on the search subject 1905c. FIG. 19d shows the resulting display after the song molecule 1920c (from FIG. 19c) is dragged and dropped into the center molecule 1905c. As shown in FIG. 19d, the top results for the surrounding categories 1910d, 1915d, 1920d, 1925d and 1930d are also refreshed to reflect the new search subject 1905c.

In some implementations, the molecular discovery component may include facilities for sharing, adding to playlist, downloading to local client, publishing, creating a magic playlist and/or the like. For example, in FIG. 19e, several bubbles for share 1940, add to playlist 1950 and download 1945 are shown surround the center molecule 1955. The bubbles may be displayed when the user selects or hovers over the center molecule. The center molecule may then be instantly shared, added to a playlist or downloaded by an action such as drag and drop. FIG. 19f shows a schematic view where the center molecule 1955 is being dragged and dropped into the bubble for download 1945. As a result of this action, the molecular discovery component may download the item in the center molecule in the user's local client. In some implementations, the center molecule and/or surrounding molecule items that are non-local may be automatically cached in the local client.

In some implementations, the molecular discovery component may track the search subjects in the center molecule over time and display an interactive historical crumb trail as shown in FIG. 19g. The historical crumb trail 1980 may include a scroll bar 1975 which may be scrolled forward or backward to view the search subjects 1960, 1965 and 1970. In a further implementation, the historical crumb trail may not only show the historical path taken by the user, but also a predictive path forward. The predictive forward path may be determined by the music intelligence component based on the user's past listening history, preferences, interest and/or social graph, Gurus, and/or the like.

In some other implementations, the molecular discovery component may also include an interface for sharing playlists or other content items with other users. An example interface is illustrated in FIG. 19h. The playlist items 1990 are shown on the left, while a list of the user's friends 1995 are shown on the right. In some implementations, the interface may include an option to select other content items such as artists, albums, songs, libraries, collections, and/or the like. Similarly, in some implementations, there may be granularity in selecting friends (e.g., all friends, n degree of friends, family, co-workers, and/or the like). In the implementation shown here, the user may select a playlist item 1998 and may drag and drop the playlist item 1998 to any friends he or she desired to share his or her playlist with.

### Mobile Application User Interfaces

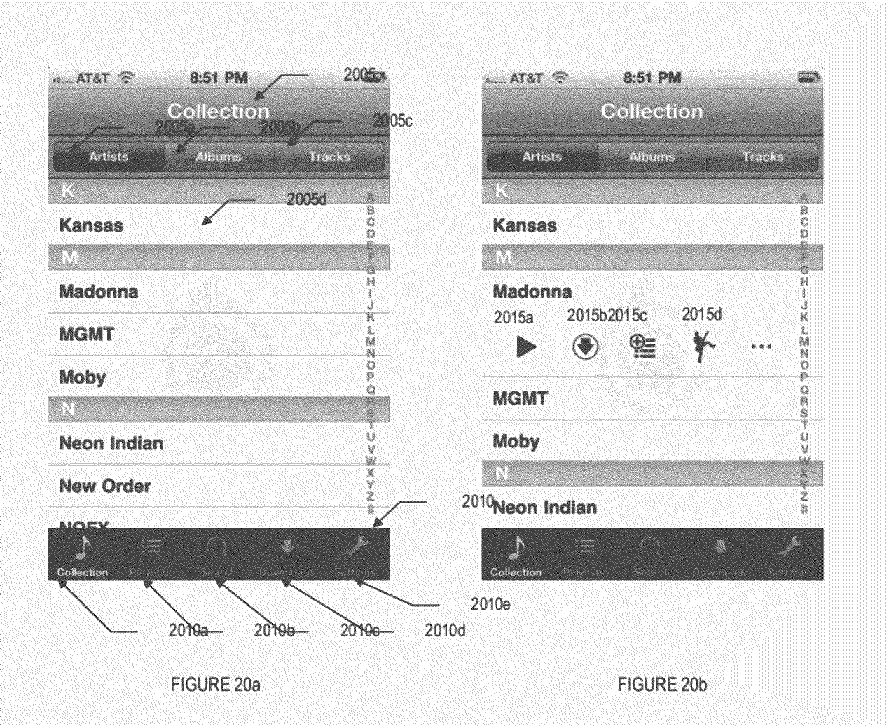

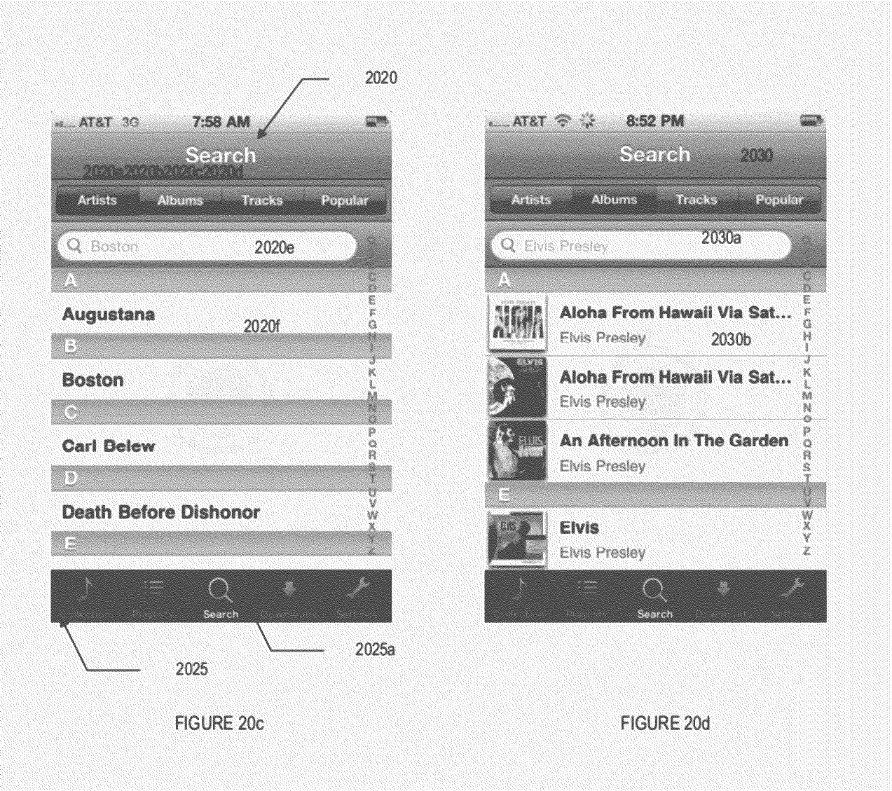

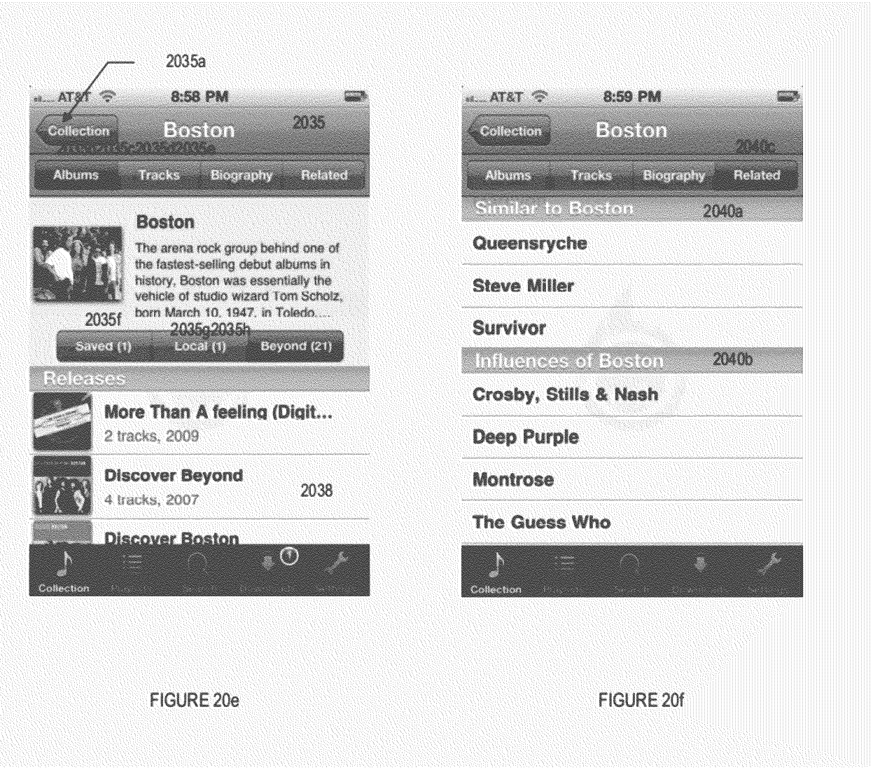

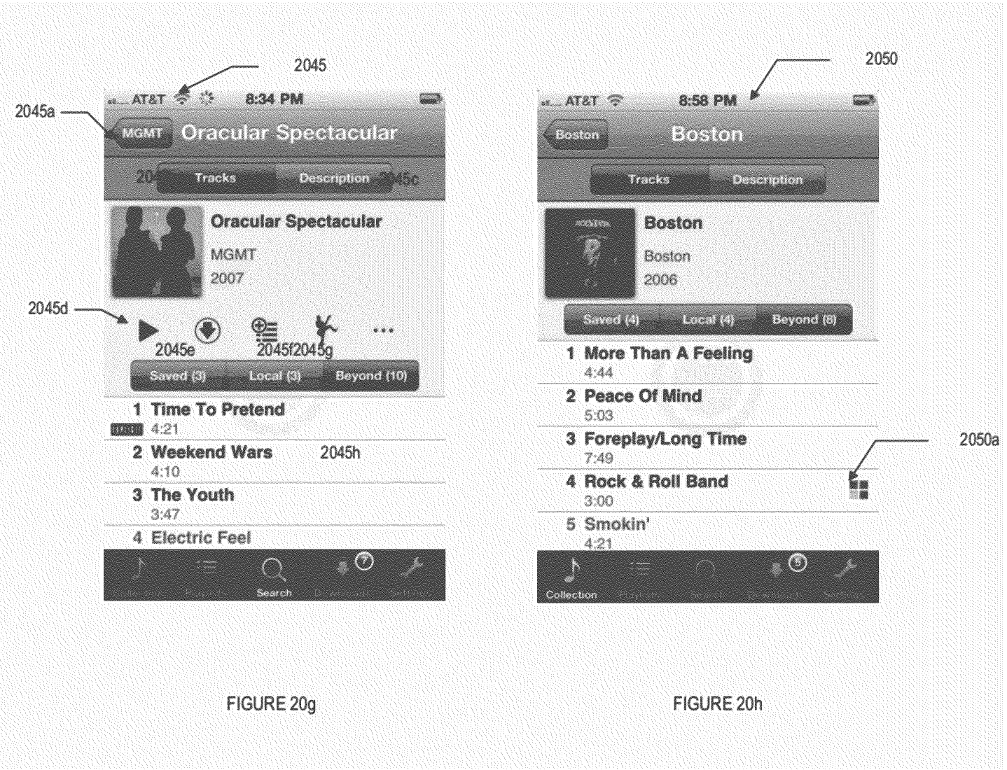

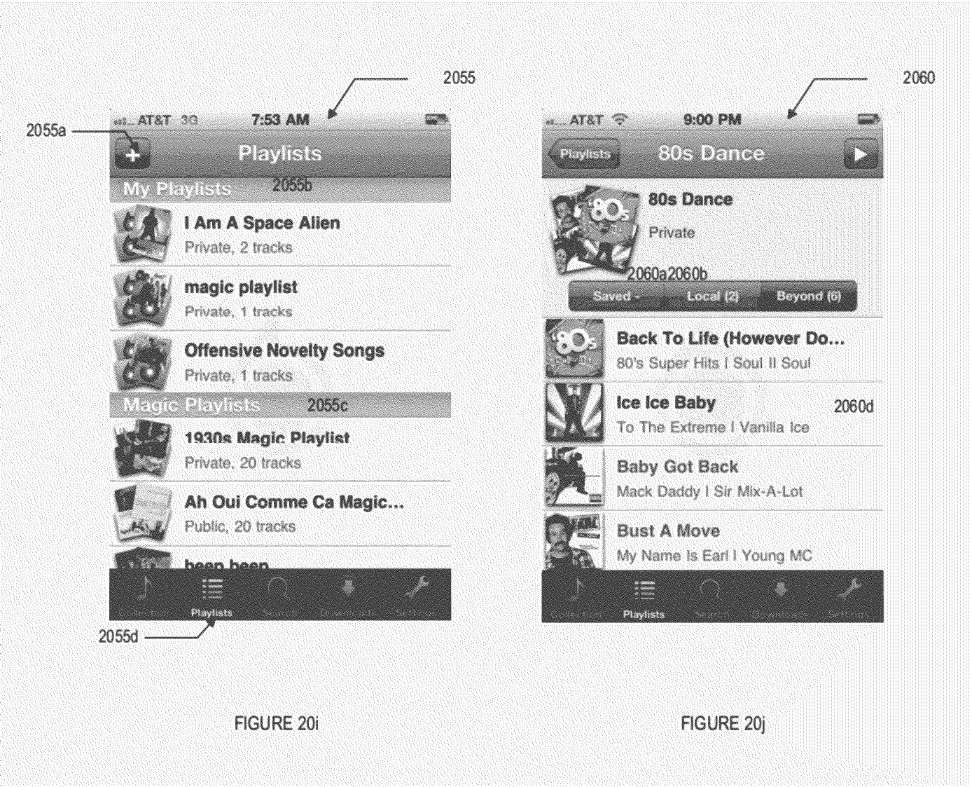

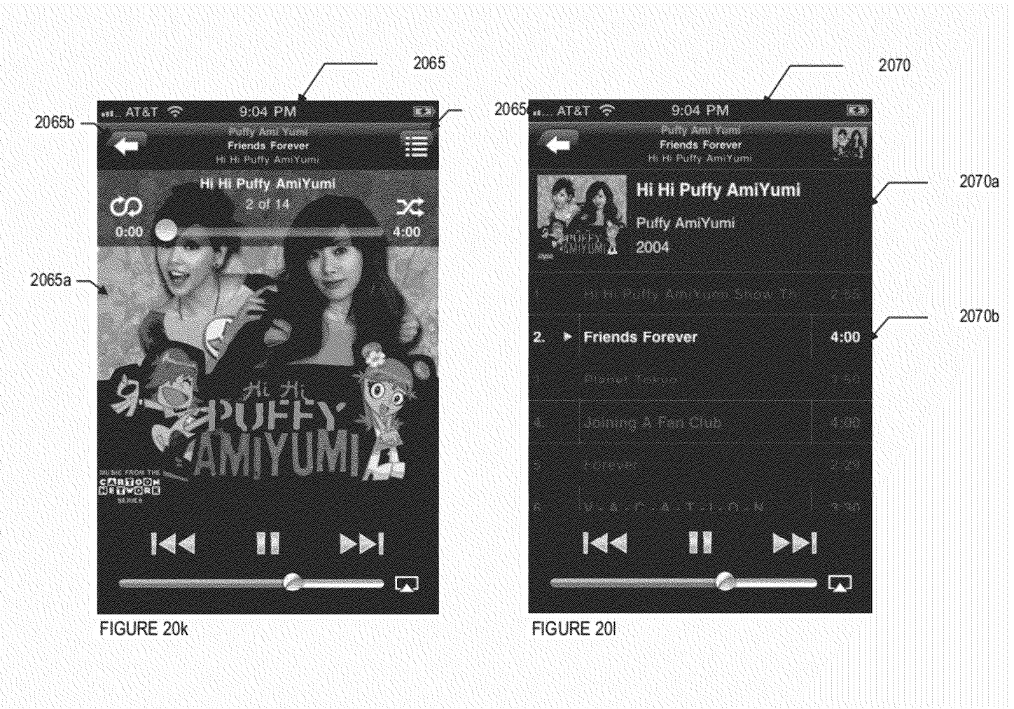

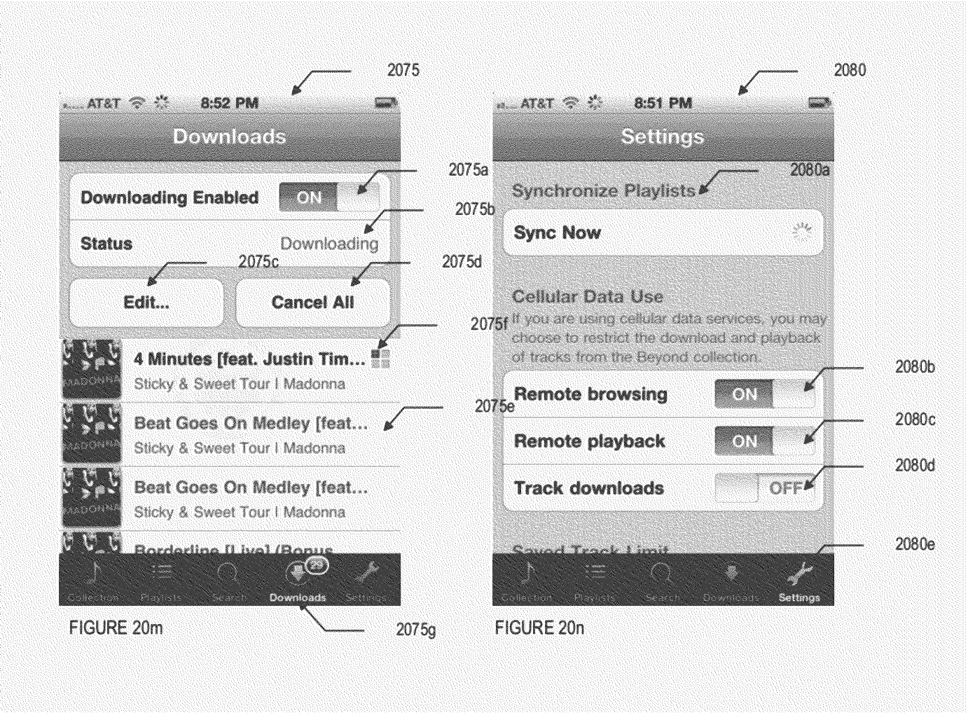

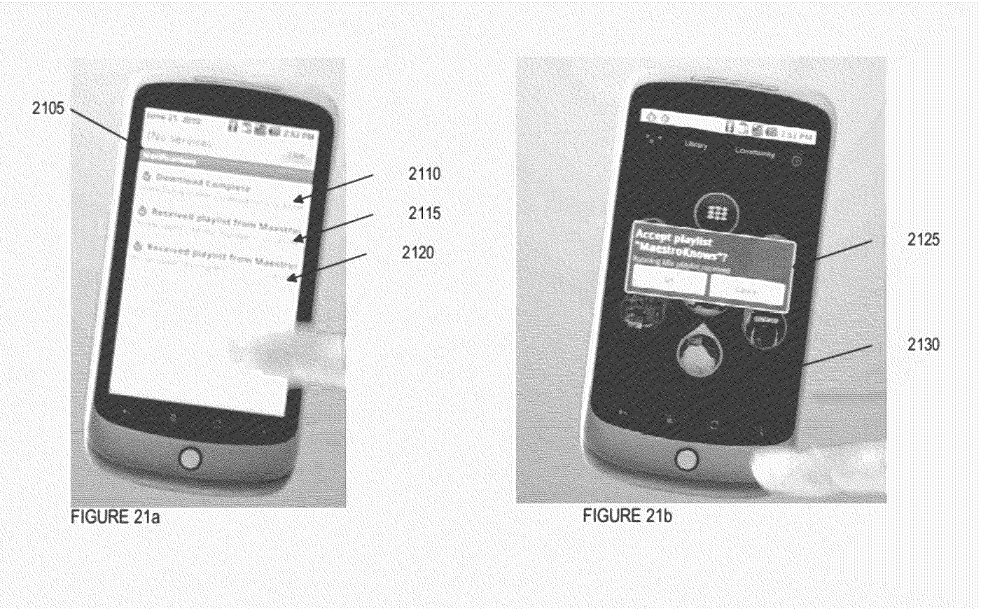

FIGS. 20a-n are schematic views of the mobile application user interface in some embodiments of the ECPP. FIG. 20a shows artist view of the collection interface 2005. The interface 2005 includes a navigation bar 2005, buttons 2005c-d, a display panel 2005e and a tab bar 2010. When the collection icon 2010a is selected along with one of the artist, album or track button, a table view of the selected artist, album or track is displayed in the display panel 2005d. Referring now to FIG. 20b, when a user performs a swiping action over an artist item (e.g., Madonna), the artist view may expose functionality such as play/pause 2015a, download 2015b, add to playlist 2015c, share 2015d, and/or the like.

Referring to FIGS. 20c, when a search icon 2025a in the tab bar 2025 is selected, the search navigation bar 2020, along with buttons 2020a-d, a search bar 2020e and a table view 2020f may be rendered. As shown in the figure, when the artist button 2020a is selected, and a search item “Boston” is entered in the search bar 2020e, the results 2020f may be displayed in table or other views. As shown in FIG. 20d, a similar search may be conducted for the album view 2030a. For example, an album name “Elvis Presley” may be entered in the search bar 2030b, and search results 2030C in album view may be displayed in the display pane.

Referring to FIG. 20e, when a user selects an artist (“Boston”), the interface 2035 may be rendered. Options for several views including album 2035b, tracks 2035c, biography 2035d and related items 2035e may be provided. As shown in FIG. 20e, when the album view 2035b is selected, information about the artist may be displayed in area of the display panel 2036. In addition, options to view saved, local and beyond albums may be available. When the saved view 2035f is selected, the display area 2038 displays only those albums that have been saved or bookmarked. When the local view 2035g is selected, the listing in 2038 includes only the albums that are available locally, the albums being stored in the memory of the mobile device. Similarly, when the beyond or cloud view 2035h is selected, the entire list of albums released by the selected artist (“Boston”) and available in the ECPP catalog may be displayed in table view in the display area 2038.

FIG. 20f is the schematic view of the interface 2035 from FIG. 20e after the selection of the related view 2035e. This related artists view 2040 may display in table view or other format, artists that are similar to the selected artist (“Boston”) in a display panel portion 2040a. In addition, influences of the selected artist (“Boston”) may also be provided in another display portion 2040b.

Referring to FIG. 20g, when a user in an album view swipes an album (“Oracular Spectacular”), the interface 2045 is displayed. The user has the option to go back to the last view by tapping on the last view button 2045a (last view was artist view and is labeled by the name of the artist “MGMT”). The user may also be provided with options to select track view 2045b which displays identifying information related to the selected album in a display panel portion 2045h and a control bar 2045d for play/pause, download, add to playlist, share and other functionalities. Additionally, a location status bar 2045e may also be provided, from where the user may select saved, local or beyond/cloud views of the tracks in the selected album. For example, as seen from the status bar 2045e, 3 tracks from the album have been saved or bookmarked, 3 tracks of the album are available locally, and similarly, 10 tracks of the album are available in the cloud catalog. The tracks corresponding to the status bar selections may be displayed in table view in the display portion 2045h. The description view 2045c may display information relating to the album and/or artist. Referring now to FIG. 20h, the interface 2050 displays an album track list in cloud view similar to FIG. 20g. Also shown next to track 4 is a caching icon 2050a indicating the track being played/cached.

Referring now to FIG. 20i, as indicated by the navigation bar and the selected playlists icon 2055d in the tab bar, a playlists view 2055 is displayed. The interface includes a listing of playlists 2055b (“my playlists”) and a listing of magic playlists 2055c. For each playlist, information such as sharing status (public/shared or private) and the number of tracks included may be identified. There may also be an option for the user to add or create playlists using the icon 2055a on the top left corner of the interface.

Referring now to FIG. 20j, the user may explore any of the playlists displayed in the playlists view of FIG. 20i. Here, the playlist “80s Dance” has been selected. In this view, a saved option 2060a, a local option 2060b and a beyond/cloud option 2060c on a location status bar are displayed for selection. In addition, the cloud view of the tracks in the playlist is shown in the display panel portion 2060d.

FIG. 20k is a schematic view showing the now playing track in one embodiment. The interface 2065 includes a navigation bar 2065a, with a back button 65b to go to the last selected item and a playlist icon 2065c which when selected causes the interface shown in FIG. 201 to be displayed. FIG. 201, as discussed, shows the playlist view with the track 2070b that is up next highlighted.

Referring to FIGS. 20m-n, some embodiments of the mobile application platform may include settings for configuring the download manager and user settings. Shown in FIG. 20m is the download manager interface 2075. The download manager interface may include options to enable or disable downloading by sliding or tapping button 2075a. Additionally, the current download status may also be identified at 2075b. Examples of status include downloading, completed, not started, paused, canceled, error etc. The interface may also display a download queue 2075e that lists the tracks that are in queue for downloading. As shown in FIG. 20m, the item that is currently being downloaded is identified by the icon 2075f. The download manager interface may also include options to edit the download queue using the edit button 2075c. Editing may including changing the order of the tracks in the queue by simple swiping motions, deleting/canceling selected tracks from the queue, etc. Additionally, the cancel all button 2075d may be used for canceling the download of all the tracks in the queue.

FIG. 20n is a schematic view showing the user settings management interface 2080. The settings management interface may be launched from the settings option 2080e on the tab bar. Using this interface, a user may configure his or device to manage synchronization, memory usage, network usage, and/or the like. As shown in FIG. 20n, the sync now option 2080a may be selected to synchronize playlists between the device and the cloud or another device. For example, the user may create a playlist in his or her mobile device. This playlist may be saved locally in the device memory until the user selects the sync now option. As a result of the syncing, the playlist may be saved in his or her beyond/cloud account. Additionally, the playlist now stored in the beyond/cloud account may be downloaded/synced with one or more LDs.

The settings interface may also be utilized to configure cellular data use. Cellular data plans subscribed by users may vary. While some users may have unlimited data plan, others may have a limited monthly plan (e.g., 2 GB/month) and may like to limit the amount of data downloading. In such a situation, the user may set on or off the remote browsing 2080b, remote playback 2080c and track downloads 2080d.

### Content Identification Component

In one embodiment of the ECPP, facilities may exist for incorporating a user's existing collection of music tracks to the ECPP music library (“beyondization”). The user may opt in to the beyondization service to obtain copies of some or all of his or her existing tracks in one or more formats at a variety of bitrates selectable by the user. The user may also choose whether to hold on to their existing files, back them up, or delete them (e.g., to save disk space). Benefits offered by beyondization may include opportunity to replace low quality tracks with higher fidelity versions and/or replace tracks that have missing metadata. In one implementation, tracks that have been beyondized may be shared or duplicated as only LDs may be able to play tracks obtained from the ECPP library. However, in other implementations, when the user chooses to not beyondize, the ECPP may not support sharing, duplicating, playlist creating, etc., activities utilizing the ECPP.

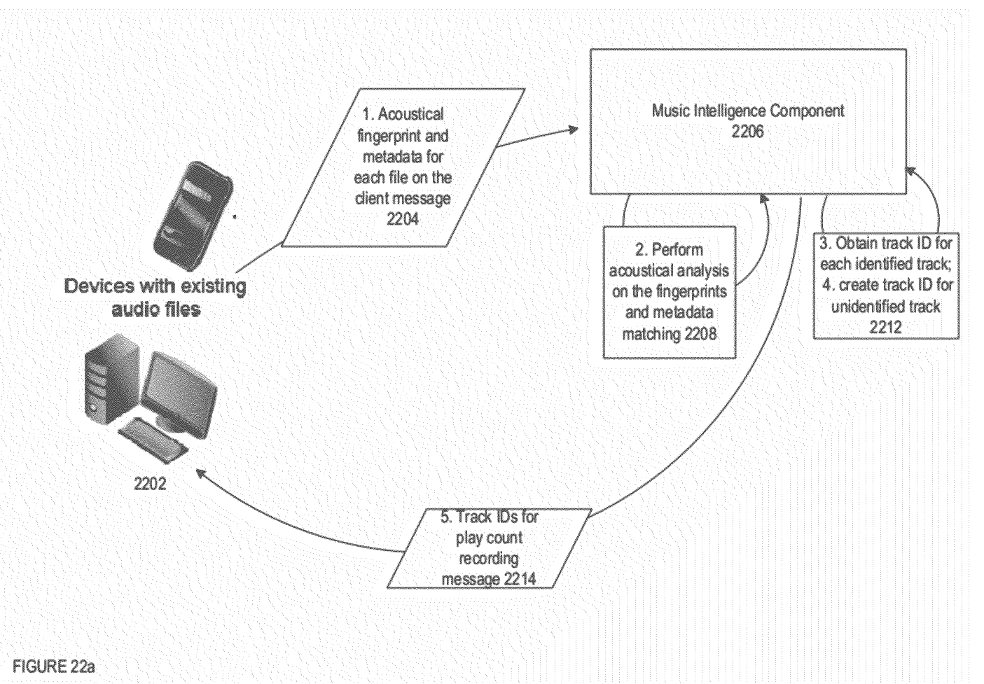

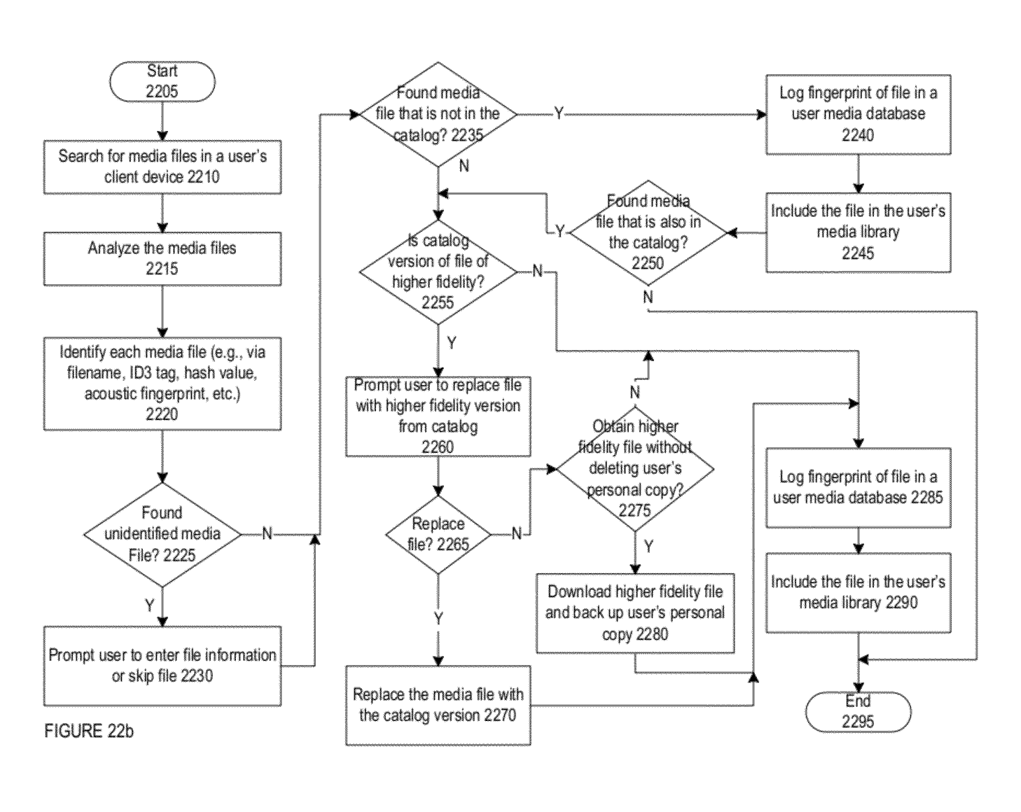

FIG. 22a is a data flow diagram of an example content identification component in some embodiments of the ECPP. Content identification may be initiated at the devices 2202 with existing audio or other media files. In one implementation, a request to identify content items from the device 2202 may be sent to the music intelligence component 2206. The request message may packaged as an HTTP(S) POST message and may include information such as acoustical fingerprints and metadata of each file on the client. An example content identification request message 2204 may be in XML format substantially in the following form:

```
POST /beyondization.php HTTP/1.1
Host: www.websitename.com
Content-Type: Application/XML
Content-Length: 1306
<?XML version = “1.0” encoding = “UTF-8”?>
<Beyondization>
          <Username>dingdong555@gmail.com</Username>
          <Timestamp>20xx-02-22 15:22:43</Timestamp>
          <ClientDetails>
                <ClientIP>192.168.23.126</ClientIP>
                <ClientType>smartphone</ClientType>
                <ClientModel>HTC Hero</ClientModel>
                <OS>Android 2.2</OS>
                <AppIinstalledFlag>true</AppInstalledFlag>
          </ClientDetails>
          <TrackDetails>
              <FingerprintID1>ABF6789</FingerprintID1>
              <FingerprintID2>ASF6H88</FingerprintID2>
          .
          .
          .
              <FingerprintID78>A7GHK33</FingerprintID78>
          </TrackDetails>
          <MetaData>
            <Track1>
                <genre>blues</genre>
                <artist>Blue man</artist>
            </Track1>
          .
          .
          .
            <Track78>
                <album>Nevermind the Wishkaws</album>
                <songtitle>smells like</songtitle>
            </Track78>
          </MetaData>
</Beyondization>
```

In one implementation, the music intelligence component 2206 may perform acoustical analysis on the fingerprints and metadata matching of the obtained files at 2208. At 2212, for each identified file, the music intelligence component may determine the corresponding track ID. In a further implementation, for files that are not recognized, or that are not present in the ECPP catalog, a new track ID may be generated. In a further implementation, one or more metadata database and/or tables may be periodically queried for identifying the unidentified files. In one implementation, the generated track IDs may be sent in a HTTP(S) POST response message 2214 to the client 2202 for play count recording and/or other customer usage recording purposes. An example response message 2214 may be in XML format substantially in the following form:

```
POST /beyondization.php HTTP/1.1
<XML>
<Beyondization>
          <Username>dingdong555@gmail.com</Username>
          <Timestamp>20xx-02-22 15:22:43</Timestamp>
          <ClientDetails>
                <ClientIP>192.168.23.126</ClientIP>
                <ClientType>smartphone</ClientType>
                <ClientModel>HTC Hero</ClientModel>
                <OS>Android 2.2</OS>
                <AppIinstalledFlag>true</AppInstalledFlag>
          </ClientDetails>
          <TrackInfo>
            <TrackID1>5768689</TrackID1>
            <TrackID2>3457689</TrackID2>
          .
          .
          .
            <TrackID78>6786889</TrackID78>
          <MetaData>
            <Track1>
                <type>audio</type>
                <name>track12.m4a</name>
                <size>64KB</size>
                <genre>blues</genre>
                <album>Taste</album
                <artist>Blue man</artist>
                <length>3 min 22 sec</length>
                <ranking>678</ranking>
                <year>1987</year>
                .
                .
                .
            </Track1>
          .
          .
          .
            <Track78>
                .
                .
                .
            </Track78>
          </MetaData>
</Beyondization>
</XML>
```

FIG. 22b is a logic flow diagram illustrating an example content identification in some embodiments of the ECPP. The beyondization may begin at 2205 with the search for media files in a user's client device at 2210. In one implementation, the search may be conducted only after verifying that the user has opted in to the beyondization service. The verification may be performed by requiring the user to confirm beyondization (e.g., click to confirm beyondization) or informing the user of the option to beyondize (e.g., want to beyondize your tracks?). At 2215, the media files may be analyzed. The analysis may include aggregating the media files, examining the files for information for metadata, bitrates, and/or the like. At 2220, each media file may be identified using information such as filename, ID3 tag or other metadata containers, hash value, acoustic fingerprint, and/or the like. If any media file is unidentified at 2225, the user may be prompted to enter the file information or skip the file at 2230. In one implementation, if a media file is not in the catalog as determined at 2235, the fingerprint and/or other identifying information relating to the file may be logged in one or more user media databases and/or tables at 2240. The media file may then be included in the user's local or offline media library at 2245. At 2250, some media files may also be found in the catalog. Those media files may be analyzed to determine whether the catalog version of the file is of higher fidelity than the local version at 2255. Similarly, if all media files are also in the catalog as determined at 2235, a further determination as to whether the catalog version of the file is of higher fidelity than the local version may be made at 2255. If the catalog version of the file is of higher fidelity, the user may be prompted to confirm the replacement of the local file with the higher fidelity version from the catalog at 2260. If the user confirms the replacement at 2265, the media file may be replaced with the catalog version at 2270 or the local version of the file is determined to be of higher fidelity as determined at 2255, the fingerprint and/or other identifying information relating to the file may be logged in the user media database and/or tables at 2285 for inclusion in the user's offline or local library at 2290. In one implementation, the user may decide to obtain a higher fidelity version of the file while keeping his or her personal copy of the file at 2275. In this case, the higher fidelity file may be downloaded and the user's personal copy may be backed up.

### Content License Acquisition Component (CLAC)

The ECPP in its effort to grow its collection and its user base seeks to improve services and facilities as well as add media that users may want to consume. In one embodiment, the ECPP employs crowd sourcing to automatically detect and initiate acquisition of rights for tracks catering to users' interests.

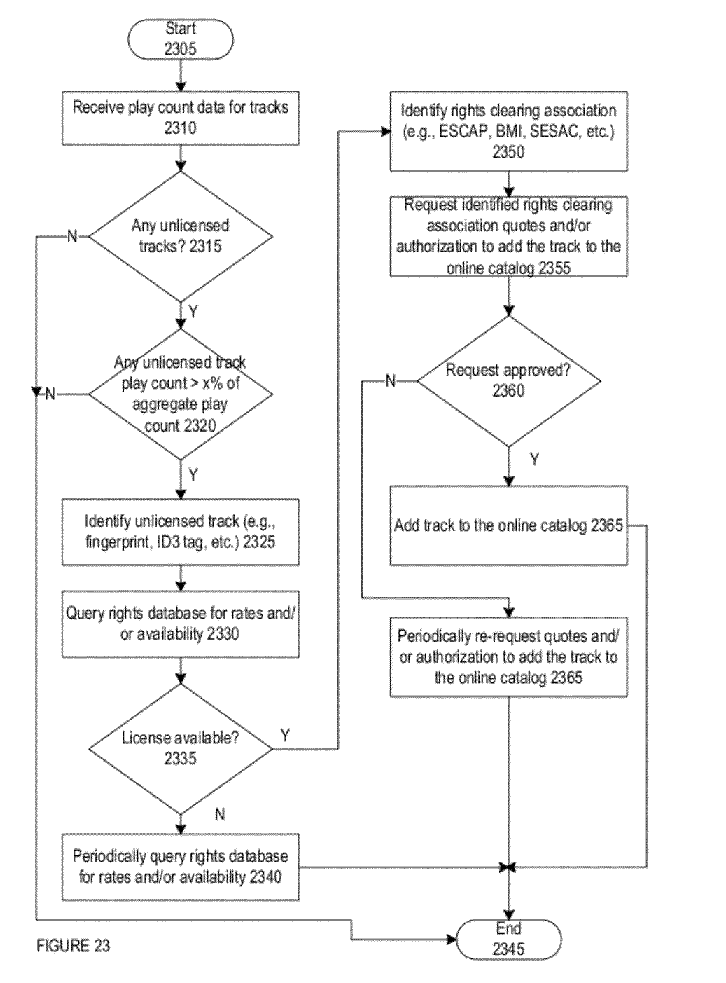

FIG. 23 is a logic flow diagram illustrating an example content license acquisition component (CLAC) in some embodiments of the ECPP. The process may start 2305 at 1402, with the receiving or retrieving of play count data at 2310. The play count data may be initially received from LDs that periodically or in real time report to the servers play data relating to each played tracks. At 2315, the play count data may be analyzed to determine any unlicensed tracks. The analysis may include, for example, examination of the tracks including track ID or other identifying information relating to the track. The analysis may further comprise checking the ECPP media databases and/or tables to determine if corresponding records of the tracks are present. Based on the analysis, a determination may be made as to whether any of the tracks being reported are unlicensed tracks. In one implementation, such tracks may be uniquely resolved within the ECPP collection and may be provided a track ID upon identification. If there are no unlicensed tracks identified at 2315, the process may end at 2345. However, for the identified unlicensed tracks, the CLAC may determine if the unlicensed tracks are popular with users, and if so, may automatically initiate a rights acquisition process. In one implementation the CLAC may obtain aggregate play count data for each unlicensed track over a period of time (e.g., a week, month, etc.). The play count data may be aggregated from one or more users of the ECPP. In a further implementation, the CLAC may also obtain aggregate play count data for all licensed tracks from one or more users of the ECPP for the same period of time. The CLAC may also retrieve one or more rights acquisition trigger rules to evaluate the obtained aggregate play count data. In one implementation, rights acquisition may be triggered when the aggregate play count for the licensed track exceeds a threshold (e.g., play count greater than 500). In another implementation, any unlicensed tracks with a non-zero play count may trigger rights acquisition. In yet another implementation, rights acquisition may be triggered when the aggregate unlicensed track play count is greater than a predefined percentage of the aggregate play count data for all licensed tracks. At 2320, if the rights acquisition is not triggered, the process may end at 2345. At 2320, if the rights acquisition is triggered, the CLAC may identify the unlicensed track using, for example, fingerprint, ID3 tag, etc., at 2325. Using the obtained information, the CLAC may the query a rights database at 2330 to obtain rates, quotes and/or availability for licensing rights. If there is an opportunity for obtaining rights for the unlicensed tracks at 2335, the CLAC may identify the appropriate rights clearing association such as ESCAP, BMI, SESAC, and/or the like at 2350. At 2355, the identified rights clearing association may be requested to provide rates, quotes and/or authorization to add the track to the ECPP catalog. If the request is approved at 2360, the added track may be added to the online catalog at 2365 and made available to the users of the ECPP. If at 2360, the request is not approved, the CLAC may periodically request rates, quotes, and/or authorization to add the track to the ECPP catalog at 2365. The process may end at 2345.

At 2335, if there is no licensing opportunity available, the CLAC may periodically query rights database for rate and/or availability at 2340. In one implementation, the rights database may be constantly updated as more tracks are licensed or are offered for licensing by partners. In one implementation, even if the rights holder cannot be identified, the CLAC may upload the unlicensed tracks to one or more servers. In some implementations, the servers may be selected based on the geographic location where the demand for the track is the highest. For example, if users in the UK are playing an unlicensed track from a music artist, a copy of the track may be uploaded to servers at or near the UK. Royalties and/or license fees for the uploaded but unlicensed track may be collected for payment upon formalization of the licensing arrangement. In this way, licensed tracks may be readily provided to the users of the ECPP, while protecting royalties owed to partners.

### License Management Component (LMC)

The ECPP provides users an unlimited access to a comprehensive catalog of multimedia content to use and share, while protecting the commercial interests of content owners, OEMs and network operators at the same time. This is facilitated by the use of Digital Rights Management (DRM) and other security technologies. The ECPP facilitates protection of the interests of content licensors through secure play count reporting. Through the use of play count reporting, royalties can be calculated and properly attributed to partners. Through DRM, the ECPP ensures that content is only playable in its territory of licensing and protects the interests of OEMs by ensuring that users can only play content on LDs. Within the ECPP ecosystem, the DRM may not inhibit using and sharing content. For example, the DRM may place no limits on duration of a user's music ownership, methods of sharing (including email, portable storage devices, drop box, etc.), the number of licensed devices that a user can own, playback quality, and/or the like.

In one implementation, the ECPP may leverage DRM technology for supporting a wide range of consumer electronics that can play multimedia content, from minimal “shuffle” type devices all the way up to desktop PCs. In a further implementation, the ECPP DRM may provide portability to a wide variety of operating platforms, including, but not limited to, broadly available OSs (e.g. Windows, Linux, Android) as well as proprietary operating platforms (e.g. Samsung BADA). In some implementation, the ECPP DRM may provide strong support for connected portable devices, to eliminate tethering to PCs through side-loading, enhancing the user experience and making the ecosystem more attractive to mobile operators. In addition, the ECPP DRM may utilize robust, field-recoverable security to eliminate or minimize the impact of hacks or other security concerns.

In yet another implementation, the ECPP DRM may facilitate flexible domain authentication, so that rights may be configured on groups of devices ranging from all devices owned by a single user up to all devices in a territory of licensing (e.g., country), thereby increasing flexibility of content usage and licensing. In one implementation, ECPP DRM may include DRM technologies developed by third parties (e.g., Marlin DRM). Many modern DRM technologies include a “root of trust” organization that may issue security material such as device certificates and encryption keys. Root-of-trust services also facilitate defining robustness rules for DRM implementations in order to thwart hacks on susceptible devices, and DRM implementers must adhere to these rules as part of their technology licensing agreements. The Marlin Trust Management Organization (MTMO) serves as the root of trust organization for Marlin. Marlin DRM uses a graph theory-based rights model, which consists of links and nodes. Nodes may represent concrete entities such as users, devices, and servers, or abstract entities such as domains (e.g., groups of users) or subscriptions (e.g., rights to content). Links may represent relationships between nodes. In order for a device to get permission to exercise rights to content (e.g., to play it), the device must connect through links to a node corresponding to the user licensed to access that content on that device. The LMC of the ECPP may leverage user nodes to authenticate content according to territories of license (e.g., countries), device personality nodes, corresponding to LDs, subscription links, referring to time-bounded licenses to all content, and/or the like. In one implementation, the ECPP may use user IDs to bind users to devices, to ensure that only the original person who bought the LD (or otherwise obtained it, e.g., got it as a gift) has access to the universal library. All compliant devices in a given geography may access content licensed for that geography. There is no need to limit the number of devices that a user may use, because each device represents a separate fee structure and royalty stream for content owners. The geographic licensing scheme may further facilitate royalty reporting component to determine which royalty scheme is to be used to calculate payments.

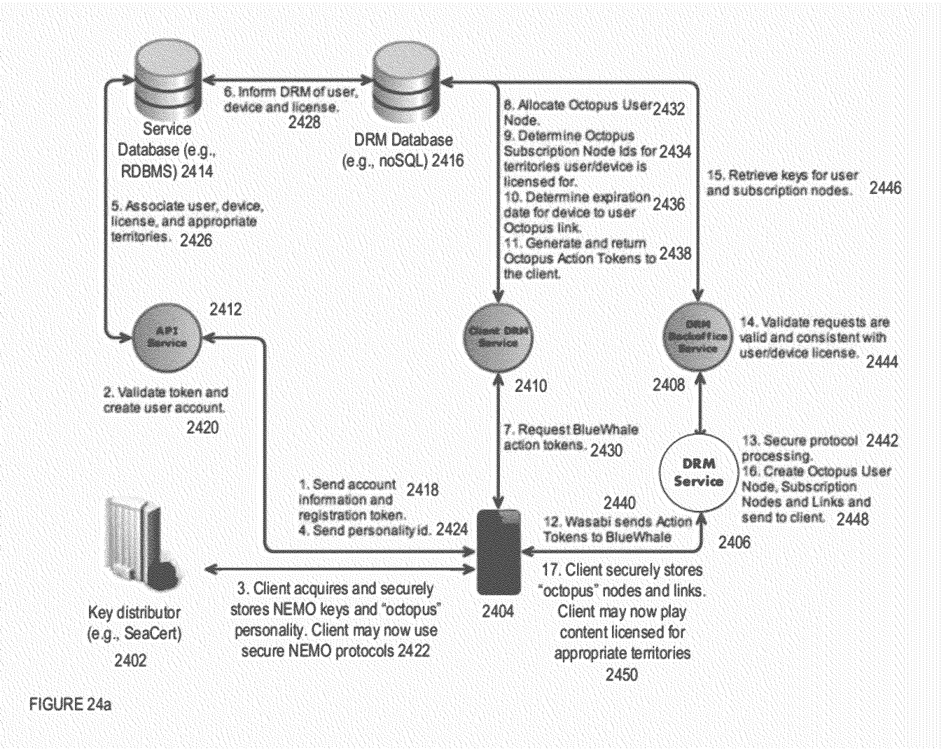

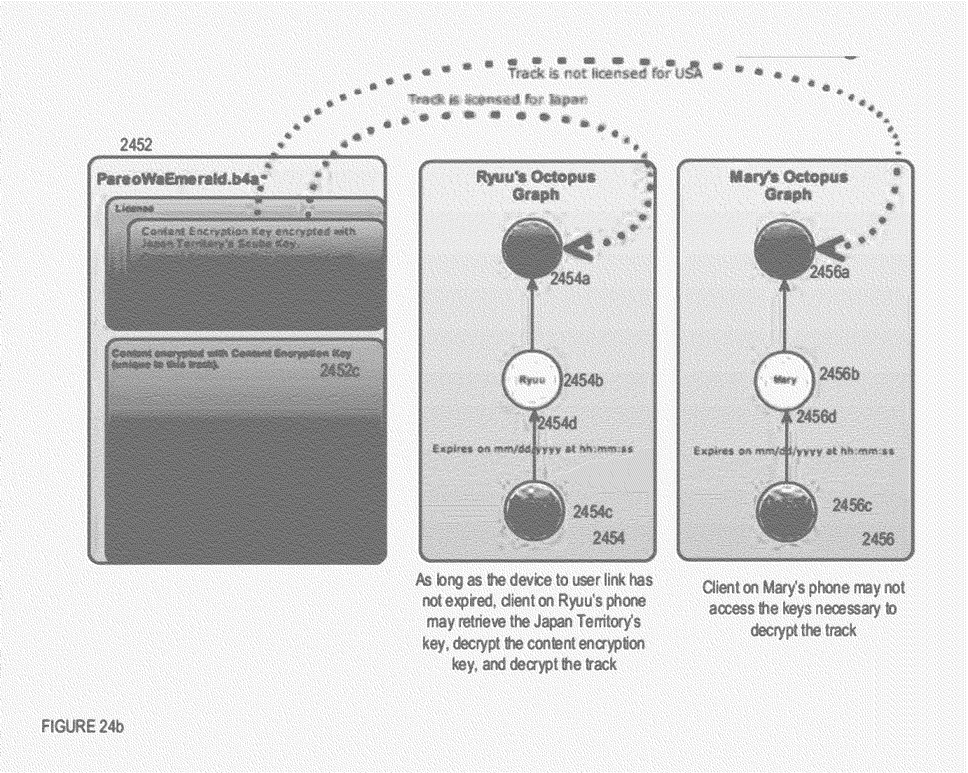

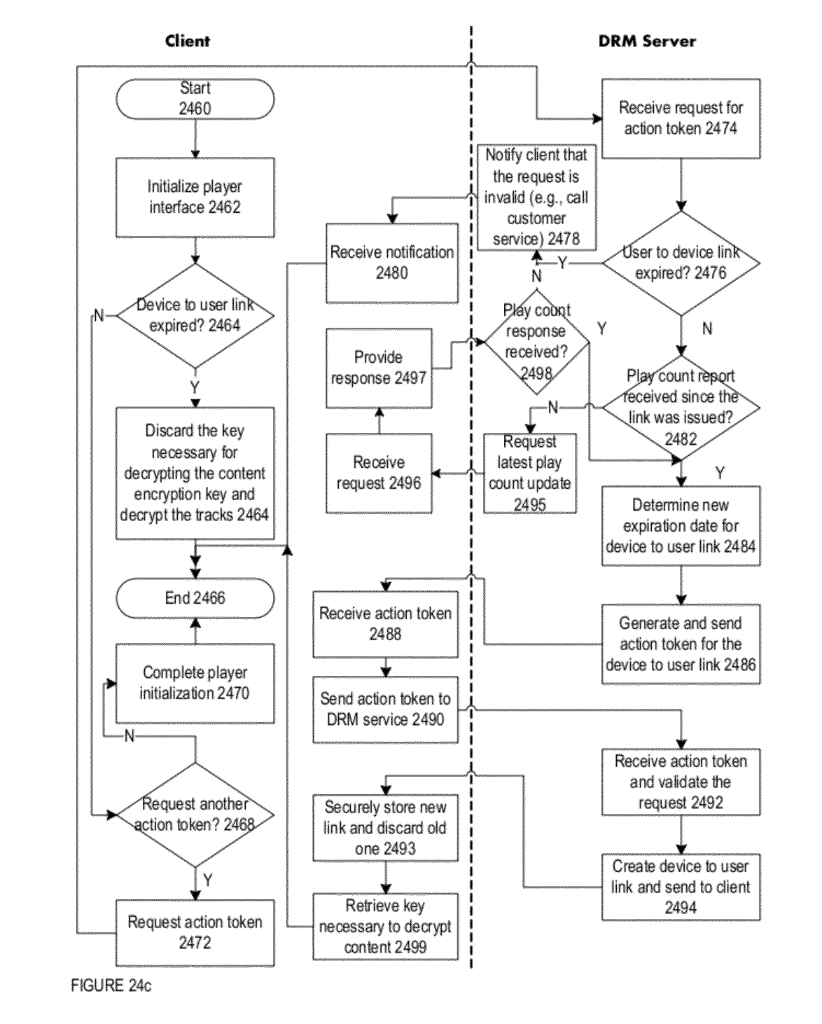

FIGS. 24a-b are data flow diagrams illustrating example license management components in some embodiments of the ECPP. As shown in FIG. 24a, at 2418, a client device 2404 may send account information obtained from user registration along with a registration token the API service 2412 of the LMC of the ECPP. The API service 2412 may receive and validate the token and create a user account for the user of the device 2404 at 2412. At 2422, the client may also request and obtain from a key distributor component of LMC (e.g., SeaCert) Network Mobility (NEMO) keys and device personality (“octopus” personality). The client may securely store the NEMO keys and may utilize NEMO protocols for obtaining keys. At 2424, the client may send device personality ID to the API service 2412. At 2426, the service database 2414 may associate user and device with license and appropriate territories. At 2428, the user, device and license information may be sent to the DRM database 2416. At 2430, the client device may request an action token from the client DRM service 2410. At 2432, the client DRM service 2410 may allocate user node at 2432, may determine subscription node IDs for territories where user and/or device is licensed for at 2434. At 2436, an expiration date for device to user link may be determined. The requested action token may then be generated and returned to the client at 2438. At 2440, the client may then send the action token to the DRM service 2406. The DRM service 2406 may perform secure protocol processing at 2442 At 2444, the DRM backoffice service 2408 may validate any requests for keys to ensure that the requests are consistent with user and/or device license. At 2446, the DRM backoffice may obtain keys for user and subscription nodes and provide them to the DRM service which may create user node, subscription node(s) and links at 2448. The created user node, subscription nodes and links may then be sent to the client at 2448. The client may receive and store the nodes and links obtained from the DRM service. The nodes and links facilitate the client to play content licensed for appropriate territories at 2450.

FIG. 24b illustrates example “octopus” graphs 2454 and 2456 for two users Ryuu and Mary respectively. In one implementation, the graph identifies the subscription nodes 2454a, 2456a, the user nodes 2454b, 2456b, the user devices 2454c, 2456c as well as the links 2454d, 2456d between the user and the device. As shown in the figure, each link may be associated with an expiration date and/or time. Each content item 2452 may include a license portion 2452a and a content portion 2452c that is encrypted with content encryption key. In this example, the license portion includes a content encryption key encrypted with Japan territory's key and Australia territory's key. From graph 2454, the user Ryuu has a subscription node for Japan territory, and as long as the device to user link has not expired, the client on Ryuu's device may retrieve the Japan territory's key, decrypt the content encryption key and decrypt the track. However, the graph 2456 shows that the user Mary has subscription node for the USA. As the content item does not include license for USA territory, the client of Mary's device may not access the keys necessary to decrypt the track. In this way, using the subscription node, user node, device node and user-device link, only contents licensed for a user/device and territory may be decrypted.

FIG. 24c is a logic flow diagram illustrating an example license management component in some embodiments of the ECPP. In one implementation, the process may start at 2460. The player interface may be initialized at 2462. At 2464, the client may determine whether the device to user link is expired. If the device to user link is expired, the key necessary for decrypting the content encryption key and decrypt the tracks may be discarded at 2464. The process may conclude at 2466. However, if the device to user link is not expired, the client may request an action token at 2468. Action tokens may be requested periodically by the client to ensure user, device and subscription nodes are valid. If the client does not need to request the action token, the player initialization may be completed at 2470. In one implementation, if the client requests an action token at 2472, the request is received by the DRM server at 2474. The server may then check whether the user to device link is expired at 2476. If the user to device link is expired, a notification may be sent to the client indicating that the request is invalid at 2478. The client may receive the notification at 2480, concluding the process. In one implementation, if the user to device link is not expired, the server may determine if a play count report has been received since the link was last issued at 2482. If the play count report has not been uploaded to the server, a request may be sent by the server to the client for the latest play count update at 2495. The request may be received by the client at 2496 and the client may provide a response at 2497. If the client fails to provide a valid play count report at 2498, the client may be notified of the invalid request at 2478. However, if the play count response is valid, or if the play count report was received since the issue of the link at 2482, the server may determine a new expiration date for the device to user link at 2484. At 2486, a new action token for the device to user link may be generated and send to the client. The client may receive the action token at 2488 and may send the token to the server at 2490. The server may receive the action token and may validate the request at 2492. The server may then create a user to device link and send the link to the client at 2494. The client may receive and securely store the link and discard the old one at 2493. The client may then retrieve the key necessary to decrypt content.

### Encryption-Free Content Purchase Component

In one embodiment of the ECPP, an encryption-free content purchase component (ECPC) may be provided to facilitate legal purchase of DRM free content items. In one implementation, a user of the ECPP may have the option to select an option to purchase a selected track, album or a playlist from the ECPP player. Using information provided by the user (e.g., a user ID and/or password), and/or user provided payment information, a transaction for the DRM free content purchase may be completed. In one implementation, the purchase price of the content item may be discounted based on social influence. For example, if the user has opted in to a Guru program, and has achieved a threshold number of influence points (e.g., 500), the user may be offered a discount on the purchase price of the DRM free content. In another example, if the item to be purchased is in a playlist published by the user, the purchase price may be discounted for every x level or degrees of separation of people that subscribe and/or add the song and/or playlist to their library. In yet another example, when a threshold number of plays of the content item is reached, the discount may be offered. In one implementation, the threshold number of plays may be reached by the user alone. In another implementation, the threshold number of plays is an aggregate number of plays from one or more users. In one implementation, discount may be provided to a user when a threshold number of plays of the content item and/or number of people that play or buy the content DRM free after discovery from people discovering the content from the user's playlists or library is reached.

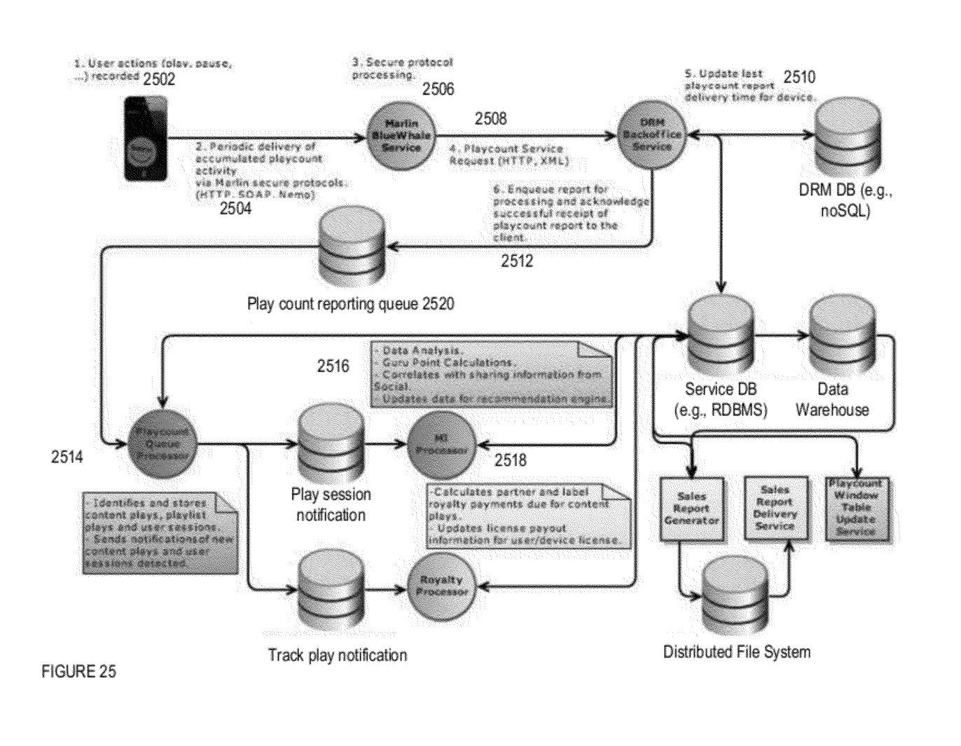

FIG. 25 is a data flow diagram illustrating an example usage reporting component in some embodiments of the ECPP. At 2502 various user actions such as play, pause, etc., are recorded by the client. At 2504, the accumulated user action activity and play count activity may be periodically delivered via secure protocols such as HTTP, SOAP, NEMO, etc., to the DRM service. At 2506, secure protocol processing may be performed before sending a play count service request (e.g., HTTP, XML) to a DRM backoffice service at 2508. The DRM backoffice service may update last play count delivery time for device in the DRM database at 2510. The obtained activity report from the client may also be placed on a play count reporting queue 2520 at 2512. An acknowledgement of successful receipt of the play count report may be sent to the client at 2512. A play count queue processor may then identify various processing components and send reporting data for further processing (e.g., 2516 in music intelligence processor and 2518 in royalty processor).

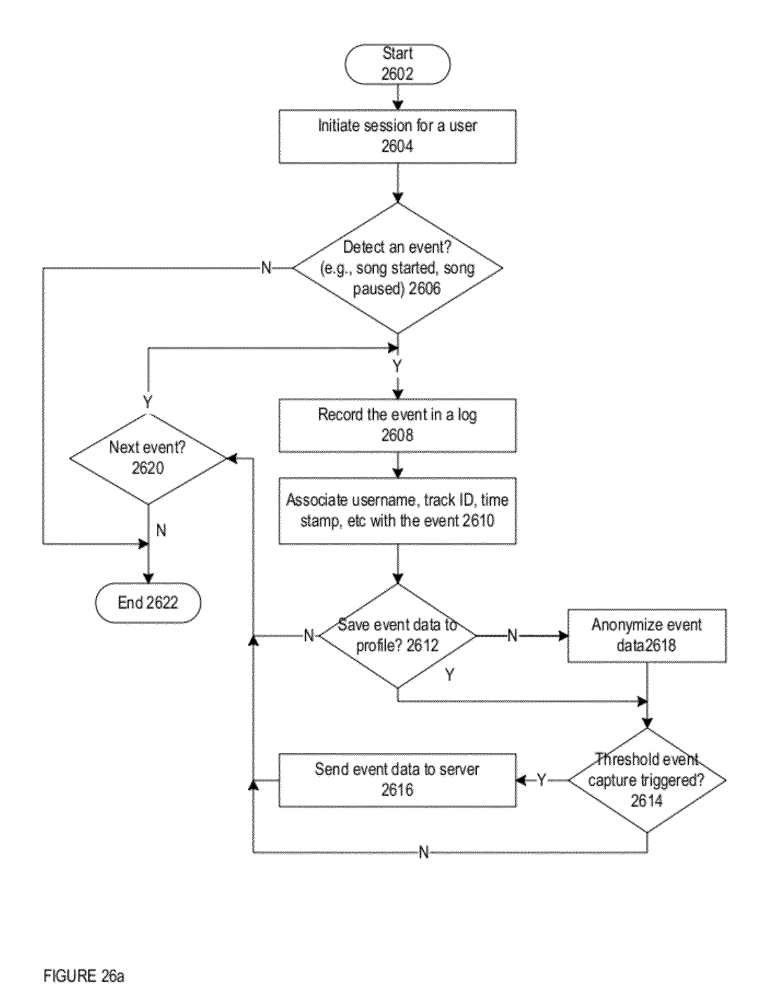

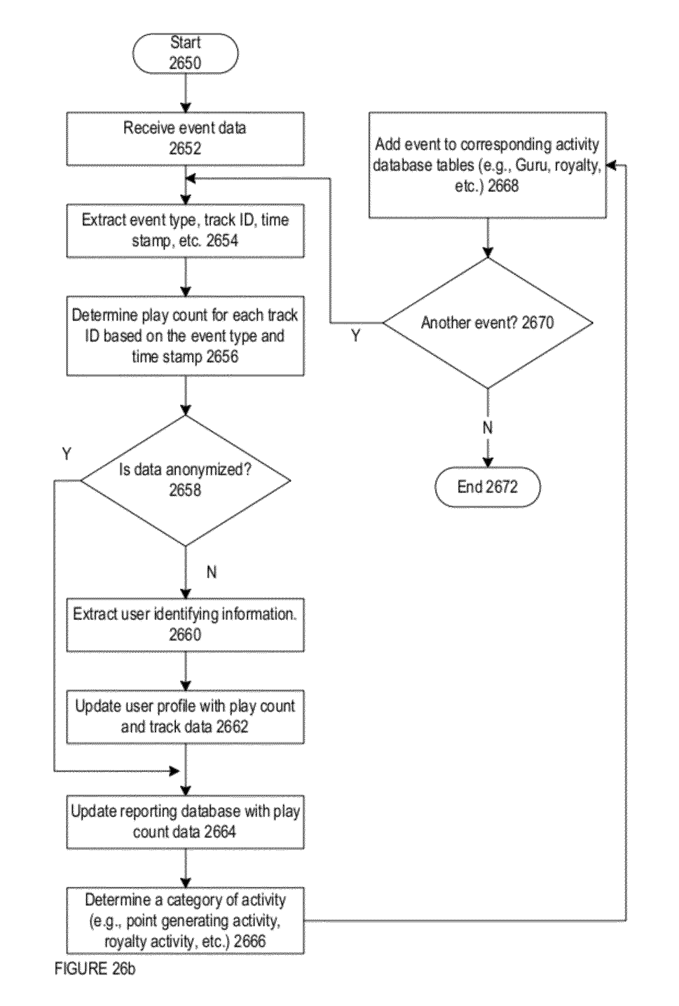

FIGS. 26a-b are logic flow diagrams illustrating example play count reporting components in some embodiments of the ECPP. As shown in FIG. 26a, the client side play count reporting may start at 2602. At 2604, a session may be launched (e.g., the client may be launched). In one implementation, a log may be created to initiate set up. Set up may include passing identifying information such as username or email address to the server. At 2606, if an event (e.g., song started, song paused, song resumed, etc.) is detected, the event may be recorded in a log at 2608. Each event record may be associated with identifying information such as username, track ID, time stamp, etc., at 2610. At 2612, the user's profile settings may be retrieved to determine whether event data should be saved to the profile. In one implementation, if the user opted to forego saving event data in his or her profile, the event data may be anonymized at 2618 such that event data may not be used to identify the user. At 2614, a determination may be made whether threshold event capture has been triggered. Examples of threshold event capture triggers include reaching a threshold size limit of the log, number of play counts, time since last event capture, type of event, and/or the like. If the threshold event capture is triggered, the log in the client device may be synced with the log in the server device by sending event and/or other data to the server at 2616. If on the other hand, connection to the server is not available, the event data may continue to be logged if there is another occurrence of an event at 2620. If there are no events (e.g., application is closed), the log file may be closed and the session may end at 2622.

As shown in FIG. 26b, the server-side play count reporting may start at 2650 by receiving event data at 2650. The event data may include information such as track ID, time at which a song started, ended, was paused or resumed, username, and/or the like. At 2654, information such as event type, track ID, time stamp, etc., may be extracted from the received event data. Using the extracted information and one or more business rules, play count for each track ID in the event data may be determined. An example business rule may include, for example, a rule which classifies a track that was played for at least x seconds (e.g., 30 seconds, 45 seconds, etc.) as a “play event.” Using the time stamp for each event (e.g., song started, song paused, song resumed or song finished) and the business rule, play count for each track may be determined at 2656. In one implementation, the event data may be anonymized with references to any identifying user information removed. If the event data is anonymized as determined at 2658, the reporting database is updated with determined play count data at 2664. On the other hand, if the event data is not anonymized, user identifying information such as username, user ID, social graph, interest graph, etc., may be extracted, obtained and/or derived at 2660. At 2662, the user profile may be obtained and updated with play count and track data at 2662. As in the case of anonymized data, the reporting database may be updated with play count data at 2664. In one implementation, a category of activity for each event may be determined at 2666. Example categories may include point generating activity, royalty activity, recommendation engine activity, and/or the like. At 2668, the event data may be added to one or more databases and/or tables corresponding to the determined activity. At 2670, if there is another event in the queue, the processing for the event may begin at 2654. If there are no other events in the queue, the process may end at 2672.

### Usage Payment Collection and Apportionment Component (UPCAC)

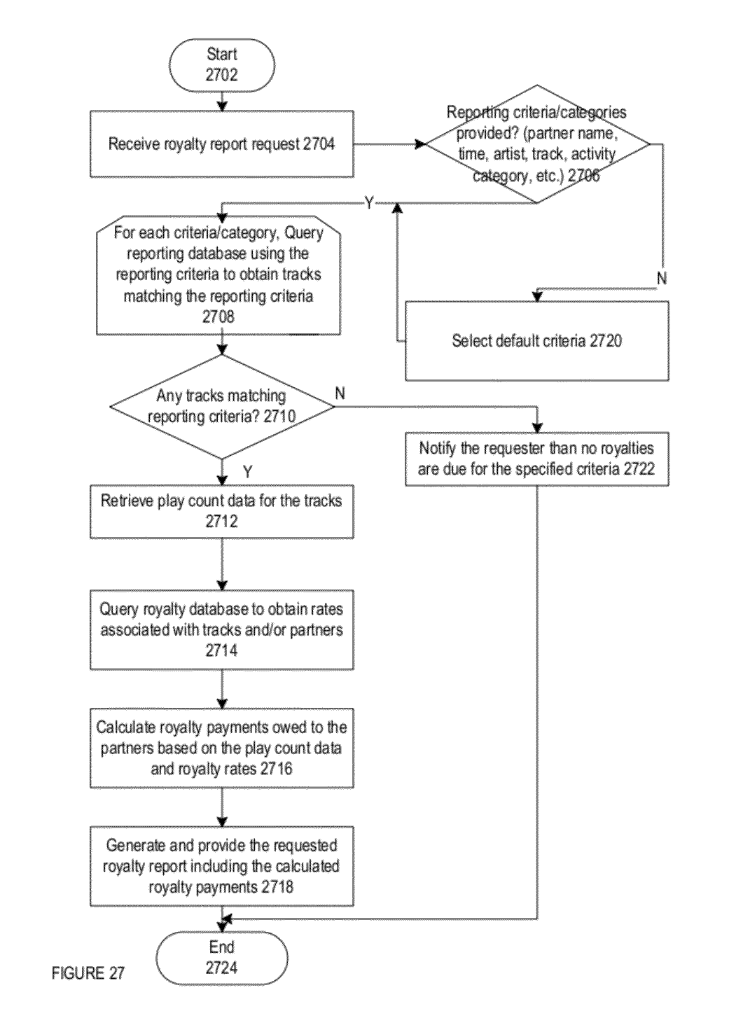

FIG. 27 is a logic flow diagram illustrating an example usage payment collection and apportionment component (UPCAC) in some embodiments of the ECPP. The process may start at 1702 by receiving a royalty report request at 2704. In one implementation, the report request may include reporting criteria and/or categories. Examples of reporting criteria and/or categories may include, for example, a statement for a selected period of time (e.g., weekly, monthly, from/to, etc.), report by track, by artist, by song, by album, by territory, partner name, activity category, etc. Yet other examples of reporting criteria may include, but are not limited to: total number of end users, number of end users by device type (e.g., users with more than one device may count more than once), number of new end users, number of new end users by device type, number of active users (e.g., users who have one or more plays or downloads during a period of time), number of active users by device type, number of active downloaders (e.g., users who have at least one download during a period of time), number of active downloaders by device type, market share of downloads by device type for a partner, total downloads of all label content by device type, total digital downloads by device type for a partner (e.g., SME, EMI, WMG, etc.), total number of active listeners, market share of plays by device type for a partner, total plays for all label content, total number of playlists created, usage code (e.g., streaming, interactive radio, tethered plays, juke box, portable, etc.) and/or the like.

At 2706, if no reporting criteria and/or categories are provided, default criteria may be selected at 2720. An example default criteria may be last statement available. However, if reporting criteria and/or categories are provided, for each provided criteria and/or category, the UPCAC may, at 2708, query a reporting database using the provided criteria and/or category to obtain matching tracks. In one implementation, no tracks matching the reporting criteria and/or categories may be obtained from the query at 2710. In this case, at 2722, the UPCAC may notify the requestor that no royalties are due for the specified criteria and the logic flow may conclude at 2724. In an alternate implementation, one or more tracks matching the provided criteria/categories may be obtained at 2710. At 2712, the play count data for each of the identified tracks may be retrieved. At 2714, a royalty database may be queried to obtain rates associated with tracks and/or partners. At 2716, royalty payments may be calculated based on the play count data and the obtained rates. Further at 2718, the requested royalty report may be generated and provided. The report may include, in one implementation, a listing of tracks matching the provided or default criteria and/or categories as well as the royalty amounts due per track.

At 1706, a list of tracks meeting the criteria may be identified. In one implementation, the criteria may include the partner name or identifier. At 1708, play count data for the identified list of tracks may be identified. At 1710, royalty rates associated with partners may be identified. At 1712, royalty payments owed to the partners based on the play count data and the royalty rates may be calculated. In one implementation, the play count data may be segmented according to territory, and royalty rates for each territory may be retrieved to determine the total royalties owed. At 1714, the requested report including the calculated royalty payments may be generated and provided to the requesting user. The process may then conclude at 1716.

### ECPP Controller

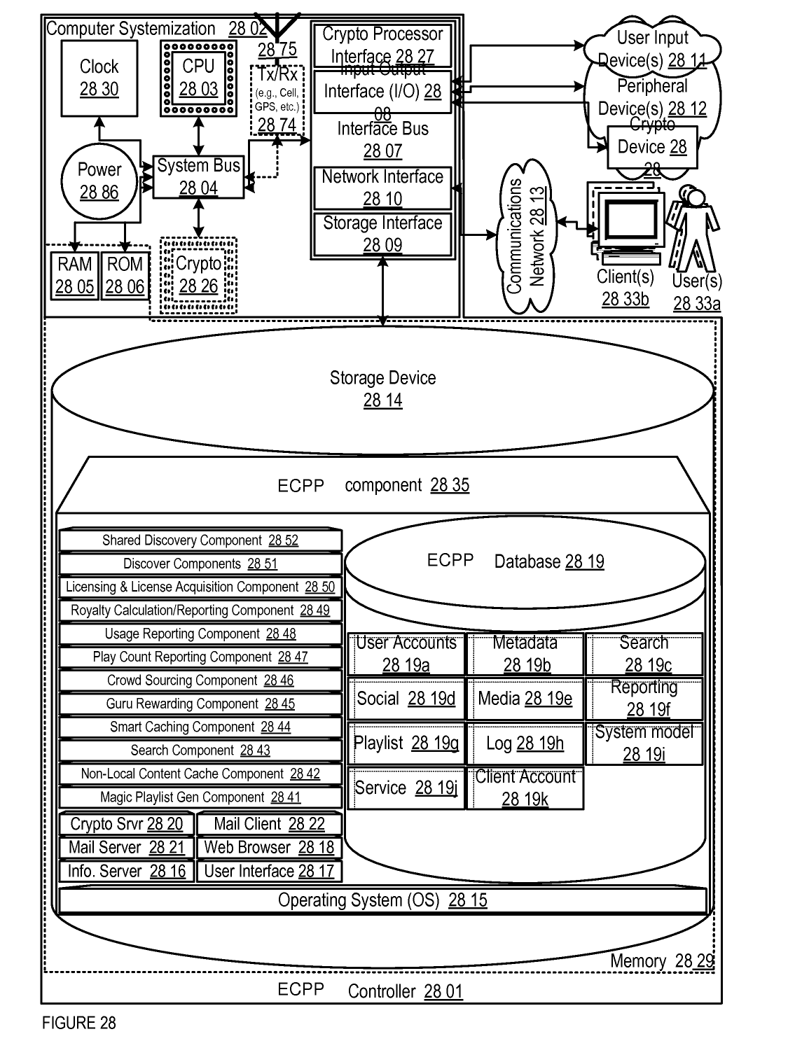

FIG. 28 shows a block diagram illustrating embodiments of a ECPP controller. In this embodiment, the ECPP controller 2801 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 2803 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2829 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the ECPP controller 2801 may be connected to and/or communicate with entities such as, but not limited to: one or more users from user input devices 2811; peripheral devices 2812; an optional cryptographic processor device 2828; and/or a communications network 2813.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The ECPP controller 2801 may be based on computer systems that may comprise, but are not limited to, components such as: a computer systemization 2802 connected to memory 2829.

### Computer Systemization

A computer systemization 2802 may comprise a clock 2830, central processing unit (“CPU(s)” and/or “processor(s)” (these terms are used interchangeable throughout the disclosure unless noted to the contrary)) 2803, a memory 2829 (e.g., a read only memory (ROM) 2806, a random access memory (RAM) 2805, etc.), and/or an interface bus 2807, and most frequently, although not necessarily, are all interconnected and/or communicating through a system bus 2804 on one or more (mother)board(s) 2802 having conductive and/or otherwise transportive circuit pathways through which instructions (e.g., binary encoded signals) may travel to effectuate communications, operations, storage, etc. The computer systemization may be connected to a power source 2886; e.g., optionally the power source may be internal. Optionally, a cryptographic processor 2826 and/or transceivers (e.g., ICs) 2874 may be connected to the system bus. In another embodiment, the cryptographic processor and/or transceivers may be connected as either internal and/or external peripheral devices via the interface bus I/O. In turn, the transceivers may be connected to antenna(s) 2875, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing ECPP controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 2829 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the ECPP controller and beyond through various interfaces. Should processing requirements dictate a greater amount speed and/or capacity, distributed processors (e.g., Distributed ECPP), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the ECPP may be achieved by implementing a microcontroller such as CAST's R8051XC2 microcontroller; Intel's MCS 51 (i.e., 8051 microcontroller); and/or the like. Also, to implement certain features of the ECPP, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the ECPP component collection (distributed or otherwise) and/or features may be implemented via the microprocessor and/or via embedded components; e.g., via ASIC, coprocessor, DSP, FPGA, and/or the like. Alternately, some implementations of the ECPP may be implemented with embedded components that are configured and used to achieve a variety of features or signal processing.

Depending on the particular implementation, the embedded components may include software solutions, hardware solutions, and/or some combination of both hardware/software solutions. For example, ECPP features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the ECPP features. A hierarchy of programmable interconnects allow logic blocks to be interconnected as needed by the ECPP system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the ECPP may be developed on regular FPGAs and then migrated into a fixed version that more resembles ASIC implementations. Alternate or coordinating implementations may migrate ECPP controller features to a final ASIC instead of or in addition to FPGAs. Depending on the implementation all of the aforementioned embedded components and microprocessors may be considered the “CPU” and/or “processor” for the ECPP.

### Power Source

The power source 2886 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2886 is connected to at least one of the interconnected subsequent components of the ECPP thereby providing an electric current to all subsequent components. In one example, the power source 2886 is connected to the system bus component 2804. In an alternative embodiment, an outside power source 2886 is provided through a connection across the I/O 2808 interface. For example, a USB and/or IEEE 1394 connection carries both data and power across the connection and is therefore a suitable source of power.

### Interface Adapters

Interface bus(ses) 2807 may accept, connect, and/or communicate to a number of interface adapters, conventionally although not necessarily in the form of adapter cards, such as but not limited to: input output interfaces (I/O) 2808, storage interfaces 2809, network interfaces 2810, and/or the like. Optionally, cryptographic processor interfaces 2827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2809 may accept, communicate, and/or connect to a number of storage devices such as, but not limited to: storage devices 2814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2810 may accept, communicate, and/or connect to a communications network 2813. Through a communications network 2813, the ECPP controller is accessible through remote clients 2833b (e.g., computers with web browsers) by users 2833a. Network interfaces may employ connection protocols such as, but not limited to: direct connect, Ethernet (thick, thin, twisted pair 10/10/1000 Base T, and/or the like), Token Ring, wireless connection such as IEEE 802.11a-x, and/or the like. Should processing requirements dictate a greater amount speed and/or capacity, distributed network controllers (e.g., Distributed ECPP), architectures may similarly be employed to pool, load balance, and/or otherwise increase the communicative bandwidth required by the ECPP controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2810 may be used to engage with various communications network types 2813. For example, multiple network interfaces may be employed to allow for the communication over broadcast, multicast, and/or unicast networks.

Input Output interfaces (I/O) 2808 may accept, communicate, and/or connect to user input devices 2811, peripheral devices 2812, cryptographic processor devices 2828, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 2811 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 2812 may be connected and/or communicate to I/O and/or other facilities of the like such as network interfaces, storage interfaces, directly to the interface bus, system bus, the CPU, and/or the like. Peripheral devices may be external, internal and/or part of the ECPP controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the ECPP controller may be embodied as an embedded, dedicated, and/or monitor-less (i.e., headless) device, wherein access would be provided over a network interface connection.

Cryptographic units such as, but not limited to, microcontrollers, processors 2826, interfaces 2827, and/or devices 2828 may be attached, and/or communicate with the ECPP controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2829. However, memory is a fungible technology and resource, thus, any number of memory embodiments may be employed in lieu of or in concert with one another. It is to be understood that the ECPP controller and/or a computer systemization may employ various forms of memory 2829. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 2829 will include ROM 2806, RAM 2805, and a storage device 2814. A storage device 2814 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2829 may contain a collection of program and/or database components and/or data such as, but not limited to: operating system component(s) (operating system); information server component(s) 2816 (information server); user interface component(s) 2817 (user interface); Web browser component(s) 2818 (Web browser); database(s) 2819; mail server component(s) 2821; mail client component(s) 2822; cryptographic server component(s) 2820 (cryptographic server); the ECPP component(s) 2835; shared discovery component 2852, discover components 2851, licensing & license acquisition component 2850, royalty calculation/reporting component 2849, usage reporting component 2848, play count reporting component 2847, crowd sourcing component 2846, guru rewarding component 2845, smart caching component 2844, search component 2843, non-local content cache component 2842, magic playlist generation component 2841, and/or the like (i.e., collectively a component collection). These components may be stored and accessed from the storage devices and/or from storage devices accessible through an interface bus. Although non-conventional program components such as those in the component collection, typically, are stored in a local storage device 2814, they may also be loaded and/or stored in memory such as: peripheral devices, RAM, remote storage facilities through a communications network, ROM, various forms of memory, and/or the like.

### Operating System

The operating system component 2815 is an executable program component facilitating the operation of the ECPP controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like.

An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the ECPP controller to communicate with other entities through a communications network 2813. Various communication protocols may be used by the ECPP controller as a subcarrier transport mechanism for interaction, such as, but not limited to: multicast, TCP/IP, UDP, unicast, and/or the like.

### Information Server

An information server component 2816 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the ECPP controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the ECPP database 2819, operating systems, other program components, user interfaces, Web browsers, and/or the like.

Access to the ECPP database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the ECPP. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the ECPP as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 2817 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2818 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the ECPP enabled nodes. The combined application may be nugatory on systems employing standard Web browsers.

### Mail Server

A mail server component 2821 is a stored program component that is executed by a CPU 2803. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the ECPP.

Access to the ECPP mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2822 is a stored program component that is executed by a CPU 2803. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

cryptographic server component 2820 is a stored program component that is executed by a CPU 2803, cryptographic processor 2826, cryptographic processor interface 2827, cryptographic processor device 2828, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the ECPP may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the ECPP component to engage in secure transactions if so desired. The cryptographic component facilitates the secure accessing of resources on the ECPP and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The ECPP Database

The ECPP database component 2819 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the ECPP database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the ECPP database is implemented as a data-structure, the use of the ECPP database 2819 may be integrated into another component such as the ECPP component 2835. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2819 includes several tables 2819a-k. A User Accounts table 2219a may include fields such as, but not limited to: user_ID, user_password, user_device, user_IP, user_entity, user_media, user_search, user_socialConnections, user_following, user_followed, and/or the like. The User table may support and/or track multiple entity accounts on a ECPP. A metadata table 2219b may include fields such as, but not limited to: track_ID, media_type, media_name, media_size, media_genre, media_album, media_artist, media_user, media_length, media_ranking, media_year, and/or the like. A search table 2219c may include fields such as, but not limited to: search_ID, search_userID, search_content, search_time, search_socialConnection, search_result, and/or the like. A social table 2219d may include fields such as, but not limited to: social_ID, social_name, social_connection, social_searchHistory, social_medialData, and/or the like. A media table 2219e may include fields such as, but not limited to: user_ID, track_ID, media_type, and/or the like. A reporting table 2219f may include fields such as, but not limited to: track_ID, track_playcount, track royalty, track_added_date, statement_ID, and/or the like. A playlist table 2219g may include fields such as, but not limited to: user_ID, track_ID, playlist_pubdate, playlist_share, and/or the like. The core may include additional databases and/or tables. A log table 2219h may include fields such as, but not limited to: log_ID, log_user_ID, log_devicelD, log_date, log_type, and/or the like. A system model layout table 2219i may include fields such as, but not limited to: layout_ID, bandwidth, and/or the like. A service table 2219j may include fields such as, but not limited to: notification_rule, threshold, log source, resource requirements, priority, and/or the like. A Client Account table 2219k may include fields such as, but not limited to: client_ID, client_account, client_name, client_password, client_permissions, and/or the like.

In one embodiment, the ECPP database may interact with other database systems. For example, employing a distributed database system, queries and data access by search ECPP component may treat the combination of the ECPP database, an integrated data security layer database as a single database entity.

In one embodiment, user programs may contain various user interface primitives, which may serve to update the ECPP. Also, various accounts may require custom database tables depending upon the environments and the types of clients the ECPP may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2819a-k. The ECPP may be configured to keep track of various settings, inputs, and parameters via database controllers.

The ECPP database may communicate to and/or with other components in a component collection, including itself, and/or facilities of the like. Most frequently, the ECPP database communicates with the ECPP component, other program components, and/or the like. The database may contain, retain, and provide information regarding other nodes and data.

### The ECPPs

The ECPP component 2835 is a stored program component that is executed by a CPU. In one embodiment, the ECPP component incorporates any and/or all combinations of the aspects of the ECPP that was discussed in the previous figures. As such, the ECPP affects accessing, obtaining and the provision of information, services, transactions, and/or the like across various communications networks.

The ECPP may transform inputs via ECPP components into outputs and/or the like and use of the ECPP. In one embodiment, the ECPP component 2235 takes inputs (e.g., content seed, play count data, event data, triggers, and/or the like) etc., and transforms the inputs via various components (e.g., discovery component, play count reporting component, license verification component, and/or the like), into outputs (e.g., search results, royalties, license verification, and/or the like).

The ECPP component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the ECPP server employs a cryptographic server to encrypt and decrypt communications. The ECPP component may communicate to and/or with other components in a component collection, including itself, and/or facilities of the like. Most frequently, the ECPP component communicates with the ECPP database, operating systems, other program components, and/or the like. The ECPP may contain, communicate, generate, obtain, and/or provide program component, system, user, and/or data communications, requests, and/or responses.

### Distributed ECPPs

The structure and/or operation of any of the ECPP node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the ECPP controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the ECPP controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
          $input = “”;
          $input = socket_read($client, 1024);
          $data .= $input;
} while($input != “”);
// parse data to extract variables
$obj = json_decode($data, true);
// store input data in a database
mysql_connect(″201.408.185.132″,$DBserver,$password);
// access database server
mysql_select(″CLIENT_DB.SQL″); // select database to append
mysql_query(“INSERT INTO UserTable (transmission)
VALUES ($data)”); // add data to UserTable table in  a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.-
jsp?topic=/com.ibm.IBMDI.doc/referenceguide295.htm

and other parser implementations:

http://publib.boulder.ibm.com/infocenter/tivihelp/v2r1/index.-
jsp?topic=/com.ibm.IBMDI.doc/referenceguide259.htm

all of which are hereby expressly incorporated by reference.

Additional example embodiments of the ECPP include:

1. A non-local content caching processor-implemented method, comprising:
obtaining a universally resolvable list of content items on a local client;
identifying a non-local item from the universally resolvable list of content items that is absent on the local client;
generating a local cache request for the identified non-local item having an associated universally resolvable content identifier;
transmitting the generated local cache request to a universally resolvable content server;
receiving, in response to the transmitted request, a universally resolvable content item corresponding to the local cache request; and
marking the requested item as temporary and locally available upon receiving the content item.

2. The method of embodiment 1, wherein the server queries a universally resolvable content database to retrieve the universally resolvable content item.

3. The method of embodiment 1, wherein identifying the non-local item includes conducting a search for the non-local item on the local client.

4. The method of embodiment 1, wherein the locally available content item is engageable as it is partially downloaded.

5. The method of embodiment 1, wherein the locally available content item is engageable as it is fully downloaded.

6. The method of embodiment 1, wherein the universally resolvable content identifier is a track identifier (ID).

7. The method of embodiment 1, wherein identifying the non-local item includes comparing track identifiers associated local items in the local client to the obtained list of track identifiers.

8. The method of embodiment 1, wherein the local cache request includes at least a universally resolvable content service user identifier and a universally resolvable content identifier associated with the identified non-local item.

9. The method of embodiment 1, further comprising:
storing the received universally resolvable content item corresponding to the local cache request in a cache in the local client.

10. The method of embodiment 1, further comprising:
deleting one or more content items in the cache local client prior to the storing.

11. The method of embodiment 10, wherein the content items are deleted based on last hit time.

12. The method of embodiment 10, wherein the content items are deleted based on content item size.

13. The method of embodiment 10, wherein the content items are deleted based on priority.

14. The method of embodiment 13, wherein the priority is determined based on user preference.

15. The method of embodiment 10, wherein the content items are deleted based on at least one of play count and creation time.

16. The method of embodiment 1, wherein the universally resolvable list of content items includes at least one of: (i) a magic playlist, (ii) a dynamically created interest list, (iii) a shared playlist, (iv) a smart cache list, and (v) a shared library.

17. The method of embodiment 1, wherein the content items include at least one of music, books, videos, applications, user's media and user's media denoted by gurus, social, friends or favorites.

18. A non-local content item caching system, comprising:
a memory;
a processor disposed in communication with said memory, and configured to issue a plurality of processing instructions stored in the memory, wherein the processor issues instructions to:
   obtain a universally resolvable list of content items on a local client;
   identify a non-local item from the universally resolvable list of content items that is absent on the local client;
   generate a local cache request for the identified non-local item having an associated universally resolvable content identifier;
   transmit the generated local cache request to a universally resolvable content server;
   receive, in response to the transmitted request, a universally resolvable content item corresponding to the local cache request; and
   mark the requested item as temporary and locally available upon receiving the content item.

19. The system of embodiment 18, wherein the server queries a universally resolvable content database to retrieve the universally resolvable content item.

20. The system of embodiment 18, wherein identifying the non-local item includes conducting a search for the non-local item on the local client.

21. The system of embodiment 18, wherein the locally available content item is engageable as it is partially downloaded.

22. The system of embodiment 18, wherein the locally available content item is engageable as it is fully downloaded.

23. The system of embodiment 18, wherein the universally resolvable content identifier is a track identifier (ID).

24. The system of embodiment 23, wherein identifying the non-local item includes comparing track identifiers associated local items in the local client to the obtained list of track identifiers.

25. The system of embodiment 18, wherein the local cache request includes at least a universally resolvable content service user identifier and a universally resolvable content identifier associated with the identified non-local item.

26. The system of embodiment 18, wherein the processor issues further instructions to:
store the received universally resolvable content item corresponding to the local cache request in a cache in the local client.

27. The system of embodiment 18, wherein the processor issues further instructions to:
delete one or more content items in the cache local client prior to the storing.

28. The system of embodiment 27, wherein the content items are deleted based on last hit time.

29. The system of embodiment 27, wherein the content items are deleted based on content item size.

30. The system of embodiment 27, wherein the content items are deleted based on priority.

31. The system of embodiment 27, wherein the priority is determined based on user preference.

32. The system of embodiment 27 wherein the content items are deleted based on at least one of play count and creation time.

33. The system of embodiment 18, wherein the universally resolvable list of content items includes at least one of: (i) a magic playlist, (ii) a dynamically created interest list, (iii) a shared playlist, (iv) a smart cache list, and (v) a shared library.

34. The system of embodiment 18, wherein the content items include at least one of music, books, videos, applications, user's media and user's media denoted by gurus, social, friends or favorites.

35. A non-local content caching processor-readable medium storing processor-issuable instructions, comprising:
obtain a universally resolvable list of content items on a local client;
identify a non-local item from the universally resolvable list of content items that is absent on the local client;
generate a local cache request for the identified non-local item having an associated universally resolvable content identifier;
transmit the generated local cache request to a universally resolvable content server;
receive, in response to the transmitted request, a universally resolvable content item corresponding to the local cache request; and
mark the requested item as temporary and locally available upon receiving the content item.

36. The medium of embodiment 35, wherein the server queries a universally resolvable content database to retrieve the universally resolvable content item.

37. The medium of embodiment 35, wherein identifying the non-local item includes conducting a search for the non-local item on the local client.

38. The medium of embodiment 35, wherein the locally available content item is engageable as it is partially downloaded.

39. The medium of embodiment 35, wherein the locally available content item is engageable as it is fully downloaded.

40. The medium of embodiment 35, wherein the universally resolvable content identifier is a track identifier (ID).

41. The medium of embodiment 35, wherein identifying the non-local item includes comparing track identifiers associated local items in the local client to the obtained list of track identifiers.

42. The medium of embodiment 35, wherein the local cache request includes at least a universally resolvable content service user identifier and a universally resolvable content identifier associated with the identified non-local item.

43. The medium of embodiment 35, wherein the processor issues further instructions to:
store the received universally resolvable content item corresponding to the local cache request in a cache in the local client.

44. The medium of embodiment 35, wherein the processor issues further instructions to:
delete one or more content items in the cache local client prior to the storing.

45. The medium of embodiment 44, wherein the content items are deleted based on last hit time.

46. The medium of embodiment 44, wherein the content items are deleted based on content item size.

47. The medium of embodiment 44, wherein the content items are deleted based on priority.

48. The medium of embodiment 47, wherein the priority is determined based on user preference.

49. The medium of embodiment 44 wherein the content items are deleted based on at least one of play count and creation time.

50. The medium of embodiment 35, wherein the universally resolvable list of content items includes at least one of: (i) a magic playlist, (ii) a dynamically created interest list, (iii) a shared playlist, (iv) a smart cache list, and (v) a shared library.

51. The medium of embodiment 35, wherein the content items include at least one of music, books, videos, applications, user's media and user's media denoted by gurus, social, friends or favorites.

52. A non-local content item caching apparatus, comprising:
a memory:
a processor disposed in communication with said memory, and configured to issue a plurality of processing instructions stored in the memory, wherein the processor issues instructions to:
   obtain a universally resolvable list of content items on a local client;
   identify a non-local item from the universally resolvable list of content items that is absent on the local client;
   generate a local cache request for the identified non-local item having an associated universally resolvable content identifier;
   transmit the generated local cache request to a universally resolvable content server;
   receive, in response to the transmitted request, a universally resolvable content item corresponding to the local cache request; and
   mark the requested item as temporary and locally available upon receiving the content item.

53. The apparatus of embodiment 52, wherein the server queries a universally resolvable content database to retrieve the universally resolvable content item.

54. The apparatus of embodiment 52, wherein identifying the non-local item includes conducting a search for the non-local item on the local client.

55. The apparatus of embodiment 52, wherein the locally available content item is engageable as it is partially downloaded.

56. The apparatus of embodiment 52, wherein the locally available content item is engageable as it is fully downloaded.

57. The apparatus of embodiment 52, wherein the universally resolvable content identifier is a track identifier (ID).

58. The apparatus of embodiment 52, wherein identifying the non-local item includes comparing track identifiers associated local items in the local client to the obtained list of track identifiers.

59. The apparatus of embodiment 52, wherein the local cache request includes at least a universally resolvable content service user identifier and a universally resolvable content identifier associated with the identified non-local item.

60. The apparatus of embodiment 52, wherein the processor issues further instructions to:
store the received universally resolvable content item corresponding to the local cache request in a cache in the local client.

61. The apparatus of embodiment 52, wherein the processor issues further instructions to:
delete one or more content items in the cache local client prior to the storing.

62. The apparatus of embodiment 61, wherein the content items are deleted based on last hit time.

63. The apparatus of embodiment 61, wherein the content items are deleted based on content item size.

64. The apparatus of embodiment 61, wherein the content items are deleted based on priority.

65. The apparatus of embodiment 64, wherein the priority is determined based on user preference.

66. The apparatus of embodiment 61 wherein the content items are deleted based on at least one of play count and creation time.

67. The system of embodiment 52, wherein the universally resolvable list of content items includes at least one of: (i) a magic playlist, (ii) a dynamically created interest list, (iii) a shared playlist, (iv) a smart cache list, and (v) a shared library.

68. The system of embodiment 52, wherein the content items include at least one of music, books, videos, applications, user's media and user's media denoted by gurus, social, friends or favorites.

69. A non-local content caching processor-implemented method, comprising:
providing a universally resolvable list of content items to a client;
obtaining an identification of a non-local item from the universally resolvable list of content items that is absent from the client;
obtaining a cache request for the identified non-local item having an associated universally resolvable content identifier;
providing, in response to the obtained request, a universally resolvable content item corresponding to the cache request; and
updating the requested item as temporary and locally available.

70. The method of embodiment 69, further comprising querying a universally resolvable content database to retrieve the universally resolvable content item.

71. The method of embodiment 69, wherein obtaining the identification of the non-local item includes conducting a search for the non-local item on the local client.

72. The method of embodiment 69, wherein the locally available content item is engageable as it is partially downloaded.

73. The method of embodiment 69, wherein the locally available content item is engageable as it is fully downloaded.

74. The method of embodiment 69, wherein the universally resolvable content identifier is a track identifier (ID).

75. The method of embodiment 74, wherein obtaining the identification of the non-local item includes comparing track identifiers associated local items in the local client to the obtained list of track identifiers.

76. The method of embodiment 69, wherein the cache request includes at least a universally resolvable content service user identifier and a universally resolvable content identifier associated with the identified non-local item.

77. The method of embodiment 69, further comprising:
providing the universally resolvable content item corresponding to the cache request for storage in a cache in the client.

78. The method of embodiment 77, further comprising:
obtaining an indication of deletion of one or more content items in the cache of the client prior to providing the content item for storage.

79. The method of embodiment 78 wherein the content items are deleted based on last hit time.

80. The method of embodiment 78, wherein the content items are deleted based on content item size.

81. The method of embodiment 78, wherein the content items are deleted based on priority.

82. The method of embodiment 81, wherein the priority is determined based on user preference.

83. The method of embodiment 78, wherein the content items are deleted based on at least one of play count and creation time.

84. The method of embodiment 69, wherein the universally resolvable list of content items includes at least one of: (i) a magic playlist, (ii) a dynamically created interest list, (iii) a shared playlist, (iv) a smart cache list, and (v) a shared library.

85. The method of embodiment 69, wherein the content items include at least one of music, books, videos, applications, user's media and user's media denoted by gurus, social, friends or favorites.

86. A non-local content item caching system, comprising:
a memory;
a processor disposed in communication with said memory, and configured to issue a plurality of processing instructions stored in the memory, wherein the processor issues instructions to:
   provide a universally resolvable list of content items to a client;
   obtain an identification of a non-local item from the universally resolvable list of content items that is absent from the client;
   obtain a cache request for the identified non-local item having an associated universally resolvable content identifier;
   provide, in response to the obtained request, a universally resolvable content item corresponding to the cache request; and
   update the requested item as temporary and locally available.

87. The system of embodiment 86, wherein the processor issues further instructions to query a universally resolvable content database to retrieve the universally resolvable content item.

88. The system of embodiment 86, wherein the processor issues further instructions to obtain the identification of the non-local item includes conducting a search for the non-local item on the local client.

89. The system of embodiment 86, wherein the locally available content item is engageable as it is partially downloaded.

90. The system of embodiment 86, wherein the locally available content item is engageable as it is fully downloaded.

91. The system of embodiment 86, wherein the universally resolvable content identifier is a track identifier (ID).

92. The system of embodiment 91, wherein the instructions to obtain the identification of the non-local item includes instructions to compare track identifiers associated local items in the local client to the obtained list of track identifiers.

93. The system of embodiment 86, wherein the cache request includes at least a universally resolvable content service user identifier and a universally resolvable content identifier associated with the identified non-local item.

94. The system of embodiment 86, wherein the processor issues further instructions to:
provide the universally resolvable content item corresponding to the cache request for storage in a cache in the client.

95. The system of embodiment 94, wherein the processor issues further instructions to:
obtaining an indication of deletion of one or more content items in the cache of the client prior to providing the content item for storage.

96. The system of embodiment 95 wherein the content items are deleted based on last hit time.

97. The system of embodiment 95, wherein the content items are deleted based on content item size.

98. The system of embodiment 95, wherein the content items are deleted based on priority.

99. The system of embodiment 81, wherein the priority is determined based on user preference.

100. The system of embodiment 95, wherein the content items are deleted based on at least one of play count and creation time.

101. The system of embodiment 86, wherein the universally resolvable list of content items includes at least one of: (i) a magic playlist, (ii) a dynamically created interest list, (iii) a shared playlist, (iv) a smart cache list, and (v) a shared library.

102. The system of embodiment 86, wherein the content items include at least one of music, books, videos, applications, user's media and user's media denoted by gurus, social, friends or favorites.

103. A non-local content caching processor-readable medium storing processor-issuable instructions, comprising:
provide a universally resolvable list of content items to a client;
obtain an identification of a non-local item from the universally resolvable list of content items that is absent from the client;
obtain a cache request for the identified non-local item having an associated universally resolvable content identifier;
provide, in response to the obtained request, a universally resolvable content item corresponding to the cache request; and
update the requested item as temporary and locally available.

104. The medium of embodiment 103, wherein the processor issues further instructions to query a universally resolvable content database to retrieve the universally resolvable content item.

105. The medium of embodiment 103, wherein the processor issues further instructions to obtain the identification of the non-local item includes conducting a search for the non-local item on the local client.

106. The medium of embodiment 103, wherein the locally available content item is engageable as it is partially downloaded.

107. The medium of embodiment 103, wherein the locally available content item is engageable as it is fully downloaded.

108. The medium of embodiment 103, wherein the universally resolvable content identifier is a track identifier (ID).

109. The medium of embodiment 108, wherein the instructions to obtain the identification of the non-local item includes instructions to compare track identifiers associated local items in the local client to the obtained list of track identifiers.

110. The medium of embodiment 103, wherein the cache request includes at least a universally resolvable content service user identifier and a universally resolvable content identifier associated with the identified non-local item.

111. The medium of embodiment 103, wherein the processor issues further instructions to:
provide the universally resolvable content item corresponding to the cache request for storage in a cache in the client.

112. The medium of embodiment 111, wherein the processor issues further instructions to:
obtaining an indication of deletion of one or more content items in the cache of the client prior to providing the content item for storage.

113. The medium of embodiment 112 wherein the content items are deleted based on last hit time.

114. The medium of embodiment 112, wherein the content items are deleted based on content item size.

115. The medium of embodiment 112, wherein the content items are deleted based on priority.

116. The medium of embodiment 115, wherein the priority is determined based on user preference.

117. The medium of embodiment 112, wherein the content items are deleted based on at least one of play count and creation time.

118. The medium of embodiment 103, wherein the universally resolvable list of content items includes at least one of: (i) a magic playlist, (ii) a dynamically created interest list, (iii) a shared playlist, (iv) a smart cache list, and (v) a shared library.

119. The medium of embodiment 103, wherein the content items include at least one of music, books, videos, applications, user's media and user's media denoted by gurus, social, friends or favorites.

120. An apparatus, comprising:
a memory;
a processor disposed in communication with said memory, and configured to issue a plurality of processing instructions stored in the memory, wherein the processor issues instructions to:
   provide a universally resolvable list of content items to a client;
   obtain an identification of a non-local item from the universally resolvable list of content items that is absent from the client;
   obtain a cache request for the identified non-local item having an associated universally resolvable content identifier;
   provide, in response to the obtained request, a universally resolvable content item corresponding to the cache request; and
   update the requested item as temporary and locally available.

121. The apparatus of embodiment 120, wherein the processor issues further instructions to query a universally resolvable content database to retrieve the universally resolvable content item.

122. The apparatus of embodiment 120, wherein the processor issues further instructions to obtain the identification of the non-local item includes conducting a search for the non-local item on the local client.

123. The apparatus of embodiment 120, wherein the locally available content item is engageable as it is partially downloaded.

124. The apparatus of embodiment 120, wherein the locally available content item is engageable as it is fully downloaded.

125. The apparatus of embodiment 120, wherein the universally resolvable content identifier is a track identifier (ID).

126. The apparatus of embodiment 125, wherein the instructions to obtain the identification of the non-local item includes instructions to compare track identifiers associated local items in the local client to the obtained list of track identifiers.

127. The apparatus of embodiment 120, wherein the cache request includes at least a universally resolvable content service user identifier and a universally resolvable content identifier associated with the identified non-local item.

128. The apparatus of embodiment 120, wherein the processor issues further instructions to:
provide the universally resolvable content item corresponding to the cache request for storage in a cache in the client.

129. The apparatus of embodiment 128, wherein the processor issues further instructions to:
obtain an indication of deletion of one or more content items in the cache of the client prior to providing the content item for storage.

130. The apparatus of embodiment 129 wherein the content items are deleted based on last hit time.

131. The apparatus of embodiment 129, wherein the content items are deleted based on content item size.

132. The apparatus of embodiment 129, wherein the content items are deleted based on priority.

133. The apparatus of embodiment 132, wherein the priority is determined based on user preference.

134. The apparatus of embodiment 129, wherein the content items are deleted based on at least one of play count and creation time.

135. The apparatus of embodiment 120, wherein the universally resolvable list of content items includes at least one of: (i) a magic playlist, (ii) a dynamically created interest list, (iii) a shared playlist, (iv) a smart cache list, and (v) a shared library.

136. The apparatus of embodiment 120, wherein the content items include at least one of music, books, videos, applications, user's media and user's media denoted by gurus, social, friends or favorites.

137. An apportionment heuristics based caching processor-implemented method, comprising:
obtaining content discovery supportive information for a universally resolvable user;
determining apportionment heuristics among the obtained information for the user;
identifying a first set of universally resolvable content items based on the determined apportionment heuristics;
creating a caching queue that includes the identified first set of universally resolvable content items; and
providing the first set of universally resolvable content items in the caching queue to the user.

138. The method of embodiment 137, wherein providing the first set of universally resolvable content items is in response to a request for transmission that is triggered when a client device bandwidth usage is below a pre-determined threshold.

139. The method of embodiment 137, wherein providing the first set of universally resolvable content items is in response to a request for transmission that is triggered in accordance with user specified caching criteria.

140. The method of embodiment 137, wherein the first set of universally resolvable content items are arranged in a predefined download order in the caching queue.

141. The method of embodiment 137, wherein the apportionment heuristics includes the user's entity graph.

142. The method of embodiment 141, wherein the user's entity graph includes at least one of a social graph and an interest graph.

143. The method of embodiment 137, wherein the apportionment heuristics includes user-specific usage.

144. The method of embodiment 137, wherein the apportionment heuristics includes aggregate usage.

145. The method of embodiment 137, wherein the apportionment heuristics includes preference profile.

146. The method of embodiment 145, wherein the preference profile is associated with at least one of a user or a group of users, and indicative of preference for at least one of: (i) genres, (ii) artists, (iii) albums, (iv) tracks, (v) music attributes, (vi) location based preferences, and (vii) time based preferences.

147. The method of embodiment 137, wherein the apportionment heuristics includes social recommendation.

148. The method of embodiment 137, wherein the content discovery supportive information is updated based on an activity associated with one or more users.

149. The method of embodiment 148, further comprising:
obtaining the updated content discovery supportive information for the universally resolvable content user;
determining updated apportionment heuristics among the obtained updated information for the user;
identifying a second set of universally resolvable content items based on the determined updated apportionment heuristics;
updating the caching queue that includes the identified second set of universally resolvable content items; and
providing the second set of universally resolvable content items in the updated caching queue to the user.

150. The method of embodiment 149, wherein the second set of universally resolvable content items includes at least one content item from the first set of universally resolvable content items.

151. The method of embodiment 137, wherein the content discovery supportive information includes at least one of: most frequently played content item, content item rated high, content item rated low, content item shared and content item bookmarked.

152. An apportionment heuristics based caching system, comprising:
a memory;
a processor disposed in communication with said memory, and configured to issue a plurality of processing instructions stored in the memory, wherein the processor issues instructions to:
   obtain content discovery supportive information for a universally resolvable user;
   determine apportionment heuristics among the obtained information for the user;
   identify a first set of universally resolvable content items based on the determined apportionment heuristics;
   create a caching queue that includes the identified first set of universally resolvable content items; and
   provide the first set of universally resolvable content items in the caching queue to the user.

153. The system of embodiment 152, wherein providing the first set of universally resolvable content items is in response to a request for transmission that is triggered when a client device bandwidth usage is below a pre-determined threshold.

154. The system of embodiment 152, wherein the instructions to provide the first set of universally resolvable content items is in response to a request for transmission that is triggered in accordance with user specified caching criteria.

155. The system of embodiment 152, wherein the first set of universally resolvable content items are arranged in a predefined download order in the caching queue.

156. The system of embodiment 152, wherein the apportionment heuristics includes the user's entity graph.

157. The system of embodiment 156, wherein the user's entity graph includes at least one of a social graph and an interest graph.

158. The system of embodiment 152, wherein the apportionment heuristics includes user-specific usage.

159. The system of embodiment 152, wherein the apportionment heuristics includes aggregate usage.

160. The system of embodiment 152, wherein the apportionment heuristics includes preference profile.

161. The system of embodiment 160, wherein the preference profile is associated with at least one of a user or a group of users, and indicative of preference for at least one of: (i) genres, (ii) artists, (iii) albums, (iv) tracks, (v) music attributes, (vi) location based preferences, and (vii) time based preferences.

162. The system of embodiment 152, wherein the apportionment heuristics includes social recommendation.

163. The system of embodiment 152, wherein the content discovery supportive information is updated based on an activity associated with one or more users.

164. The system of embodiment 163, wherein the processor issues further instructions to:
obtain the updated content discovery supportive information for the universally resolvable content user;
determine updated apportionment heuristics among the obtained updated information for the user;
identify a second set of universally resolvable content items based on the determined updated apportionment heuristics;
update the caching queue that includes the identified second set of universally resolvable content items; and
provide the second set of universally resolvable content items in the updated caching queue to the user.

165. The system of embodiment 164, wherein the second set of universally resolvable content items includes at least one content item from the first set of universally resolvable content items.

166. The system of embodiment 152, wherein the content discovery supportive information includes at least one of: most frequently played content item, content item rated high, content item rated low, content item shared and content item bookmarked.

167. An apportionment heuristics based caching processor-readable medium storing processor-issuable instructions, comprising:
obtain content discovery supportive information for a universally resolvable user;
determine apportionment heuristics among the obtained information for the user;
identify a first set of universally resolvable content items based on the determined apportionment heuristics;
create a caching queue that includes the identified first set of universally resolvable content items; and
provide the first set of universally resolvable content items in the caching queue to the user.

168. The medium of embodiment 167, wherein providing the first set of universally resolvable content items is in response to a request for transmission that is triggered when a client device bandwidth usage is below a pre-determined threshold.

169. The medium of embodiment 167, wherein the instructions to provide the first set of universally resolvable content items is in response to a request for transmission that is triggered in accordance with user specified caching criteria.

170. The medium of embodiment 167 wherein the first set of universally resolvable content items are arranged in a predefined download order in the caching queue.

171. The medium of embodiment 167, wherein the apportionment heuristics includes the user's entity graph.

172. The medium of embodiment 171, wherein the user's entity graph includes at least one of a social graph and an interest graph.

173. The medium of embodiment 167, wherein the apportionment heuristics includes user-specific usage.

174. The medium of embodiment 167, wherein the apportionment heuristics includes aggregate usage.

175. The medium of embodiment 167, wherein the apportionment heuristics includes preference profile.

176. The medium of embodiment 175, wherein the preference profile is associated with at least one of a user or a group of users, and indicative of preference for at least one of: (i) genres, (ii) artists, (iii) albums, (iv) tracks, (v) music attributes, (vi) location based preferences, and (vii) time based preferences.

177. The medium of embodiment 167, wherein the apportionment heuristics includes social recommendation.

178. The medium of embodiment 167, wherein the content discovery supportive information is updated based on an activity associated with one or more users.

179. The medium of embodiment 178, wherein the processor issues further instructions to:
obtain the updated content discovery supportive information for the universally resolvable content user;
determine updated apportionment heuristics among the obtained updated information for the user;
identify a second set of universally resolvable content items based on the determined updated apportionment heuristics;
update the caching queue that includes the identified second set of universally resolvable content items; and
provide the second set of universally resolvable content items in the updated caching queue to the user.

180. The medium of embodiment 179, wherein the second set of universally resolvable content items includes at least one content item from the first set of universally resolvable content items.

181. The medium of embodiment 167, wherein the content discovery supportive information includes at least one of: most frequently played content item, content item rated high, content item rated low, content item shared and content item bookmarked.

182. An apportionment heuristics based caching apparatus, comprising:
a memory;
a processor disposed in communication with said memory, and configured to issue a plurality of processing instructions stored in the memory, wherein the processor issues instructions to:
   obtain content discovery supportive information for a universally resolvable user;
   determine apportionment heuristics among the obtained information for the user;
   identify a first set of universally resolvable content items based on the determined apportionment heuristics;
   create a caching queue that includes the identified first set of universally resolvable content items; and
   provide the first set of universally resolvable content items in the caching queue to the user.

183. The apparatus of embodiment 182, wherein providing the first set of universally resolvable content items is in response to a request for transmission that is triggered when a client device bandwidth usage is below a pre-determined threshold.

184. The apparatus of embodiment 182, wherein the instructions to provide the first set of universally resolvable content items is in response to a request for transmission that is triggered in accordance with user specified caching criteria.

185. The apparatus of embodiment 182, wherein the first set of universally resolvable content items are arranged in a predefined download order in the caching queue.

186. The apparatus of embodiment 182, wherein the apportionment heuristics includes the user's entity graph.

187. The apparatus of embodiment 186, wherein the user's entity graph includes at least one of a social graph and an interest graph.

188. The apparatus of embodiment 182, wherein the apportionment heuristics includes user-specific usage.

189. The apparatus of embodiment 182, wherein the apportionment heuristics includes aggregate usage.

190. The apparatus of embodiment 182, wherein the apportionment heuristics includes preference profile.

191. The apparatus of embodiment 160, wherein the preference profile is associated with at least one of a user or a group of users, and indicative of preference for at least one of: (i) genres, (ii) artists, (iii) albums, (iv) tracks, (v) music attributes, (vi) location based preferences, and (vii) time based preferences.

192. The apparatus of embodiment 182, wherein the apportionment heuristics includes social recommendation.

193. The apparatus of embodiment 182, wherein the content discovery supportive information is updated based on an activity associated with one or more users.

194. The apparatus of embodiment 193, wherein the processor issues further instructions to:
obtain the updated content discovery supportive information for the universally resolvable content user;
determine updated apportionment heuristics among the obtained updated information for the user;
identify a second set of universally resolvable content items based on the determined updated apportionment heuristics;
update the caching queue that includes the identified second set of universally resolvable content items; and
provide the second set of universally resolvable content items in the updated caching queue to the user.

195. The apparatus of embodiment 194, wherein the second set of universally resolvable content items includes at least one content item from the first set of universally resolvable content items.

196. The apparatus of embodiment 182, wherein the content discovery supportive information includes at least one of: most frequently played content item, content item rated high, content item rated low, content item shared and content item bookmarked.

197. An apportionment heuristics based caching processor-implemented method, comprising:
providing content discovery supportive information for a universally resolvable user;
providing an indication of apportionment heuristics among the obtained information for the user;
obtaining an identification of a first set of universally resolvable content items based on the determined apportionment heuristics;
obtaining an indication of creation of a caching queue that includes the identified first set of universally resolvable content items; and
obtaining the first set of universally resolvable content items in the caching queue to the user.

198. The method of embodiment 197, wherein obtaining the first set of universally resolvable content items is in response to a request for transmission that is triggered when a client device bandwidth usage is below a pre-determined threshold.

199. The method of embodiment 197, wherein obtaining the first set of universally resolvable content items is in response to a request for transmission that is triggered in accordance with user specified caching criteria.

200. The method of embodiment 197, wherein the first set of universally resolvable content items are arranged in a predefined download order in the caching queue.

201. The method of embodiment 197, wherein the apportionment heuristics includes the user's entity graph.

202. The method of embodiment 201, wherein the user's entity graph includes at least one of a social graph and an interest graph.

203. The method of embodiment 197, wherein the apportionment heuristics includes user-specific usage.

204. The method of embodiment 197, wherein the apportionment heuristics includes aggregate usage.

205. The method of embodiment 197, wherein the apportionment heuristics includes preference profile.

206. The method of embodiment 205, wherein the preference profile is associated with at least one of a user or a group of users, and indicative of preference for at least one of: (i) genres, (ii) artists, (iii) albums, (iv) tracks, (v) music attributes, (vi) location based preferences, and (vii) time based preferences.

207. The method of embodiment 197, wherein the apportionment heuristics includes social recommendation.

208. The method of embodiment 197, wherein the content discovery supportive information is updated based on an activity associated with one or more users.

209. The method of embodiment 208, further comprising:
providing the updated content discovery supportive information for the universally resolvable content user;
obtaining an indication of determination of updated apportionment heuristics among the obtained updated information for the user;
obtaining an indication of identification of a second set of universally resolvable content items based on the determined updated apportionment heuristics;
obtaining the caching queue that includes the identified second set of universally resolvable content items; and
obtaining the second set of universally resolvable content items in the updated caching queue to the user.

210. The method of embodiment 209, wherein the second set of universally resolvable content items includes at least one content item from the first set of universally resolvable content items.

211. The method of embodiment 197, wherein the content discovery supportive information includes at least one of: most frequently played content item, content item rated high, content item rated low, content item shared and content item bookmarked.

212. An apportionment heuristics based caching system, comprising:
a memory;
a processor disposed in communication with said memory, and configured to issue a plurality of processing instructions stored in the memory, wherein the processor issues instructions to:
   provide content discovery supportive information for a universally resolvable user;
   obtain an indication of determination of apportionment heuristics among the obtained information for the user;
   obtain an indication of identification of a first set of universally resolvable content items based on the determined apportionment heuristics;
   obtain a caching queue that includes the identified first set of universally resolvable content items; and
   obtain the first set of universally resolvable content items in the caching queue to the user.

213. The system of embodiment 212, wherein obtaining the first set of universally resolvable content items is in response to a request for transmission that is triggered when a client device bandwidth usage is below a pre-determined threshold.

214. The system of embodiment 212, wherein the instructions to obtain the first set of universally resolvable content items is in response to a request for transmission that is triggered in accordance with user specified caching criteria.

215. The system of embodiment 212, wherein the first set of universally resolvable content items are arranged in a predefined download order in the caching queue.

216. The system of embodiment 212, wherein the apportionment heuristics includes the user's entity graph.

217. The system of embodiment 216, wherein the user's entity graph includes at least one of a social graph and an interest graph.

218. The system of embodiment 212, wherein the apportionment heuristics includes user-specific usage.

219. The system of embodiment 212, wherein the apportionment heuristics includes aggregate usage.

220. The system of embodiment 212, wherein the apportionment heuristics includes preference profile.

221. The system of embodiment 220, wherein the preference profile is associated with at least one of a user or a group of users, and indicative of preference for at least one of: (i) genres, (ii) artists, (iii) albums, (iv) tracks, (v) music attributes, (vi) location based preferences, and (vii) time based preferences.

222. The system of embodiment 212, wherein the apportionment heuristics includes social recommendation.

223. The system of embodiment 212, wherein the content discovery supportive information is updated based on an activity associated with one or more users.

224. The system of embodiment 223, wherein the processor issues further instructions to:
provide the updated content discovery supportive information for the universally resolvable content user;
obtain an indication of determination of updated apportionment heuristics among the obtained updated information for the user;
obtain an indication of identification of a second set of universally resolvable content items based on the determined updated apportionment heuristics;
obtaining an indication of update of the caching queue that includes the identified second set of universally resolvable content items; and
obtaining the second set of universally resolvable content items in the updated caching queue to the user.

225. The system of embodiment 224, wherein the second set of universally resolvable content items includes at least one content item from the first set of universally resolvable content items.

226. The system of embodiment 212, wherein the content discovery supportive information includes at least one of: most frequently played content item, content item rated high, content item rated low, content item shared and content item bookmarked.

227. An apportionment heuristics based caching processor-readable medium storing processor-issuable instructions, comprising:
provide content discovery supportive information for a universally resolvable user;
obtain apportionment heuristics among the obtained information for the user;
obtain a first set of universally resolvable content items based on the determined apportionment heuristics;
obtain a caching queue that includes the identified first set of universally resolvable content items; and
obtain the first set of universally resolvable content items in the caching queue to the user.

228. The medium of embodiment 227, wherein the instructions to obtain the first set of universally resolvable content items is in response to a request for transmission that is triggered when a client device bandwidth usage is below a pre-determined threshold.

229. The medium of embodiment 227, wherein the instructions to provide the first set of universally resolvable content items is in response to a request for transmission that is triggered in accordance with user specified caching criteria.

230. The medium of embodiment 227 wherein the first set of universally resolvable content items are arranged in a predefined download order in the caching queue.

231. The medium of embodiment 227, wherein the apportionment heuristics includes the user's entity graph.

232. The medium of embodiment 231, wherein the user's entity graph includes at least one of a social graph and an interest graph.

233. The medium of embodiment 227, wherein the apportionment heuristics includes user-specific usage.

234. The medium of embodiment 227, wherein the apportionment heuristics includes aggregate usage.

235. The medium of embodiment 227, wherein the apportionment heuristics includes preference profile.

236. The medium of embodiment 235, wherein the preference profile is associated with at least one of a user or a group of users, and indicative of preference for at least one of: (i) genres, (ii) artists, (iii) albums, (iv) tracks, (v) music attributes, (vi) location based preferences, and (vii) time based preferences.

237. The medium of embodiment 227, wherein the apportionment heuristics includes social recommendation.

238. The medium of embodiment 227, wherein the content discovery supportive information is updated based on an activity associated with one or more users.

239. The medium of embodiment 238, wherein the processor issues further instructions to:
provide the updated content discovery supportive information for the universally resolvable content user;
obtain an indication of determination of updated apportionment heuristics among the obtained updated information for the user;
obtain an identification of a second set of universally resolvable content items based on the determined updated apportionment heuristics;
obtain an indication to update the caching queue that includes the identified second set of universally resolvable content items; and
obtain the second set of universally resolvable content items in the updated caching queue to the user.

240. The medium of embodiment 239, wherein the second set of universally resolvable content items includes at least one content item from the first set of universally resolvable content items.

241. The medium of embodiment 227, wherein the content discovery supportive information includes at least one of: most frequently played content item, content item rated high, content item rated low, content item shared and content item bookmarked.

242. An apportionment heuristics based caching apparatus, comprising:
a memory;
a processor disposed in communication with said memory, and configured to issue a plurality of processing instructions stored in the memory, wherein the processor issues instructions to:
   provide content discovery supportive information for a universally resolvable user;
   obtain an indication of determination of apportionment heuristics among the obtained information for the user;
   obtain an indication of identification of a first set of universally resolvable content items based on the determined apportionment heuristics;
   obtain a caching queue that includes the identified first set of universally resolvable content items; and
   obtain the first set of universally resolvable content items in the caching queue to the user.

243. The apparatus of embodiment 242, wherein providing the first set of universally resolvable content items is in response to a request for transmission that is triggered when a client device bandwidth usage is below a pre-determined threshold.

244. The apparatus of embodiment 242, wherein the instructions to provide the first set of universally resolvable content items is in response to a request for transmission that is triggered in accordance with user specified caching criteria.

245. The apparatus of embodiment 242, wherein the first set of universally resolvable content items are arranged in a predefined download order in the caching queue.

246. The apparatus of embodiment 242, wherein the apportionment heuristics includes the user's entity graph.

247. The apparatus of embodiment 246, wherein the user's entity graph includes at least one of a social graph and an interest graph.

248. The apparatus of embodiment 242, wherein the apportionment heuristics includes user-specific usage.

249. The apparatus of embodiment 242, wherein the apportionment heuristics includes aggregate usage.

250. The apparatus of embodiment 242, wherein the apportionment heuristics includes preference profile.

251. The apparatus of embodiment 250, wherein the preference profile is associated with at least one of a user or a group of users, and indicative of preference for at least one of: (i) genres, (ii) artists, (iii) albums, (iv) tracks, (v) music attributes, (vi) location based preferences, and (vii) time based preferences.

252. The apparatus of embodiment 242, wherein the apportionment heuristics includes social recommendation.

253. The apparatus of embodiment 242, wherein the content discovery supportive information is updated based on an activity associated with one or more users.

254. The apparatus of embodiment 253, wherein the processor issues further instructions to:
provide the updated content discovery supportive information for the universally resolvable content user;
obtain an indication of determination of updated apportionment heuristics among the obtained updated information for the user;
obtain an indication of identification of a second set of universally resolvable content items based on the determined updated apportionment heuristics;
obtain an indication of update of the caching queue that includes the identified second set of universally resolvable content items; and
obtain the second set of universally resolvable content items in the updated caching queue to the user.

255. The apparatus of embodiment 254, wherein the second set of universally resolvable content items includes at least one content item from the first set of universally resolvable content items.

256. The apparatus of embodiment 242, wherein the content discovery supportive information includes at least one of: most frequently played content item, content item rated high, content item rated low, content item shared and content item bookmarked.

257. A processor-implemented method for providing shared access to a media content collection, comprising:
obtaining from a first universally resolvable media content service user a request to share the user's universally resolvable media content collection;
obtaining from the first user a selection of at least one second universally resolvable user;
configuring the first user's media content collection with restricted shared access controls for the second user; and
providing the second user restricted shared access to the shared media content collection based on the configured restricted shared access controls.

258. The method of embodiment 257, further comprising:
receiving from one of a plurality of shared users having access to the shared media content collection a request to perform an action on the shared media content collection;
performing said action on the shared media content collection to obtain a modified shared media content collection; and
providing the plurality of shared users access to the modified shared media content collection.

259. The method of embodiment 257, further comprising:
downloading non-local content items of the shared media content collection to client devices of a plurality of shared users having access to the shared media content collection, wherein the plurality of shared users includes at least the first user and the second user.

260. The method of embodiment 259, wherein the non-local content items are downloaded in the cache.

261. The method of embodiment 257, wherein the shared media collection is stored in a universally resolvable content database in a server.

262. The method of embodiment 258, wherein said action is selected from any of: (i) add a content item, (ii) remove a content item, (iii) re-order content items, (iv) modify privacy settings, (v) share with another universally resolvable user, (vi) delete the shared media collection, (vii) create a playlist, (viii) add an entity graph member, (ix) publish media collection, and (x) change meta data for a content item.

263. The method of embodiment 257, wherein prior to receiving from the first user the request to share the first user's media content collection:
receiving from the first user a request to create the media content collection; and
receiving from the first user at least one content item for including in the created media content collection.

264. The method of embodiment 257, wherein the media collection any one of: (i) a universally resolvable media content service user created media content collection, and (ii) a system generated media content collection.

265. The method of embodiment 257, further comprising:
configuring access by other universally resolvable media content service users to the shared media collection based on the first user selected access constraints.

266. The method of embodiment 265, wherein the access constraints define read only access to the shared media content collection to any one of: (i) friends having a predetermined degree of separation, (ii) Gurus, (iii) social network members having a predetermined degree of separation, (iv) relationship categories, and (v) everyone.

267. The method of embodiment 257, further comprising:
receiving a request from the second user to perform an action on the shared media content collection; and
obtaining from the first user an acceptance or a denial to the received request to perform the action on the shared media content collection.

268. The method of embodiment 267, wherein when said acceptance is obtained,
performing said action on the shared media content collection to obtain a modified shared media content collection; and
providing the modified shared media content collection to the first user and the second user; and

when said denial is obtained,
providing the second user a request declined message.

269. The method of embodiment 257, wherein the media content collection includes: (i) a playlist, (ii) at least one content item, (iii) a media library in the cloud, and (iv) a media library in a local client.

270. The method of embodiment 257, wherein said configuring includes obtaining the first user specified content parameters and access control parameters for the content.

271. The method of embodiment 257, further comprising: determining a subset of the first user's media content collection that is restricted by the first user's access control parameters for access by the second user.

272. A system for providing shared access to a media content collection, comprising:
a memory;
a processor disposed in communication with said memory, and configured to issue a plurality of processing instructions stored in the memory, wherein the processor issues instructions to:
   obtain from a first universally resolvable media content service user a request to share the user's universally resolvable media content collection;
   obtain from the first user a selection of at least one second universally resolvable user;
   configure the first user's media content collection for shared access with the second user; and
   provide the second user access to the shared media content collection.

273. The system of embodiment 272, wherein the processor issues further instructions to:
receive from one of a plurality of shared users having access to the shared media content collection a request to perform an action on the shared media content collection;
perform said action on the shared media content collection to obtain a modified shared media content collection; and
provide the plurality of shared users access to the modified shared media content collection.

274. The system of embodiment 273, wherein said action is selected from any of: (i) add a content item, (ii) remove a content item, (iii) re-order content items, (iv) modify privacy settings, (v) share with another universally resolvable user, (vi) delete the shared media collection, (vii) create a playlist, (viii) add an entity graph member, (ix) publish media collection, and (x) change meta data for a content item.

275. The system of embodiment 272, wherein the processor issues further instructions to:
download non-local content items of the shared media content collection to client devices of a plurality of shared users having access to the shared media content collection, wherein the plurality of shared users includes at least the first user and the second user.

276. The system of embodiment 275, wherein the non-local content items are downloaded in the cache.

277. The system of embodiment 272, wherein the shared media collection is stored in a universally resolvable content database in a server.

278. The system of embodiment 272, wherein prior to issuing instructions to receive from the first user the request to share the first user's media content collection, the processor issues instruction to;
receive from the first user a request to create the media content collection; and
receive from the first user at least one content item for including in the created media content collection.

279. The system of embodiment 272, wherein the media collection any one of: (i) a universally resolvable media content service user created media content collection, and (ii) a system generated media content collection.

280. The system of embodiment 272, wherein the processor issues further instructions to:
configure access by other universally resolvable media content service users to the shared media collection based on the first user selected access constraints.

281. The system of embodiment 280, wherein the access constraints define read only access to the shared media content collection to any one of: (i) friends having a predetermined degree of separation, (ii) Gurus, (iii) social network members having a predetermined degree of separation, (iv) relationship categories, and (v) everyone.

282. The system of embodiment 272, wherein the processor issues further instructions to:
receive a request from the second user to perform an action on the shared media content collection; and
obtain from the first user an acceptance or a denial to the received request to perform the action on the shared media content collection.

283. The system of embodiment 282, wherein when said acceptance is obtained, the processor issues instructions to:
perform said action on the shared media content collection to obtain a modified shared media content collection; and
provide the modified shared media content collection to the first user and the second user; and

when said denial is obtained, the processor issues instructions to:
provide the second user a request declined message.

284. The system of embodiment 272, wherein the media content collection includes: (i) a playlist, (ii) at least one content item, (iii) a media library in the cloud, and (iv) a media library in a local client.

285. The system of embodiment 272, wherein said instructions to configure includes instructions to obtain the first user specified content parameters and access control parameters for the content.

286. The system of embodiment 272, wherein said processor issues further instructions to:
determine a subset of the first user's media content collection that is restricted by the first user's access control parameters for access by the second user.

287. A processor-readable medium storing processor-issuable instructions for providing shared access to a media content collection, wherein the processor issues instructions to:
obtain from a first universally resolvable media content service user a request to share the user's universally resolvable media content collection;
obtain from the first user a selection of at least one second universally resolvable user;
configure the first user's media content collection for shared access with the second user; and
provide the second user access to the shared media content collection.

288. The medium of embodiment 287, wherein the processor issues further instructions to:
receive from one of a plurality of shared users having access to the shared media content collection a request to perform an action on the shared media content collection;
perform said action on the shared media content collection to obtain a modified shared media content collection; and
provide the plurality of shared users access to the modified shared media content collection.

289. The medium tem of embodiment 288, wherein said action is selected from any of: (i) add a content item, (ii) remove a content item, (iii) re-order content items, (iv) modify privacy settings, (v) share with another universally resolvable user, (vi) delete the shared media collection, (vii) create a playlist, (viii) add an entity graph member, (ix) publish media collection, and (x) change meta data for a content item.

290. The medium of embodiment 287, wherein the processor issues further instructions to:
download non-local content items of the shared media content collection to client devices of a plurality of shared users having access to the shared media content collection, wherein the plurality of shared users includes at least the first user and the second user.

291. The medium of embodiment 290, wherein the non-local content items are downloaded in the cache.

292. The medium of embodiment 287, wherein the shared media collection is stored in a universally resolvable content database in a server.

293. The medium of embodiment 287, wherein prior to issuing instructions to receive from the first user the request to share the first user's media content collection, the processor issues instruction to;
receive from the first user a request to create the media content collection; and
receive from the first user at least one content item for including in the created media content collection.

294. The medium of embodiment 287, wherein the media collection any one of: (i) a universally resolvable media content service user created media content collection, and (ii) a system generated media content collection.

295. The medium of embodiment 287, wherein the processor issues further instructions to:
configure access by other universally resolvable media content service users to the shared media collection based on the first user selected access constraints.

296. The medium of embodiment 295, wherein the access constraints define read only access to the shared media content collection to any one of: (i) friends having a predetermined degree of separation, (ii) Gurus, (iii) social network members having a predetermined degree of separation, (iv) relationship categories, and (v) everyone.

297. The medium of embodiment 287, wherein the processor issues further instructions to:
receive a request from the second user to perform an action on the shared media content collection; and
obtain from the first user an acceptance or a denial to the received request to perform the action on the shared media content collection.

298. The medium of embodiment 297, wherein when said acceptance is obtained, the processor issues instructions to:
perform said action on the shared media content collection to obtain a modified shared media content collection; and
provide the modified shared media content collection to the first user and the second user; and

when said denial is obtained, the processor issues instructions to:
provide the second user a request declined message.

299. The medium of embodiment 287, wherein the media content collection includes: (i) a playlist, (ii) at least one content item, (iii) a media library in the cloud, and (iv) a media library in a local client.

300. The medium of embodiment 287, wherein said instructions to configure includes instructions to obtain the first user specified content parameters and access control parameters for the content.

301. The medium of embodiment 287, wherein said processor issues further instructions to:
determine a subset of the first user's media content collection that is restricted by the first user's access control parameters for access by the second user.

302. An apparatus for providing shared access to a media content collection, comprising:
a memory;
a processor disposed in communication with said memory, and configured to issue a plurality of processing instructions stored in the memory, wherein the processor issues instructions to:
   obtain from a first universally resolvable media content service user a request to share the user's universally resolvable media content collection;
   obtain from the first user a selection of at least one second universally resolvable user;
   configure the first user's media content collection for shared access with the second user; and
   provide the second user access to the shared media content collection.

303. The apparatus of embodiment 302, wherein the processor issues further instructions to:
receive from one of a plurality of shared users having access to the shared media content collection a request to perform an action on the shared media content collection;
perform said action on the shared media content collection to obtain a modified shared media content collection; and
provide the plurality of shared users access to the modified shared media content collection.

304. The apparatus of embodiment 303, wherein said action is selected from any of: (i) add a content item, (ii) remove a content item, (iii) re-order content items, (iv) modify privacy settings, (v) share with another universally resolvable user, (vi) delete the shared media collection, (vii) create a playlist, (viii) add an entity graph member, (ix) publish media collection, and (x) change meta data for a content item.

305. The apparatus of embodiment 302, wherein the processor issues further instructions to:
download non-local content items of the shared media content collection to client devices of a plurality of shared users having access to the shared media content collection, wherein the plurality of shared users includes at least the first user and the second user.

306. The apparatus of embodiment 305, wherein the non-local content items are downloaded in the cache.

307. The apparatus of embodiment 302, wherein the shared media collection is stored in a universally resolvable content database in a server.

308. The apparatus of embodiment 302, wherein prior to issuing instructions to receive from the first user the request to share the first user's media content collection, the processor issues instruction to;
receive from the first user a request to create the media content collection; and
receive from the first user at least one content item for including in the created media content collection.

309. The apparatus of embodiment 302, wherein the media collection any one of: (i) a universally resolvable media content service user created media content collection, and (ii) a system generated media content collection.

310. The apparatus of embodiment 302, wherein the processor issues further instructions to:
configure access by other universally resolvable media content service users to the shared media collection based on the first user selected access constraints.

311. The apparatus of embodiment 310, wherein the access constraints define read only access to the shared media content collection to any one of: (i) friends having a predetermined degree of separation, (ii) Gurus, (iii) social network members having a predetermined degree of separation, (iv) relationship categories, and (v) everyone.

312. The apparatus of embodiment 302, wherein the processor issues further instructions to:
receive a request from the second user to perform an action on the shared media content collection; and
obtain from the first user an acceptance or a denial to the received request to perform the action on the shared media content collection.

313. The apparatus of embodiment 282, wherein when said acceptance is obtained, the processor issues instructions to:
perform said action on the shared media content collection to obtain a modified shared media content collection; and
provide the modified shared media content collection to the first user and the second user; and

when said denial is obtained, the processor issues instructions to:
provide the second user a request declined message.

314. The apparatus of embodiment 302, wherein the media content collection includes: (i) a playlist, (ii) at least one content item, (iii) a media library in the cloud, and (iv) a media library in a local client.

315. The apparatus of embodiment 302, wherein said instructions to configure includes instructions to obtain the first user specified content parameters and access control parameters for the content.

316. The apparatus of embodiment 302, wherein said processor issues further instructions to:
determine a subset of the first user's media content collection that is restricted by the first user's access control parameters for access by the second user.

317. A processor-implemented method, comprising:
providing from a first universally resolvable media content service user a request to share the user's universally resolvable media content collection;
providing from the first user a selection of at least one second universally resolvable user;
providing authorization to configuring the first user's media content collection with restricted shared access controls for the second user; and
providing authorization to provide the second user restricted shared access to the shared media content collection based on the configured restricted shared access controls.

318. The method of embodiment 317, further comprising:
providing to one of a plurality of shared users having access to the shared media content collection a request to perform an action on the shared media content collection;
providing authorization to perform said action on the shared media content collection to obtain a modified shared media content collection; and
obtaining for the plurality of shared users access to the modified shared media content collection.

319. The method of embodiment 317, further comprising:
providing authorization to download non-local content items of the shared media content collection to client devices of a plurality of shared users having access to the shared media content collection, wherein the plurality of shared users includes at least the first user and the second user.

320. The method of embodiment 319, wherein the non-local content items are downloaded in the cache.

321. The method of embodiment 317, wherein the shared media collection is stored in a universally resolvable content database in a server.

322. The method of embodiment 318, wherein said action is selected from any of: (i) add a content item, (ii) remove a content item, (iii) re-order content items, (iv) modify privacy settings, (v) share with another universally resolvable user, (vi) delete the shared media collection, (vii) create a playlist, (viii) add an entity graph member, (ix) publish media collection, and (x) change meta data for a content item.

323. The method of embodiment 317, wherein prior to providing from the first user the request to share the first user's media content collection:
providing from the first user a request to create the media content collection; and
providing from the first user at least one content item for including in the created media content collection.

324. The method of embodiment 317, wherein the media collection any one of: (i) a universally resolvable media content service user created media content collection, and (ii) a system generated media content collection.

325. The method of embodiment 317, further comprising:
providing authorization to configure access by other universally resolvable media content service users to the shared media collection based on the first user selected access constraints.

326. The method of embodiment 325, wherein the access constraints define read only access to the shared media content collection to any one of: (i) friends having a predetermined degree of separation, (ii) Gurus, (iii) social network members having a predetermined degree of separation, (iv) relationship categories, and (v) everyone.

327. The method of embodiment 317, further comprising:
providing a request from the second user to perform an action on the shared media content collection; and
providing from the first user an acceptance or a denial to the received request to perform the action on the shared media content collection.

328. The method of embodiment 327, wherein when said acceptance is obtained,
providing authorization to perform said action on the shared media content collection to obtain a modified shared media content collection; and
obtaining the modified shared media content collection to the first user and the second user; and

when said denial is obtained,
obtaining the second user a request declined message.

329. The method of embodiment 317, wherein the media content collection includes: (i) a playlist, (ii) at least one content item, (iii) a media library in the cloud, and (iv) a media library in a local client.

330. The method of embodiment 317, wherein said configuring includes obtaining the first user specified content parameters and access control parameters for the content.

331. The method of embodiment 317, further comprising:
obtaining an indication of determination of a subset of the first user's media content collection that is restricted by the first user's access control parameters for access by the second user.

332. A system for providing shared access to a media content collection, comprising:
a memory;
a processor disposed in communication with said memory, and configured to issue a plurality of processing instructions stored in the memory, wherein the processor issues instructions to:
   provide from a first universally resolvable media content service user a request to share the user's universally resolvable media content collection;
   provide from the first user a selection of at least one second universally resolvable user;
   provide authorization to configure the first user's media content collection for shared access with the second user; and
   provide authorization to the second user access to the shared media content collection.

333. The system of embodiment 332, wherein the processor issues further instructions to:
provide from one of a plurality of shared users having access to the shared media content collection a request to perform an action on the shared media content collection;
provide authorization to perform said action on the shared media content collection to obtain a modified shared media content collection; and
obtain the plurality of shared users access to the modified shared media content collection.

334. The system of embodiment 333, wherein said action is selected from any of: (i) add a content item, (ii) remove a content item, (iii) re-order content items, (iv) modify privacy settings, (v) share with another universally resolvable user, (vi) delete the shared media collection, (vii) create a playlist, (viii) add an entity graph member, (ix) publish media collection, and (x) change meta data for a content item.

335. The system of embodiment 332, wherein the processor issues further instructions to:
provide authorization to download non-local content items of the shared media content collection to client devices of a plurality of shared users having access to the shared media content collection, wherein the plurality of shared users includes at least the first user and the second user.

336. The system of embodiment 335, wherein the non-local content items are downloaded in the cache.

337. The system of embodiment 332, wherein the shared media collection is stored in a universally resolvable content database in a server.

338. The system of embodiment 332, wherein prior to issuing instructions to receive from the first user the request to share the first user's media content collection, the processor issues instruction to;
receive from the first user a request to create the media content collection; and
receive from the first user at least one content item for including in the created media content collection.

339. The system of embodiment 332, wherein the media collection any one of: (i) a universally resolvable media content service user created media content collection, and (ii) a system generated media content collection.

340. The system of embodiment 332, wherein the processor issues further instructions to:
configure access by other universally resolvable media content service users to the shared media collection based on the first user selected access constraints.

341. The system of embodiment 330, wherein the access constraints define read only access to the shared media content collection to any one of: (i) friends having a predetermined degree of separation, (ii) Gurus, (iii) social network members having a predetermined degree of separation, (iv) relationship categories, and (v) everyone.

342. The system of embodiment 332, wherein the processor issues further instructions to:
receive a request from the second user to perform an action on the shared media content collection; and
obtain from the first user an acceptance or a denial to the received request to perform the action on the shared media content collection.

343. The system of embodiment 342, wherein when said acceptance is obtained, the processor issues instructions to:
perform said action on the shared media content collection to obtain a modified shared media content collection; and
provide the modified shared media content collection to the first user and the second user; and

when said denial is obtained, the processor issues instructions to:
provide the second user a request declined message.

344. The system of embodiment 332, wherein the media content collection includes: (i) a playlist, (ii) at least one content item, (iii) a media library in the cloud, and (iv) a media library in a local client.

345. The system of embodiment 332, wherein said instructions to configure includes instructions to obtain the first user specified content parameters and access control parameters for the content.

346. The system of embodiment 332, wherein said processor issues further instructions to:
determine a subset of the first user's media content collection that is restricted by the first user's access control parameters for access by the second user.

347. A processor-readable medium storing processor-issuable instructions for providing shared access to a media content collection, wherein the processor issues instructions to:
provide from a first universally resolvable media content service user a request to share the user's universally resolvable media content collection;
provide from the first user a selection of at least one second universally resolvable user;
provide authorization to configure the first user's media content collection for shared access with the second user; and
provide authorization to provide the second user access to the shared media content collection.

348. The medium of embodiment 347, wherein the processor issues further instructions to:
provide from one of a plurality of shared users having access to the shared media content collection a request to perform an action on the shared media content collection;
provide authorization to perform said action on the shared media content collection to obtain a modified shared media content collection; and
obtain the plurality of shared users access to the modified shared media content collection.

349. The medium of embodiment 348, wherein said action is selected from any of: (i) add a content item, (ii) remove a content item, (iii) re-order content items, (iv) modify privacy settings, (v) share with another universally resolvable user, (vi) delete the shared media collection, (vii) create a playlist, (viii) add an entity graph member, (ix) publish media collection, and (x) change meta data for a content item.

350. The medium of embodiment 347, wherein the processor issues further instructions to:
provide authorization to download non-local content items of the shared media content collection to client devices of a plurality of shared users having access to the shared media content collection, wherein the plurality of shared users includes at least the first user and the second user.

351. The medium of embodiment 350, wherein the non-local content items are downloaded in the cache.

352. The medium of embodiment 347, wherein the shared media collection is stored in a universally resolvable content database in a server.

353. The medium of embodiment 347, wherein prior to issuing instructions to receive from the first user the request to share the first user's media content collection, the processor issues instruction to;
provide from the first user a request to create the media content collection; and
provide from the first user at least one content item for including in the created media content collection.

354. The medium of embodiment 347, wherein the media collection any one of: (i) a universally resolvable media content service user created media content collection, and (ii) a system generated media content collection.

355. The medium of embodiment 347, wherein the processor issues further instructions to:
provide authorization to configure access by other universally resolvable media content service users to the shared media collection based on the first user selected access constraints.

356. The medium of embodiment 355, wherein the access constraints define read only access to the shared media content collection to any one of: (i) friends having a predetermined degree of separation, (ii) Gurus, (iii) social network members having a predetermined degree of separation, (iv) relationship categories, and (v) everyone.

357. The medium of embodiment 347, wherein the processor issues further instructions to:
provide a request from the second user to perform an action on the shared media content collection; and
provide from the first user an acceptance or a denial to the received request to perform the action on the shared media content collection.

358. The medium of embodiment 357, wherein when said acceptance is obtained, the processor issues instructions to:
provide authorization to perform said action on the shared media content collection to obtain a modified shared media content collection; and
obtain the modified shared media content collection to the first user and the second user; and

when said denial is obtained, the processor issues instructions to:
provide authorization to provide the second user a request declined message.

359. The medium of embodiment 347, wherein the media content collection includes: (i) a playlist, (ii) at least one content item, (iii) a media library in the cloud, and (iv) a media library in a local client.

360. The medium of embodiment 347, wherein said instructions to configure includes instructions to obtain the first user specified content parameters and access control parameters for the content.

361. The medium of embodiment 347, wherein said processor issues further instructions to:
provide authorization to determine a subset of the first user's media content collection that is restricted by the first user's access control parameters for access by the second user.

362. An apparatus for providing shared access to a media content collection, comprising:
a memory;
a processor disposed in communication with said memory, and configured to issue a plurality of processing instructions stored in the memory, wherein the processor issues instructions to:
   provide from a first universally resolvable media content service user a request to share the user's universally resolvable media content collection;
   provide from the first user a selection of at least one second universally resolvable user;
   provide authorization to configure the first user's media content collection for shared access with the second user; and
   provide authorization to provide the second user access to the shared media content collection.

363. The apparatus of embodiment 362, wherein the processor issues further instructions to:
obtain from one of a plurality of shared users having access to the shared media content collection a request to perform an action on the shared media content collection;
provide authorization to perform said action on the shared media content collection to obtain a modified shared media content collection; and
obtain the plurality of shared users access to the modified shared media content collection.

364. The apparatus of embodiment 363, wherein said action is selected from any of: (i) add a content item, (ii) remove a content item, (iii) re-order content items, (iv) modify privacy settings, (v) share with another universally resolvable user, (vi) delete the shared media collection, (vii) create a playlist, (viii) add an entity graph member, (ix) publish media collection, and (x) change meta data for a content item.

365. The apparatus of embodiment 362, wherein the processor issues further instructions to:
provide authorization to download non-local content items of the shared media content collection to client devices of a plurality of shared users having access to the shared media content collection, wherein the plurality of shared users includes at least the first user and the second user.

366. The apparatus of embodiment 365, wherein the non-local content items are downloaded in the cache.

367. The apparatus of embodiment 362, wherein the shared media collection is stored in a universally resolvable content database in a server.

368. The apparatus of embodiment 362, wherein prior to issuing instructions to receive from the first user the request to share the first user's media content collection, the processor issues instruction to;
provide from the first user a request to create the media content collection; and
provide from the first user at least one content item for including in the created media content collection.

369. The apparatus of embodiment 362, wherein the media collection any one of: (i) a universally resolvable media content service user created media content collection, and (ii) a system generated media content collection.

370. The apparatus of embodiment 362, wherein the processor issues further instructions to:
provide authorization to configure access by other universally resolvable media content service users to the shared media collection based on the first user selected access constraints.

371. The apparatus of embodiment 370, wherein the access constraints define read only access to the shared media content collection to any one of: (i) friends having a predetermined degree of separation, (ii) Gurus, (iii) social network members having a predetermined degree of separation, (iv) relationship categories, and (v) everyone.

372. The apparatus of embodiment 362, wherein the processor issues further instructions to:
provide a request from the second user to perform an action on the shared media content collection; and
provide from the first user an acceptance or a denial to the received request to perform the action on the shared media content collection.

373. The apparatus of embodiment 372, wherein when said acceptance is obtained, the processor issues instructions to:
provide authorization to perform said action on the shared media content collection to obtain a modified shared media content collection; and
obtain the modified shared media content collection to the first user and the second user; and

when said denial is obtained, the processor issues instructions to:
obtain the second user a request declined message.

374. The apparatus of embodiment 362, wherein the media content collection includes: (i) a playlist, (ii) at least one content item, (iii) a media library in the cloud, and (iv) a media library in a local client.

375. The apparatus of embodiment 362, wherein said instructions to configure includes instructions to obtain the first user specified content parameters and access control parameters for the content.

376. The apparatus of embodiment 362, wherein said processor issues further instructions to:
provide authorization to determine a subset of the first user's media content collection that is restricted by the first user's access control parameters for access by the second user.

377. A processor-implemented method for providing access to a portion of a media library, comprising:
receiving from a first universally resolvable user a request to access a media library of a second universally resolvable user;
retrieving the second user specified privacy controls;
applying the second user specified privacy controls to determine a portion of the media library permitted for shared access by the first user; and
allowing the first user access to the determined portion of the media library.

378. The method of embodiment 377, further comprising:
determining a degree of separation between the first user and the second user; and
applying the degree of separation as an access constraint to the media library of the second user.

379. The method of embodiment 377, further comprising:
receiving a request from the first user to download at least one content item located in the determined portion of the media library; and
in response to the received request to download the at least one content item, providing the at least one content item in the first user's media library.

380. The method of embodiment 377, wherein access by the first user includes modification of the second user's media library.

381. The method of embodiment 380, wherein the modification of the second user's media library includes at least one of: (i) adding a local content item, (ii) removing a content item, (iii) adding a social graph member, and (iv) creating a playlist.

382. The method of embodiment 381, wherein the content item includes: (i) a playlist, (ii) entity graph, (iii) music, (iv) movie, (v) book, and (vi) video.

383. The method of embodiment 380, wherein the playlist is a shared playlist modifiable by the first user and the second user.

384. The method of embodiment 377, wherein the portion of the media library permitted for access by the first user includes at least one of: (i) albums, (ii) genre, (iii) artists, (iv) purchased, (v) playlist, and (vii) all content.

385. A system for providing access to a portion of a media library, comprising:
a memory;
a processor disposed in communication with said memory, and configured to issue a plurality of processing instructions stored in the memory, wherein the processor issues instructions to:
   receive from a first universally resolvable user a request to access a media library of a second universally resolvable user;
   retrieve the second user specified privacy controls;
   apply the second user specified privacy controls to determine a portion of the media library permitted for access by the first user; and
   allow the first user access to the determined portion of the media library.

386. The system of embodiment 385, wherein the processor issues further instructions to:
determine a degree of separation between the first user and the second user; and
apply the degree of separation as an access constraint to the media library of the second user.

387. The system of embodiment 385, wherein the processor issues further instructions to:
receive a request from the first user to download at least one content item located in the determined portion of the media library; and
in response to the received request to download the at least one content item, provide the at least one content item in the first user's media library.

388. The system of embodiment 385, wherein access by the first user includes modification of the second user's media library.

389. The system of embodiment 388, wherein the modification of the second user's media library includes at least one of: (i) adding a local content item, (ii) removing a content item, (iii) adding a social graph member, and (iv) creating a playlist.

390. The system of embodiment 389, wherein the content item includes: (i) a playlist, (ii) entity graph, (iii) music, (iv) movie, (v) book, and (vi) video.

391. The system of embodiment 390, wherein the playlist is a shared playlist modifiable by the first user and the second user.

392. The system of embodiment 385, wherein the portion of the media library permitted for access by the first user includes at least one of: (i) albums, (ii) genre, (iii) artists, (iv) purchased, (v) playlist, and (vii) all content.

393. A processor-readable medium storing processor-issuable instructions for providing access to a portion of a media library wherein the processor issues instructions to:
receive from a first universally resolvable user a request to access a media library of a second universally resolvable user;
retrieve the second user specified privacy controls;
apply the second user specified privacy controls to determine a portion of the media library permitted for access by the first user; and
allow the first user access to the determined portion of the media library.

394. The medium of embodiment 393, wherein the processor issues further instructions to:
determine a degree of separation between the first user and the second user; and
apply the degree of separation as an access constraint to the media library of the second user.

395. The medium of embodiment 393, wherein the processor issues further instructions to:
receive a request from the first user to download at least one content item located in the determined portion of the media library; and
in response to the received request to download the at least one content item, provide the at least one content item in the first user's media library.

396. The medium of embodiment 393, wherein access by the first user includes modification of the second user's media library.

397. The medium of embodiment 396, wherein the modification of the second user's media library includes at least one of: (i) adding a local content item, (ii) removing a content item, (iii) adding a social graph member, and (iv) creating a playlist.

398. The medium of embodiment 397, wherein the content item includes: (i) a playlist, (ii) entity graph, (iii) music, (iv) movie, (v) book, and (vi) video.

399. The medium of embodiment 398, wherein the playlist is a shared playlist modifiable by the first user and the second user.

400. The medium of embodiment 393, wherein the portion of the media library permitted for access by the first user includes at least one of: (i) albums, (ii) genre, (iii) artists, (iv) purchased, (v) playlist, and (vii) all content.

401. An apparatus for providing access to a portion of a media library wherein the processor issues instructions to:
a memory;
a processor disposed in communication with said memory, and configured to issue a plurality of processing instructions stored in the memory, wherein the processor issues instructions to:
   receive from a first universally resolvable user a request to access a media library of a second universally resolvable user;
   retrieve the second user specified privacy controls;
   apply the second user specified privacy controls to determine a portion of the media library permitted for access by the first user; and
   allow the first user access to the determined portion of the media library.

402. The apparatus of embodiment 401, wherein the processor issues further instructions to:
determine a degree of separation between the first user and the second user; and
apply the degree of separation as an access constraint to the media library of the second user.

403. The apparatus of embodiment 401, wherein the processor issues further instructions to:
receive a request from the first user to download at least one content item located in the determined portion of the media library; and
in response to the received request to download the at least one content item, provide the at least one content item in the first user's media library.

404. The apparatus of embodiment 401, wherein access by the first user includes modification of the second user's media library.

405. The apparatus of embodiment 404, wherein the modification of the second user's media library includes at least one of: (i) adding a local content item, (ii) removing a content item, (iii) adding a social graph member, and (iv) creating a playlist.

406. The apparatus of embodiment 405, wherein the content item includes: (i) a playlist, (ii) entity graph, (iii) music, (iv) movie, (v) book, and (vi) video.

407. The apparatus of embodiment 404, wherein the playlist is a shared playlist modifiable by the first user and the second user.

408. The apparatus of embodiment 401, wherein the portion of the media library permitted for access by the first user includes at least one of: (i) albums, (ii) genre, (iii) artists, (iv) purchased, (v) playlist, and (vii) all content.

409. A processor-implemented method for sharing a universally resolvable media content collection, comprising:
obtaining privacy settings for sharing a universally resolvable media content collection, said privacy settings identifying:
   a selection of a universally resolvable media content collection; and
   a selection of at least one universally resolvable user authorized to access the universally resolvable media content collection;
generating and transmitting a sharing request including the privacy settings;
receiving a confirmation that the universally resolvable media content collection is configured for sharing with the at least one universally resolvable user.

410. The method of embodiment 409, wherein the at least one universally resolvable user includes at least one of: (i) a friend having a specified degree of separation; (ii) a social network member having a specified degree of separation; (iii) a friend; (iv) a family; (v) an acquaintance; and (vi) a work friend.

411. The method of embodiment 409, wherein the at least one universally resolvable content collection includes at least one of: (i) all content items in the collection; (ii) most recently played; (iii) playlists; (iv) selected; (v) highest rated; (vi) purchased; and (vii) most frequently played.

412. The method of embodiment 409, further comprising:
receiving a request from a universally resolvable user to access a universally resolvable content collection.

413. The method of embodiment 412, further comprising:
in response to the request, allowing the universally resolvable user access the universally resolvable content collection.

414. The method of embodiment 412, further comprising:
in response to the request, denying the universally resolvable user access the at least one universally resolvable content collection.

415. A system for sharing a universally resolvable media content collection, comprising:
a memory;
a processor disposed in communication with said memory, and configured to issue a plurality of processing instructions stored in the memory, wherein the processor issues instructions to:
   obtain privacy settings for sharing a universally resolvable media content collection, said privacy settings identifying:
   a select of a universally resolvable media content collection; and
   a select of at least one universally resolvable user authorized to access the universally resolvable media content collection;
   generate and transmit a sharing request including the privacy settings;
   receive a confirmation that the universally resolvable media content collection is configured for sharing with the at least one universally resolvable user.

416. The system of embodiment 415, wherein the at least one universally resolvable user includes at least one of: (i) a friend having a specified degree of separation; (ii) a social network member having a specified degree of separation; (iii) a friend; (iv) a family; (v) an acquaintance; and (vi) a work friend.

417. The system of embodiment 415, wherein the at least one universally resolvable content collection includes at least one of: (i) all content items in the collection; (ii) most recently played; (iii) playlists; (iv) selected; (v) highest rated; (vi) purchased; and (vii) most frequently played.

418. The system of embodiment 415, wherein the processor issues further instructions to:
receive a request from a universally resolvable user to access a universally resolvable content collection.

419. The system of embodiment 418, wherein in response to the request, the processor issues further instructions to allow the universally resolvable user access the universally resolvable content collection.

420. The system of embodiment 418, wherein in response to the request, the processor issues further instructions to deny the universally resolvable user access the at least one universally resolvable content collection.

421. A processor-readable medium storing processor-issuable instructions for providing access to a portion of a media library wherein the processor issues instructions to:
obtain privacy settings for sharing a universally resolvable media content collection, said privacy settings identifying:
a select of a universally resolvable media content collection; and
a select of at least one universally resolvable user authorized to access the universally resolvable media content collection;
generate and transmit a sharing request including the privacy settings;
receive a confirmation that the universally resolvable media content collection is configured for sharing with the at least one universally resolvable user.

422. The medium of embodiment 421, wherein the at least one universally resolvable user includes at least one of: (i) a friend having a specified degree of separation; (ii) a social network member having a specified degree of separation; (iii) a friend; (iv) a family; (v) an acquaintance; and (vi) a work friend.

423. The medium of embodiment 421, wherein the at least one universally resolvable content collection includes at least one of: (i) all content items in the collection; (ii) most recently played; (iii) playlists; (iv) selected; (v) highest rated; (vi) purchased; and (vii) most frequently played.

424. The medium of embodiment 421, wherein the processor issues further instructions to:
receive a request from a universally resolvable user to access a universally resolvable content collection.

425. The medium of embodiment 424, wherein in response to the request, the processor issues further instructions to allow the universally resolvable user access the universally resolvable content collection.

426. The medium of embodiment 424, wherein in response to the request, the processor issues further instructions to deny the universally resolvable user access the at least one universally resolvable content collection.

427. An apparatus for sharing a universally resolvable media content collection, comprising:
a memory;
a processor disposed in communication with said memory, and configured to issue a plurality of processing instructions stored in the memory, wherein the processor issues instructions to:
   obtain privacy settings for sharing a universally resolvable media content collection, said privacy settings identifying:
   a select of a universally resolvable media content collection; and
   a select of at least one universally resolvable user authorized to access the universally resolvable media content collection;
   generate and transmit a sharing request including the privacy settings;
   receive a confirmation that the universally resolvable media content collection is configured for sharing with the at least one universally resolvable user.

428. The apparatus of embodiment 427, wherein the at least one universally resolvable user includes at least one of: (i) a friend having a specified degree of separation; (ii) a social network member having a specified degree of separation; (iii) a friend; (iv) a family; (v) an acquaintance; and (vi) a work friend.

429. The apparatus of embodiment 427, wherein the at least one universally resolvable content collection includes at least one of: (i) all content items in the collection; (ii) most recently played; (iii) playlists; (iv) selected; (v) highest rated; (vi) purchased; and (vii) most frequently played.

430. The apparatus of embodiment 427, wherein the processor issues further instructions to:
receive a request from a universally resolvable user to access a universally resolvable content collection.

431. The apparatus of embodiment 430, wherein in response to the request, the processor issues further instructions to allow the universally resolvable user access the universally resolvable content collection.

432. The apparatus of embodiment 430, wherein in response to the request, the processor issues further instructions to deny the universally resolvable user access the at least one universally resolvable content collection.

433. A processor-implemented method, comprising:
generating from a first universally resolvable user a request to access a media library of a second universally resolvable user;
retrieving the second user specified privacy controls;
supplying the second user specified privacy controls to determine a portion of the media library permitted for shared access by the first user; and
providing authorization to allow the first user access to the determined portion of the media library.

434. The method of embodiment 433, further comprising:
obtaining indication of determination of a degree of separation between the first user and the second user; and
providing authorization to apply the degree of separation as an access constraint to the media library of the second user.

435. The method of embodiment 433, further comprising:
providing a request from the first user to download at least one content item located in the determined portion of the media library; and
in response to the provided request to download the at least one content item, obtaining the at least one content item in the first user's media library.

436. The method of embodiment 433, wherein access by the first user includes modification of the second user's media library.

437. The method of embodiment 436, wherein the modification of the second user's media library includes at least one of: (i) adding a local content item, (ii) removing a content item, (iii) adding a social graph member, and (iv) creating a playlist.

438. The method of embodiment 437, wherein the content item includes: (i) a playlist, (ii) entity graph, (iii) music, (iv) movie, (v) book, and (vi) video.

439. The method of embodiment 436, wherein the playlist is a shared playlist modifiable by the first user and the second user.

440. The method of embodiment 433, wherein the portion of the media library permitted for access by the first user includes at least one of: (i) albums, (ii) genre, (iii) artists, (iv) purchased, (v) playlist, and (vii) all content.

441. A system for providing access to a portion of a media library, comprising:
a memory;
a processor disposed in communication with said memory, and configured to issue a plurality of processing instructions stored in the memory, wherein the processor issues instructions to:
   generate from a first universally resolvable user a request to access a media library of a second universally resolvable user;
   retrieve the second user specified privacy controls;
   supply the second user specified privacy controls to determine a portion of the media library permitted for access by the first user; and
   provide authorization to the first user access to the determined portion of the media library.

442. The system of embodiment 441, wherein the processor issues further instructions to:
obtain indication of determination of a degree of separation between the first user and the second user; and
supply the degree of separation as an access constraint to the media library of the second user.

443. The system of embodiment 441, wherein the processor issues further instructions to:
provide a request from the first user to download at least one content item located in the determined portion of the media library; and
in response to the request to download the at least one content item, obtain the at least one content item in the first user's media library.

444. The system of embodiment 441, wherein access by the first user includes modification of the second user's media library.

445. The system of embodiment 444, wherein the modification of the second user's media library includes at least one of: (i) adding a local content item, (ii) removing a content item, (iii) adding a social graph member, and (iv) creating a playlist.

446. The system of embodiment 445, wherein the content item includes: (i) a playlist, (ii) entity graph, (iii) music, (iv) movie, (v) book, and (vi) video.

447. The system of embodiment 446, wherein the playlist is a shared playlist modifiable by the first user and the second user.

448. The system of embodiment 441, wherein the portion of the media library permitted for access by the first user includes at least one of: (i) albums, (ii) genre, (iii) artists, (iv) purchased, (v) playlist, and (vii) all content.

449. A processor-readable medium storing processor-issuable instructions for providing access to a portion of a media library wherein the processor issues instructions to:
generate from a first universally resolvable user a request to access a media library of a second universally resolvable user;
retrieve the second user specified privacy controls;
supply the second user specified privacy controls to determine a portion of the media library permitted for access by the first user; and
providing authorization to the first user access to the determined portion of the media library.

450. The medium of embodiment 449, wherein the processor issues further instructions to:
obtain indication of determination of a degree of separation between the first user and the second user; and
apply the degree of separation as an access constraint to the media library of the second user.

451. The medium of embodiment 449, wherein the processor issues further instructions to:
provide a request from the first user to download at least one content item located in the determined portion of the media library; and
in response to the request to download the at least one content item, provide the at least one content item in the first user's media library.

452. The medium of embodiment 449, wherein access by the first user includes modification of the second user's media library.

453. The medium of embodiment 452, wherein the modification of the second user's media library includes at least one of: (i) adding a local content item, (ii) removing a content item, (iii) adding a social graph member, and (iv) creating a playlist.

454. The medium of embodiment 453, wherein the content item includes: (i) a playlist, (ii) entity graph, (iii) music, (iv) movie, (v) book, and (vi) video.

455. The medium of embodiment 454, wherein the playlist is a shared playlist modifiable by the first user and the second user.

456. The medium of embodiment 449, wherein the portion of the media library permitted for access by the first user includes at least one of: (i) albums, (ii) genre, (iii) artists, (iv) purchased, (v) playlist, and (vii) all content.

457. An apparatus for providing access to a portion of a media library wherein the processor issues instructions to:
a memory;
a processor disposed in communication with said memory, and configured to issue a plurality of processing instructions stored in the memory, wherein the processor issues instructions to:
   provide from a first universally resolvable user a request to access a media library of a second universally resolvable user;
   retrieve the second user specified privacy controls;
   supply the second user specified privacy controls to determine a portion of the media library permitted for access by the first user; and
   provide authorization to the first user access to the determined portion of the media library.

458. The apparatus of embodiment 457, wherein the processor issues further instructions to:
obtain an indication of determination of a degree of separation between the first user and the second user; and
supply the degree of separation as an access constraint to the media library of the second user.

459. The apparatus of embodiment 457, wherein the processor issues further instructions to:
provide a request from the first user to download at least one content item located in the determined portion of the media library; and
in response to the request to download the at least one content item, obtain the at least one content item in the first user's media library.

460. The apparatus of embodiment 457, wherein access by the first user includes modification of the second user's media library.

461. The apparatus of embodiment 460, wherein the modification of the second user's media library includes at least one of: (i) adding a local content item, (ii) removing a content item, (iii) adding a social graph member, and (iv) creating a playlist.

462. The apparatus of embodiment 461, wherein the content item includes: (i) a playlist, (ii) entity graph, (iii) music, (iv) movie, (v) book, and (vi) video.

463. The apparatus of embodiment 460, wherein the playlist is a shared playlist modifiable by the first user and the second user.

464. The apparatus of embodiment 457, wherein the portion of the media library permitted for access by the first user includes at least one of: (i) albums, (ii) genre, (iii) artists, (iv) purchased, (v) playlist, and (vii) all content.

465. A processor-implemented method for sharing a universally resolvable media content collection, comprising:
providing privacy settings for sharing a universally resolvable media content collection, said privacy settings identifying:
   a selection of a universally resolvable media content collection; and
   a selection of at least one universally resolvable user authorized to access the universally resolvable media content collection;
providing authorization to generate and transmit a sharing request including the privacy settings;
providing a confirmation that the universally resolvable media content collection is configured for sharing with the at least one universally resolvable user.

466. The method of embodiment 465, wherein the at least one universally resolvable user includes at least one of: (i) a friend having a specified degree of separation; (ii) a social network member having a specified degree of separation; (iii) a friend; (iv) a family; (v) an acquaintance; and (vi) a work friend.

467. The method of embodiment 465, wherein the at least one universally resolvable content collection includes at least one of: (i) all content items in the collection; (ii) most recently played; (iii) playlists; (iv) selected; (v) highest rated; (vi) purchased; and (vii) most frequently played.

468. The method of embodiment 465, further comprising:
providing a request from a universally resolvable user to access a universally resolvable content collection.

469. The method of embodiment 468, further comprising:
in response to the request, providing authorization to allow the universally resolvable user access the universally resolvable content collection.

470. The method of embodiment 468, further comprising:
in response to the request, providing authorization to deny the universally resolvable user access the at least one universally resolvable content collection.

471. A system for sharing a universally resolvable media content collection, comprising:
a memory;
a processor disposed in communication with said memory, and configured to issue a plurality of processing instructions stored in the memory, wherein the processor issues instructions to:
   provide privacy settings for sharing a universally resolvable media content collection, said privacy settings identifying:
      a selection of a universally resolvable media content collection; and
      a selection of at least one universally resolvable user authorized to access the universally resolvable media content collection;
   providing authorization to generate and transmit a sharing request including the privacy settings;
   provide a confirmation that the universally resolvable media content collection is configured for sharing with the at least one universally resolvable user.

472. The system of embodiment 471, wherein the at least one universally resolvable user includes at least one of: (i) a friend having a specified degree of separation; (ii) a social network member having a specified degree of separation; (iii) a friend; (iv) a family; (v) an acquaintance; and (vi) a work friend.

473. The system of embodiment 471, wherein the at least one universally resolvable content collection includes at least one of: (i) all content items in the collection; (ii) most recently played; (iii) playlists; (iv) selected; (v) highest rated; (vi) purchased; and (vii) most frequently played.

474. The system of embodiment 471, wherein the processor issues further instructions to:
provide a request from a universally resolvable user to access a universally resolvable content collection.

475. The system of embodiment 474, wherein in response to the request, the processor issues further instructions to provide authorization to allow the universally resolvable user access the universally resolvable content collection.

476. The system of embodiment 474, wherein in response to the request, the processor issues further instructions to provide authorization to deny the universally resolvable user access the at least one universally resolvable content collection.

477. A processor-readable medium storing processor-issuable instructions for providing access to a portion of a media library wherein the processor issues instructions to:
provide privacy settings for sharing a universally resolvable media content collection, said privacy settings identifying:
a selection of a universally resolvable media content collection; and
a selection of at least one universally resolvable user authorized to access the universally resolvable media content collection;
provide authorization to generate and transmit a sharing request including the privacy settings;
provide a confirmation that the universally resolvable media content collection is configured for sharing with the at least one universally resolvable user.

478. The medium of embodiment 477, wherein the at least one universally resolvable user includes at least one of: (i) a friend having a specified degree of separation; (ii) a social network member having a specified degree of separation; (iii) a friend; (iv) a family; (v) an acquaintance; and (vi) a work friend.

479. The medium of embodiment 477, wherein the at least one universally resolvable content collection includes at least one of: (i) all content items in the collection; (ii) most recently played; (iii) playlists; (iv) selected; (v) highest rated; (vi) purchased; and (vii) most frequently played.

480. The medium of embodiment 477, wherein the processor issues further instructions to:
receive a request from a universally resolvable user to access a universally resolvable content collection.

481. The medium of embodiment 480, wherein in response to the request, the processor issues further instructions to allow the universally resolvable user access the universally resolvable content collection.

482. The medium of embodiment 480, wherein in response to the request, the processor issues further instructions to deny the universally resolvable user access the at least one universally resolvable content collection.

483. An apparatus for sharing a universally resolvable media content collection, comprising:
a memory;
a processor disposed in communication with said memory, and configured to issue a plurality of processing instructions stored in the memory, wherein the processor issues instructions to:
   provide privacy settings for sharing a universally resolvable media content collection, said privacy settings identifying:
   a selection of a universally resolvable media content collection; and
   a selection of at least one universally resolvable user authorized to access the universally resolvable media content collection;
   provide authorization to generate and transmit a sharing request including the privacy settings;
   provide a confirmation that the universally resolvable media content collection is configured for sharing with the at least one universally resolvable user.

484. The apparatus of embodiment 483, wherein the at least one universally resolvable user includes at least one of: (i) a friend having a specified degree of separation; (ii) a social network member having a specified degree of separation; (iii) a friend; (iv) a family; (v) an acquaintance; and (vi) a work friend.

485. The apparatus of embodiment 483, wherein the at least one universally resolvable content collection includes at least one of: (i) all content items in the collection; (ii) most recently played; (iii) playlists; (iv) selected; (v) highest rated; (vi) purchased; and (vii) most frequently played.

486. The apparatus of embodiment 483, wherein the processor issues further instructions to:
provide a request from a universally resolvable user to access a universally resolvable content collection.

487. The apparatus of embodiment 486, wherein in response to the request, the processor issues further instructions to provide authorization to allow the universally resolvable user access the universally resolvable content collection.

488. The apparatus of embodiment 486, wherein in response to the request, the processor issues further instructions to provide authorization to deny the universally resolvable user access the at least one universally resolvable content collection.

489. A graphical user interface, comprising:
a media display view, said media display view including a plurality of universally resolvable attribute rows, wherein each attribute row is configured to display universally resolvable attribute row items including social graph, wherein the media display view is configured to recursively:
   obtain a selected content attribute row item;
   display the selected content attribute row item in a corresponding attribute row of a first selection column;
   identify related content attribute row items; and
   provide the identified related content attribute row items for selection; and
   display the selected related content attribute row item in a corresponding attribute row of a subsequent selection column.

490. The graphical user interface of embodiment 489, wherein the selection column establishes the sequence of selection of the content attribute row items.

491. The graphical user interface of embodiment 489, further comprising a media selection view displaying a designated spotlight area that is configured to receive the selected content attribute row item.

492. The graphical user interface of embodiment 491, wherein the selection of the content attribute row item is made by a user via one of (i) a single action, or (ii) a double action.

493. The graphical user interface of embodiment 492, wherein rows and columns are orthogonal and not spatially perpendicular.

494. The graphical user interface of embodiment 489, wherein the media display view is one of a plurality of media display views, wherein each media display view corresponds to a time period and is configured to:
obtain data corresponding to a plurality of content attribute row items spotlighted during the time period; and
display the obtained data in corresponding content attribute rows and selection columns.

495. The graphical user interface of embodiment 489, wherein the content attribute row items are selected from a group including: (i) artists, (ii) tracks, (iii) albums, (iv) playlists, (v) gurus, and (vi) social graph.

496. A processor-implemented method for displaying content items, comprising:
obtaining a user selection of a content attribute row item;
displaying the selected content attribute row item in a corresponding attribute row of a first selection column of a media display view;
identifying related content attribute row items; and
providing the identified related content attribute row items for selection; and
displaying the selected related content attribute row item in a corresponding attribute row of a subsequent selection column of the media display view.

497. The method of embodiment 496, wherein the selection column establishes the sequence of selection of the content attribute row items.

498. The method of embodiment 496, further comprising a media selection view displaying a designated spotlight area that is configured to receive the selected content attribute row item.

499. The method of embodiment 497, wherein the selection of the content attribute row item is made by a user via one of (i) a single action, or (ii) a double action.

500. The method of embodiment 489, wherein rows and columns are orthogonal and not spatially perpendicular.

501. The method of embodiment 496, wherein the media display view corresponds to a time period, the method further comprising:
obtaining data corresponding to a plurality of content attribute row items spotlighted during the time period; and
displaying the obtained data in corresponding content attribute rows and selection columns.

502. The method of embodiment 496, wherein the content attribute row items are selected from a group including: (i) artists, (ii) tracks, (iii) albums, (iv) playlists, (v) gurus, and (vi) social graph.

503. A system for displaying content items, comprising:
a memory;
a processor disposed in communication with said memory, and configured to issue a plurality of processing instructions stored in the memory, wherein the processor issues instructions to:
   obtain a user selection of a content attribute row item;
   display the selected content attribute row item in a corresponding attribute row of a first selection column of a media display view;
   identify related content attribute row items; and
   provide the identified related content attribute row items for selection; and
   display the selected related content attribute row item in a corresponding attribute row of a subsequent selection column of the media display view.

504. The system of embodiment 503, wherein the selection column establishes the sequence of selection of the content attribute row items.

505. The system of embodiment 503, further comprising a media selection view wherein the processor issues instructions to display a designated spotlight area that is configured to receive the selected content attribute row item.

506. The system of embodiment 504, wherein the selection of the content attribute row item is made by a user via one of (i) a single action, or (ii) a double action.

507. The system of embodiment 503, wherein rows and columns are orthogonal and not spatially perpendicular.

508. The system of embodiment 503, wherein the media display view corresponds to a time period, and wherein the processor issues further instructions to:
obtain data corresponding to a plurality of content attribute row items spotlighted during the time period; and
display the obtained data in corresponding content attribute rows and selection columns.

509. The system of embodiment 503, wherein the content attribute row items are selected from a group including: (i) artists, (ii) tracks, (iii) albums, (iv) playlists, (v) gurus, and (vi) social graph.

510. A processor-readable medium storing processor-issuable instructions for displaying content items wherein the processor issues instructions to:
obtain a user selection of a content attribute row item;
display the selected content attribute row item in a corresponding attribute row of a first selection column of a media display view;
identify related content attribute row items; and
provide the identified related content attribute row items for selection; and
display the selected related content attribute row item in a corresponding attribute row of a subsequent selection column in the media display view.

511. The medium of embodiment 510, wherein the selection column establishes the sequence of selection of the content attribute row items.

512. The medium of embodiment 510, further comprising a media selection view wherein the processor issues instructions to display a designated spotlight area that is configured to receive the selected content attribute row item.

513. The medium of embodiment 511, wherein the selection of the content attribute row item is made by a user via one of (i) a single action, or (ii) a double action.

514. The medium of embodiment 510, wherein rows and columns are orthogonal and not spatially perpendicular.

515. The medium of embodiment 510, wherein each media display view corresponds to a time period, and wherein the processor issues further instructions to:
obtain data corresponding to a plurality of content attribute row items spotlighted during the time period; and
display the obtained data in corresponding content attribute rows and selection columns.

516. The medium of embodiment 510, wherein the content attribute row items are selected from a group including: (i) artists, (ii) tracks, (iii) albums, (iv) playlists, (v) gurus, and (vi) social graph.

517. A search and discovery interface, comprising:
an entry point representation surrounded by a plurality of discovery supportive heuristic representations,
   wherein the entry point representation is configured to receive a first universally resolvable content item selected from one of the plurality of discovery supportive heuristic representations;
   wherein the interface is configured to identify, for each of the plurality of discovery supportive heuristic representations, a universally resolvable content item related to the content item in the entry point representation; and
   wherein each of the plurality of discovery supportive heuristic representations is configured to display the corresponding identified universally resolvable content item.

518. The interface of embodiment 517, wherein the plurality of discovery supportive heuristic representations include (i) track, (ii) artist, (iii) album, (iv) gurus, and (v) playlist.

519. The interface of embodiment 518, wherein the content item in each of the plurality of discovery supportive heuristic representations is the most related (i) track, (ii) artist, (iii) album, (iv) gurus, and (v) playlist.

520. The interface of embodiment 517, wherein the universally resolvable content seed in the entry point representation and in each one of the plurality of discovery supportive category representations is shareable with one or more users.

521. The interface of embodiment 517, wherein the universally resolvable content seed in the entry point representation and in each one of the plurality of discovery supportive category representations is downloadable to one or more client devices.

522. The interface of embodiment 517, wherein the universally resolvable content seed in the entry point representation and in each one of the plurality of discovery supportive category representations is includable in one or more playlists.

523. A processor-implemented search and discovery method, comprising:
receiving at an entry point representation a first universally resolvable content item seed selected from one of a plurality of discovery supportive heuristic representations;
obtaining for each of the plurality of discovery supportive heuristic representations a universally resolvable content item related to the content item seed; and
displaying at each of the plurality of discovery supportive heuristic representations the corresponding related universally resolvable content item.

524. The method of embodiment 523, wherein the plurality of discovery supportive heuristic representations include (i) track, (ii) artist, (iii) album, (iv) gurus, and (v) playlist.

525. The method of embodiment 524, wherein the content item in each of the plurality of discovery supportive heuristic representations is the most related (i) track, (ii) artist, (iii) album, (iv) gurus, and (v) playlist.

526. The method of embodiment 523, wherein the universally resolvable content seed in the entry point representation and in each one of the plurality of discovery supportive category representations is shareable with one or more users.

527. The method of embodiment 523, wherein the universally resolvable content seed in the entry point representation and in each one of the plurality of discovery supportive category representations is downloadable to one or more client devices.

528. The method of embodiment 523, wherein the universally resolvable content seed in the entry point representation and in each one of the plurality of discovery supportive category representations is includable in one or more playlists.

529. A search and discovery system, comprising:
a memory;
a processor disposed in communication with said memory, and configured to issue a plurality of processing instructions stored in the memory, wherein the processor issues instructions to:
   receive at an entry point representation a first universally resolvable content item seed selected from one of a plurality of discovery supportive heuristic representations;
   obtain for each of the plurality of discovery supportive heuristic representations a universally resolvable content item related to the content item seed; and
   display at each of the plurality of discovery supportive heuristic representations the corresponding related universally resolvable content item.

530. The system of embodiment 529, wherein the plurality of discovery supportive heuristic representations include (i) track, (ii) artist, (iii) album, (iv) gurus, and (v) playlist.

531. The system of embodiment 530, wherein the content item in each of the plurality of discovery supportive heuristic representations is the most related (i) track, (ii) artist, (iii) album, (iv) gurus, and (v) playlist.

532. The system of embodiment 529, wherein the universally resolvable content seed in the entry point representation and in each one of the plurality of discovery supportive category representations is shareable with one or more users.

533. The system of embodiment 529, wherein the universally resolvable content seed in the entry point representation and in each one of the plurality of discovery supportive category representations is downloadable to one or more client devices.

534. The system of embodiment 529, wherein the universally resolvable content seed in the entry point representation and in each one of the plurality of discovery supportive category representations is includable in one or more playlists.

535. A processor-readable search and discovery medium storing processor-issuable instructions, wherein the processor issues instructions to:
receive at an entry point representation a first universally resolvable content item seed selected from one of a plurality of discovery supportive heuristic representations;
obtain for each of the plurality of discovery supportive heuristic representations a universally resolvable content item related to the content item seed; and
display at each of the plurality of discovery supportive heuristic representations the corresponding related universally resolvable content item.

536. The medium of embodiment 535, wherein the plurality of discovery supportive heuristic representations include (i) track, (ii) artist, (iii) album, (iv) gurus, and (v) playlist.

537. The medium of embodiment 536, wherein the content item in each of the plurality of discovery supportive heuristic representations is the most related (i) track, (ii) artist, (iii) album, (iv) gurus, and (v) playlist.

538. The medium of embodiment 535, wherein the universally resolvable content seed in the entry point representation and in each one of the plurality of discovery supportive category representations is shareable with one or more users.

539. The medium of embodiment 535, wherein the universally resolvable content seed in the entry point representation and in each one of the plurality of discovery supportive category representations is downloadable to one or more client devices.

540. The medium of embodiment 535, wherein the universally resolvable content seed in the entry point representation and in each one of the plurality of discovery supportive category representations is includable in one or more playlists.

541. A processor-implemented method for providing universally resolvable content items, comprising:
receiving user selection of a universally resolvable content seed;
determining via a processor socially influenced content attributes associated with the universally resolvable content seed;
querying a universally resolvable content database using the socially influenced content attributes;
obtaining a ranked list of universally resolvable content items from the querying;
providing the ranked list of universally resolvable content items to the user.

542. The method of embodiment 541, further comprising:
creating a content query based on the socially influenced content attributes for the querying.

543. The method of embodiment 542, further comprising:
creating socially influenced ranking categories and populating the ranking categories with results from the query to obtain the ranked list of universally resolvable content items.

544. The method of embodiment 541, wherein determining the socially influenced content attributes associated with the universally resolvable content seed includes:
determining if the universally resolvable content seed is a universally resolvable content item seed.

545. The method of embodiment 544, wherein when the universally resolvable content seed is a universally resolvable content item seed, determining the socially influenced content attributes includes:
retrieving user profile and social graph preferences;
utilizing the retrieved user profile and social graph preferences to create socially influenced ranking categories to obtain the ranked list of universally resolvable content items.

546. The method of embodiment 545, wherein the social graph preferences are derived from the user's one or more social networks.

547. The method of embodiment 544, wherein when the universally resolvable content seed is not a content item seed, determining the socially influenced content attributes further comprises:
selecting a socially influenced content item seed selection criterion; and
retrieving a universally resolvable content item seed associated with the universally resolvable content seed based on the selected criterion.

548. The method of embodiment 547, further comprising:
retrieving user profile and social graph preferences; and
utilizing the retrieved user profile and social graph preferences to create socially influenced ranking categories for obtaining the ranked list of universally resolvable content items.

549. The method of embodiment 547, wherein the socially influenced content item seed selection criterion is one of a: (i) a specified default, (ii) currently played track, (iii) most played track, (iv) favorite track, (v) favorite genre, and (vi) last purchase.

550. The method of embodiment 543, wherein the results from the query are assigned a weight corresponding to relevance to the content query.

551. The method of embodiment 550, wherein obtaining the ranked list of universally resolvable content item further comprises:
assigning a category weight to each one of the socially influenced ranking categories; and
ranking the socially influenced categorized results based on a calculated social influence score.

552. The method of embodiment 551, further comprising:
for each one of the unique results, calculating the social influence score based on the assigned category weight and the weight corresponding to relevance to the content query.

553. The method of embodiment 541, further comprising:
obtaining from the user's client device a local cache request for a non-local universally resolvable content item; and
providing the non-local universally resolvable content item to the user's client device.

554. The method of embodiment 551, wherein the non-local universally resolvable content item in the user's client device is marked as temporary.

555. The method of embodiment 541, further comprising:
determining via the processor interest graph influenced content attributes associated with the universally resolvable content seed;
querying the universally resolvable content database using the interest graph influenced content attributes;
obtaining a ranked list of universally resolvable content items from the querying;
providing the ranked list of universally resolvable content items to the user.

556. A system for providing universally resolvable content items, comprising:
a memory;
a processor disposed in communication with said memory, and configured to issue a plurality of processing instructions stored in the memory, wherein the processor issues instructions to:
   receive user selection of a universally resolvable content seed;
   determine via a processor socially influenced content attributes associated with the universally resolvable content seed;
   query a universally resolvable content database using the socially influenced content attributes;
   obtain a ranked list of universally resolvable content items from the querying; and
   provide the ranked list of universally resolvable content items to the user.

557. The system of embodiment 556, wherein the processor issues further instructions to:
create a content query based on the socially influenced content attributes for the querying.

558. The system of embodiment 557, wherein the processor issues further instructions to:
create socially influenced ranking categories and populating the ranking categories with results from the query to obtain the ranked list of universally resolvable content items.

559. The system of embodiment 556, wherein the instructions to determine the socially influenced content attributes associated with the universally resolvable content seed includes instructions to:
determine if the universally resolvable content seed is a universally resolvable content item seed.

560. The system of embodiment 559, wherein when the universally resolvable content seed is a universally resolvable content item seed, the instructions to determine the socially influenced content attributes includes instructions to:
retrieve user profile and social graph preferences;
utilize the retrieved user profile and social graph preferences to create socially influenced ranking categories to obtain the ranked list of universally resolvable content items.

561. The system of embodiment 560, wherein the social graph preferences are derived from the user's one or more social networks.

562. The system of embodiment 559, wherein when the universally resolvable content seed is not a content item seed, the instructions to determine the socially influenced content attributes further comprises instructions to:
select a socially influenced content item seed selection criterion; and
retrieve a universally resolvable content item seed associated with the universally resolvable content seed based on the selected criterion.

563. The system of embodiment 562, wherein the processor issues further instructions to:
retrieve user profile and social graph preferences; and
utilize the retrieved user profile and social graph preferences to create socially influenced ranking categories for obtaining the ranked list of universally resolvable content items.

564. The system of embodiment 562, wherein the socially influenced content item seed selection criterion is one of a: (i) a specified default, (ii) currently played track, (iii) most played track, (iv) favorite track, (v) favorite genre, and (vi) last purchase.

565. The system of embodiment 558, wherein the results from the query are assigned a weight corresponding to relevance to the content query.

566. The system of embodiment 565, wherein the instructions to obtain the ranked list of universally resolvable content item further comprises instructions to:
assign a category weight to each one of the socially influenced ranking categories; and
rank the socially influenced categorized results based on a calculated social influence score.

567. The system of embodiment 566, wherein for each one of the unique results, the processor issues further instructions to calculate the social influence score based on the assigned category weight and the weight corresponding to relevance to the content query.

568. The system of embodiment 556, wherein the processor issues further instructions to:
obtain from the user's client device a local cache request for a non-local universally resolvable content item; and
provide the non-local universally resolvable content item to the user's client device.

569. The system of embodiment 568, wherein the non-local universally resolvable content item in the user's client device is marked as temporary.

570. The system of embodiment 556, wherein the processor issues further instructions to:
determine via the processor interest graph influenced content attributes associated with the universally resolvable content seed;
query the universally resolvable content database using the interest graph influenced content attributes;
obtain a ranked list of universally resolvable content items from the querying;
provide the ranked list of universally resolvable content items to the user.

571. A processor-readable medium storing processor-issuable instructions for providing universally resolvable content items, wherein the processor issues instructions to:
receive user selection of a universally resolvable content seed;
determine via a processor socially influenced content attributes associated with the universally resolvable content seed;
query a universally resolvable content database using the socially influenced content attributes;
obtain a ranked list of universally resolvable content items from the querying; and
provide the ranked list of universally resolvable content items to the user.

572. The medium of embodiment 571, wherein the processor issues further instructions to:
create a content query based on the socially influenced content attributes for the querying.

573. The medium of embodiment 572, wherein the processor issues further instructions to:
create socially influenced ranking categories and populating the ranking categories with results from the query to obtain the ranked list of universally resolvable content items.

574. The medium of embodiment 571, wherein the instructions to determine the socially influenced content attributes associated with the universally resolvable content seed includes instructions to:
determine if the universally resolvable content seed is a universally resolvable content item seed.

575. The medium of embodiment 574, wherein when the universally resolvable content seed is a universally resolvable content item seed, the instructions to determine the socially influenced content attributes includes instructions to:
retrieve user profile and social graph preferences;
utilize the retrieved user profile and social graph preferences to create socially influenced ranking categories to obtain the ranked list of universally resolvable content items.

576. The medium of embodiment 575, wherein the social graph preferences are derived from the user's one or more social networks.

577. The medium of embodiment 574, wherein when the universally resolvable content seed is not a content item seed, the instructions to determine the socially influenced content attributes further comprises instructions to:
select a socially influenced content item seed selection criterion; and
retrieve a universally resolvable content item seed associated with the universally resolvable content seed based on the selected criterion.

578. The medium of embodiment 577, wherein the processor issues further instructions to:
retrieve user profile and social graph preferences; and
utilize the retrieved user profile and social graph preferences to create socially influenced ranking categories for obtaining the ranked list of universally resolvable content items.

579. The medium of embodiment 577, wherein the socially influenced content item seed selection criterion is one of a: (i) a specified default, (ii) currently played track, (iii) most played track, (iv) favorite track, (v) favorite genre, and (vi) last purchase.

580. The medium of embodiment 573, wherein the results from the query are assigned a weight corresponding to relevance to the content query.

581. The medium of embodiment 580, wherein the instructions to obtain the ranked list of universally resolvable content item further comprises instructions to:
assign a category weight to each one of the socially influenced ranking categories; and
rank the socially influenced categorized results based on a calculated social influence score.

582. The medium of embodiment 581, wherein for each one of the unique results, the processor issues further instructions to calculate the social influence score based on the assigned category weight and the weight corresponding to relevance to the content query.

583. The medium of embodiment 571, wherein the processor issues further instructions to:
obtain from the user's client device a local cache request for a non-local universally resolvable content item; and
provide the non-local universally resolvable content item to the user's client device.

584. The medium of embodiment 583, wherein the non-local universally resolvable content item in the user's client device is marked as temporary.

585. The medium of embodiment 571, wherein the processor issues further instructions to:
determine via the processor interest graph influenced content attributes associated with the universally resolvable content seed;
query the universally resolvable content database using the interest graph influenced content attributes;
obtain a ranked list of universally resolvable content items from the querying;
provide the ranked list of universally resolvable content items to the user.

586. An apparatus for providing universally resolvable content items, comprising:
a memory;
a processor disposed in communication with said memory, and configured to issue a plurality of processing instructions stored in the memory, wherein the processor issues instructions to:
   receive user selection of a universally resolvable content seed;
   determine via a processor socially influenced content attributes associated with the universally resolvable content seed;
   query a universally resolvable content database using the socially influenced content attributes;
   obtain a ranked list of universally resolvable content items from the querying; and
   provide the ranked list of universally resolvable content items to the user.

587. The apparatus of embodiment 586, wherein the processor issues further instructions to:
create a content query based on the socially influenced content attributes for the querying.

588. The apparatus of embodiment 587, wherein the processor issues further instructions to:
create socially influenced ranking categories and populating the ranking categories with results from the query to obtain the ranked list of universally resolvable content items.

589. The apparatus of embodiment 586, wherein the instructions to determine the socially influenced content attributes associated with the universally resolvable content seed includes instructions to:
determine if the universally resolvable content seed is a universally resolvable content item seed.

590. The apparatus of embodiment 589, wherein when the universally resolvable content seed is a universally resolvable content item seed, the instructions to determine the socially influenced content attributes includes instructions to:
retrieve user profile and social graph preferences;
utilize the retrieved user profile and social graph preferences to create socially influenced ranking categories to obtain the ranked list of universally resolvable content items.

591. The apparatus of embodiment 590, wherein the social graph preferences are derived from the user's one or more social networks.

592. The apparatus of embodiment 589, wherein when the universally resolvable content seed is not a content item seed, the instructions to determine the socially influenced content attributes further comprises instructions to:
select a socially influenced content item seed selection criterion; and
retrieve a universally resolvable content item seed associated with the universally resolvable content seed based on the selected criterion.

593. The apparatus of embodiment 592, wherein the processor issues further instructions to:
retrieve user profile and social graph preferences; and
utilize the retrieved user profile and social graph preferences to create socially influenced ranking categories for obtaining the ranked list of universally resolvable content items.

594. The apparatus of embodiment 592, wherein the socially influenced content item seed selection criterion is one of a: (i) a specified default, (ii) currently played track, (iii) most played track, (iv) favorite track, (v) favorite genre, and (vi) last purchase.

595. The apparatus of embodiment 588, wherein the results from the query are assigned a weight corresponding to relevance to the content query.

596. The apparatus of embodiment 595, wherein the instructions to obtain the ranked list of universally resolvable content item further comprises instructions to:
assign a category weight to each one of the socially influenced ranking categories; and
rank the socially influenced categorized results based on a calculated social influence score.

597. The apparatus of embodiment 596, wherein for each one of the unique results, the processor issues further instructions to calculate the social influence score based on the assigned category weight and the weight corresponding to relevance to the content query.

598. The apparatus of embodiment 586, wherein the processor issues further instructions to:
obtain from the user's client device a local cache request for a non-local universally resolvable content item; and
provide the non-local universally resolvable content item to the user's client device.

599. The apparatus of embodiment 598, wherein the non-local universally resolvable content item in the user's client device is marked as temporary.

600. The apparatus of embodiment 586, wherein the processor issues further instructions to:
determine via the processor interest graph influenced content attributes associated with the universally resolvable content seed;
query the universally resolvable content database using the interest graph influenced content attributes;
obtain a ranked list of universally resolvable content items from the querying;
provide the ranked list of universally resolvable content items to the user.

601. A processor-implemented method for providing universally resolvable content items, comprising:
providing user selection of a universally resolvable content seed;
providing a request to determine via a processor socially influenced content attributes associated with the universally resolvable content seed;
providing a request to querying a universally resolvable content database using the socially influenced content attributes;
providing a request obtaining a ranked list of universally resolvable content items from the querying;
receiving the ranked list of universally resolvable content items to the user.

602. The method of embodiment 601, further comprising:
creating a content query based on the socially influenced content attributes for the querying.

603. The method of embodiment 602, further comprising:
providing authorization to create socially influenced ranking categories and populating the ranking categories with results from the query to obtain the ranked list of universally resolvable content items.

604. The method of embodiment 601, wherein determining the socially influenced content attributes associated with the universally resolvable content seed includes:
providing authorization to determine if the universally resolvable content seed is a universally resolvable content item seed.

605. The method of embodiment 604, wherein when the universally resolvable content seed is a universally resolvable content item seed, determining the socially influenced content attributes includes:
retrieving user profile and social graph preferences;
utilizing the retrieved user profile and social graph preferences to create socially influenced ranking categories to obtain the ranked list of universally resolvable content items.

606. The method of embodiment 605, wherein the social graph preferences are derived from the user's one or more social networks.

607. The method of embodiment 604, wherein when the universally resolvable content seed is not a content item seed, determining the socially influenced content attributes further comprises:
selecting a socially influenced content item seed selection criterion; and
retrieving a universally resolvable content item seed associated with the universally resolvable content seed based on the selected criterion.

608. The method of embodiment 607, further comprising:
providing user profile and social graph preferences; and
providing authorization to utilize the retrieved user profile and social graph preferences to create socially influenced ranking categories for obtaining the ranked list of universally resolvable content items.

609. The method of embodiment 607, wherein the socially influenced content item seed selection criterion is one of a: (i) a specified default, (ii) currently played track, (iii) most played track, (iv) favorite track, (v) favorite genre, and (vi) last purchase.

610. The method of embodiment 603, wherein the results from the query are assigned a weight corresponding to relevance to the content query.

611. The method of embodiment 610, wherein obtaining the ranked list of universally resolvable content item further comprises:
assigning a category weight to each one of the socially influenced ranking categories; and
ranking the socially influenced categorized results based on a calculated social influence score.

612. The method of embodiment 611, further comprising:
for each one of the unique results, calculating the social influence score based on the assigned category weight and the weight corresponding to relevance to the content query.

613. The method of embodiment 601, further comprising:
obtaining from the user's client device a local cache request for a non-local universally resolvable content item; and
providing the non-local universally resolvable content item to the user's client device.

614. The method of embodiment 611, wherein the non-local universally resolvable content item in the user's client device is marked as temporary.

615. The method of embodiment 601, further comprising:
providing authorization to determine via the processor interest graph influenced content attributes associated with the universally resolvable content seed;
providing authorization to query the universally resolvable content database using the interest graph influenced content attributes;
providing a ranked list of universally resolvable content items from the querying;
obtaining the ranked list of universally resolvable content items to the user.

616. A system for providing universally resolvable content items, comprising:
a memory;
a processor disposed in communication with said memory, and configured to issue a plurality of processing instructions stored in the memory, wherein the processor issues instructions to:
   provide user selection of a universally resolvable content seed;
   provide a request to determine via a processor socially influenced content attributes associated with the universally resolvable content seed;
   provide a request to query a universally resolvable content database using the socially influenced content attributes;
   provide a request to obtain a ranked list of universally resolvable content items from the querying; and
   obtain the ranked list of universally resolvable content items to the user.

617. The system of embodiment 616, wherein the processor issues further instructions to:
create a content query based on the socially influenced content attributes for the querying.

618. The system of embodiment 617, wherein the processor issues further instructions to:
create socially influenced ranking categories and populating the ranking categories with results from the query to obtain the ranked list of universally resolvable content items.

619. The system of embodiment 616, wherein the instructions to determine the socially influenced content attributes associated with the universally resolvable content seed includes instructions to:
determine if the universally resolvable content seed is a universally resolvable content item seed.

620. The system of embodiment 619, wherein when the universally resolvable content seed is a universally resolvable content item seed, the instructions to determine the socially influenced content attributes includes instructions to:
retrieve user profile and social graph preferences;
utilize the retrieved user profile and social graph preferences to create socially influenced ranking categories to obtain the ranked list of universally resolvable content items.

621. The system of embodiment 620, wherein the social graph preferences are derived from the user's one or more social networks.

622. The system of embodiment 619, wherein when the universally resolvable content seed is not a content item seed, the instructions to determine the socially influenced content attributes further comprises instructions to:
select a socially influenced content item seed selection criterion; and
retrieve a universally resolvable content item seed associated with the universally resolvable content seed based on the selected criterion.

623. The system of embodiment 622, wherein the processor issues further instructions to:
retrieve user profile and social graph preferences; and
utilize the retrieved user profile and social graph preferences to create socially influenced ranking categories for obtaining the ranked list of universally resolvable content items.

624. The system of embodiment 622, wherein the socially influenced content item seed selection criterion is one of a: (i) a specified default, (ii) currently played track, (iii) most played track, (iv) favorite track, (v) favorite genre, and (vi) last purchase.

625. The system of embodiment 618, wherein the results from the query are assigned a weight corresponding to relevance to the content query.

626. The system of embodiment 625, wherein the instructions to obtain the ranked list of universally resolvable content item further comprises instructions to:
assign a category weight to each one of the socially influenced ranking categories; and
rank the socially influenced categorized results based on a calculated social influence score.

627. The system of embodiment 626, wherein for each one of the unique results, the processor issues further instructions to calculate the social influence score based on the assigned category weight and the weight corresponding to relevance to the content query.

628. The system of embodiment 616, wherein the processor issues further instructions to:
obtain from the user's client device a local cache request for a non-local universally resolvable content item; and
provide the non-local universally resolvable content item to the user's client device.

629. The system of embodiment 628, wherein the non-local universally resolvable content item in the user's client device is marked as temporary.

630. The system of embodiment 616, wherein the processor issues further instructions to:
provide a request to determine via the processor interest graph influenced content attributes associated with the universally resolvable content seed;
provide a request to query the universally resolvable content database using the interest graph influenced content attributes;
provide a request to obtain a ranked list of universally resolvable content items from the querying;
obtain the ranked list of universally resolvable content items to the user.

631. A processor-readable medium storing processor-issuable instructions for providing universally resolvable content items, wherein the processor issues instructions to:
provide user selection of a universally resolvable content seed;
provide a request to determine via a processor socially influenced content attributes associated with the universally resolvable content seed;
provide a request to query a universally resolvable content database using the socially influenced content attributes;
provide a request to obtain a ranked list of universally resolvable content items from the querying; and
obtain the ranked list of universally resolvable content items to the user.

632. The medium of embodiment 631, wherein the processor issues further instructions to:
create a content query based on the socially influenced content attributes for the querying.

633. The medium of embodiment 632, wherein the processor issues further instructions to:
create socially influenced ranking categories and populating the ranking categories with results from the query to obtain the ranked list of universally resolvable content items.

634. The medium of embodiment 631, wherein the instructions to determine the socially influenced content attributes associated with the universally resolvable content seed includes instructions to:
determine if the universally resolvable content seed is a universally resolvable content item seed.

635. The medium of embodiment 634, wherein when the universally resolvable content seed is a universally resolvable content item seed, the instructions to determine the socially influenced content attributes includes instructions to:
retrieve user profile and social graph preferences;
utilize the retrieved user profile and social graph preferences to create socially influenced ranking categories to obtain the ranked list of universally resolvable content items.

636. The medium of embodiment 635, wherein the social graph preferences are derived from the user's one or more social networks.

637. The medium of embodiment 634, wherein when the universally resolvable content seed is not a content item seed, the instructions to determine the socially influenced content attributes further comprises instructions to:
select a socially influenced content item seed selection criterion; and
retrieve a universally resolvable content item seed associated with the universally resolvable content seed based on the selected criterion.

638. The medium of embodiment 637, wherein the processor issues further instructions to:
retrieve user profile and social graph preferences; and
utilize the retrieved user profile and social graph preferences to create socially influenced ranking categories for obtaining the ranked list of universally resolvable content items.

639. The medium of embodiment 637, wherein the socially influenced content item seed selection criterion is one of a: (i) a specified default, (ii) currently played track, (iii) most played track, (iv) favorite track, (v) favorite genre, and (vi) last purchase.

640. The medium of embodiment 633, wherein the results from the query are assigned a weight corresponding to relevance to the content query.

641. The medium of embodiment 640, wherein the instructions to obtain the ranked list of universally resolvable content item further comprises instructions to:
assign a category weight to each one of the socially influenced ranking categories; and
rank the socially influenced categorized results based on a calculated social influence score.

642. The medium of embodiment 641, wherein for each one of the unique results, the processor issues further instructions to calculate the social influence score based on the assigned category weight and the weight corresponding to relevance to the content query.

643. The medium of embodiment 631, wherein the processor issues further instructions to:
obtain from the user's client device a local cache request for a non-local universally resolvable content item; and
provide the non-local universally resolvable content item to the user's client device.

644. The medium of embodiment 643, wherein the non-local universally resolvable content item in the user's client device is marked as temporary.

645. The medium of embodiment 631, wherein the processor issues further instructions to:
provide a request to determine via the processor interest graph influenced content attributes associated with the universally resolvable content seed;
provide a request to query the universally resolvable content database using the interest graph influenced content attributes;
provide a request to obtain a ranked list of universally resolvable content items from the querying;
obtain the ranked list of universally resolvable content items to the user.

646. An apparatus for providing universally resolvable content items, comprising:
a memory;
a processor disposed in communication with said memory, and configured to issue a plurality of processing instructions stored in the memory, wherein the processor issues instructions to:
   provide user selection of a universally resolvable content seed;
   provide a request to determine via a processor socially influenced content attributes associated with the universally resolvable content seed;
   provide a request to query a universally resolvable content database using the socially influenced content attributes;
   provide a request to obtain a ranked list of universally resolvable content items from the querying; and
   obtain the ranked list of universally resolvable content items to the user.

647. The apparatus of embodiment 646, wherein the processor issues further instructions to:
create a content query based on the socially influenced content attributes for the querying.

648. The apparatus of embodiment 647, wherein the processor issues further instructions to:
create socially influenced ranking categories and populating the ranking categories with results from the query to obtain the ranked list of universally resolvable content items.

649. The apparatus of embodiment 646, wherein the instructions to determine the socially influenced content attributes associated with the universally resolvable content seed includes instructions to:
determine if the universally resolvable content seed is a universally resolvable content item seed.

650. The apparatus of embodiment 649, wherein when the universally resolvable content seed is a universally resolvable content item seed, the instructions to determine the socially influenced content attributes includes instructions to:
retrieve user profile and social graph preferences;
utilize the retrieved user profile and social graph preferences to create socially influenced ranking categories to obtain the ranked list of universally resolvable content items.

651. The apparatus of embodiment 650, wherein the social graph preferences are derived from the user's one or more social networks.

652. The apparatus of embodiment 649, wherein when the universally resolvable content seed is not a content item seed, the instructions to determine the socially influenced content attributes further comprises instructions to:
select a socially influenced content item seed selection criterion; and
retrieve a universally resolvable content item seed associated with the universally resolvable content seed based on the selected criterion.

653. The apparatus of embodiment 652, wherein the processor issues further instructions to:
retrieve user profile and social graph preferences; and
utilize the retrieved user profile and social graph preferences to create socially influenced ranking categories for obtaining the ranked list of universally resolvable content items.

654. The apparatus of embodiment 652, wherein the socially influenced content item seed selection criterion is one of a: (i) a specified default, (ii) currently played track, (iii) most played track, (iv) favorite track, (v) favorite genre, and (vi) last purchase.

655. The apparatus of embodiment 648, wherein the results from the query are assigned a weight corresponding to relevance to the content query.

656. The apparatus of embodiment 655, wherein the instructions to obtain the ranked list of universally resolvable content item further comprises instructions to:
assign a category weight to each one of the socially influenced ranking categories; and
rank the socially influenced categorized results based on a calculated social influence score.

657. The apparatus of embodiment 656, wherein for each one of the unique results, the processor issues further instructions to calculate the social influence score based on the assigned category weight and the weight corresponding to relevance to the content query.

658. The apparatus of embodiment 646, wherein the processor issues further instructions to:
obtain from the user's client device a local cache request for a non-local universally resolvable content item; and
provide the non-local universally resolvable content item to the user's client device.

659. The apparatus of embodiment 658, wherein the non-local universally resolvable content item in the user's client device is marked as temporary.

660. The apparatus of embodiment 646, wherein the processor issues further instructions to:
provide a request to determine via the processor interest graph influenced content attributes associated with the universally resolvable content seed;
provide a request to query the universally resolvable content database using the interest graph influenced content attributes;
provide a request to obtain a ranked list of universally resolvable content items from the querying;
obtain the ranked list of universally resolvable content items to the user.

661. A processor-implemented method, comprising:
obtaining information relating to universally resolvable media content (“URMC”) social influence weighted user engagement in at least one URMC socially influencing activity;
obtaining the user's social influence weight in a universally resolvable media content service;
obtaining a social influence weight associated with the activity; and
updating the user's social influence profile based on the activity.

662. The method of embodiment 661, further comprising:
prior to the updating, determining whether the activity meets the social influence weight upgrade criteria.

663. The method of embodiment 661, wherein updating the user's social influence profile based on the activity further comprises:
obtaining social influence points associated with the activity; and
determine the social influence weight corresponding to the social influence points.

664. The method of embodiment 663, further comprising:
obtaining historical data corresponding to the user engagement in the activity; and
adjusting the social influence points based on the historical data.

665. The method of embodiment 661, wherein the activity is at least one of: (i) playlist creation; (ii) playlist sharing; (iii) media content rating; (iv) messaging; (v) posting; and (vi) influencing a number of users to play, download or purchase one or more tracks.

666. The method of embodiment 661, further comprising:
qualifying the user for at least one promotional incentive based on the updated social influence profile.

667. The method of embodiment 666, wherein the at least one promotional incentive is one: (i) purchase discount; (ii) free merchandise; and (iii) admission to events.

668. The method of embodiment 666, further comprising:
providing the user the at least one promotional incentive when the activity matches one or more activity criteria.

669. The method of embodiment 661, wherein the socially influencing activity is related to at least one of: a social graph and an interest graph.

670. The method of embodiment 665, further comprising:
determining whether the activity is a URMC socially influencing activity.

671. The method of embodiment 670, wherein the determining is based on tracked frequency of user engagement with a playlist sharing activity.

672. The method of embodiment 670, wherein the determining is based on tracked license purchase attributable to the user.

673. The method of embodiment 670, wherein the determining is based on tracked number of users following and unfollowing the user.

674. The method of embodiment 670, wherein the determining is based on tracked response to content sharing.

675. The method of embodiment 670, wherein the determining is based on tracked usage volume of other users attributable to the user.

676. A system, comprising:
a memory;
a processor disposed in communication with said memory, and configured to issue a plurality of processing instructions stored in the memory, wherein the processor issues instructions to:
   obtain information relating to universally resolvable media content (“URMC”) social influence weighted user engagement in at least one URMC socially influencing activity;
   obtain the user's social influence weight in a universally resolvable media content service;
   obtain a social influence weight associated with the activity; and
   update the user's social influence profile based on the activity.

677. The system of embodiment 676, wherein the processor issues further instructions to:
prior to the update, determine whether the activity meets the social influence weight upgrade criteria.

678. The system of embodiment 676, wherein the instructions to update the user's social influence profile based on the activity further comprises instructions to:
obtain social influence points associated with the activity; and
determine the social influence weight corresponding to the social influence points.

679. The system of embodiment 678, wherein the processor issues further instructions to: obtain historical data corresponding to the user engagement in the activity; and
adjust the social influence points based on the historical data.

680. The system of embodiment 676, wherein the activity is at least one of: (i) playlist creation; (ii) playlist sharing; (iii) media content rating; (iv) messaging; (v) posting; and (vi) influencing a number of users to play, download or purchase one or more tracks.

681. The system of embodiment 676, wherein the processor issues further instructions to:
qualify the user for at least one promotional incentive based on the updated social influence profile.

682. The system of embodiment 681, wherein the at least one promotional incentive is one: (i) purchase discount; (ii) free merchandise; and (iii) admission to events.

683. The system of embodiment 681, wherein the processor issues further instructions to:
provide the user the at least one promotional incentive when the activity matches one or more activity criteria.

684. The system of embodiment 676, wherein the socially influencing activity is related to at least one of: a social graph and an interest graph.

685. The system of embodiment 680, wherein the processor issues further instructions to:
determine whether the activity is a URMC socially influencing activity.

686. The system of embodiment 685, wherein the determination is based on tracked frequency of user engagement with a playlist sharing activity.

687. The system of embodiment 685, wherein the determination is based on tracked license purchase attributable to the user.

688. The system of embodiment 685, wherein the determination is based on tracked number of users following and unfollowing the user.

689. The system of embodiment 685, wherein the determination is based on tracked response to content sharing.

690. The system of embodiment 685, wherein the determination is based on tracked usage volume of other users attributable to the user.

691. A processor-readable medium storing processor-issuable instructions, wherein the processor issues instructions to:
obtain information relating to universally resolvable media content (“URMC”) social influence weighted user engagement in at least one URMC socially influencing activity;
obtain the user's social influence weight in a universally resolvable media content service;
obtain a social influence weight associated with the activity; and
update the user's social influence profile based on the activity.

692. The medium of embodiment 691, wherein the processor issues further instructions to:
prior to the update, determine whether the activity meets the social influence weight upgrade criteria.

693. The medium of embodiment 691, wherein the instructions to update the user's social influence profile based on the activity further comprises instructions to:
obtain social influence points associated with the activity; and
determine the social influence weight corresponding to the social influence points.

694. The medium of embodiment 693, wherein the processor issues further instructions to: obtain historical data corresponding to the user engagement in the activity; and
adjust the social influence points based on the historical data.

695. The medium of embodiment 691, wherein the activity is at least one of: (i) playlist creation; (ii) playlist sharing; (iii) media content rating; (iv) messaging; (v) posting; and (vi) influencing a number of users to play, download or purchase one or more tracks.

696. The medium of embodiment 691, wherein the processor issues further instructions to:
qualify the user for at least one promotional incentive based on the updated social influence profile.

697. The medium of embodiment 696, wherein the at least one promotional incentive is one: (i) purchase discount; (ii) free merchandise; and (iii) admission to events.

698. The medium of embodiment 696, wherein the processor issues further instructions to:
provide the user the at least one promotional incentive when the activity matches one or more activity criteria.

699. The medium of embodiment 691, wherein the socially influencing activity is related to at least one of: a social graph and an interest graph.

700. The medium of embodiment 695 wherein the processor issues further instructions to:
determine whether the activity is a URMC socially influencing activity.

701. The medium of embodiment 700, wherein the determination is based on tracked frequency of user engagement with a playlist sharing activity.

702. The medium of embodiment 700, wherein the determination is based on tracked license purchase attributable to the user.

703. The medium of embodiment 700, wherein the determination is based on tracked number of users following and unfollowing the user.

704. The medium of embodiment 700, wherein the determination is based on tracked response to content sharing.

705. The medium of embodiment 700, wherein the determination is based on tracked usage volume of other users attributable to the user.

706. An apparatus, comprising:
a memory;
a processor disposed in communication with said memory, and configured to issue a plurality of processing instructions stored in the memory, wherein the processor issues instructions to:
   obtain information relating to universally resolvable media content (“URMC”) social influence weighted user engagement in at least one URMC socially influencing activity;
   obtain the user's social influence weight in a universally resolvable media content service;
   obtain a social influence weight associated with the activity; and
   update the user's social influence profile based on the activity.

707. The apparatus of embodiment 706, wherein the processor issues further instructions to:
prior to the update, determine whether the activity meets the social influence weight upgrade criteria.

708. The apparatus of embodiment 706, wherein the instructions to update the user's social influence profile based on the activity further comprises instructions to:
obtain social influence points associated with the activity; and
determine the social influence weight corresponding to the social influence points.

709. The apparatus of embodiment 708, wherein the processor issues further instructions to: obtain historical data corresponding to the user engagement in the activity; and
adjust the social influence points based on the historical data.

710. The apparatus of embodiment 706, wherein the activity is at least one of: (i) playlist creation; (ii) playlist sharing; (iii) media content rating; (iv) messaging; (v) posting; and (vi) influencing a number of users to play, download or purchase one or more tracks.

711. The apparatus of embodiment 706, wherein the processor issues further instructions to:
qualify the user for at least one promotional incentive based on the updated social influence profile.

712. The apparatus of embodiment 711, wherein the at least one promotional incentive is one: (i) purchase discount; (ii) free merchandise; and (iii) admission to events.

713. The apparatus of embodiment 711, wherein the processor issues further instructions to:
provide the user the at least one promotional incentive when the activity matches one or more activity criteria.

714. The apparatus of embodiment 706, wherein the socially influencing activity is related to at least one of: a social graph and an interest graph.

715. The apparatus of embodiment 710 wherein the processor issues further instructions to:
determine whether the activity is a URMC socially influencing activity.

716. The apparatus of embodiment 715, wherein the determination is based on tracked frequency of user engagement with a playlist sharing activity.

717. The apparatus of embodiment 715, wherein the determination is based on tracked license purchase attributable to the user.

718. The apparatus of embodiment 715, wherein the determination is based on tracked number of users following and unfollowing the user.

719. The apparatus of embodiment 715, wherein the determination is based on tracked response to content sharing.

720. The apparatus of embodiment 715, wherein the determination is based on tracked usage volume of other users attributable to the user.

721. A processor-implemented method, comprising:
providing information relating to universally resolvable media content (“URMC”) social influence weighted user engagement in at least one URMC socially influencing activity;
providing the user's social influence weight in a universally resolvable media content service;
providing a social influence weight associated with the activity; and
providing a request to update the user's social influence profile based on the activity.

722. The method of embodiment 721, further comprising:
prior to the updating, determining whether the activity meets the social influence weight upgrade criteria.

723. The method of embodiment 721, wherein updating the user's social influence profile based on the activity further comprises:
obtaining social influence points associated with the activity; and
determine the social influence weight corresponding to the social influence points.

724. The method of embodiment 723, further comprising:
obtaining historical data corresponding to the user engagement in the activity; and
adjusting the social influence points based on the historical data.

725. The method of embodiment 721, wherein the activity is at least one of: (i) playlist creation; (ii) playlist sharing; (iii) media content rating; (iv) messaging; (v) posting; and (vi) influencing a number of users to play, download or purchase one or more tracks.

726. The method of embodiment 721, further comprising:
qualifying the user for at least one promotional incentive based on the updated social influence profile.

727. The method of embodiment 726, wherein the at least one promotional incentive is one: (i) purchase discount; (ii) free merchandise; and (iii) admission to events.

728. The method of embodiment 726, further comprising:
providing the user the at least one promotional incentive when the activity matches one or more activity criteria.

729. The method of embodiment 721, wherein the socially influencing activity is related to at least one of: a social graph and an interest graph.

730. The method of embodiment 725, further comprising:
determining whether the activity is a URMC socially influencing activity.

731. The method of embodiment 730, wherein the determining is based on tracked frequency of user engagement with a playlist sharing activity.

732. The method of embodiment 730, wherein the determining is based on tracked license purchase attributable to the user.

733. The method of embodiment 730, wherein the determining is based on tracked number of users following and unfollowing the user.

734. The method of embodiment 730, wherein the determining is based on tracked response to content sharing.

735. The method of embodiment 730, wherein the determining is based on tracked usage volume of other users attributable to the user.

736. A system, comprising:
a memory;
a processor disposed in communication with said memory, and configured to issue a plurality of processing instructions stored in the memory, wherein the processor issues instructions to:
   provide information relating to universally resolvable media content (“URMC”) social influence weighted user engagement in at least one URMC socially influencing activity;
   provide the user's social influence weight in a universally resolvable media content service;
   provide a social influence weight associated with the activity; and
   providing a request to update the user's social influence profile based on the activity.

737. The system of embodiment 736, wherein the processor issues further instructions to:
prior to the update, determine whether the activity meets the social influence weight upgrade criteria.

738. The system of embodiment 736, wherein the instructions to update the user's social influence profile based on the activity further comprises instructions to:
obtain social influence points associated with the activity; and
determine the social influence weight corresponding to the social influence points.

739. The system of embodiment 738, wherein the processor issues further instructions to: obtain historical data corresponding to the user engagement in the activity; and
adjust the social influence points based on the historical data.

740. The system of embodiment 736, wherein the activity is at least one of: (i) playlist creation; (ii) playlist sharing; (iii) media content rating; (iv) messaging; (v) posting; and (vi) influencing a number of users to play, download or purchase one or more tracks.

741. The system of embodiment 736, wherein the processor issues further instructions to:
qualify the user for at least one promotional incentive based on the updated social influence profile.

742. The system of embodiment 741, wherein the at least one promotional incentive is one: (i) purchase discount; (ii) free merchandise; and (iii) admission to events.

743. The system of embodiment 741, wherein the processor issues further instructions to:
provide the user the at least one promotional incentive when the activity matches one or more activity criteria.

744. The system of embodiment 736, wherein the socially influencing activity is related to at least one of: a social graph and an interest graph.

745. The system of embodiment 740, wherein the processor issues further instructions to:
determine whether the activity is a URMC socially influencing activity.

746. The system of embodiment 745, wherein the determination is based on tracked frequency of user engagement with a playlist sharing activity.

747. The system of embodiment 745, wherein the determination is based on tracked license purchase attributable to the user.

748. The system of embodiment 745, wherein the determination is based on tracked number of users following and unfollowing the user.

749. The system of embodiment 745, wherein the determination is based on tracked response to content sharing.

750. The system of embodiment 745, wherein the determination is based on tracked usage volume of other users attributable to the user.

751. A processor-readable medium storing processor-issuable instructions, wherein the processor issues instructions to:
provide information relating to universally resolvable media content (“URMC”) social influence weighted user engagement in at least one URMC socially influencing activity;
provide the user's social influence weight in a universally resolvable media content service;
provide a social influence weight associated with the activity; and
providing a request to update the user's social influence profile based on the activity.

752. The medium of embodiment 751, wherein the processor issues further instructions to:
prior to the update, determine whether the activity meets the social influence weight upgrade criteria.

753. The medium of embodiment 751, wherein the instructions to update the user's social influence profile based on the activity further comprises instructions to:
obtain social influence points associated with the activity; and
determine the social influence weight corresponding to the social influence points.

754. The medium of embodiment 753, wherein the processor issues further instructions to: obtain historical data corresponding to the user engagement in the activity; and
adjust the social influence points based on the historical data.

755. The medium of embodiment 751, wherein the activity is at least one of: (i) playlist creation; (ii) playlist sharing; (iii) media content rating; (iv) messaging; (v) posting; and (vi) influencing a number of users to play, download or purchase one or more tracks.

756. The medium of embodiment 751, wherein the processor issues further instructions to:
qualify the user for at least one promotional incentive based on the updated social influence profile.

757. The medium of embodiment 756, wherein the at least one promotional incentive is one: (i) purchase discount; (ii) free merchandise; and (iii) admission to events.

758. The medium of embodiment 756, wherein the processor issues further instructions to:
provide the user the at least one promotional incentive when the activity matches one or more activity criteria.

759. The medium of embodiment 751, wherein the socially influencing activity is related to at least one of: a social graph and an interest graph.

760. The medium of embodiment 755 wherein the processor issues further instructions to:
determine whether the activity is a URMC socially influencing activity.

761. The medium of embodiment 760, wherein the determination is based on tracked frequency of user engagement with a playlist sharing activity.

762. The medium of embodiment 760, wherein the determination is based on tracked license purchase attributable to the user.

763. The medium of embodiment 760, wherein the determination is based on tracked number of users following and unfollowing the user.

764. The medium of embodiment 760, wherein the determination is based on tracked response to content sharing.

765. The medium of embodiment 760, wherein the determination is based on tracked usage volume of other users attributable to the user.

766. An apparatus, comprising:
a memory;
a processor disposed in communication with said memory, and configured to issue a plurality of processing instructions stored in the memory, wherein the processor issues instructions to:
   obtain information relating to universally resolvable media content (“URMC”) social influence weighted user engagement in at least one URMC socially influencing activity;
   provide the user's social influence weight in a universally resolvable media content service;
   provide a social influence weight associated with the activity; and
   provide a request to update the user's social influence profile based on the activity.

767. The apparatus of embodiment 766, wherein the processor issues further instructions to:
prior to the update, determine whether the activity meets the social influence weight upgrade criteria.

768. The apparatus of embodiment 766, wherein the instructions to update the user's social influence profile based on the activity further comprises instructions to:
obtain social influence points associated with the activity; and
determine the social influence weight corresponding to the social influence points.

769. The apparatus of embodiment 768, wherein the processor issues further instructions to: obtain historical data corresponding to the user engagement in the activity; and
adjust the social influence points based on the historical data.

770. The apparatus of embodiment 766, wherein the activity is at least one of: (i) playlist creation; (ii) playlist sharing; (iii) media content rating; (iv) messaging; (v) posting; and (vi) influencing a number of users to play, download or purchase one or more tracks.

771. The apparatus of embodiment 766, wherein the processor issues further instructions to:
qualify the user for at least one promotional incentive based on the updated social influence profile.

772. The apparatus of embodiment 771, wherein the at least one promotional incentive is one: (i) purchase discount; (ii) free merchandise; and (iii) admission to events.

773. The apparatus of embodiment 771, wherein the processor issues further instructions to:
provide the user the at least one promotional incentive when the activity matches one or more activity criteria.

774. The apparatus of embodiment 766, wherein the socially influencing activity is related to at least one of: a social graph and an interest graph.

775. The apparatus of embodiment 770 wherein the processor issues further instructions to:
determine whether the activity is a URMC socially influencing activity.

776. The apparatus of embodiment 775, wherein the determination is based on tracked frequency of user engagement with a playlist sharing activity.

777. The apparatus of embodiment 775, wherein the determination is based on tracked license purchase attributable to the user.

778. The apparatus of embodiment 775, wherein the determination is based on tracked number of users following and unfollowing the user.

779. The apparatus of embodiment 775, wherein the determination is based on tracked response to content sharing.

780. The apparatus of embodiment 775, wherein the determination is based on tracked usage volume of other users attributable to the user.

781. A processor-implemented method, comprising:
detecting user initiation of a universally resolvable media content (“URMC”) event in a client;
obtaining the URMC event identifying information;
recording the URMC event identifying information in association with the event in an event log in the client;
obtaining reporting frequency preference setting, wherein the preference setting includes at least one URMC user activity upload rule;
determining activation of a URMC upload threshold trigger by evaluating the at least one URMC user activity upload rule;
initiating reporting of the logged URMC event identifying information based on the trigger activation; and
updating the client upon successful acknowledgement of said reporting by a server.

782. The method of embodiment 781, further comprising:
anonymizing the URMC event identifying information in the event log before initiating said reporting.

783. The method of embodiment 782, wherein a decision for anonymizing the URMC event identifying information is based on user preference information.

784. The method of embodiment 781, wherein when the client is disconnected from a communication network:
suspending said reporting until the client is connected to the communication network.

785. The method of embodiment 784, wherein when said reporting is suspended and a user initiation of a URMC event is detected:
determining, using at least one URMC upload threshold rule, whether to disable contents of the URMC collection in the client.

786. The method of embodiment 781, wherein the URMC event is one of: (1) content started; (ii) content paused; (iii) content stopped; (iv) content skipped; and (v) application closed.

787. The method of embodiment 781, wherein the URMC event identifying information includes play session information including: play session start time, play session end time, total play session time for each content item in at least one of user library section, community section, discovery section and magic playlist.

788. The method of embodiment 781, wherein the URMC event identifying information includes at least one of: (i) content event name; (ii) event time stamp; (iii) universally resolvable content identifier; and (iv) user information.

789. The method of embodiment 781, wherein the at least one URMC user activity upload rule specifies a time for initiating reporting.

790. The method of embodiment 781, wherein the at least one URMC user activity upload rule specifies a number of URMC events for initiating reporting.

791. The method of embodiment 781, wherein the at least one URMC user activity upload rule specifies a number of each type of URMC event for initiating reporting.

792. The method of embodiment 781, further comprising categorizing the URMC event as at least one of: (i) play event; (ii) import event; (iii) share event; (iv) community event; and (v) search event.

793. The method of embodiment 792, further comprising selecting one or more URMC event categories for reporting based on the user's enrollment status in guru program.

794. The method of embodiment 792, wherein the reported URMC event identifying information is used for determining influence points attributable to one or more URMC service users.

795. The method of embodiment 792, wherein the reported URMC event identifying information is used for determining recommendations for the user.

796. The method of embodiment 792, wherein the reported URMC event identifying information is used for determining license payouts to URMC service partners.

797. A system, comprising:
a memory;
a processor disposed in communication with said memory, and configured to issue a plurality of processing instructions stored in the memory, wherein the processor issues instructions to:
   detect user initiation of a universally resolvable media content (“URMC”) event in a client;
   obtain the URMC event identifying information;
   record the URMC event identifying information in association with the event in an event log in the client;
   obtain reporting frequency preference setting, wherein the preference setting includes at least one URMC user activity upload rule;
   determine activation of a URMC upload threshold trigger by evaluating the at least one URMC user activity upload rule;
   initiate reporting of the logged URMC event identifying information based on the trigger activation; and
   update the client upon successful acknowledgement of said reporting by a server.

798. The system of embodiment 797, further comprising instructions to:
anonymize the URMC event identifying information in the event log before initiating said reporting.

799. The system of embodiment 798, wherein a decision for anonymizing the URMC event identifying information is based on user preference information.

800. The system of embodiment 797, wherein when the client is disconnected from a communication network, providing instructions to:
suspend said reporting until the client is connected to the communication network.

801. The system of embodiment 800, wherein when said reporting is suspended and a user initiation of a URMC event is detected, providing instructions to:
determine, using at least one URMC upload threshold rule, whether to disable contents of the URMC collection in the client.

802. The system of embodiment 797, wherein the URMC event is one of: (1) content started; (ii) content paused; (iii) content stopped; (iv) content skipped; and (v) application closed.

803. The system of embodiment 797, wherein the URMC event identifying information includes play session information including: play session start time, play session end time, total play session time for each content item in at least one of user library section, community section, discovery section and magic playlist.

804. The system of embodiment 797, wherein the URMC event identifying information includes at least one of: (i) content event name; (ii) event time stamp; (iii) universally resolvable content identifier; and (iv) user information.

805. The system of embodiment 797, wherein the at least one URMC user activity upload rule specifies a time for initiating reporting.

806. The system of embodiment 797, wherein the at least one URMC user activity upload rule specifies a number of URMC events for initiating reporting.

807. The system of embodiment 797, wherein the at least one URMC user activity upload rule specifies a number of each type of URMC event for initiating reporting.

808. The system of embodiment 797, further comprising categorizing the URMC event as at least one of: (i) play event; (ii) import event; (iii) share event; (iv) community event; and (v) search event.

809. The system of embodiment 808, further comprising instructions to select one or more URMC event categories for reporting based on the user's enrollment status in guru program.

810. The system of embodiment 808, wherein the reported URMC event identifying information is used for determining influence points attributable to one or more URMC service users.

811. The system of embodiment 808, wherein the reported URMC event identifying information is used for determining recommendations for the user.

812. The system of embodiment 808, wherein the reported URMC event identifying information is used for determining license payouts to URMC service partners.

813. A processor-readable medium storing processor-issuable instructions, wherein the processor issues instructions to:
detect user initiation of a universally resolvable media content (“URMC”) event in a client;
obtain the URMC event identifying information;
record the URMC event identifying information in association with the event in an event log in the client;
obtain reporting frequency preference setting, wherein the preference setting includes at least one URMC user activity upload rule;
determine activation of a URMC upload threshold trigger by evaluating the at least one URMC user activity upload rule;
initiate reporting of the logged URMC event identifying information based on the trigger activation; and
update the client upon successful acknowledgement of said reporting by a server.

814. The medium of embodiment 813, further comprising instructions to:
anonymize the URMC event identifying information in the event log before initiating said reporting.

815. The medium of embodiment 814, wherein a decision for anonymizing the URMC event identifying information is based on user preference information.

816. The medium of embodiment 813, wherein when the client is disconnected from a communication network, providing instructions to:
suspend said reporting until the client is connected to the communication network.

817. The medium of embodiment 816, wherein when said reporting is suspended and a user initiation of a URMC event is detected, providing instructions to:
determine, using at least one URMC upload threshold rule, whether to disable contents of the URMC collection in the client.

818. The medium of embodiment 813, wherein the URMC event is one of: (1) content started; (ii) content paused; (iii) content stopped; (iv) content skipped; and (v) application closed.

819. The medium of embodiment 813, wherein the URMC event identifying information includes play session information including: play session start time, play session end time, total play session time for each content item in at least one of user library section, community section, discovery section and magic playlist.

820. The medium of embodiment 813, wherein the URMC event identifying information includes at least one of: (i) content event name; (ii) event time stamp; (iii) universally resolvable content identifier; and (iv) user information.

821. The medium of embodiment 813, wherein the at least one URMC user activity upload rule specifies a time for initiating reporting.

822. The medium of embodiment 813, wherein the at least one URMC user activity upload rule specifies a number of URMC events for initiating reporting.

823. The medium of embodiment 813, wherein the at least one URMC user activity upload rule specifies a number of each type of URMC event for initiating reporting.

824. The medium of embodiment 813, further comprising categorizing the URMC event as at least one of: (i) play event; (ii) import event; (iii) share event; (iv) community event; and (v) search event.

825. The medium of embodiment 824, further comprising instructions to select one or more URMC event categories for reporting based on the user's enrollment status in guru program.

826. The medium of embodiment 824, wherein the reported URMC event identifying information is used for determining influence points attributable to one or more URMC service users.

827. The medium of embodiment 824, wherein the reported URMC event identifying information is used for determining recommendations for the user.

828. The medium of embodiment 824, wherein the reported URMC event identifying information is used for determining license payouts to URMC service partners.

829. An apparatus, comprising:
a memory;
a processor disposed in communication with said memory, and configured to issue a plurality of processing instructions stored in the memory, wherein the processor issues instructions to:
   detect user initiation of a universally resolvable media content (“URMC”) event in a client;
   obtain the URMC event identifying information;
   record the URMC event identifying information in association with the event in an event log in the client;
   obtain reporting frequency preference setting, wherein the preference setting includes at least one URMC user activity upload rule;
   determine activation of a URMC upload threshold trigger by evaluating the at least one URMC user activity upload rule;
   initiate reporting of the logged URMC event identifying information based on the trigger activation; and
   update the client upon successful acknowledgement of said reporting by a server.

830. The apparatus of embodiment 829, further comprising instructions to:
anonymize the URMC event identifying information in the event log before initiating said reporting.

831. The apparatus of embodiment 830, wherein a decision for anonymizing the URMC event identifying information is based on user preference information.

832. The apparatus of embodiment 829, wherein when the client is disconnected from a communication network, providing instructions to:
suspend said reporting until the client is connected to the communication network.

833. The apparatus of embodiment 832, wherein when said reporting is suspended and a user initiation of a URMC event is detected, providing instructions to:
determine, using at least one URMC upload threshold rule, whether to disable contents of the URMC collection in the client.

834. The apparatus of embodiment 829, wherein the URMC event is one of: (1) content started; (ii) content paused; (iii) content stopped; (iv) content skipped; and (v) application closed.

835. The apparatus of embodiment 829, wherein the URMC event identifying information includes play session information including: play session start time, play session end time, total play session time for each content item in at least one of user library section, community section, discovery section and magic playlist.

836. The apparatus of embodiment 829, wherein the URMC event identifying information includes at least one of: (i) content event name; (ii) event time stamp; (iii) universally resolvable content identifier; and (iv) user information.

837. The apparatus of embodiment 829, wherein the at least one URMC user activity upload rule specifies a time for initiating reporting.

838. The apparatus of embodiment 829, wherein the at least one URMC user activity upload rule specifies a number of URMC events for initiating reporting.

839. The apparatus of embodiment 829, wherein the at least one URMC user activity upload rule specifies a number of each type of URMC event for initiating reporting.

840. The apparatus of embodiment 829, further comprising categorizing the URMC event as at least one of: (i) play event; (ii) import event; (iii) share event; (iv) community event; and (v) search event.

841. The apparatus of embodiment 840, further comprising instructions to select one or more URMC event categories for reporting based on the user's enrollment status in guru program.

842. The apparatus of embodiment 840, wherein the reported URMC event identifying information is used for determining influence points attributable to one or more URMC service users.

843. The apparatus of embodiment 840, wherein the reported URMC event identifying information is used for determining recommendations for the user.

844. The apparatus of embodiment 840, wherein the reported URMC event identifying information is used for determining license payouts to URMC service partners.

845. A processor-implemented method, comprising:
obtaining notification of a user initiation of a universally resolvable media content (“URMC”) event in a client;
obtaining an event log recording the URMC event identifying information in association with the event;
providing reporting frequency preference setting, wherein the preference setting includes at least one URMC user activity upload rule;
obtaining reporting of the logged URMC event identifying information that is triggered in accordance with at least one URMC user activity upload rule; and
providing an acknowledgment to the client upon obtaining said reporting.

846. A system, comprising:
a memory;
a processor disposed in communication with said memory, and configured to issue a plurality of processing instructions stored in the memory, wherein the processor issues instructions to:
   obtain notification of a user initiation of a universally resolvable media content (“URMC”) event in a client;
   obtain an event log recording the URMC event identifying information in association with the event;
   provide reporting frequency preference setting, wherein the preference setting includes at least one URMC user activity upload rule;
   obtain reporting of the logged URMC event identifying information that is triggered in accordance with at least one URMC user activity upload rule; and
   provide an acknowledgment to the client upon obtaining said reporting.

847. A processor-readable medium storing processor-issuable instructions, wherein the processor issues instructions to:
obtain notification of a user initiation of a universally resolvable media content (“URMC”) event in a client;
obtain an event log recording the URMC event identifying information in association with the event;
provide reporting frequency preference setting, wherein the preference setting includes at least one URMC user activity upload rule;
obtain reporting of the logged URMC event identifying information that is triggered in accordance with at least one URMC user activity upload rule; and
provide an acknowledgment to the client upon obtaining said reporting.

848. An apparatus, comprising:
a memory;
a processor disposed in communication with said memory, and configured to issue a plurality of processing instructions stored in the memory, wherein the processor issues instructions to:
   obtain notification of a user initiation of a universally resolvable media content (“URMC”) event in a client;
   obtain an event log recording the URMC event identifying information in association with the event;
   provide reporting frequency preference setting, wherein the preference setting includes at least one URMC user activity upload rule;
   obtain reporting of the logged URMC event identifying information that is triggered in accordance with at least one URMC user activity upload rule; and
   provide an acknowledgment to the client upon obtaining said reporting.

849. A processor-implemented method, comprising:
identifying an unlicensed content item and uniquely resolving it within a universally resolvable media content (“URMC”) service;
obtaining aggregate URMC service user engagement metric associated with the uniquely resolved content item during a predefined period of time;
obtaining an aggregate URMC service user engagement metric associated with a plurality of URMC items during the predefined period of time;
evaluating the obtained aggregate URMC service user engagement metrics using at least one URMC license request threshold rule;
identifying a target for a license request for the uniquely resolved content item; and
sending the license request to the identified target.

850. The method of embodiment 849, further comprising:
obtaining, from the target, a license authorizing addition of the uniquely resolved content item to the URMC catalog.

851. The method of embodiment 850, further comprising:
obtaining lossless original media file;
licensing, encrypting and encoding the obtained media file; and
making the encoded content media file available to users of the URMC service.

852. The method of embodiment 851, wherein the encoding includes a standard quality encoding and a mobile quality encoding.

853. The method of embodiment 849, wherein the license request includes at least the uniquely resolved content identifying information and a request to add the content item to the URMC collection.

854. The method of embodiment 849, wherein the URMC service user engagement metric is track play count.

855. The method of embodiment 849, wherein the URMC service user engagement metric is at least one of: (i) share count; (ii) download count; (iii) rating; and (iv) comment count.

856. The method of embodiment 855, wherein the URMC service user engagement metric is associated with at least one of: (i) a track; (ii) a playlist; (iii) a smart playlist; (iv) a shared playlist; (v) a magic playlist; and (vi) a shared library.

857. The method of embodiment 849, wherein the at least one URMC license request threshold rule specifies a trigger for the license request when the aggregate URMC service user engagement metric associated with the uniquely resolved content item is greater than a percent threshold of the aggregate URMC service user engagement metric associated with the plurality of URMC content items.

858. The method of embodiment 849, wherein the at least one URMC license request threshold rule specifies a threshold for the aggregate URMC service user engagement metrics associated with the uniquely resolved content item.

859. The method of embodiment 849, wherein identifying the unlicensed content item and uniquely resolving it within the URMC service further comprises acoustically matching the content item with URMC items in a URMC catalog.

860. The method of embodiment 849, wherein identifying the unlicensed content item and uniquely resolving it within the URMC service further comprises querying a URMC metadata database using metadata associated with the content item.

861. The method of embodiment 849, further comprising:
obtaining metadata associated with the uniquely resolved content item; and
querying a URMC license database using the obtained metadata for availability of license.

862. The method of embodiment 849, wherein the target for the license request is identified based on at least one of an acoustical fingerprint and metadata associated with the uniquely resolved content item.

863. The method of embodiment 849, wherein the identified target is a rights clearing agency.

864. The method of embodiment 849, wherein the identified target is one of participating licensors of the URMC service.

865. A system, comprising:
a memory;
a processor disposed in communication with said memory, and configured to issue a plurality of processing instructions stored in the memory, wherein the processor issues instructions to:
   identify an unlicensed content item and uniquely resolving it within a universally resolvable media content (“URMC”) service;
   obtain aggregate URMC service user engagement metric associated with the uniquely resolved content item during a predefined period of time;
   obtain an aggregate URMC service user engagement metric associated with a plurality of URMC items during the predefined period of time;
   evaluate the obtained aggregate URMC service user engagement metrics using at least one URMC license request threshold rule;
   identify a target for a license request for the uniquely resolved content item; and
   send the license request to the identified target.

866. The system of embodiment 865, further comprising instructions to:
obtain, from the target, a license authorizing addition of the uniquely resolved content item to the URMC catalog.

867. The system of embodiment 866, further comprising instructions to:
obtain lossless original media file;
license, encrypting and encoding the obtained media file; and
make the encoded content media file available to users of the URMC service.

868. The system of embodiment 867, wherein the encoding includes a standard quality encoding and a mobile quality encoding.

869. The system of embodiment 865, wherein the license request includes at least the uniquely resolved content identifying information and a request to add the content item to the URMC collection.

870. The system of embodiment 865, wherein the URMC service user engagement metric is track play count.

871. The system of embodiment 865, wherein the URMC service user engagement metric is at least one of: (i) share count; (ii) download count; (iii) rating; and (iv) comment count.

872. The system of embodiment 871, wherein the URMC service user engagement metric is associated with at least one of: (i) a track; (ii) a playlist; (iii) a smart playlist; (iv) a shared playlist; (v) a magic playlist; and (vi) a shared library.

873. The system of embodiment 865, wherein the at least one URMC license request threshold rule specifies a trigger for the license request when the aggregate URMC service user engagement metric associated with the uniquely resolved content item is greater than a percent threshold of the aggregate URMC service user engagement metric associated with the plurality of URMC content items.

874. The system of embodiment 865, wherein the at least one URMC license request threshold rule specifies a threshold for the aggregate URMC service user engagement metrics associated with the uniquely resolved content item.

875. The system of embodiment 865, wherein identifying the unlicensed content item and uniquely resolving it within the URMC service further comprises acoustically matching the content item with URMC items in a URMC catalog.

876. The system of embodiment 865, wherein identifying the unlicensed content item and uniquely resolving it within the URMC service further comprises querying a URMC metadata database using metadata associated with the content item.

877. The system of embodiment 865, further comprising instructions to:
obtain metadata associated with the uniquely resolved content item; and
query a URMC license database using the obtained metadata for availability of license.

878. The system of embodiment 865, wherein the target for the license request is identified based on at least one of an acoustical fingerprint and metadata associated with the uniquely resolved content item.

879. The system of embodiment 865, wherein the identified target is a rights clearing agency.

880. The system of embodiment 865, wherein the identified target is one of participating licensors of the URMC service.

881. A processor-readable medium storing processor-issuable instructions, wherein the processor issues instructions to:
identify an unlicensed content item and uniquely resolving it within a universally resolvable media content (“URMC”) service;
obtain aggregate URMC service user engagement metric associated with the uniquely resolved content item during a predefined period of time;
obtain an aggregate URMC service user engagement metric associated with a plurality of URMC items during the predefined period of time;
evaluate the obtained aggregate URMC service user engagement metrics using at least one URMC license request threshold rule;
identify a target for a license request for the uniquely resolved content item; and
send the license request to the identified target.

882. The medium of embodiment 881, further comprising instructions to:
obtain, from the target, a license authorizing addition of the uniquely resolved content item to the URMC catalog.

883. The medium of embodiment 882, further comprising instructions to:
obtain lossless original media file;
license, encrypting and encoding the obtained media file; and
make the encoded content media file available to users of the URMC service.

884. The medium of embodiment 883, wherein the encoding includes a standard quality encoding and a mobile quality encoding.

885. The medium of embodiment 881, wherein the license request includes at least the uniquely resolved content identifying information and a request to add the content item to the URMC collection.

886. The medium of embodiment 881, wherein the URMC service user engagement metric is track play count.

887. The medium of embodiment 881, wherein the URMC service user engagement metric is at least one of: (i) share count; (ii) download count; (iii) rating; and (iv) comment count.

888. The medium of embodiment 887, wherein the URMC service user engagement metric is associated with at least one of: (i) a track; (ii) a playlist; (iii) a smart playlist; (iv) a shared playlist; (v) a magic playlist; and (vi) a shared library.

889. The medium of embodiment 881, wherein the at least one URMC license request threshold rule specifies a trigger for the license request when the aggregate URMC service user engagement metric associated with the uniquely resolved content item is greater than a percent threshold of the aggregate URMC service user engagement metric associated with the plurality of URMC content items.

890. The medium of embodiment 881, wherein the at least one URMC license request threshold rule specifies a threshold for the aggregate URMC service user engagement metrics associated with the uniquely resolved content item.

891. The medium of embodiment 881, wherein identifying the unlicensed content item and uniquely resolving it within the URMC service further comprises acoustically matching the content item with URMC items in a URMC catalog.

892. The medium of embodiment 881, wherein identifying the unlicensed content item and uniquely resolving it within the URMC service further comprises querying a URMC metadata database using metadata associated with the content item.

893. The medium of embodiment 881, further comprising instructions to:
obtain metadata associated with the uniquely resolved content item; and
query a URMC license database using the obtained metadata for availability of license.

894. The medium of embodiment 881, wherein the target for the license request is identified based on at least one of an acoustical fingerprint and metadata associated with the uniquely resolved content item.

895. The medium of embodiment 881, wherein the identified target is a rights clearing agency.

896. The medium of embodiment 881, wherein the identified target is one of participating licensors of the URMC service.

897. An apparatus, comprising:
a memory;
a processor disposed in communication with said memory, and configured to issue a plurality of processing instructions stored in the memory, wherein the processor issues instructions to:
   identify an unlicensed content item and uniquely resolving it within a universally resolvable media content (“URMC”) service;
   obtain aggregate URMC service user engagement metric associated with the uniquely resolved content item during a predefined period of time;
   obtain an aggregate URMC service user engagement metric associated with a plurality of URMC items during the predefined period of time;
   evaluate the obtained aggregate URMC service user engagement metrics using at least one URMC license request threshold rule;
   identify a target for a license request for the uniquely resolved content item; and
   send the license request to the identified target.

898. The apparatus of embodiment 897, further comprising instructions to:
obtain, from the target, a license authorizing addition of the uniquely resolved content item to the URMC catalog.

899. The apparatus of embodiment 898, further comprising instructions to:
obtain lossless original media file;
license, encrypting and encoding the obtained media file; and
make the encoded content media file available to users of the URMC service.

900. The apparatus of embodiment 899, wherein the encoding includes a standard quality encoding and a mobile quality encoding.

901. The apparatus of embodiment 897, wherein the license request includes at least the uniquely resolved content identifying information and a request to add the content item to the URMC collection.

902. The apparatus of embodiment 897, wherein the URMC service user engagement metric is track play count.

903. The apparatus of embodiment 897, wherein the URMC service user engagement metric is at least one of: (i) share count; (ii) download count; (iii) rating; and (iv) comment count.

904. The apparatus of embodiment 903, wherein the URMC service user engagement metric is associated with at least one of: (i) a track; (ii) a playlist; (iii) a smart playlist; (iv) a shared playlist; (v) a magic playlist; and (vi) a shared library.

905. The apparatus of embodiment 897, wherein the at least one URMC license request threshold rule specifies a trigger for the license request when the aggregate URMC service user engagement metric associated with the uniquely resolved content item is greater than a percent threshold of the aggregate URMC service user engagement metric associated with the plurality of URMC content items.

906. The apparatus of embodiment 897, wherein the at least one URMC license request threshold rule specifies a threshold for the aggregate URMC service user engagement metrics associated with the uniquely resolved content item.

907. The apparatus of embodiment 897, wherein identifying the unlicensed content item and uniquely resolving it within the URMC service further comprises acoustically matching the content item with URMC items in a URMC catalog.

908. The apparatus of embodiment 897, wherein identifying the unlicensed content item and uniquely resolving it within the URMC service further comprises querying a URMC metadata database using metadata associated with the content item.

909. The apparatus of embodiment 897, further comprising instructions to:
obtain metadata associated with the uniquely resolved content item; and
query a URMC license database using the obtained metadata for availability of license.

910. The apparatus of embodiment 897, wherein the target for the license request is identified based on at least one of an acoustical fingerprint and metadata associated with the uniquely resolved content item.

911. The apparatus of embodiment 897, wherein the identified target is a rights clearing agency.

912. The apparatus of embodiment 897, wherein the identified target is one of participating licensors of the URMC service.

913. A processor-implemented method, comprising:
providing an unlicensed content item for identification and uniquely resolving it within a universally resolvable media content (“URMC”) service;
providing an indication to obtain aggregate URMC service user engagement metric associated with the uniquely resolved content item during a predefined period of time;
providing an indication to obtain an aggregate URMC service user engagement metric associated with a plurality of URMC items during the predefined period of time;
obtaining an indication of an evaluation of the aggregate URMC service user engagement metrics using at least one URMC license request threshold rule;
obtaining an identification of a target for a license request for the uniquely resolved content item; and
obtaining an indication of sending the license request to the identified target.

914. A system, comprising:
a memory;
a processor disposed in communication with said memory, and configured to issue a plurality of processing instructions stored in the memory, wherein the processor issues instructions to:
   provide an unlicensed content item for identification and uniquely resolving it within a universally resolvable media content (“URMC”) service;
   provide an indication to obtain aggregate URMC service user engagement metric associated with the uniquely resolved content item during a predefined period of time;
   provide an indication to obtain an aggregate URMC service user engagement metric associated with a plurality of URMC items during the predefined period of time;
   obtain an indication of an evaluation of the aggregate URMC service user engagement metrics using at least one URMC license request threshold rule;
   obtain an identification of a target for a license request for the uniquely resolved content item; and
   obtain an indication of sending the license request to the identified target.

915. A processor-readable medium storing processor-issuable instructions, wherein the processor issues instructions to:
provide an unlicensed content item for identification and uniquely resolving it within a universally resolvable media content (“URMC”) service;
provide an indication to obtain aggregate URMC service user engagement metric associated with the uniquely resolved content item during a predefined period of time;
provide an indication to obtain an aggregate URMC service user engagement metric associated with a plurality of URMC items during the predefined period of time;
obtain an indication of an evaluation of the aggregate URMC service user engagement metrics using at least one URMC license request threshold rule;
obtain an identification of a target for a license request for the uniquely resolved content item; and
obtain an indication of sending the license request to the identified target.

916. An apparatus, comprising:
a memory;
a processor disposed in communication with said memory, and configured to issue a plurality of processing instructions stored in the memory, wherein the processor issues instructions to:
   provide an unlicensed content item for identification and uniquely resolving it within a universally resolvable media content (“URMC”) service;
   provide an indication to obtain aggregate URMC service user engagement metric associated with the uniquely resolved content item during a predefined period of time;
   provide an indication to obtain an aggregate URMC service user engagement metric associated with a plurality of URMC items during the predefined period of time;
   obtain an indication of an evaluation of the aggregate URMC service user engagement metrics using at least one URMC license request threshold rule;
   obtain an identification of a target for a license request for the uniquely resolved content item; and
   obtain an indication of sending the license request to the identified target.

917. A processor-implemented method, comprising:
detecting a plurality of universally resolvable media content (“URMC”) events initiated at a client;
obtaining URMC event identifying information for each detected URMC event;
determining if each detected URMC event is reportable based on the URMC event identifying information;
determining a reporting category for each reportable URMC event based on the URMC event identifying information;
recording each reportable URMC event and the associated reporting category in an event log in the client; and
initiating reporting of the logged URMC event identifying information.

918. The method of embodiment 917, further comprising:
obtaining reporting frequency preference setting, wherein the preference setting includes at least one URMC event reporting rule; and
initiating reporting of the logged URMC event identifying information based on the obtained reporting frequency preference setting.

919. The method of embodiment 918, further comprising updating the client upon successful acknowledgement of said reporting by a server.

920. The method of embodiment 917, wherein reportable events include at least one of: (i) play session time; (ii) playlist feature use; (iii) importing; (iv) sharing; (v) community; (vi) search; (vii) website; (viii) client; (ix) email; (x) marketing; (xi) user; and (xii) license and device.

921. The method of embodiment 920, wherein each reportable event is associated with a URMC service user identifier and a date and time stamp.

922. The method of embodiment 921, wherein determining if each detected URMC event is reportable based on the URMC event identifying information.

923. A system, comprising:
a memory;
a processor disposed in communication with said memory, and configured to issue a plurality of processing instructions stored in the memory, wherein the processor issues instructions to:
   detect a plurality of universally resolvable media content (“URMC”) events initiated at a client;
   obtain URMC event identifying information for each detected URMC event;
   determine if each detected URMC event is reportable based on the URMC event identifying information;
   determine a reporting category for each reportable URMC event based on the URMC event identifying information;
   record each reportable URMC event and the associated reporting category in an event log in the client; and
   initiate reporting of the logged URMC event identifying information.

924. The system of embodiment 923, further comprising:
obtain reporting frequency preference setting, wherein the preference setting includes at least one URMC event reporting rule; and
initiate reporting of the logged URMC event identifying information based on the obtained reporting frequency preference setting.

925. The system of embodiment 924, further comprising updating the client upon successful acknowledgement of said reporting by a server.

926. The system of embodiment 923, wherein reportable events include at least one of: (i) play session time; (ii) playlist feature use; (iii) importing; (iv) sharing; (v) community; (vi) search; (vii) website; (viii) client; (ix) email; (x) marketing; (xi) user; and (xii) license and device.

927. The system of embodiment 926, wherein each reportable event is associated with a URMC service user identifier and a date and time stamp.

928. The system of embodiment 927, wherein determining if each detected URMC event is reportable based on the URMC event identifying information.

929. A processor-readable medium storing processor-issuable instructions, wherein the processor issues instructions to:
detect a plurality of universally resolvable media content (“URMC”) events initiated at a client;
obtain URMC event identifying information for each detected URMC event;
determine if each detected URMC event is reportable based on the URMC event identifying information;
determine a reporting category for each reportable URMC event based on the URMC event identifying information;
record each reportable URMC event and the associated reporting category in an event log in the client; and
initiate reporting of the logged URMC event identifying information.

930. The medium of embodiment 929, further comprising:
obtain reporting frequency preference setting, wherein the preference setting includes at least one URMC event reporting rule; and
initiate reporting of the logged URMC event identifying information based on the obtained reporting frequency preference setting.

931. The medium of embodiment 930, further comprising updating the client upon successful acknowledgement of said reporting by a server.

932. The medium of embodiment 929, wherein reportable events include at least one of: (i) play session time; (ii) playlist feature use; (iii) importing; (iv) sharing; (v) community; (vi) search; (vii) website; (viii) client; (ix) email; (x) marketing; (xi) user; and (xii) license and device.

933. The medium of embodiment 932, wherein each reportable event is associated with a URMC service user identifier and a date and time stamp.

934. The medium of embodiment 933, wherein determining if each detected URMC event is reportable based on the URMC event identifying information.

935. An apparatus, comprising:
a memory;
a processor disposed in communication with said memory, and configured to issue a plurality of processing instructions stored in the memory, wherein the processor issues instructions to:
   detect a plurality of universally resolvable media content (“URMC”) events initiated at a client;
   obtain URMC event identifying information for each detected URMC event;
   determine if each detected URMC event is reportable based on the URMC event identifying information;
   determine a reporting category for each reportable URMC event based on the URMC event identifying information;
   record each reportable URMC event and the associated reporting category in an event log in the client; and
   initiate reporting of the logged URMC event identifying information.

936. The apparatus of embodiment 935, further comprising:
obtain reporting frequency preference setting, wherein the preference setting includes at least one URMC event reporting rule; and
initiate reporting of the logged URMC event identifying information based on the obtained reporting frequency preference setting.

937. The apparatus of embodiment 936, further comprising updating the client upon successful acknowledgement of said reporting by a server.

938. The apparatus of embodiment 935, wherein reportable events include at least one of: (i) play session time; (ii) playlist feature use; (iii) importing; (iv) sharing; (v) community; (vi) search; (vii) website; (viii) client; (ix) email; (x) marketing; (xi) user; and (xii) license and device.

939. The apparatus of embodiment 938, wherein each reportable event is associated with a URMC service user identifier and a date and time stamp.

940. The apparatus of embodiment 939, wherein determining if each detected URMC event is reportable based on the URMC event identifying information.

941. A processor-implemented method, comprising:
providing a request to detect a plurality of universally resolvable media content (“URMC”) events initiated at a client;
providing URMC event identifying information for each detected URMC event;
providing a request to determine if each detected URMC event is reportable based on the URMC event identifying information;
providing a request to determine a reporting category for each reportable URMC event based on the URMC event identifying information;
providing a request to record each reportable URMC event and the associated reporting category in an event log in the client; and
providing a request to initiate reporting of the logged URMC event identifying information.

942. A system, comprising:
a memory;
a processor disposed in communication with said memory, and configured to issue a plurality of processing instructions stored in the memory, wherein the processor issues instructions to:
   provide a request to detect a plurality of universally resolvable media content (“URMC”) events initiated at a client;
   provide URMC event identifying information for each detected URMC event;
   provide a request to determine if each detected URMC event is reportable based on the URMC event identifying information;
   provide a request to determine a reporting category for each reportable URMC event based on the URMC event identifying information;
   provide a request to record each reportable URMC event and the associated reporting category in an event log in the client; and
   provide a request to initiate reporting of the logged URMC event identifying information.

943. A processor-readable medium storing processor-issuable instructions, wherein the processor issues instructions to:
provide a request to detect a plurality of universally resolvable media content (“URMC”) events initiated at a client;
provide URMC event identifying information for each detected URMC event;
provide a request to determine if each detected URMC event is reportable based on the URMC event identifying information;
provide a request to determine a reporting category for each reportable URMC event based on the URMC event identifying information;
provide a request to record each reportable URMC event and the associated reporting category in an event log in the client; and
provide a request to initiate reporting of the logged URMC event identifying information.

944. An apparatus, comprising:
a memory;
a processor disposed in communication with said memory, and configured to issue a plurality of processing instructions stored in the memory, wherein the processor issues instructions to:
   provide a request to detect a plurality of universally resolvable media content (“URMC”) events initiated at a client;
   provide URMC event identifying information for each detected URMC event;
   provide a request to determine if each detected URMC event is reportable based on the URMC event identifying information;
   provide a request to determine a reporting category for each reportable URMC event based on the URMC event identifying information;
   provide a request to record each reportable URMC event and the associated reporting category in an event log in the client; and
   provide a request to initiate reporting of the logged URMC event identifying information.

945. A processor-implemented method, comprising:
receiving from a requestor a payment request for usage of a universally resolvable media content (“URMC”) item;
querying a URMC usage database to obtain the URMC item usage metric;
determining, based on URMC usage payment obligation rules associated with the requestor and the URMC item usage metric, a payment amount owed for usage of the URMC item; and
providing the determined payment amount to the requestor.

946. The method of embodiment 945, wherein the URMC usage payment obligation rules specify royalty rate for a unit of the usage metric.

947. The method of embodiment 946, wherein the royalty rate is specific to a geography.

948. The method of embodiment 945, wherein the payment amount is device license fees based on prorated share of the URMC item usage.

949. The method of embodiment 945, wherein the request specifies at least one criterion for selecting the URMC item.

950. The method of embodiment 945, further comprising querying a URMC reporting database using the specified criterion to obtain the URMC item.

951. The method of embodiment 945, wherein the URMC usage metric is play count.

952. The method of embodiment 945, wherein the URMC usage metric is number of license activations.

953. A system, comprising:
a memory;
a processor disposed in communication with said memory, and configured to issue a plurality of processing instructions stored in the memory, wherein the processor issues instructions to:
   receive from a requestor a payment request for usage of a universally resolvable media content (“URMC”) item;
   query a URMC usage database to obtain the URMC item usage metric;
   determine, based on URMC usage payment obligation rules associated with the requestor and the URMC item usage metric, a payment amount owed for usage of the URMC item; and
   provide the determined payment amount to the requestor.

954. The system of embodiment 953, wherein the URMC usage payment obligation rules specify royalty rate for a unit of the usage metric.

955. The system of embodiment 954, wherein the royalty rate is specific to a geography.

956. The system of embodiment 953, wherein the payment amount is device license fees based on prorated share of the URMC item usage.

957. The system of embodiment 953, wherein the request specifies at least one criterion for selecting the URMC item.

958. The system of embodiment 953, further comprising instructions to query a URMC reporting database using the specified criterion to obtain the URMC item.

959. The system of embodiment 953, wherein the URMC usage metric is play count.

960. The system of embodiment 953, wherein the URMC usage metric is number of license activations.

961. A processor-readable medium storing processor-issuable instructions, wherein the processor issues instructions to:
receive from a requestor a payment request for usage of a universally resolvable media content (“URMC”) item;
query a URMC usage database to obtain the URMC item usage metric;
determine, based on URMC usage payment obligation rules associated with the requestor and the URMC item usage metric, a payment amount owed for usage of the URMC item; and
provide the determined payment amount to the requestor.

962. The medium of embodiment 961, wherein the URMC usage payment obligation rules specify royalty rate for a unit of the usage metric.

963. The medium of embodiment 962, wherein the royalty rate is specific to a geography.

964. The medium of embodiment 961, wherein the payment amount is device license fees based on prorated share of the URMC item usage.

965. The medium of embodiment 961, wherein the request specifies at least one criterion for selecting the URMC item.

966. The medium of embodiment 961, further comprising instructions to query a URMC reporting database using the specified criterion to obtain the URMC item.

967. The medium of embodiment 961, wherein the URMC usage metric is play count.

968. The medium of embodiment 961, wherein the URMC usage metric is number of license activations.

969. An apparatus, comprising:
a memory;
a processor disposed in communication with said memory, and configured to issue a plurality of processing instructions stored in the memory, wherein the processor issues instructions to:
   receive from a requestor a payment request for usage of a universally resolvable media content (“URMC”) item;
   query a URMC usage database to obtain the URMC item usage metric;
   determine, based on URMC usage payment obligation rules associated with the requestor and the URMC item usage metric, a payment amount owed for usage of the URMC item; and
   provide the determined payment amount to the requestor.

970. The apparatus of embodiment 969, wherein the URMC usage payment obligation rules specify royalty rate for a unit of the usage metric.

971. The apparatus of embodiment 970, wherein the royalty rate is specific to a geography.

972. The apparatus of embodiment 969, wherein the payment amount is device license fees based on prorated share of the URMC item usage.

973. The apparatus of embodiment 969, wherein the request specifies at least one criterion for selecting the URMC item.

974. The apparatus of embodiment 969, further comprising instructions to query a URMC reporting database using the specified criterion to obtain the URMC item.

975. The apparatus of embodiment 969, wherein the URMC usage metric is play count.

976. The apparatus of embodiment 969, wherein the URMC usage metric is number of license activations.

977. A processor-implemented method, comprising:
providing from a requestor a payment request for usage of a universally resolvable media content (“URMC”) item;
providing a request to query a URMC usage database to obtain the URMC item usage metric;
providing a request to determine, based on URMC usage payment obligation rules associated with the requestor and the URMC item usage metric, a payment amount owed for usage of the URMC item; and
obtaining the determined payment amount to the requestor.

978. A system, comprising:
a memory;
a processor disposed in communication with said memory, and configured to issue a plurality of processing instructions stored in the memory, wherein the processor issues instructions to:
   provide from a requestor a payment request for usage of a universally resolvable media content (“URMC”) item;
   provide a request to query a URMC usage database to obtain the URMC item usage metric;
   provide a request to determine, based on URMC usage payment obligation rules associated with the requestor and the URMC item usage metric, a payment amount owed for usage of the URMC item; and
   obtain the determined payment amount to the requestor.

979. A processor-readable medium storing processor-issuable instructions, wherein the processor issues instructions to:
provide from a requestor a payment request for usage of a universally resolvable media content (“URMC”) item;
provide a request to query a URMC usage database to obtain the URMC item usage metric;
provide a request to determine, based on URMC usage payment obligation rules associated with the requestor and the URMC item usage metric, a payment amount owed for usage of the URMC item; and
obtain the determined payment amount to the requestor.

980. An apparatus, comprising:
a memory;
a processor disposed in communication with said memory, and configured to issue a plurality of processing instructions stored in the memory, wherein the processor issues instructions to:
   provide from a requestor a payment request for usage of a universally resolvable media content (“URMC”) item;
   provide a request to query a URMC usage database to obtain the URMC item usage metric;
   provide a request to determine, based on URMC usage payment obligation rules associated with the requestor and the URMC item usage metric, a payment amount owed for usage of the URMC item; and
   obtain the determined payment amount to the requestor.

981. A processor-implemented method, comprising:
obtaining from a user of a universally resolvable media content (“URMC”) service a request to purchase an unlocked URMC item;
obtaining the user's social influence metric in the service;
obtaining a purchase price associated with the URMC content item;
determining, based on the user's social influence metric, a discount;
providing the user an option to purchase the URMC content item at a purchase price reduced by the discount;
receiving from the user an indication and an authorization to purchase the URMC item;
charging an account associated with the user the purchase price reduced by the discount; and
providing the user a mechanism for unlocking the URMC item.

982. The method of embodiment 981, wherein the unlocking mechanism is a digital rights management (DRM) free version of the URMC item provided to the client.

983. The method of embodiment 981, wherein the unlocking mechanism is a decryption key configured to unlock the URMC item by the user's client software.

984. The method of embodiment 981, wherein the unlocked URMC item has no rights management restrictions.

985. The method of embodiment 981, wherein the unlocked URMC item has no encryption

986. The method of embodiment 981, wherein the social influence metric is a number of points associated with a social activity.

987. The method of embodiment 986, wherein the discount is triggered when the number of social activity points associated with the user exceeds a threshold.

988. A system, comprising:
a memory;
a processor disposed in communication with said memory, and configured to issue a plurality of processing instructions stored in the memory, wherein the processor issues instructions to:
   obtain from a user of a universally resolvable media content (“URMC”) service a request to purchase an unlocked URMC item;
   obtain the user's social influence metric in the service;
   obtain a purchase price associated with the URMC content item;
   determine, based on the user's social influence metric, a discount;
   provide the user an option to purchase the URMC content item at a purchase price reduced by the discount;
   receive from the user an indication and an authorization to purchase the URMC item;
   charge an account associated with the user the purchase price reduced by the discount; and
   provide the user a mechanism for unlocking the URMC item.

989. The system of embodiment 988, wherein the unlocking mechanism is a digital rights management (DRM) free version of the URMC item provided to the client.

990. The system of embodiment 988, wherein the unlocking mechanism is a decryption key configured to unlock the URMC item by the user's client software.

991. The system of embodiment 988, wherein the unlocked URMC item has no rights management restrictions.

992. The system of embodiment 988, wherein the unlocked URMC item has no encryption

993. The system of embodiment 988, wherein the social influence metric is a number of points associated with a social activity.

994. The system of embodiment 993, wherein the discount is triggered when the number of social activity points associated with the user exceeds a threshold.

955. A processor-readable medium storing processor-issuable instructions, wherein the processor issues instructions to:
obtain from a user of a universally resolvable media content (“URMC”) service a request to purchase an unlocked URMC item;
obtain the user's social influence metric in the service;
obtain a purchase price associated with the URMC content item;
determine, based on the user's social influence metric, a discount;
provide the user an option to purchase the URMC content item at a purchase price reduced by the discount;
receive from the user an indication and an authorization to purchase the URMC item;
charge an account associated with the user the purchase price reduced by the discount; and
provide the user a mechanism for unlocking the URMC item.

996. The medium of embodiment 995, wherein the unlocking mechanism is a digital rights management (DRM) free version of the URMC item provided to the client.

997. The medium of embodiment 995, wherein the unlocking mechanism is a decryption key configured to unlock the URMC item by the user's client software.

998. The medium of embodiment 995, wherein the unlocked URMC item has no rights management restrictions.

999. The medium of embodiment 995, wherein the unlocked URMC item has no encryption

1000. The medium of embodiment 995, wherein the social influence metric is a number of points associated with a social activity.

1001. The medium of embodiment 1000, wherein the discount is triggered when the number of social activity points associated with the user exceeds a threshold.

1002. An apparatus, comprising:
a memory;
a processor disposed in communication with said memory, and configured to issue a plurality of processing instructions stored in the memory, wherein the processor issues instructions to:
   obtain from a user of a universally resolvable media content (“URMC”) service a request to purchase an unlocked URMC item;
   obtain the user's social influence metric in the service;
   obtain a purchase price associated with the URMC content item;
   determine, based on the user's social influence metric, a discount;
   provide the user an option to purchase the URMC content item at a purchase price reduced by the discount;
   receive from the user an indication and an authorization to purchase the URMC item;
   charge an account associated with the user the purchase price reduced by the discount; and
   provide the user a mechanism for unlocking the URMC item.

1003. The apparatus of embodiment 1002, wherein the unlocking mechanism is a digital rights management (DRM) free version of the URMC item provided to the client.

1004. The apparatus of embodiment 1002, wherein the unlocking mechanism is a decryption key configured to unlock the URMC item by the user's client software.

1005. The apparatus of embodiment 1002, wherein the unlocked URMC item has no rights management restrictions.

1006. The apparatus of embodiment 1002, wherein the unlocked URMC item has no encryption

1007. The apparatus of embodiment 1002, wherein the social influence metric is a number of points associated with a social activity.

1008. The apparatus of embodiment 1007, wherein the discount is triggered when the number of social activity points associated with the user exceeds a threshold.

1009. A processor-implemented method, comprising:
obtaining a request to purchase an encryption free universally resolvable media content (“URMC”) item from a user of the URMC service;
obtaining a purchase price associated with the content item;
determining whether the user meets a discount criteria for purchasing the encryption free content item;
calculating, based on the determining, a discounted purchase price;
providing the user an option to purchase the encryption free content item at the discounted purchase price;
receiving from the user an indication and an authorization to purchase the encryption free content item;
charging an account associated with the user the discounted purchase price; and
providing the user the encryption free content item.

1010. The method of embodiment 1009, wherein the discount criteria includes reaching a threshold number of points via influencing activity.

1011. The method of embodiment 1009, wherein the discount criteria includes having the content item in a playlist created by the user.

1012. The method of embodiment 1011, wherein the purchase price is progressively discounted by an amount for every degree of separation users that add the content.

1013. The method of embodiment 1009, wherein the discount criteria includes reaching a threshold number of plays of the content item discovered via the user's playlist or library.

1014. The method of embodiment 1009, wherein the discount criteria includes reaching a threshold number of users playing the content item discovered via the user's playlist or library.

1015. The method of embodiment 1009, wherein the discount criteria includes reaching a threshold number of encryption free purchases of content item.

1016. A system, comprising:
a memory;
a processor disposed in communication with said memory, and configured to issue a plurality of processing instructions stored in the memory, wherein the processor issues instructions to:
   obtain a request to purchase an encryption free universally resolvable media content (“URMC”) item from a user of the URMC service;
   obtain a purchase price associated with the content item;
   determine whether the user meets a discount criteria for purchasing the encryption free content item;
   calculate, based on the determining, a discounted purchase price;
   provide the user an option to purchase the encryption free content item at the discounted purchase price;
   receive from the user an indication and an authorization to purchase the encryption free content item;
   charge an account associated with the user the discounted purchase price; and
   provide the user the encryption free content item.

1017. The system of embodiment 1016, wherein the discount criteria includes reaching a threshold number of points via influencing activity.

1018. The system of embodiment 1016, wherein the discount criteria includes having the content item in a playlist created by the user.

1019. The system of embodiment 1018, wherein the purchase price is progressively discounted by an amount for every degree of separation users that add the content.

1020. The system of embodiment 1016, wherein the discount criteria includes reaching a threshold number of plays of the content item discovered via the user's playlist or library.

1021. The system of embodiment 1016, wherein the discount criteria includes reaching a threshold number of users playing the content item discovered via the user's playlist or library.

1022. The system of embodiment 1016, wherein the discount criteria includes reaching a threshold number of encryption free purchases of content item.

1023. A processor-readable medium storing processor-issuable instructions, wherein the processor issues instructions to:
obtain a request to purchase an encryption free universally resolvable media content (“URMC”) item from a user of the URMC service;
obtain a purchase price associated with the content item;
determine whether the user meets a discount criteria for purchasing the encryption free content item;
calculate, based on the determining, a discounted purchase price;
provide the user an option to purchase the encryption free content item at the discounted purchase price;
receive from the user an indication and an authorization to purchase the encryption free content item;
charge an account associated with the user the discounted purchase price; and
provide the user the encryption free content item.

1024. The medium of embodiment 1023, wherein the discount criteria includes reaching a threshold number of points via influencing activity.

1025. The medium of embodiment 1023, wherein the discount criteria includes having the content item in a playlist created by the user.

1026. The medium of embodiment 1025, wherein the purchase price is progressively discounted by an amount for every degree of separation users that add the content.

1027. The medium of embodiment 1023, wherein the discount criteria includes reaching a threshold number of plays of the content item discovered via the user's playlist or library.

1028. The medium of embodiment 1023, wherein the discount criteria includes reaching a threshold number of users playing the content item discovered via the user's playlist or library.

1029. The medium of embodiment 1023, wherein the discount criteria includes reaching a threshold number of encryption free purchases of content item.

1030. An apparatus, comprising:
a memory;
a processor disposed in communication with said memory, and configured to issue a plurality of processing instructions stored in the memory, wherein the processor issues instructions to:
   obtain a request to purchase an encryption free universally resolvable media content (“URMC”) item from a user of the URMC service;
   obtain a purchase price associated with the content item;
   determine whether the user meets a discount criteria for purchasing the encryption free content item;
   calculate, based on the determining, a discounted purchase price;
   provide the user an option to purchase the encryption free content item at the discounted purchase price;
   receive from the user an indication and an authorization to purchase the encryption free content item;
   charge an account associated with the user the discounted purchase price; and
   provide the user the encryption free content item.

1031. The apparatus of embodiment 1030, wherein the discount criteria includes reaching a threshold number of points via influencing activity.

1032. The apparatus of embodiment 1030, wherein the discount criteria includes having the content item in a playlist created by the user.

1033. The apparatus of embodiment 1032, wherein the purchase price is progressively discounted by an amount for every degree of separation users that add the content.

1034. The apparatus of embodiment 1030, wherein the discount criteria includes reaching a threshold number of plays of the content item discovered via the user's playlist or library.

1035. The apparatus of embodiment 1030, wherein the discount criteria includes reaching a threshold number of users playing the content item discovered via the user's playlist or library.

1036. The apparatus of embodiment 1030, wherein the discount criteria includes reaching a threshold number of encryption free purchases of content item.

1037. A processor-implemented method, comprising:
obtaining from a user of a universally resolvable media content (“URMC”) service a request to purchase an unlocked URMC item;
obtaining a purchase price associated with the URMC item;
providing the user an option to purchase the URMC item at a purchase price;
receiving from the user an indication and an authorization to purchase the URMC item;
charging an account associated with the user the purchase price; and
providing the user a mechanism for unlocking the URMC item.

1038. A system, comprising:
a memory;
a processor disposed in communication with said memory, and configured to issue a plurality of processing instructions stored in the memory, wherein the processor issues instructions to:
   obtain from a user of a universally resolvable media content (“URMC”) service a request to purchase an unlocked URMC item;
   obtain a purchase price associated with the URMC item;
   provide the user an option to purchase the URMC item at a purchase price;
   receive from the user an indication and an authorization to purchase the URMC item;
   charge an account associated with the user the purchase price; and
   provide the user a mechanism for unlocking the URMC item.

1039. A processor-readable medium storing processor-issuable instructions, wherein the processor issues instructions to:
obtain from a user of a universally resolvable media content (“URMC”) service a request to purchase an unlocked URMC item;
obtain a purchase price associated with the URMC item;
provide the user an option to purchase the URMC item at a purchase price;
receive from the user an indication and an authorization to purchase the URMC item;
charge an account associated with the user the purchase price; and
provide the user a mechanism for unlocking the URMC item.

1040. An apparatus, comprising:
a memory;
a processor disposed in communication with said memory, and configured to issue a plurality of processing instructions stored in the memory, wherein the processor issues instructions to:
   obtain from a user of a universally resolvable media content (“URMC”) service a request to purchase an unlocked URMC item;
   obtain a purchase price associated with the URMC item;
   provide the user an option to purchase the URMC item at a purchase price;
   receive from the user an indication and an authorization to purchase the URMC item;
   charge an account associated with the user the purchase price; and
   provide the user a mechanism for unlocking the URMC item.

1041. A processor implemented method comprising:
detecting a request to engage a universally resolvable media content (“URMC”) item;
obtaining an expiration date for a URMC license token associated with the URMC item;
determining, based on the obtained expiration date, whether the license token is expired;
discarding a license key associated with the expired license token;
denying the request to engage the URMC item with the associated expired license token;
providing a request for an updated token and requisite credentials for the updated token;
obtaining a response including an updated token; and
engaging the requested URMC item with an associated valid updated token.

1042. The method of embodiment 1041, wherein the response includes a user node identifier and at least one subscription node identifier.

1043. The method of embodiment 1042, wherein the response includes the user node to the at least one subscription node link.

1044. The method of embodiment 1043, wherein the subscription node specifies a territory where a user's device is licensed for use.

1045. The method of embodiment 1043, wherein the subscription node specifies a territory where the URMC item is licensed for use.

1046. The method of embodiment 1041, wherein the response includes a user to device link having an associated expiration date.

1047. The method of embodiment 1043, further comprising retrieving a key for territory specified by the subscription node for decrypting encryption for engaging the URMC item.

1048. A system, comprising:
a memory;
a processor disposed in communication with said memory, and configured to issue a plurality of processing instructions stored in the memory, wherein the processor issues instructions to:
   detect a request to engage a universally resolvable media content (“URMC”) item;
   obtain an expiration date for a URMC license token associated with the URMC item;
   determine, based on the obtained expiration date, whether the license token is expired;
   discard a license key associated with the expired license token;
   deny the request to engage the URMC item with the associated expired license token;
   provide a request for an updated token and requisite credentials for the updated token;
   obtain a response including an updated token; and
   engage the requested URMC item with an associated valid updated token.

1049. The system of embodiment 1048, wherein the response includes a user node identifier and at least one subscription node identifier.

1050. The system of embodiment 1049, wherein the response includes the user node to the at least one subscription node link.

1051. The system of embodiment 1050, wherein the subscription node specifies a territory where a user's device is licensed for use.

1052. The system of embodiment 1050, wherein the subscription node specifies a territory where the URMC item is licensed for use.

1053. The system of embodiment 1048, wherein the response includes a user to device link having an associated expiration date.

1054. The system of embodiment 1050, further comprising instructions to retrieve a key for territory specified by the subscription node for decrypting encryption for engaging the URMC item.

1055. A processor-readable medium storing processor-issuable instructions, wherein the processor issues instructions to:
detect a request to engage a universally resolvable media content (“URMC”) item;
obtain an expiration date for a URMC license token associated with the URMC item;
determine, based on the obtained expiration date, whether the license token is expired;
discard a license key associated with the expired license token;
deny the request to engage the URMC item with the associated expired license token;
provide a request for an updated token and requisite credentials for the updated token;
obtain a response including an updated token; and
engage the requested URMC item with an associated valid updated token.

1056. The medium of embodiment 1055, wherein the response includes a user node identifier and at least one subscription node identifier.

1057. The medium of embodiment 1056, wherein the response includes the user node to the at least one subscription node link.

1058. The medium of embodiment 1057, wherein the subscription node specifies a territory where a user's device is licensed for use.

1059. The medium of embodiment 1057, wherein the subscription node specifies a territory where the URMC item is licensed for use.

1060. The medium of embodiment 1055, wherein the response includes a user to device link having an associated expiration date.

1061. The medium of embodiment 1057, further comprising instructions to retrieve a key for territory specified by the subscription node for decrypting encryption for engaging the URMC item.

1062. An apparatus, comprising:
a memory;
a processor disposed in communication with said memory, and configured to issue a plurality of processing instructions stored in the memory, wherein the processor issues instructions to:
   detect a request to engage a universally resolvable media content (“URMC”) item;
   obtain an expiration date for a URMC license token associated with the URMC item;
   determine, based on the obtained expiration date, whether the license token is expired;
   discard a license key associated with the expired license token;
   deny the request to engage the URMC item with the associated expired license token;
   provide a request for an updated token and requisite credentials for the updated token;
   obtain a response including an updated token; and
   engage the requested URMC item with an associated valid updated token.

1063. The apparatus of embodiment 1062, wherein the response includes a user node identifier and at least one subscription node identifier.

1064. The apparatus of embodiment 1063, wherein the response includes the user node to the at least one subscription node link.

1065. The apparatus of embodiment 1064, wherein the subscription node specifies a territory where a user's device is licensed for use.

1066. The apparatus of embodiment 1064, wherein the subscription node specifies a territory where the URMC item is licensed for use.

1067. The apparatus of embodiment 1062, wherein the response includes a user to device link having an associated expiration date.

1068. The apparatus of embodiment 1064, further comprising instructions to retrieve a key for territory specified by the subscription node for decrypting encryption for engaging the URMC item.

1069. A processor-implemented method, comprising:
obtaining a request for a license token for decrypting a universally resolvable media content (“URMC”) item for a user of the URMC service;
determining whether an issued link between the user and at least one device associated with the request is valid;
obtaining confirmation of at least one instance of content usage reporting for the issued link from the device;
determining, based on the valid issued link and the obtained confirmation, an expiration date for a new link;
generating and sending the requested license token for the new link to the device; and
issuing and sending the new link to the device.

1070. A system, comprising:
a memory;
a processor disposed in communication with said memory, and configured to issue a plurality of processing instructions stored in the memory, wherein the processor issues instructions to:
   obtain a request for a license token for decrypting a universally resolvable media content (“URMC”) item for a user of the URMC service;
   determine whether an issued link between the user and at least one device associated with the request is valid;
   obtain confirmation of at least one instance of content usage reporting for the issued link from the device;
   determine, based on the valid issued link and the obtained confirmation, an expiration date for a new link;
   generate and send the requested license token for the new link to the device; and
   issue and send the new link to the device.

1071. A processor-readable medium storing processor-issuable instructions, wherein the processor issues instructions to:
obtain a request for a license token for decrypting a universally resolvable media content (“URMC”) item for a user of the URMC service;
determine whether an issued link between the user and at least one device associated with the request is valid;
obtain confirmation of at least one instance of content usage reporting for the issued link from the device;
determine, based on the valid issued link and the obtained confirmation, an expiration date for a new link;
generate and send the requested license token for the new link to the device; and
issue and send the new link to the device.

1072. An apparatus, comprising:
a memory;
a processor disposed in communication with said memory, and configured to issue a plurality of processing instructions stored in the memory, wherein the processor issues instructions to:
   obtain a request for a license token for decrypting a universally resolvable media content (“URMC”) item for a user of the URMC service;
   determine whether an issued link between the user and at least one device associated with the request is valid;
   obtain confirmation of at least one instance of content usage reporting for the issued link from the device;
   determine, based on the valid issued link and the obtained confirmation, an expiration date for a new link;
   generate and send the requested license token for the new link to the device; and
   issue and send the new link to the device.

In order to address various issues and advance the art, the entirety of this application for ENCRYPTION-FREE CONTENT PURCHASE PLATFORM APPARATUSES, METHODS AND SYSTEMS (including the Cover Page, Title, Headings, Field, Background, Summary, Brief Description of the Drawings, Detailed Description, Claims, Abstract, FIGUREs, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a ECPP individual and/or enterprise user, database configuration and/or relational model, data type, data transmission and/or network framework, syntax structure, and/or the like, various embodiments of the ECPP, may be implemented that enable a great deal of flexibility and customization. For example, aspects of the ECPP may be adapted for p2p music discovery and delivery platform. While various embodiments and discussions of the ECPP have been directed to multimedia applications, however, it is to be understood that the embodiments described herein may be readily configured and/or customized for a wide variety of other applications and/or implementations.

What is claimed is:

1. A processor-implemented method, comprising:
obtaining from a user of a universally resolvable media content (“URMC”) service a request to purchase an unlocked URMC item;
obtaining the user's social influence metric in the service;
obtaining a purchase price associated with the URMC content item;
determining, based on the user's social influence metric, a discount;
providing the user an option to purchase the URMC content item at a purchase price reduced by the discount;
receiving from the user an indication and an authorization to purchase the URMC item;
charging an account associated with the user the purchase price reduced by the discount; and
providing the user a mechanism for unlocking the URMC item.

2. The method of claim 1, wherein the unlocking mechanism is a digital rights management (DRM) free version of the URMC item provided to the client.

3. The method of claim 1, wherein the unlocking mechanism is a decryption key configured to unlock the URMC item by the user's client software.

4. The method of claim 1, wherein the unlocked URMC item has no rights management restrictions.

5. The method of claim 1, wherein the unlocked URMC item has no encryption

6. The method of claim 1, wherein the social influence metric is a number of points associated with a social activity.

7. The method of claim 6, wherein the discount is triggered when the number of social activity points associated with the user exceeds a threshold.

8. A system, comprising:
a memory;
a processor disposed in communication with said memory, and configured to issue a plurality of processing instructions stored in the memory, wherein the processor issues instructions to:
obtain from a user of a universally resolvable media content (“URMC”) service a request to purchase an unlocked URMC item;
obtain the user's social influence metric in the service;
obtain a purchase price associated with the URMC content item;
determine, based on the user's social influence metric, a discount;
provide the user an option to purchase the URMC content item at a purchase price reduced by the discount;
receive from the user an indication and an authorization to purchase the URMC item;
charge an account associated with the user the purchase price reduced by the discount; and
provide the user a mechanism for unlocking the URMC item.

9. The system of claim 8, wherein the unlocking mechanism is a digital rights management (DRM) free version of the URMC item provided to the client.

10. The system of claim 8, wherein the unlocking mechanism is a decryption key configured to unlock the URMC item by the user's client software.

11. The system of claim 8, wherein the unlocked URMC item has no rights management restrictions.

12. The system of claim 8, wherein the unlocked URMC item has no encryption

13. The system of claim 8, wherein the social influence metric is a number of points associated with a social activity.

14. The system of claim 13, wherein the discount is triggered when the number of social activity points associated with the user exceeds a threshold.

15. A processor-readable medium storing processor-issuable instructions, wherein the processor issues instructions to:
obtain from a user of a universally resolvable media content (“URMC”) service a request to purchase an unlocked URMC item;
obtain the user's social influence metric in the service;
obtain a purchase price associated with the URMC content item;
determine, based on the user's social influence metric, a discount;
provide the user an option to purchase the URMC content item at a purchase price reduced by the discount;
receive from the user an indication and an authorization to purchase the URMC item;
charge an account associated with the user the purchase price reduced by the discount; and
provide the user a mechanism for unlocking the URMC item.

16. An apparatus, comprising:
a memory;
a processor disposed in communication with said memory, and configured to issue a plurality of processing instructions stored in the memory, wherein the processor issues instructions to:
obtain from a user of a universally resolvable media content (“URMC”) service a request to purchase an unlocked URMC item;
obtain the user's social influence metric in the service;
obtain a purchase price associated with the URMC content item;
determine, based on the user's social influence metric, a discount;
provide the user an option to purchase the URMC content item at a purchase price reduced by the discount;
receive from the user an indication and an authorization to purchase the URMC item;
charge an account associated with the user the purchase price reduced by the discount; and
provide the user a mechanism for unlocking the URMC item.

17. A processor-implemented method, comprising:
obtaining a request to purchase an encryption free universally resolvable media content (“URMC”) item from a user of the URMC service;
obtaining a purchase price associated with the content item;
determining whether the user meets a discount criteria for purchasing the encryption free content item;
calculating, based on the determining, a discounted purchase price;
providing the user an option to purchase the encryption free content item at the discounted purchase price;
receiving from the user an indication and an authorization to purchase the encryption free content item;
charging an account associated with the user the discounted purchase price; and
providing the user the encryption free content item.

18. The method of claim 17, wherein the discount criteria includes reaching a threshold number of points via influencing activity.

19. The method of claim 17, wherein the discount criteria includes having the content item in a playlist created by the user.

20. The method of claim 19, wherein the purchase price is progressively discounted by an amount for every degree of separation users that add the content.

21. The method of claim 17, wherein the discount criteria includes reaching a threshold number of plays of the content item discovered via the user's playlist or library.

22. The method of claim 17, wherein the discount criteria includes reaching a threshold number of users playing the content item discovered via the user's playlist or library.

23. The method of claim 17, wherein the discount criteria includes reaching a threshold number of encryption free purchases of content item.
